(19) United States
(12) Patent Application Publication
(10) Pub. No.: US 2012/0211367 A1
(43) Pub. Date: Aug. 23, 2012

(54) ELECTROCHEMICAL CARBON NANOTUBE FILTER AND METHOD

(75) Inventor: Chad D. Vecitis, Somerville, MA (US)

(73) Assignee: PRESIDENT AND FELLOWS OF HARVARD COLLEGE, Cambridge, MA (US)

(21) Appl. No.: 13/358,248

(22) Filed: Jan. 25, 2012

Related U.S. Application Data
(60) Provisional application No. 61/436,031, filed on Jan. 25, 2011.

(51) Int. Cl. B03C 5/02; B82Y 99/00; B82Y 30/00

(52) U.S. Cl. 204/554; 204/665; 977/742; 977/752; 977/902

(57) ABSTRACT

A filtration apparatus and filtration method can be used to reduce at least one contaminant (e.g., organic molecules, ions and/or biological microorganisms) in an aqueous fluid. The filtration apparatuses and methods of the invention can separate at least one contaminant from an aqueous fluid and/or oxidize at least one contaminant. In operation, an aqueous fluid is flowed through a filtration apparatus comprising a porous carbon nanotube filter material at an applied voltage.

### CROSS-REFERENCE TO RELATED APPLICATIONS

This application claims benefit under 35 U.S.C. §119(e) of provisional application No. 61/436,031, filed on Jan. 25, 2011, the content of which is incorporated herein by reference in its entirety.

### FIELD OF THE INVENTION

The invention relates generally to filtration apparatuses and methods for reducing one or more contaminants from a fluid, e.g., an aqueous fluid. In particular, the invention is directed to filtration apparatuses and methods using an applied voltage for reducing aqueous contaminants.

### BACKGROUND OF THE INVENTION

Waterborne contaminants e.g., toxic chemical substances and pathogens, are a primary public health concern in developing countries and result in millions of deaths every year [1]. Minimal drinking water treatment is beneficial and should include removal of harmful contaminants such as organic molecules, ions, and pathogens.

Electrochemical processes have been reported to inactivate both viruses and bacteria [5-7]. Most previous studies have focused on electrochemical generation of active chlorine species (>2.5 V; HOCl, Cl2.⁻) or electrochlorination [6, 8]. However, active chlorine-based pathogen inactivation can result in formation of harmful disinfection by-products [9], making the treated water unsuitable for drinking. As such, boron-doped diamond (BDD) anodes have been developed for bacterial inactivation. Although BDD anodes do not generate active chlorine species [10, 11], they require greater driving potentials (>3.0 V) than electrochlorination and thus increase energetic requirements for the disinfection process. Another alternative material for electrochemical disinfection is porous elemental carbon. Carbon cloth [12], carbon fiber [13], and granular activated carbon [14] anodes have been reported to be useful for electrochemical inactivation of attached bacteria at relatively low potentials (˜1 V). While the low driving potentials of these carbon-based anodes may reduce energy requirements and avoid disinfection by-product formation, these porous elemental carbon anodes do not have large specific surface area for efficient electrochemical processes. Previous research has also discussed destruction of organic compounds by electrochemical oxidation. However, the low mass transfer of contaminants from water to the electrode surface has limited the usefulness of electrochemical techniques in water treatment.

A recent study has been attempted to improve the overall mass transfer of chemical compounds in electrochemical treatment of contaminated water. Yang J. et al., 43 Environ. Sci. Technol. 3796 (2009). The Yang J. et al.'s system utilizes electrodes made of carbon nanotubes (CNTs) packed between two activated carbon fiber felts. Such system has been shown to degrade an organic dye (e.g., X-3B) present in water by re-circulating the contaminated water through the system for ˜90 mins at an applied potential of about 10V. However, re-circulation of contaminated water through the system limits its usefulness in continuous free-flow processes. Further, the Yang et al. reference does not disclose the ability of the system to remove biological microorganisms such as pathogens in in aqueous fluid.

Other studies have also previously reported that CNTs can be useful for adsorbing ionic dyes (7), chlorophenols (8), and natural organic matter via van der Waals interactions with the sp²-conjugated (planar) CNT sidewalls (9). CNT oxidation produces a large number of carboxylate surface groups that can bind metal ions such as Zn²⁺ and Cd²⁺ (10). CNTs coated with ceria have been utilized to separate chromium and arsenate from aqueous solutions (11, 12). Further, randomly-oriented single-walled carbon nanotube (SWNT) (14, 15) and multi-walled carbon nanotube (MWNT) (16) filters have been previously shown to isolate bacteria and virus from an aqueous fluid by sieving and depth filtration, respectively. Aligned MWNT network can also be useful for isolation of heavy petroleum hydrocarbons, bacteria, and virus from aqueous solution by gravity filtration through their interstitial space (19). Although the CNTs have been used to separate organic matters and bacteria from an aqueous fluid, e.g., by adsorption and filtration (mainly size exclusion), adsorption breakthrough can occur over time. Unless the adsorbed/sieved matters on the CNTs are destroyed and/or removed, the over-loaded CNTs would be rendered ineffective for further filtration. In addition, the adsorbed/sieved organics and pathogens may remain active, toxic, and/or viable. If they are not inactivated or degraded, the adsorbed matters can still pose potential health hazards in our environment.

The application of electrochemical processes in water treatment has drawn considerable attention in the past few years, because the electrolytic process is easy to control by potential and current, and such process can operate at low temperatures and pressures. However, the electrochemical technique is not widely applied in water treatment because of the high cost and low current efficiency caused by low contaminant mass transfer from water to the electrode surface. While CNT is an attractive material for aqueous filtration due to large specific surface area, adsorption breakthrough poses a limitation on the filter life-time and its usage in continuous water treatment processes. As such, there is a strong need to develop a more effective and efficient apparatuses and/or methods for water treatment. Further, there is an unmet need in the art for development of novel point-of-use water filtration devices and methods for removal and/or inactivation of waterborne pathogens and/or contaminants.

### SUMMARY OF THE INVENTION

Aspects of the present invention stems from the discovery that an electrochemical filter comprising carbon nanotubes, e.g., multi-walled carbon nanotubes (MWNTs), can efficiently reduce at least one contaminant present in an aqueous solution, e.g., organic molecules, aqueous anions (e.g., chlorides and iodides), or biological microorganisms (e.g., viruses and bacteria), through a porous carbon nanotube network when a potential is applied. At an applied potential, the electrochemical MWNT filter can separate the contaminants from the aqueous fluid. Further, the MWNT filter can transform the contaminants (e.g., by oxidation). In some embodiments, the contaminants can be oxidized or deactivated on the MWNT filter. Accordingly, provided herein are filtration apparatuses and methods for reducing at least one contaminant in a fluid, e.g., an aqueous fluid. Examples of contaminants include, but are not limited to, chemical substances (e.g., organic molecules, and ions) and biological microorganisms (e.g., viruses, and bacteria). In some embodiments, the fluid, e.g., an aqueous fluid, can include an electrolyte, e.g., an ionic solution.

In one aspect, the present invention is directed to a filtration apparatus, for example, for reducing at least one contaminant in a fluid, e.g., an aqueous fluid. The filtration apparatus described herein includes (1) a housing forming a chamber with an inlet for receiving an input fluid and an outlet for releasing an output fluid; (2) a porous carbon nanotube filter material positioned between the inlet and the outlet, wherein at least a portion of the porous carbon nanotube filter material is in contact with a first conducting material, e.g., titanium; and (3) a second conducting material, e.g., permeable stainless steel, positioned between the inlet and the outlet. In some embodiments of the invention, the second conducting material and first conducting material can be separated or held in a spaced apart configuration by an insulating or dielectric material. In some embodiments, the second conducting material and the porous carbon nanotube filter material can be separated or held in a spaced apart configuration.

In some embodiments, the porous carbon nanotube filter material is utilized as an anode and connected to a voltage source via mechanical contact to the first conducting material, e.g., titanium.

In operation, the first and second conducting materials can be connected to a voltage source providing an applied potential between an anode and a cathode formed by the conducting materials. In some embodiments, a potential of at least about 1 volt is applied to the filtration apparatus.

In some embodiments, the porous carbon nanotube filter material includes a network of carbon nanotubes, e.g., multi-walled carbon nanotubes, with a porosity of at least about 10%. In some embodiments, the carbon nanotube filter material has an average pore size of at least about 0.5 nm. In some embodiments, the carbon nanotubes include a catalyst, e.g., metals, metal alloys, metal oxides, doped metal oxides, or a composite thereof.

Another aspect of the invention provides methods for reducing at least one contaminant from an aqueous fluid. The method includes (a) providing at least one filtration apparatus described herein; (b) connecting the first conducting material to a positive pole of a voltage source; (c) connecting the second conducting material to a negative pole of the voltage source; (d) applying a voltage from the voltage source; (e) passing the aqueous fluid through the porous carbon nanotube material from the inlet of the filtration apparatus, wherein the porous carbon nanotube material separates at least one contaminant from the aqueous fluid; and (f) collecting the output fluid from the outlet of the filtration apparatus.

In some embodiments, the applied voltage from the voltage source can be less than 10 volts. In other embodiments, the applied voltage from the voltage source can be at least about 1 volt, at least about 2 volts or at least about 3 volts. In some embodiments, the applied voltage can be sufficient for at least one contaminant to be oxidized or deactivated within the porous carbon nanotube filter material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A to 1G show a schematic diagram and images of one embodiment of the electrochemical filtration apparatus described herein. FIG. 1A shows a diagram of the filter 100 according to the present invention. The filter 100 can include an enclosure or casing 102 adapted to enclose a perforated stainless steel cathode 112, an insulating silicone rubber separator and seal 114, a titanium anodic ring 110 that can be pressed into the carbon nanotube anodic filter, and the MWNT anodic filter 108 supported, for example, by a PTFE membrane. FIG. 1B shows an image of one embodiment of the electrochemical filtration set-up. FIG. 1C shows an image of a polycarbonate filter casing 102 with cathodic (connected to 112) and anodic (connected to 110) leads on top. FIG. 1D shows an image of the modified filtration casing, the perforated stainless steel cathode 112 in the back and is separated from the anodic titanium ring 110 by the insulating silicone rubber O-ring 114. FIG. 1E shows an image a MWNT filter 108 composed of 3 mg MWNTs (0.31 mg/cm² coverage) on a Teflon membrane (5-μm pore size) on the bottom piece of apparatus. FIG. 1F shows an image of two MWNT filters prior to use. FIG. 1G shows an image of two MWNT filters post-electrochemical filtration (2 V, left; 3 V, right). Note that the filters are still free-standing and intact. Filters in FIGS. 1F and 1G are roughly scaled to size.

FIGS. 2A to 2F show scanning electron micrographs of the MWNT filter. FIGS. 2A to 2C show aerial images of the MWNT filter with an average pore size of 115±47 nm in indicated length scales. FIGS. 2D to 2F show cross-section images of the MWNT filter with an average height of 41±8 μm in indicated scales.

FIGS. 3A to 3C show electrochemical MWNT filter I-V curves as a function of NaCl concentration and liquid flow rate. FIG. 3A shows ‘instantaneous’ current (mA) as a function of applied potential (V) for [NaCl]ᵢₙ=0 mM, 1 mM, 10 mM, and 100 mM where ‘instantaneous’ is described as the first current reading displayed after setting to a specific voltage. FIG. 3B shows a comparison of ‘instantaneous’ vs. ‘steady-state’ I-V curves for 10 mM NaCl at 1.5 mL min⁻¹ where ‘steady-state’ occurs after sufficient electrolysis time such that the current does not change, e.g., after 10-15 s. FIG. 3C shows ‘instantaneous’ I-V curves for 10 mM NaCl at flow rates of 0 mL min⁻¹, 0.5 mL min⁻¹, 1.5 mL min⁻¹, 2.5 mL min⁻¹, and 3.5 mL min⁻¹, respectively.

FIGS. 4A to 4C show MWNT filter dye adsorption isotherms. FIG. 4A shows a schematic diagram of dye adsorption on the MW NT filter. FIG. 4B shows methylene blue adsorption breakthrough curves for MWNT filters of various dimensions; [MB]ᵢₙ=7.0±1.0 μM, [NaCl]=10 mM, and 1.5±0.1 mL min⁻¹. FIG. 4C shows methyl orange adsorption breakthrough curves for three MWNT filters of similar dimensions; [MO]ᵢₙ=25.0±2.0 μM, [NaCl]=10 mM, 1.5±0.1 mL min⁻¹, h=41 μm, and d=30 mm. Representative plots are shown, and all experiments were completed in at least duplicate.

FIG. 5 shows images of the electrochemical MWNT filtration cell during methylene blue adsorption under 0 V followed by desorption and oxidation at ˜3 V upon application of a potential after 105 minutes. The images correspond to data in FIG. 4B and 3 volts in FIG. 7B.

FIG. 6 shows images of the electrochemical MWNT filtration cell during methyl orange adsorption under 0 V followed by oxidation at ˜3V upon application of a potential after 35 minutes. The images correspond to data in FIG. 4C and 3 volts in FIG. 7C.

FIGS. 7A to 7C show electrochemical desorption and/or oxidation of adsorbed dye as a function of applied potential. Dye adsorption was completed in the absence of applied potential under similar conditions as described in FIGS. 4A to 4C. Negative time points are the time prior to application of potential at t=0 noted by the vertical dashed line. FIG. 7A shows a schematic diagram of electrochemical desorption (top panel) and oxidation (bottom panel) of adsorbed dye. FIG. 7B shows adsorbed methylene blue desorption and oxidation at potentials of 1 V (square), 2 V (circle), and 3 V (triangle). The inset is the same plot zoomed in on the y-axis to show low concentration data. FIG. 7C shows adsorbed methyl orange oxidation at potentials of 1 V (square), 2 V (circle), and 3 V (triangle). It is of note that no desorption is observed for the negatively charged methyl orange. Representative plots are shown, all experiments were completed in at least duplicate, and lines are eye guides.

FIGS. 8A to 8B show electrochemical filtration of dyes as a function of applied potential. Experimental set-up is the same as those in FIGS. 1A to 1G. FIG. 8A shows electrochemical filtration of methylene blue at potentials of 0 V (square), 1 V (circle), 2 V (triangle), and 3 V (inverted triangle), respectively. FIG. 8B shows electrochemical filtration of methyl orange at potentials of 0 V (square), 1 V (circle), 2 V (triangle), and 3 V (inverted triangle), respectively. Representative plots are shown, and all experiments were completed in at least duplicate.

FIGS. 9A to 9C show I-V curves and electrochemical filtration of NaCl and NaI. Experimental conditions are J=1.5 min⁻¹. FIG. 9A shows steady-state I-V curves for [NaCl]ᵢₙ=10 mM (square) and [NaCl]ᵢₙ=10 mM & [NaI]ᵢₙ=10 mM (circle). FIG. 9B shows electrochemical iodide filtration at potentials of 0 V (square), 1 V (circle), 2 V (triangle), and 3 V (inverted triangle), respectively. Representative plots are shown, and all experiments were completed in at least duplicate. FIG. 9C shows electrochemical iodide filtration over a range of [NaCl] and [NaI]. In the legend, X-Y is representative of salt concentrations in mM where X is NaCl and Y is NaI. Open symbols represent experiments run at ˜2 V and closed symbols represent experiments run at ˜3 V. All experiments were completed in at least duplicate.

FIG. 10 shows thermogravimetric analysis (TGA) of as-received MWNTs. The MWNTs were used for all experiments (1.3% amorphous carbon and 8.7% residual, mostly Fe as determined by EDX) in the Examples 7-10.

FIGS. 11A to 11G show characterization of the MWNT filter in various length scales. FIGS. 11A to 11D show SEMs of the aerial view of MWNT filters in indicated length scales. FIGS. 11E to 11G show SEMs of side view of MWNT filters in indicated length scales.

FIGS. 12A to 12C show electrochemical characterization of the MWNT filter. FIG. 12A show current vs. potential at various ionic strengths of NaCl (1-155 mM). FIG. 12B is a zoom-in graph of FIG. 12A to show threshold potential. FIG. 12C shows current vs. time at constant voltage (V) for [NaCl]=˜100 mM.

FIGS. 13A and 13B show effect of potentials on electrochemical MS2 removal and/or inactivation. FIG. 13A displays log MS2 removal as a function of applied potential during filtration. The input fluid was 10 mL of 10 mM NaCl (pH 5.7) and 10⁶ viruses/mL and was filtered at a rate of 4 mL/min (filter approach velocity of 250 L/m²/h). At ˜2 V and ˜3 V, no viruses were detected in the output fluid from the filter. FIG. 13B displays culturable virus PFU from MWNT filter extraction as a function of the post-filtration applied potential. The input fluid was 10 mL of 10 mM NaCl (pH 5.7) with ˜10⁶ virus/mL and was filtered at a rate of 4 mL/min (filter approach velocity of 250 L/m²/h) in the absence of potential. Adsorbed viruses were then electrolyzed for ˜30 s at ˜2 V or ˜3 V before they were extracted from the MWNT filter. It should be noted that extractable and culturable virus from the filter is about 0.5% to about 1.0% of the total virus adsorbed. Each data point represents the mean of at least duplicate measurements under the same experimental conditions, with error bars representing standard deviations.

FIG. 14 shows culturable MS2 desorbed from filter as percentage of total MS2 sorbed on filter. MWNT filter was bath sonicated in 10 mL of 10 mM NaCl until the MWNTs were removed (1-2 min) from the PTFE membrane and suspended in solution. Adsorbed viruses in the suspension of recovered MWNTs were subsequently analyzed by the PFU protocol. Total MS2 sorbed on the filter was determined by taking the difference in viral PFU concentrations between the output and input fluids.

FIG. 15 shows electrochemical loss of E. coli viability versus potential and time. E. coli suspension (˜10⁷ cells, [NaCl]=10 mM, pH 5.7) was first sieved onto the MWNT filter and then electrolyzed at an applied voltage of ˜1 V, ˜2 V, or ˜3 V for ˜10 s or ˜30 s. Bacteria were stained immediately after electrolysis for viability assay. Each data point represents the mean of at least duplicate measurements under the same experimental conditions, with error bars representing standard deviations.

FIGS. 16A to 16D show scanning electron micrographs (SEM) of E. coli on the MWNT filter before and after electrolysis. Bacteria were fixed (glutaraldehyde and osmium tetroxide) and dehydrated in preparation for SEM analysis. FIG. 16A display cells fixed immediately after sieving onto the MWNT filter. FIGS. 16B, 16C and 16D show cells exposed to electrolysis for ˜30 s in 10 mM NaCl at an applied potential of ˜1 V, ˜2 V, and ˜3V, respectively.

FIGS. 17A to 17E show electrolytic inactivation mechanisms and voltage-dependent dye oxidation. FIG. 17A depicts direct (left) electrochemical oxidation of bacteria adhered to MWNT surface, and indirect (right) electrochemical production of aqueous oxidant that subsequently inactivates the bacteria in solution. FIGS. 17B, 17C, and 17D show epifluorescence images of PI-stained bacteria electrolyzed at an applied potential of ˜1 V, ˜2 V, and ˜3 V, respectively, for ˜30 s in 10 mM NaCl (pH 5.7). Typical PI red fluorescence is shown at ˜1V and ˜2V, whereas the fluorescence at ˜3 V has been shifted towards a lower wavelength. FIG. 17E shows a fluorescent emission spectra (λ_{exc}=450 nm) of PI (1.2 mL, 50 μM) reacted with 0 μL, 1 μL, 2 μL, and 3 μL of 50 mM HOCl. Location of fluorescence emission peak shifts to a lower wavelength with addition of oxidant (HOCl).

FIGS. 18A-18G show SEM images, thermogravimetric analysis and X-ray photoelectron spectrum of some embodiments of the CNT networks described herein. FIG. 18A shows an aerial image of C-CNT-HCl network. FIG. 18B shows a cross section of raw CNT network, and FIG. 18C shows an aerial image of C-CNT-SS network. FIG. 18D shows a set of scanning electron micrographs of the various CNT filters at 10 k× and 50 k× magnifications. FIG. 18E shows a schematic diagram of CNT surface chemistry after various CNT surface treatments described herein. FIG. 18F shows a set of thermogravimetric analysis data of the various CNT samples. FIG. 18G shows a set of X-ray photoelectron spectrum of the various CNT samples in various binding energy ranges: C1s, O1s, and Fe2p3 for all samples and Sn3d5 and Sb3d5 for the C-CNT-SS.

FIGS. 19A-19F show electrochemical characterization data of different CNT filters. Unless otherwise stated, FIGS. 19A-19F were generated using influent conditions of 1 mM MO, 100 mM Na₂SO₄, and a flow rate of 1.5 mL min⁻¹. FIG. 19A shows a cyclic voltammogram of the C-CNT-sample completed at a scan rate of 10 mV FIG. 19B shows linear sweep voltammograms for different indicated CNT filter samples, and FIG. 19C shows anodic and cathodic open circuit potential (V) of the C-CNT sample over a range of applied voltages from 0V to 3 V. FIG. 19D shows cyclic voltammograms of different indicated CNT samples. FIG. 19E shows a plot of open circuit potential vs. time for different indicated CNT samples, and FIG. 19F shows an analysis result of electrochemical impedance spectroscopy of different indicated CNT samples.

FIGS. 20A-20D show sets of data indicating electrochemical CNT filter batch oxidative performance. Electrochemical filters were challenged with 1 mM MO in 100 mM Na₂SO₄ electrolyte at a flow rate of 1.5 mL min⁻¹. Steady-state current (mA; blue bars), MO degradation (%; red bars), and electrochemical impedance (ohm; gray bars) are plotted in an approximate order of increasing performance at an applied potential of (FIG. 20A) 2 V and (FIG. 20B) 3 V. FIG. 20C shows data of oxidative performance at 3V of the C-CNT-HCl (blue) and C-CNT-HNO₃ (red) networks toward MO and MB decolorization, phenol TOC removal, and CTAB, methanol, formaldehyde, and formate conversion to carbon dioxide. FIG. 20D shows a set of data indicating electrochemical filtration of various organic chemicals using the indicated CNT filters (i.e., C-CNT-HCl (top panel) and C-CNT-HNO₃ (bottom panel)) at 3 V. The influent concentration of all species is 1 mM with the exception of CTAB at 0.1 mM. The percent degradation (red bars) is in terms of decolorization (for MO and MB), TOC removal (for phenol), and TIC formation i.e., conversion to carbon dioxide (for CTAB, MeOH, formaldehyde, formate). The current is presented as the blue bars in mA and the electrochemical impedance is presented in the gray bars in ohm.

FIGS. 21A-21F show results of electrochemical and effluent characteristics vs. applied voltages for different indicated surface chemistry of the CNT samples: CNT (black squares), C-CNT (red circles), CNT-HNO₃ (blue up triangles), C-CNT-HNO₃ (green down triangles), CNT-HCl (pink left triangles), C-CNT-HCl (yellow right triangles), and C-CNT-SS (navy diamonds). FIG. 21A shows a plot of MO degradation (1-[MO]_{ef}/[MO]ᵢₙ) as a function of applied voltages for different indicated CNT samples. FIG. 21B shows a plot steady-state current (mA) as a function of applied voltages for different indicated CNT samples. FIG. 21C shows a plot of an anode potential (V) as a function of applied voltages for different indicated CNT samples. FIG. 21D shows a plot of effluent pH as a function of applied voltages for different indicated CNT samples. FIG. 21E shows a plot of back pressure (kPa) as a function of applied voltage (V) different indicated CNT samples. FIG. 21F shows a set of images of the gas bubbles produced during electrochemical CNT filtration. Error bars were not shown in FIGS. 21A-21E for clarity, and typical standard deviations for the degradation, current, and potential plots were ±5%, and for pH and back pressure, typical standard deviations were ±20%.

FIGS. 22A-22G show direct injection mass spectrums of influent as compared to effluent of different CNT electrochemical filter at applied potentials of 2 V and 3 V. FIG. 22A: CNT; FIG. 22B: C-CNT; FIG. 22C: CNT-HCl; FIG. 22D: CNT-HNO₃; FIG. 22E: C-CNT-HCl; FIG. 22F: C-CNT-HNO₃, and FIG. 22G: C-CNT-SS.

FIGS. 23A-23C show SEM images of Nation-coated CNT network in various Nafion/CNT ratios. FIG. 23A shows a set of SEM images of Nafion-coated CNT network with a Nafion/CNT ratio of 1:6. FIG. 23B shows a set of SEM images of Nation-coated CNT network with a Nafion/CNT ratio of 1:2.4. FIG. 23C shows a set of SEM images of Nation-coated CNT network with a Nafion/CNT ratio of 2:3.

FIGS. 24A-24E show SEM images of Nation-coated CNT network (in a ratio of 1:6 Nafion: CNT) with SnO₂ deposition. FIG. 24A shows a set of SEM images of in situ Nation-coated CNT network with SnO₂ deposition. FIG. 24B shows a set of SEM images of soaked Nafion-coated CNT network with SnO2 deposition. FIGS. 24C-24E show SEM images of the cathode of Nafion-coated CNT network with SnO2 deposition.

FIGS. 25A-25D show chronoamperometry data for Nafion-coated CNT networks performed at different anode potentials. FIGS. 25A and 25B show chronoamperometry data for Nafion-coated CNT networks (using 40 uL Nafion) performed at 1.2 V and 1.7 V, respectively. FIGS. 25C and 25D show chronoamperometry data for Nafion 20-SnO2-Nafion 40-coated CNT networks performed at 2.0 V and 2.2 V, respectively. The term “Nafion 20-SnO2-Nafion 40-coated CNT” as used herein refers to CNT-Nafion composite films in which at least one additional Nafion coating is applied after SnO₂ deposition on the Nafion-coated CNT films.

FIGS. 26A-26C show energy efficiency and oxidation data for Nafion-coated CNT films as compared to uncoated films (normal films), represented by plots of a change in MO concentration/current as a function of anode potentials.

FIGS. 27A-27E show experimental data for titanium and CNT passivation. The current in mA and the effluent TOC in mgC L⁻¹ were monitored as a function of time. The electrochemical impedance in ohms was measured at the start and at the end of each run. The electrochemical filtration conditions were [PhOH]ᵢₙ=1 mM=72 mgC L⁻¹, [Na₂SO₄]ᵢₙ=100 mM, and J (flow rate)=1.5 mL min⁻¹, anode potential=1.60 V. FIG. 27A shows data for fresh Ti ring and fresh CNT film run for 360 min. FIG. 27B shows data for continuation of the run (from FIG. 27A) for another 360 min after polishing the Ti ring with a sandpaper. FIG. 27C shows data for continuation of the run (from FIG. 27B) with fresh CNT film for 400 min. FIG. 27D shows data of LSV performed under the same conditions as above with a scan rate 10 mV s⁻¹. FIG. 27E shows a relationship between applied voltage and anode potential.

FIGS. 28A-28E show experimental data for regeneration of the used CNT films. The electrochemical filtration conditions were [PhOH]ᵢₙ=1 mM=72 mgC L⁻¹, [Na₂SO₄]ᵢₙ=100 mM, and J (flow rate)=1.5 mL min⁻¹, anode potential=1.60 V. FIG. 28A shows data for used Ti and CNT film run for 400 min. FIG. 28B shows data for continuation of the run (from FIG. 28A) after regenerating the CNT film by flowing with mixture solution containing EtOH and DI Water (V:V=1:1) and HCl (pH=1.7) at the rate 1 mL min⁻¹ for 60 min. FIG. 28C shows data for continuation of the run (from FIG. 28B) after regenerating the CNT film (from the end of run of FIG. 28B) by dispensing the CNT film in 30 ml pure DMSO and re-forming the CNT afterward. FIG. 28D shows data of LSV performed under the same conditions as above with a scan rate 10 mV s⁻¹. FIG. 28E shows a relationship between applied voltage and anode potential.

FIGS. 29A-29C show experimental data for additional regeneration methods: (1) electrochemical regeneration method (denoted by EtOH—HCl-CV) in which 60 mL mixture solution containing EtOH and DI water (V:V=1:1) and HCl was flowed through the CNT film, and cyclic voltammetry (CV) was performed with a scan rate 10 mv s⁻¹ for strengthening reactivation performance; (2) calcinations in which the used CNT films were calcinated in a tube furnace by increasing from room temperature to 400° C. for at a rate of 5° C. per min and holding for 60 min; (3) the used CNT films were dispersed in 30 mL of eight solutions or solvents: NaOH (pH=13), NaOH (pH=13)+SDS (0.1%), HCl (pH=1.76), n-methylpyrrolidone (MP), DMSO, ethanol (EtOH), toluene and hexane. The same CNT film preparation was performed as discussed earlier, except that the dispersed CNT solution were put into 50° C. oven for about 24 h followed by CNT film preparation by vacuum system. FIG. 29A shows data of polymer removal efficiencies under different indicated conditions. FIG. 29B shows data of the final CNT diameter or polymer removal percent as a function of the polarity of the regeneration solution. FIG. 29C shows a set of scanning electron micrographs of the various CNT filters treated with different regeneration solutions.

FIGS. 30A-30F show experimental data for electrochemical characterization of the regenerated CNT filter performance. Electrochemical conditions were J (flow rate)=1.6 mL min⁻¹, [MOH]=1.0 mM, and [Na₂SO₄]=100 mM. FIG. 30A shows data of LSV performed under the same conditions as above with a scan rate 10 mV s⁻¹. FIG. 30B shows a relationship between anode potential and voltage. FIG. 30C shows the steady-state anode potential-current relation, where each anode potential was run for 15-20 min. FIG. 30D shows a steady-state anode potential-applied voltage relation. FIG. 30E shows effluent TOC as a function of anode potential where the applied voltage was increased until the anode potential reached 1.6 V. FIG. 30F shows effluent TOC as a function of time where the electrolysis was continued for another 3-4 hours at an anode potential of 1.6 V.

FIGS. 31A-31E show experimental data for the CNT films run in long term at different anode potentials of 0.82 V, 1.60 V and 2.10 V. Electrochemical conditions were J (flow rate)=1.6 mL min⁻¹, [PhOH]=1.0 mM, and [Na₂SO₄]=100 mM. FIG. 31A shows effluent TOC as a function of time where the electrolysis was continued for 3-6 hours. FIGS. 31B-31D show SEM photographs of CNT networks after use at the anode potentials of 0.82 V, 1.60 V and 2.10 V, respectively. FIG. 31E shows a plot of current as a function of time at different anode potentials of 0.82 V, 1.60 V and 2.10 V.

FIGS. 32A-32F show scanning electron micrographs, and thermogravimetric analysis of fresh and electrolyzed CNT networks (including C-CNT, B-CNT and N-CNT). FIG. 32A shows a plot of mass percent and dTG (peaks) in mg ° C.⁻¹ as a function of temperature for fresh B-CNT (solid), C-CNT (dashed), and N-CNT (short dash) networks. FIGS. 32B, 32C, and 32D show scanning electron micrographs of the B-CNT, C-CNT, and N-CNT, respectively. FIG. 32E shows a set of SEM images of fresh and electrolyzed CNT networks including C-CNT, B-CNT and N-CNT networks at 50 k× and 100 k× magnifications. FIG. 32F shows a set of thermogravimetric data for fresh and electrolyzed CNT networks including C-CNT, B-CNT and N-CNT networks.

FIGS. 33A-33C show X-ray photoelectron spectroscopy (XPS) data of fresh and electrolyzed CNT networks (including C-CNT, B-CNT and N-CNT). FIG. 33A corresponds to one or more embodiments of the C-CNT networks used in the filtration apparatus described herein. FIG. 33B corresponds to one or more embodiments of the B-CNT networks used in the filtration apparatus described herein. FIG. 33C corresponds to one or more embodiments of the N-CNT networks used in the filtration apparatus described herein.

FIGS. 34A-34C show sets of data for electrochemical and effluent characteristics of different CNT networks (including C-CNT, B-CNT and N-CNT networks) during electrochemical filtration of various phenol concentrations as a function of applied voltage and time. FIG. 34A corresponds to electrochemical filtration of 0.0 mM phenol and 100 mM sodium sulfate as function of applied voltage and time. FIG. 34B corresponds to electrochemical filtration of 0.2 mM phenol and 100 mM sodium sulfate as function of applied voltage and time. FIG. 34C corresponds to electrochemical filtration of 1.0 mM phenol and 100 mM sodium sulfate as function of applied voltage and time.

FIGS. 35A-35C show plots of electrochemical filtration of phenol as a function of CNT doping, applied voltage, and time. In all indicated cases, the applied voltage was increased until the anode potential reached 1.6 V vs. SCE as described in the left half of the plots and then the electrolysis was continued for another 5 to 6 hours as described in the right hand of the plots. Electrochemical conditions were J=1.5 mL min⁻¹, [PhOH]=0.2 mM, and [Na₂SO₄]=100 mM for B-CNT (squares-solid line), C-CNT (circles-dashed line) and N-CNT (triangles-short dash line). FIG. 35A shows a plot of steady-state current in mA as a function of applied voltages and time for different doped CNT network. FIG. 35B shows a plot of effluent total organic carbon (TOC) in mgC/L as a function of applied voltages and time for different doped CNT network. FIG. 35C shows a plot of TOC removal current efficiency in % as a function of applied voltages and time for different doped CNT network.

FIGS. 36A-36F show experimental data for electrochemical phenol polymerization and electrolyte precipitation. Electrochemical C-CNT filtration conditions were J=1.5 mL min⁻¹, [Na₂SO₄]=100 mM, t=5 h, and 3 V. FIG. 36A shows a plot of TGA mass percent and dTG (peaks) of a fresh C-CNT network (solid), C-CNT network after filtration of 1 mM phenol in the absence of potential (dashed), C-CNT network after electrochemical filtration (short dash), and C-CNT network after electrochemical filtration of 1 mM phenol (dot). FIG. 36B shows a SEM image of fresh C-CNT network. FIG. 36C shows a plot of percent CNT, residual, and polymer versus CNT network. FIG. 36D shows a SEM image of C-CNT network after electrochemical filtration of 1 mM phenol. FIG. 36E shows a SEM image of N-CNT network after electrochemical filtration of 1 mM phenol. FIG. 36F shows a SEM image of C-CNT network after electrochemical filtration of 1 mM phenol for 20 h.

FIGS. 37A-37D show analysis results of CNT oxidation versus electrolyte precipitation. Electrochemical C-CNT filtration conditions were J=1.5 mL min⁻¹, [Na₂SO₄]=100 mM, t=5 h, and 3 V. FIG. 37A shows a C-CNT network thermogravimetric analysis of percent mass and dTG (peaks) versus temperature for fresh (1, solid), electrochemical filtration (3, dash), electrochemical filtration with 1 mM phenol (6, short dash), electrochemical filtration sample washed with acidic water-ethanol mixture (4, dot), and electrochemical filtration with 1 mM phenol sample washed with acidic water-ethanol mixture (7, dash dot). FIG. 37B shows burn peak temperature of samples from FIG. 37A. FIG. 37C shows O/C, S/C, and S/O ratios of samples from FIG. 37A determined by XPS. FIG. 37D shows a C-CNT network thermogravimetric analysis of percent mass and dTG (dash) versus temperature (solid) for fresh network (black) and networks mixed with 20% w/w of sodium sulfate (red), potassium persulfate (green), and sodium carbonate (blue).

FIGS. 38A-38C show experimental data for electrochemical Polymer Growth. FIG. 38A shows a plot of CNT diameter (determined from SEM images) as a function of doping, electrochemistry, and phenol concentration. FIG. 38B shows a plot of CNT network pore diameter (determined from SEM images) as a function of doping, electrochemistry, and phenol concentration. FIG. 38C shows a plot of C-CNT diameter (determined from SEM images) as a function of electrochemistry, phenol concentration, network washing and electrolysis time.

FIG. 39 shows a schematic diagram of an exemplary electrochemical filtration reactive transport mechanism. (1) Molecules are transported to electrode surface via convective and diffusive mass transfer as a function of flow rate, J, and concentration, C. (2) Molecules are adsorbed onto CNT surface as a function of temperature, T. (3) Molecules diffuse on the CNT surface to electrochemically active sites and electron transfer occurs as a function of anode potential, V.

FIG. 40 is a SEM aerial image of one or more embodiments of the CNT network used for electrochemical filtration.

FIG. 41 shows data of chronoamperometry for the batch and filtration electrochemical systems. The conditions are [MO]ᵢₙ=300 μM and [NaCl]=10 mM for both systems and J=1.5 mL min⁻¹ for the filtration system. The inset displays a linear plot of current versus time^{-1/2} for the batch system.

FIGS. 42A-42B show normal pulse voltammograms for the batch and filtration electrochemical systems. FIG. 42A corresponds to [MO]ᵢₙ=300 μM and FIG. 42B corresponds to [MO]ᵢₙ=1,100 μM. The experimental conditions are [NaCl]=10 mM and the flow rate was J=1.5 mL min⁻¹ for the filtration system. The mass transfer limited regime is marked with a horizontal line.

FIGS. 43A-43B show a diagrammatic scheme of representative diffusion layer concentration profile: (FIG. 43A) batch system and (FIG. 43B) filtration system.

FIGS. 44A-44B show effects of temperature on electrochemical filtration oxidation kinetics. FIG. 44A shows effect of temperature on the extent of oxidation during electrochemical filtration where the applied voltage=2 V, J=1.5 mL min⁻¹, and [MO]ᵢₙ=300 μM. FIG. 44B shows effect of temperature on MO dye adsorption to the CNTs. Adsorption used 0.015 g CNTs, V=100 mL, and allowed for 24 h to reach equilibrium. The points are experimental data and lines are fitted to the Langmuir isotherm.

FIGS. 45A-45B show data for concentration dependent oxidation of methyl orange and methylene blue during electrochemical filtration. FIG. 45A corresponds to data for methyl orange and FIG. 45B corresponds to data for methylene blue. The conditions are [NaCl]=10 mM, T=25° C., and J=1.5 mL min⁻¹ for all experiments.

FIGS. 46A-46B show data for voltage-dependent oxidation during electrochemical filtration. FIGS. 46A and 46B corresponds to data for methyl orange and methylene blue, respectively. For all experiments, the conditions are [MO]ᵢₙ=[MB]ᵢₙ=7 μM, [NaCl]=10 mM, J=1.5 mL min⁻¹, and T=25° C. for all experiments.

FIG. 47 shows effect of anode potential on MO oxidation and anodic current density during electrochemical filtration. Experimental conditions were [NaCl]=10 mM, J=1.5 mL min⁻¹, and [MO]ᵢₙ=300 μM.

FIG. 48 shows a schematic, simplified diagram of a 2-D CNT filter structure used in numerical simulation: CNTs are modeled to be an array of cylinders aligned along the direction that is perpendicular to the flow.

FIG. 49 shows dependence of methyl orange oxidation on influent concentration.

FIG. 50 shows linear fitting of Butler-Volmer kinetics. The dots are experimental data and the line is the linear fitting of the data to Butler-Volmer kinetics model.

FIGS. 51A-51B show representations of velocity fields calculated based on the mathematical model. FIGS. 51A and 51B correspond to velocity surface and velocity contour, respectively.

FIG. 52 shows a concentration contour map, where flow is introduced from the top surface of the CNT filter. The red lines denote highest concentration and blue lines denote lowest concentration.

FIGS. 53A and 53B show comparison of kinetics model prediction values and experimental data for influent concentration-dependent experiment and potential-dependent experiment, respectively. In both figures, the flow rate is 1.5 mL/min. The anode potential is kept constant at 2V in FIG. 53A, whereas the influent concentration is kept constant at 300 μM.

FIGS. 54A and 54B show concentration surface of CNTs based on numerical simulation under mass transfer limitation and oxidation kinetics limitation, respectively.

FIGS. 55A-55E show simulated results of an array of CNT anodes and a single CNT anode. In these simulations, a flow of 35.4 um s⁻¹ is introduced from the top surface of the CNT anode array, and the influent concentration is 1 uM at an anode potential of 0.8 V. FIG. 55A shows simulated flux magnitude for a 3 by 3 array of CNT anodes. FIG. 55B shows simulated velocity contour of one cylinder CNT anode. FIG. 55C shows simulated flux magnitude of one cylinder CNT anode. FIG. 55D shows a set of simulated concentration surface and contour maps of one cylinder CNT anode. FIG. 55E shows simulated reaction rates along the perimeter of one cylinder CNT anode.

### DETAILED DESCRIPTION OF THE INVENTION

The present invention is directed to a filtration device comprising a carbon nanotube filter material, for example, for reducing at least one contaminant in an input fluid flowing there through. The input fluid can be any aqueous fluid, e.g., comprising at least one contaminant described herein. Without limitations, the contaminant can be any particulate, molecule, or cellular material. Examples of contaminants include, but are not limited to, organic molecules, ions such as anions, biological microorganisms, and any combination thereof.

In embodiments of the invention, the filtration apparatus includes (a) a housing forming a chamber with an inlet for receiving an input fluid and an outlet for releasing an output fluid; (b) a porous carbon nanotube filter material positioned between the inlet and the outlet, wherein at least a portion of the porous carbon nanotube filter material is in contact with a first conducting material; and (c) a second conducting material positioned between the inlet and the outlet.

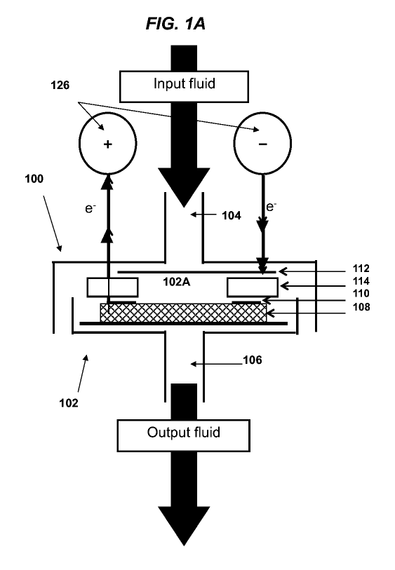

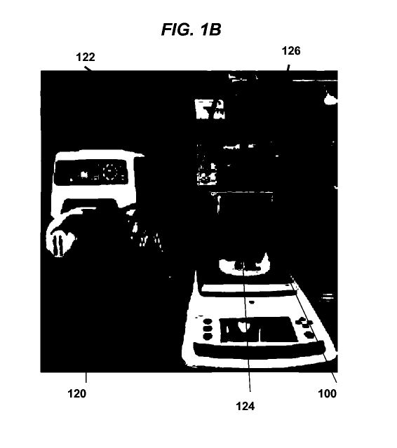

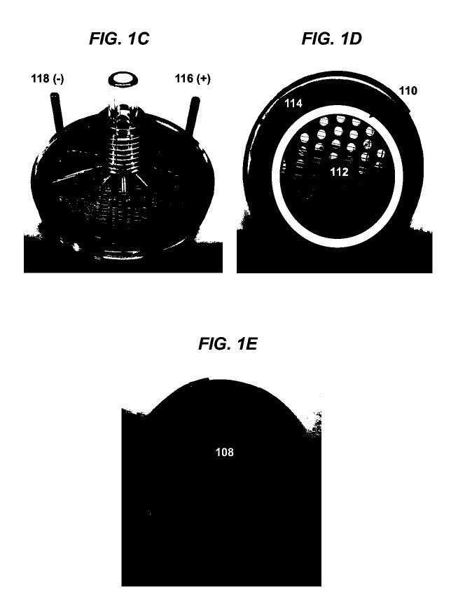

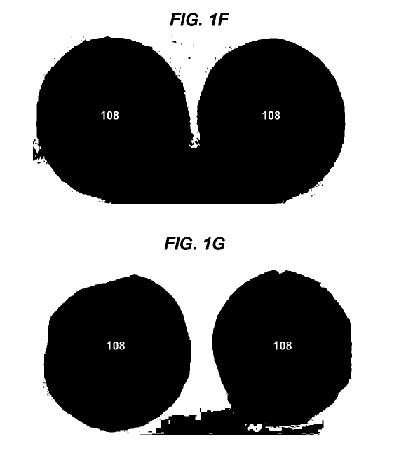

FIG. 1A illustrates a cross-sectional diagrammatic view of a filtration apparatus in accordance with one or more embodiments of the invention. The filtration apparatus 100 includes a housing 102 forming a chamber 102A with an inlet 104 and an outlet 106. Inside the chamber 102A, a porous carbon nanotube filter material 108 is positioned between the inlet 104 and the outlet 106, wherein at least a portion of the porous carbon nanotube filter material 108 is in contact with a first conducting material 110. In addition, a second conducting material 112 is positioned between the inlet 104 and the outlet 106. In some embodiments, the second conducting material 112 can be positioned between the carbon nanotube filter material 108 and the inlet 104, as shown in FIG. 1A. In alternative embodiments, the second conducting material 112 can be positioned between the carbon nanotube filter material 108 and the outlet 106. In such configuration, any gases, e.g., hydrogen, produced on the second conducting material 112 can be carried out through the outlet 106 without being driven into the porous carbon nanotube filter material 108 that may result in a blockage of the pores.

In some embodiments, the second conducting material 112 and the porous carbon nanotube filter material 108 can be separated and positioned in a spaced-apart configuration. In these embodiments, the distance between the second conducting material 112 and the porous carbon nanotube filter material 108 can be less than 5 cm, less than 4 cm, less than 3 cm, less than 2 cm, less than 1 cm, less than 500 μm or less than 250 μm. In one embodiment, the distance between the second conducting material 112 and the porous carbon nanotube filter material 108 is less than 1 cm. It should be noted that the electrolysis efficacy improves with decreasing distance between the first conducting material 110/porous carbon nanotube filter 108 and second conducting material 112. In some embodiments, the second conducting material is not in contact with the porous carbon nanotube filter material 108 or the first conducting material 110. The second conducting material 112 can be separated from the porous carbon nanotube filter material 108 and/or the first conducing material 110 by an insulting material, e.g., an insulating silicone rubber seal 114, as shown in FIGS. 1A and 1D.

In some embodiments of the invention, the first conducting material 110 is in contact with at least a portion of the porous carbon nanotube filter material 108. In various embodiments, the first conducting material 110 can be porous and allow an input fluid to penetrate through and contact the porous carbon nanotube filter material 108. For example, the first conducting material 110 can be a ring as shown in FIG. 1D. As the carbon nanotubes are conductive in one dimension, the first conducting material can facilitate a current flow between the carbon nanotube filter material and an external voltage source. It will be understood that the first conducting material 110 can have any shape and/or size, e.g., based upon the shape and/or size of the carbon nanotube filter material 108.

In various embodiments, the second conducting material 112 can be permeable to an input fluid, i.e., an input fluid can penetrate through the second conducting material. For example, in one embodiment, the second conducting material 112 can be perforated, as shown in FIG. 1D. In another embodiment, the second conducting material 112 can be a mesh. The shape and size of the second conducting material 112 can be adjusted according to the shape and size of the filtration surface area, i.e., the surface area of the carbon nanotube filter material 108.

The first 110 and second 112 conducting materials can be any electrically-conductive materials known in the art. The electrically-conductive materials can be any metal, transition metal, non-metal, oxides or any composite thereof. Without limitations, exemplary conducting materials include stainless steel, titanium or titanium alloys, zirconium alloy, nickel or nickel alloys, brass, carbon-amorphous, graphite, copper, copper graphite, copper tellurium, copper tungsten, copper zirconium diboride, gold or gold alloy, electrographite, metal graphite, molybdenum, palladium or palladium alloys, platinum or platinum alloys, plated base metal, resin bonded graphite, gold or gold alloys, silver or silver alloys, silver copper, silver cadmium oxide, silver graphite, silver molybdenum, silver nickel, silver tin oxide, silver tungsten, silver tungsten carbide, tungsten, and tungsten carbide. In some embodiments, the conducting materials can comprise a coating of metal, transition metal, oxides or any composite thereof. The choice of the first and second conducting materials can depend upon a number of factors, for example, the nature of the fluid to be processed, its relative pH, various types and relative concentrations of its contaminates.

In some embodiments, the first conducting material 110 includes titanium, e.g., at a percentage of at least about 10%, at least about 20%, at least about 30%, at least about 40%, at least about 50%, at least about 60%, at least about 70%, at least about 80%, at least about 90%, at least about 95%, at least about 98%, about 99%, or 100%. In one embodiment, the first conducting material 110 is titanium. Titanium is resistant to corrosion and relatively low-cost, compared to other corrosion-resistant materials. In some embodiments, the first conducting material 110 should be corrosion-resistant.

In some embodiments, the second conducting material 112 includes stainless steel, e.g., at a percentage of at least about 10%, at least about 20%, at least about 30%, at least about 40%, at least about 50%, at least about 60%, at least about 70%, at least about 80%, at least about 90%, at least about 95%, at least about 98%, about 99%, or 100%. In one embodiment, the second conducting material 112 is stainless steel. Stainless steel is relatively low-cost and contains iron that can catalyze hydrogen production. In some embodiments, the second conducting material can contain iron. In some embodiments, the second conducting material can be any other conducting metal, such as copper, nickel, silver, gold, or platinum. In some embodiments, the second conducting material can be another porous carbon nanotube filter material described therein. One of skill in the art can select an appropriate second conducting material, depending on the goal of the electrochemical reaction. For example, hydrogen production efficiency can be improved by adding some nickel or platinum into the second conducting material 112. If carbon dioxide is desired to be reduced, a copper cathode can be used.

In some embodiments of the filtration apparatus, the housing 102 can be made of any material compatible to the input fluid to be processed, e.g., resistant to a solvent, or a biological solution. In some embodiments, the material of the housing can be selected for its resistance to cleaning and/or sterilization methods, such as UV-irradiation, disinfectants, steams and/or high pressures. In one embodiment, the housing of the invention is made of plastic, e.g., polycarbonate. Depending on choice of an input fluid and/or process conditions, a skilled artisan will be able to select an appropriate housing material. For example, acetone can dissolve polycarbonate. If the input fluid is an organic solvent, e.g., acetone, a different housing material, other than polycarbonate, will be selected.

In further embodiments, as shown in FIG. 1C, the housing 102 of the filtration apparatus 100 can have at least two openings (preferably sealed openings) for a first conducting lead 116 and a second conducting lead 118, wherein the first conducting lead 116 contacts the first conducting material 110, and the second conducting lead 118 contacts the second conducting material 112. The first conducting lead 116 and the second conducting lead 118 can be used herein to facilitate an electrical connection to the positive and negative poles of a voltage source 126. In some embodiments, the first conducting material 110 can be connected to a positive pole or a negative pole of a voltage source 126, e.g., via the first conducting lead 116. The second conducting material 112 can be connected to a positive pole or a negative pole of a voltage source 126, e.g., via the second conducting lead 118. It should be appreciated that the first and second conducting leads can be any electrically-conductive materials (e.g., any metal or non-metal) of any shape, which allow an electric current flow through the voltage source and the first and second conducting materials when connected to a voltage source.

As used herein, the phrase “a voltage source” refers to an electrical device or an electrical component that supplies a voltage or an electric potential between two terminals to induce a current to flow through path between the positive and negative terminals. In one embodiment, the voltage sources supplies a direct-current (DC) potential. In another embodiment, the voltage sources supplies an alternating-current (AC) potential. Non-limiting examples of a voltage source include a battery, a voltage generator, and a power supply. As understood in the art, electrons flow from the negative pole (“anode”) of a voltage source, through the circuit and return to the positive pole (“cathode”) of the voltage source. Stated in another convention, an electric current flows from the positive pole of a voltage source, through the circuit and returns to the negative pole of the voltage source.

In some embodiments, the voltage source can produce a potential of at least about 0.5 volt, at least about 1 volt, at least about 2 volts, or at least about 3 volts. In some embodiments, the voltage source can produce a potential of less than 10 volts, less than 9 volts, less than 8 volts, less than 7 volts, less than 6 volts, less than 5 volts or less than 4 volts. In one embodiment, the voltage source produces a potential of about 0.5 volt to about 10 volts, about 1 volt to about 8 volts, or about 1 volt to about 5 volts.

Without wishing to be bound by theory, when the filtration apparatus of the invention is in operation, gases can be produced, e.g., due to electrolysis reaction, and accumulate inside the filtration apparatus. In some circumstances, the gas formation can result in blockage of the pores within the carbon nanotube filter material, affecting the operating condition thereof. Accordingly, in some embodiments, a valve or vent, such as a pressure release valve, can be incorporated into the filtration apparatus to vent the accumulated gases.

### Porous Carbon Nanotube Filter Material

The carbon nanotube filter material 108 of the filtration apparatus described herein can include a network of carbon nanotubes. As used herein, the phrase “a network of carbon nanotubes” refers to an arrangement of intertwined carbon nanotubes. The carbon nanotubes can be intertwined in a random orientation, in an ordered configuration, or a combination thereof. In some embodiments, the carbon nanotubes can be randomly or evenly distributed within the network.

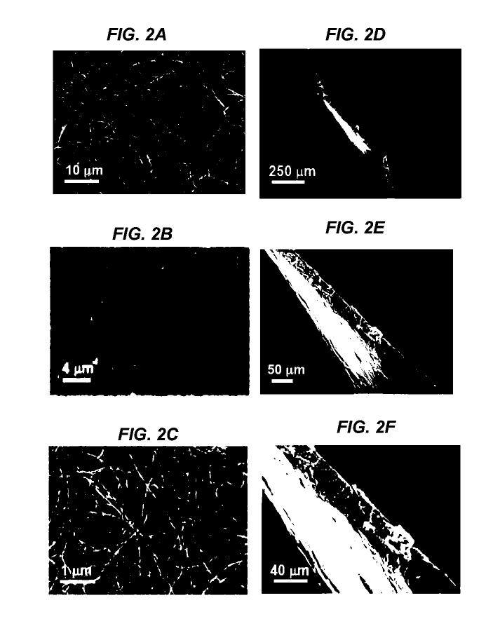

In various embodiments, the network of carbon nanotubes can form a two-dimensional or three-dimensional structure. In some embodiments, the network of carbon nanotubes can form a mesh. In some embodiments, the network of carbon nanotubes can form a mat, as shown in FIGS. 2A to 2G, or FIGS. 11A to 11G. In some embodiments, the carbon nanotube filter material 108 can be free-standing (as shown in FIG. 1F), as opposed to carbon nanotubes packed between two conducting and/or porous materials (e.g., activated carbon felts) described in Yang et al (30).

The carbon nanotube filter material can be fabricated by any methods known to a skilled artisan, e.g., the methods disclosed in U.S. App. Nos.: US 2006/0027499 and US 2006/0073089, which are hereby incorporated by reference in their entirety. In general, the carbon nanotubes can be dispersed in an organic solvent, e.g., DMSO, by a mechanical means such as probe-sonication, and the carbon nanotube suspension can then be filtered through a porous membrane. The carbon nanotubes collected on the porous membrane form the carbon nanotube filter material 108 as shown in FIG. 1E.

It will be understood by one of ordinary skill in the art that the carbon nanotube filter material can exhibit a distribution of pore sizes. The pores can have any shape, e.g., spherical, elliptical, or polygonal. The pore shape can be heterogeneous within the carbon nanotube filter material. The pore size distribution can be determined from any methods known in the art. For example, the pore size distribution can be determined by analysis of images from scanning electron microscopy (FIGS. 2A to 2C and FIGS. 11A to 11D) described in the Examples. Alternatively, the pore size distribution can be determined by flowing a medium with beads of various known sizes through the carbon nanotube filter material, and then analyzing the size distribution in the downstream flow. Accordingly, in some embodiments, the carbon nanotube filter material can have a pore size distribution ranging from about 0.1 nm to about 5 μm, about 0.5 nm to about 5 μm, about 1 nm to about 5 μm, about 5 nm to about 5 μm, from about 10 nm to about 2 μm, from about 30 nm to about 1 μm, from about 50 nm to about 500 nm, or from about 50 nm to about 200 nm. In one embodiment, the carbon nanotube filter material has a pore size of about 50 nm to about 200 nm.

Unless otherwise stated, the term “average pore size” as used herein refers to the average of a pore size distribution. In some embodiments, the carbon nanotube filter material amenable to the invention can have an average pore size of at least about 0.1 nm, at least about 0.5 nm, at least about 1 nm, at least about 5 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 250 nm, at least about 500 nm, or at least about 1 μm.

In reference to the carbon nanotube filter material, the term “porosity” or “porous” as used herein describes the permeability of a filter material. For example, a porous filter permits a fluid to penetrate through. In contrast, a non-porous filter is impermeable and does not let a fluid to pass through. The term “porosity” as used herein is a measure of the extent of permeability of a filter material. Stated in another way, the term “porosity” is a measure of void spaces in a material, and is a fraction of volume of voids over the total volume, as a percentage between 0 and 100% (or between 0 and 1).

In some embodiments, the carbon nanotube filter material has a porosity of at least about 10%, at least about 20%, at least about 30%, at least about 40%, at least about 50%, at least about 60%, at least about 70%, at least about 80%, at least about 90% or more. In some embodiments, the carbon nanotube filter material can have a porosity of about 50% to about 98%, about 70% to about 95% or about 80% to about 95%. The pore size and total porosity values can be quantified using conventional methods and models known to those of skill in the art, such as mercury porosimetry and nitrogen adsorption. One of ordinary skill in the art can determine the optimal porosity of the carbon nanotube filter material for the purpose of the invention. For example, the porosity and/or pore size of the carbon nanotube filter material can be optimized, e.g., according to the operating condition and properties of contaminants to be reduced.

Thickness of the carbon nanotube filter material can vary in accordance with different embodiments of the invention. In some embodiments, the filter material can have a thickness ranging from about 5 μm to about 1000 μm, from about 5 μm to about 500 μm, from about 5 μm to about 250 μm, from about 10 μm to about 100 μm, or from about 15 μm to about 80 μm. In one embodiment, the filter material has a thickness of about 10 μm to about 30 μm. In one embodiment, the filter material has a thickness of about 25 μm to about 80 μm. Different carbon nanotube filter thickness can be used based upon the properties of the input fluid and contaminants therein, the respective concentration of the contaminants, and/or the desired contact surface area of the carbon nanotube filter material. For example, a higher contact surface area of the carbon nanotube filter material can be achieved by increasing the loading of the carbon nanotubes and thus the thickness of the carbon nanotube filter material. As illustrated in the Examples, a thinner carbon nanotube filter material can be used to reduce pathogens (e.g., viruses and bacteria) in a contaminated aqueous fluid, as compared to reducing organic molecules therein. In some embodiments, the filter material can have a thickness in the millimeter or centimeter range, e.g., a thickness of at least about 1 mm, at least about 3 mm, at least about 5 mm, at least about 1 cm, at least about 5 cm, at least about 10 cm, at least about 20 cm, at least about 30 cm, at least about 40 cm, at least about 50 cm or thicker. Such filter material can be used in an industrial-type filter, such as a packed-bed filter.

In some embodiments, the porous carbon nanotube filter material can be a composite of two or more layers of the carbon nanotube filter materials. Each carbon nanotube filter material layer can have different porosity, pore size, and/or loading and types of carbon nanotubes.

The design (e.g., shape or size) of the carbon nanotube filter material can vary according to the shape, size and capacity of the filtration apparatus. Depending upon the design of the housing, the filter material can have any shape. In one embodiment, a circular filter material is encased inside a cylindrical housing (FIG. 1C). Further, the diameter of the filter material can be adjusted according to the width of the housing, and/or the desired throughput of the filtration apparatus described herein. If a higher filtration throughput is desired for processing a large volume of a fluid, e.g., in a wastewater treatment plant, a filter material with a larger cross-sectional area could be used. On the other hand, if the filter material is designed for a portable filtration device, the size of the filter has to be taken into consideration with respect to ease of transport. Accordingly, the size of the filter material 108 can vary from millimeters to meters, e.g., from about 5 mm to about 500 m, from about 10 mm to about 250 m, from about 20 mm to about 100 m, from about 30 mm to about 50 m, from about 35 mm to about 25 m. In one embodiment, the diameter of the filter material is comparable to the width of the housing (FIG. 1E), e.g., from about 30 mm to about 60 mm. In some embodiments, the filtration apparatus can be designed for processing micro-volume of fluid. In such cases, the size of the filter material can be reduced down to a micro-meter level, and vary from about 10 μm to about 1000 μm, from about 20 μm to about 750 μm, from about 50 μm to about 500 μm, or from about 20 μm to about 500 μm.

Without limitations, alternative filter designs, other than a flat-sheet filter material as illustrated in FIG. 1A, can be used for the purpose of the invention. For example, a hollow-fiber filter material, e.g., hollow fibers arranged in a coaxial configuration, can be wrapped or encased by a second conducting material. In such configuration, a pressure source, e.g., vacuum, can be used to draw the fluid through the pores and into the hollow-fiber filter material.

In additional embodiments, the carbon nanotube filter material can include an agent, e.g., to target a desired component, to enhance its electrical properties, or to enhance its electrochemical activity. In some embodiments, the agent can be dispersed within the carbon nanotube filter material. In some embodiments, the agent can be dispersed in a coating (e.g., a film coating or a particle coating) formed on the surface of the carbon nanotube filter material. In some embodiments, the agent can be bonded to the carbon nanotube filter material. Exemplary agents can include, but are not limited to, peptides, nucleic acid (e.g., DNA or RNA), antibodies, small molecules, biological or organic enzymes, catalysts, and inorganic compounds (e.g., metal, transition metal, non-metal, and oxides). In one embodiment, the agent is a catalyst, which can be selected from a metal, a metal alloy, a metal oxide, a doped metal oxide or any combination thereof. Non-limiting examples of a catalyst include platinum and platinum alloys, silver and silver alloys, nickel and nickel alloys, tin oxide and doped tin oxides, titanium oxide and doped titanium oxide, and any combination thereof.

In certain embodiments, the agent described herein can be dispersed in a network of carbon nanotubes. In some embodiments, the agent described herein can be dispersed within the carbon nanotubes. In other embodiments, the agent can be incorporated into the structure of the carbon nanotubes. In alternative embodiments, the agent described herein can be dispersed in a coating (e.g., a film coating or a particle coating) formed on the surface of the carbon nanotubes.

As used herein, “carbon nanotubes” refers to graphene sheets rolled into single-walled nanotubes (SWNTs) or coaxial double- and multi-walled nanotubes (DWNTs and MWNTs) (2). In one embodiment, the carbon nanotubes can be multi-walled carbon nanotubes. For example, the multi-walled carbon nanotubes can comprise at least two layers (e.g., in concentric tubes) of graphite, including at least three layers, at least four layers, at least five layers, at least six layers, at least seven layers or more, of carbon or its allotropes. In another embodiment, the carbon nanotubes can be a combination of SWNTs and MWNTs. In accordance with some embodiments of the invention, the CNTs can have high aspect ratios' (10³-10⁷), large specific surface areas (50-1000 m²g⁻¹) (3), exceptional mechanical strength (4), and be conducting or semiconducting (5). The conductive nature of CNTs [4] allows for simultaneous electrochemistry during the filtration process that can enhance separation of contaminants from an aqueous and/or and electrochemically inactivate the contaminants.

In some embodiments, at least a portion of the carbon nanotubes can be doped carbon nanotubes. As used herein, the term “doped” is used in reference to the presence of at least one ion or atom, other than carbon, in the crystal structure of the rolled sheets of hexagonal carbon. That is, doped carbon nanotubes have at least one carbon in the hexagonal ring replaced with a non-carbon atom. Examples of non-carbon atoms include, without limitations, a trivalent atom or p-type dopant (e.g., elements with three valence electrons such as boron or aluminum), a pentavalent atom or a n-type dopant (e.g., elements with five valence electrons such as nitrogen and phosphorous), a halogen (e.g., F, Cl, or Br) and any combinations thereof. In some embodiments, the doped carbon nanotubes can be nitrogen-doped carbon nanotubes. In some embodiments, the doped carbon nanotubes can be boron-doped carbon nanotubes. In some embodiments, the doped carbon nanotubes can be fluorine-doped carbon nanotubes, e.g., by fluorination. Doping can influence the physical and/or chemical properties of the carbon nanotubes such as conductivity and specific capacitance, and thus the electrochemical activity of the CNT filter material. Doping of carbon nanotubes are known to one of skill in the art, e.g., see the chapter of “Doping of carbon nanotubes” in “Doped Nanomaterials and Nanodevices,” Wei Chen (2010) Volume 3.

According to some embodiments, at least a portion of the carbon nanotubes can be doped with boron, nitrogen, or a combination thereof. In one embodiment, for example, doped carbon nanotubes can comprise boron in an amount ranging from about 0.01 weight percent to about 10 weight percent. In another embodiment, doped carbon nanotubes can comprise about 0.1 weight percent boron to about 5 weight percent. In other embodiments, doped carbon nanotubes can comprise nitrogen in an amount ranging from about 0.01 weight percent to about weight 20 percent, from about 0.1 weight percent to about 10 weight percent, or from about 0.1 weight percent to about 5 weight percent. In some embodiments, doped carbon nanotubes can comprise boron and nitrogen. In such embodiments, doped carbon nanotubes can have any weight percent of boron and nitrogen as described herein, for example, between about 0.01 weight percent and about 10 weight percent, or between about 0.1 weight percent and about 5 weight percent, of boron and nitrogen.

The diameter and length of the carbon nanotubes can be changed to modify the structure (e.g., porosity and/or pore size) and/or property of the carbon nanotube filter material. In some embodiments, the diameter of the carbon nanotubes can be in a range of about 0.1 nm to about 100 nm, about 0.5 nm to about 100 nm, about 0.5 nm to about 50 nm, about 0.5 nm to about 40 nm, about 0.5 nm to about 30 nm, about 1 nm to about 30 nm, or about 5 nm to about 30 nm. In some embodiments, the length of the carbon nanotubes can be in a range of about 20 nm to about 200 nm, about 30 nm to about 180 nm, about 50 nm to about 150 nm, or about 50 nm to about 130 nm. With respect to the length of the carbon nanotubes, it can be in a range of about 10 μm to about 500 μm, about 25 μm to about 400 μm, or about 50 μm to about 200 μm.

In some embodiments, the carbon nanotubes can comprise amorphous carbon, which is an allotrope of carbon without a crystalline structure. In some embodiments, the carbon nanotubes can comprise amorphous carbon at a percentage of less than 20%, less than 10%, less than 5%, or less than 3%.

In some embodiments, the carbon nanotubes can comprise metal residues, e.g., metal residues arising from the use of a metal, e.g., iron, as a catalyst during synthesis of carbon nanotubes. In such cases, the carbon nanotubes can comprise metal residues of up to about 20%, about 15%, about 10%, or about 5%. In one embodiment, the carbon nanotubes comprise about 8% to about 9% residual iron. In one embodiment, the carbon nanotubes comprise about 4% to about 5% residual iron.

Carbon nanotubes (CNTs) can be produced by any methods known in the art, e.g., arc discharge method, laser evaporation method, or chemical vapor deposition method. Depending upon the structure or configuration of the carbon nanotubes, a skilled artisan can select appropriate methods to prepare the desired carbon nanotubes. Alternatively, commercially-available carbon nanotubes, e.g., from Nanotech Labs, can also be purchased for use in the invention.

In some embodiments, at least a portion of the carbon nanotubes can be subjected to at least one processing treatment (including at least two, at least three, at least four or more processing treatments), e.g., to increase reactive CNT surface sites and/or to enhance the electrooxidative performance of the anodic porous carbon nanotube filter material described herein. For example, the surface chemistry of at least a portion of the carbon nanotubes can be modified by at least one processing treatment (including at least two, at least three, at least four or more processing treatments), e.g., to affect the chemical, physical and/or electrochemical properties of the carbon nanotubes such as chemical absorption, colloidal properties, antimicrobial properties, and/or electrooxidative performance.

Various processing treatments to modify surface chemistry of the carbon nanotubes are known in the art. Examples of such processing treatments include, but are not limited to, chemical modification of the carbon nanotubes with a functional group (e.g., a chemical functional groups such as a carbonyl group), functionalization of the carbon nanotubes with a polymer or dendrimer, photo-oxidation (e.g., with UV radiation), plasma polymerization, high-temperature heating, silanization, acid-oxidation, calcination, surface coating treatment (e.g., coating with catalyst particles), and any combinations thereof. Depending on desired properties of the CNTs, one of skill in the art can perform appropriate art-recognized surface treatments accordingly.

In some embodiments, at least a portion of the carbon nanotubes can be subjected to at least one processing treatment comprising high-temperature heating or calcination. The term “calcination” as used herein refers to a thermal process applied to carbon nanotubes generally to remove any amorphous or other carbon impurities. The calcination process generally takes places at temperatures below the melting point of the carbon nanotubes. For example, calcination of the carbon nanotubes can be carried out in air heated to about 200° C.-about 800° C., or to about 400° C.-about 700° C. In some embodiments, the calcination can be performed at higher temperatures, e.g., up to about 1200° C. under different pressure conditions. For example, calcination of the carbon nanotubes can be carried out at higher temperatures (e.g., up to about 1200° C.) in the absence of oxygen, either in vacuum or in the presence of hydrogen and/or an inert gas such as argon. Such higher temperature anoxic treatment can result in calcination with no formation of oxidation functional groups. In some embodiments, calcination of carbon nanotubes can be performed in a variety of gases containing oxygen, and/or at a variety of pressures, such as between 10⁻⁵ bar and 10 bars, or higher, provided that a mild oxidation of the nanotube results that does not affect the performance of the carbon nanotube filter material. Any other art-recognized calcination methods for carbon nanotubes, e.g., the method described in U.S. Pat. App. No.: US 2008/0292530, can be used to treat the carbon nanotubes.

In one embodiment, the carbon nanotubes can be calcinated, e.g., in a tube furnace, by increasing the temperature from room temperature to about 400° C. at any reasonable rate, e.g., at a rate of about 5° C./min or higher, and maintaining for a certain period of time (e.g., about 1 hour or more) at about 400° C. The duration of the calcination process can range from minutes to days, e.g., 30 mins, 60 mins, 1 hour, 2 hours, 3 hours, 6 hours, 12 hours, 1 day, 2 days or longer, depending on the types and/or concentrations of impurities to be removed, and the calcination temperature. See Example 11 for exemplary methods of CNT calcination and its effects on electrooxidative CNT filter performance.

In some embodiments, at least a portion of the carbon nanotubes can be subjected to at least one processing treatment comprising contacting at least a portion of the carbon nanotubes with an acid, e.g., a mineral acid, an organic acid, or combinations thereof. Examples of acids that can used to treat the carbon nanotubes include, but are not limited to, hydrochloric acid, hydrofluoric acid, hydrobromic acid, hydroiodic acid, sulfuric acid, oleum, nitric acid, citric acid, oxalic acid, chlorosulfonic acid, phosphoric acid, trifluoromethane sulfonic acid, glacial acetic acid, monobasic organic acids, dibasic organic acids, and any combinations thereof. The acid used can be a pure acid or diluted with a liquid medium, such as an aqueous and/or organic solvent. In some embodiments, concentrated hydrochloric acid can be used, e.g., to remove any metallic or metal oxide impurities (e.g., Fe₂O₃ nanoparticles). In some embodiments, concentrated nitric acid can be used, e.g., to induce formation of surficial oxy-functional groups, such as surface carbonyl, hydroxyl, and carboxyl groups. After acid treatment, the acid and impurities can be removed from the carbon nanotubes by washing or rinsing, e.g., with a solvent such as water. See Example 11 for exemplary methods of acid treatment and its effects on electrooxidative CNT filter performance.

In some embodiments, at least one catalyst can be introduced to or dispersed in at least a portion of the carbon nanotube ends, interior and/or exterior surfaces by any known methods in the art, e.g., solution chemical deposition, electrochemical deposition, chemical deposition, physical deposition by evaporation, sputtering, molecular beam epitaxy, electrostatic interaction (e.g., van der Waals forces) or any combination thereof. In some embodiments, the catalyst can be dispersed as individual molecules randomly and/or orderly to at least a portion of the carbon nanotube ends, interior and/or exterior surfaces. In some embodiments, the catalyst can be dispersed in a coating (e.g., a film coating or a particle coating) formed on the surface of at least a portion of the carbon nanotubes.

In some embodiments, the catalyst can be an electrocatalyst. An “electrocatalyst” is generally a material that is capable of increasing the rate of electrochemical oxidation or reduction of a redox reactant, as compared to the rate of electrochemical oxidation or reduction of a redox reactant in the absence of the electrocatalyst. An electrocatalyst can be a metal or a metal alloy (e.g., platinum, silver, nickel, iron, antimony, alloys thereof or any combinations thereof), a metal oxide (e.g., tin oxide or titanium oxide), a doped metal oxide (e.g., doped tin oxide or doped titanium oxide) or any combinations thereof. In some embodiments, the electrocatalyst can comprise metal oxide, e.g., tin oxide or titanium oxide. In one embodiment, the electrocatalyst can comprise doped metal oxide, e.g., doped tin oxide. In such embodiment, the dopant present in the doped metal oxide can comprise antimony, e.g., the electrocatalyst can comprise Sb-doped SnO₂ particles.

In some embodiments, the electrocatalyst added to the carbon nanotubes is an electrocatalyst with a high O₂ overpotential. The term “overpotential” as used herein is generally referred to the potential (voltage) difference between a half-reaction's thermodynamically determined reduction potential and the potential at which the redox event is experimentally observed. As used herein, the term “high overpotential” generally refers to a condition in which the overpotential is more than the overpotential that would be normally observed for a given reaction. In order to prevent oxygen evolution at an operational potential of the filtration apparatus described herein, e.g., an operational potential of at least about 1.5 V, at least about 2 V, at least about 3 V or higher, an electrocatalyst that allows oxygen evolution to occur at any potential higher than the operational potential can be desirable. In some embodiments, the electrocatalyst with a high O₂ overpotential can comprise Sb-doped SnO₂ particles.

In one embodiment, at least a portion of the carbon nanotubes can be coated with an electrocatalyst comprising antimony-doped tin oxide (Sb-doped SnO₂ particles). By way of example only, the carbon nanotubes coated with Sb-doped SnO₂ particles can be prepared by a hydrothermal method (e.g., described in Fujuhara S. et al. (2004) 20 Langmuir 6476; and Wen Z. H. et al. (2007) 17 Adv. Funct. Mater. 2772) or any other methods known in the art. See Example 11 for exemplary methods of Sb-doped SnO₂ particle coating and its effects on electrooxidative CNT filter performance.

In some embodiments, the carbon nanotubes can be derivatized or functionalized with one or more functional groups. The functionalization of the carbon nanotubes can be covalent or non-covalent. In some embodiments, the carbon nanotubes can be derivatized or functionalized on their ends or sides with functional groups, such as carboxylic acid, alkyl, acyl, aryl, aralkyl, halogen; substituted or unsubstituted thiol; unsubstituted or substituted amino; hydroxy, and OR′ wherein R′ is selected from the group consisting of alkyl, acyl, aryl aralkyl, unsubstituted or substituted amino; substituted or unsubstituted thiol, and halogen; and a linear or cyclic carbon chain optionally substituted with one or more heteroatom. The number of carbon atoms in the alkyl, acyl, aryl, aralkyl groups can vary depending on types and/or sizes of the functional groups. In some embodiments, the number of carbon atoms in the alkyl, acyl, aryl, aralkyl groups can be in the range of about 1 to about 30, and in some embodiments in the range of about 1 to about 10. In some embodiments, the carbon nanotubes can be derivatized or functionalized with at least one aryl group or at least one aromatic-type molecules such as pyrene and naphthalene.

In some embodiments, the carbon nanotubes can be derivatized or functionalized with one or more function groups before introduction of a catalyst or an electrocatalyst. In such embodiments, the derivatization or functionalization of the carbon nanotubes can provide catalyst support performance, e.g., by promoting chemical bonding, chelating or creating a polar attraction of the catalyst to the ends and/or sidewalls of the carbon nanotubes. For example, carboxylic acid functional groups on a carbon nanotube can bond, chelate or provide a polar attraction to a catalyst and promote a catalyst-nanotube interaction. The functionality on the carbon nanotubes can provide “docking sites” for the catalyst.

In some embodiments, the carbon nanotubes can be derivatized or functionalized with at least one or more functional groups, e.g., oxy-functional groups, by contacting the carbon nanotubes with an acid, e.g., nitric acid for surficial formation of oxy-functional groups such as carbonyl, hydroxyl, and/or carboxyl groups. Accordingly, in some embodiments, the carbon nanotubes can be treated with an acid, e.g., nitric acid, prior to introduction of a catalyst or an electrocatalyst.

In some embodiments where at least one end of the carbon nanotubes is not initially open, e.g., covered by amorphous carbon, the carbon nanotubes can be subjected to calcination (or high-temperature heating) before any further processing treatments so that the interior surface of the carbon nanotubes can be exposed to any subsequent processing treatments. For example, in some embodiments, the carbon nanotubes can be subjected to calcination before treatment with an acid, e.g., hydrochloric acid or nitric acid. In one embodiment, the carbon nanotubes can be calcinated (or subjected to high-temperature heating) followed by acid treatment and introduction of a catalyst or an electrocatalyst.

In additional embodiments, the carbon nanotubes can be coated with a polymer, e.g., a polymer with ionic properties. In some embodiments, the polymer with ionic properties can comprise a sulfonated tetrafluoroethylene based fluoropolymer-copolymer, e.g., Nafion. Such polymer coating can not only enhance strength and/or durability of the carbon nanotubes, but can also wrap catalyst or electrocatalyst particles to the carbon nanotubes. See, e.g., Example 12. The amount ratio of the polymer to the carbon nanotubes can be value provided that the composition does not significantly affect the permeability and/or porosity of the carbon nanotube filter material. In some embodiments, the ratio of the polymer (e.g., Nafion) to the carbon nanotubes can be less that 1:4, less than 1:5, less than 1:6, less than 1:7, less than 1:8, less than 1:9, less than 1:10 or lower. Additional polymers that can be used to coat the carbon nanotubes include, without limitations, polyvinylidene fluoride (PVDF), polyethersulfone, polyamide, polysulfone, cellulose acetate, polytetrafluoroethylene (PTFE), polystyrene, and any combinations thereof. Any art-recognized polymers typically used in membranes can also be used to coat the carbon nanotubes used in the filtration apparatus described herein.

In some embodiments, surface charges of the carbon nanotubes can be modified, e.g., to effect the adsorption of a contaminant (or a molecule to be removed from an aqueous fluid) on the CNT surface. For example, the carbon nanotubes can be treated with an acid, e.g., nitric acid, to induced formation of negatively-charged surface oxy-groups, for increased adsorption of positively-charged molecules on the CNT surface.

Accordingly, in certain embodiments, at least a portion of the carbon nanotubes can be subjected to at least two processing treatments, at least three processing treatments, at least four processing treatments or more, as described above.

### Methods of the Invention

In accordance with the invention, contaminants such as organic molecules and/or biological microorganisms present in an aqueous fluid can be reduced after passing through the filtration apparatus of the invention. Accordingly, another aspect of the invention provides for methods of reducing at least one contaminant in an aqueous fluid. The method includes (a) providing at least one filtration apparatus described herein; (b) connecting the first conducting material to a positive pole of a voltage source; (c) connecting the second conducting material to a negative pole of the voltage source; (d) applying a voltage from the voltage source; (e) passing the aqueous fluid through the inlet of the filtering apparatus; (f) extracting at least one contaminant in filtration apparatus from the aqueous fluid as it flows from the inlet to the outlet; and (g) collecting the fluid from the outlet of the filtration apparatus.

As used herein, the term “reduce” or “reducing” when referring to filtration generally means a decrease in the amount of at least one contaminant present in an aqueous fluid. In some embodiments, the term “reduce” or “reducing” means a statistically significant decrease in the amount of at least one contaminant present in an aqueous fluid, for example, by at least about 5% as compared to the amount in the absence of filtration, for example a decrease by at least about 10%, at least about 20%, at least about 30%, at least about 40%, at least about 50%, at least about 60%, at least about 70%, at least about 80%, at least about 90% or more, up to and including a 100% reduction, or any decrease in the amount of at least one contaminant between 5-100% in an aqueous fluid as compared to the amount in the absence of filtration.

In reference to reduction of contaminants in an aqueous fluid by the filtration apparatus of the invention, the term “reduce” or “reducing” can encompass separation of at least one contaminant from an aqueous fluid, e.g., by adsorption or sieving. It can further encompass a transformation of at least one contaminant in an aqueous fluid. With respect to biological contaminants, e.g., biological microorganisms, the transformation of a contaminant can involve a change in cell morphology, e.g., cell shape, structure, composition and/or texture. In some embodiments, a bacterial cell in contact with the carbon nanotube filter material, e.g., E. coli, becomes elongated or have a disturbance (e.g., a disruption) in the cell membrane. Additionally or optionally, the transformation of a biological contaminant can involve a decrease or at least a partial inactivation of a cell's function, e.g., cell viability or infectivity. With respect to a non-biological contaminant, e.g., organic molecules, the transformation of a contaminant can mean a change in the molecular composition and/or structure of the contaminant, e.g., by oxidation. In accordance with the invention, the term “reduce” or “reducing” when referring to a contaminant can further encompass a partial or complete destruction of at least one contaminant in an aqueous fluid. For example, contaminants such as organic molecules and/or biological microorganisms in an aqueous fluid can be destroyed by degradation and/or transformation described herein, e.g., oxidation.

In accordance with the invention, non-biological contaminants such as organic molecules or anions in an aqueous fluid can be adsorbed to the carbon nanotube filter material in the absence of an applied potential. When an applied potential is applied, the adsorbed organic molecules or anions can be oxidized (see Examples 1-6). In one embodiment, the method described herein using an applied potential of about 2 volts results in greater than 90% oxidation of the fluid contaminant during a single pass through the filtration apparatus with a residence time of less than 2 seconds.

In a further accordance with the invention, biological contaminants such as viruses and bacteria in an aqueous fluid can be sieved and/or adsorbed on the carbon nanotube filter material in the absence of an applied potential. An applied potential can further reduce the number of viruses and bacteria in the fluid, e.g., to the level below the limit of detection, and inactivate the sieved bacteria and adsorbed virus (see Examples 7-10). In one embodiment, the method described herein using an applied potential of about 2 volts to about 3 volts results in at least greater than 90% reduction of bacteria or virus from the aqueous fluid. The term “inactivate” as used herein, in reference to biological microorganisms such as pathogens, refers to a decrease in function of a biological microorganism, e.g., cell viability and/or infectivity. Methods for determining viability and/or infectivity of biological organisms are well established in the art. The methods described in the Materials and Methods for Examples 7-10 can also be used for such purposes.

In accordance with the invention, at least one contaminant present in an aqueous fluid can be reduced by using the filtration apparatus described herein. By way of example, one embodiment of the filtration apparatus is utilized in describing the methods of the invention. However, as one of ordinary skill will appreciate, various embodiments of the filtration apparatus can be employed in the methods described herein.

In operation, as shown in FIGS. 1A and 1B, the first conducting material 110 should be connected to a positive pole of a voltage source, e.g., via a first conducting lead 116, while the second conducting material 112 is connected to a negative pole of a voltage source, e.g., via a second conducting lead 118.

After both the first and second conducting materials have been properly connected to a voltage source, a voltage or a potential can be supplied to the filtration apparatus from the voltage source. In some embodiments, a potential of at least about 0.5 volt, at least about 1 volt, at least about 2 volts, or at least about 3 volts can be applied to the filtration apparatus. In some embodiments, the potential applied to the filtration apparatus should be less than 10 volts, less than 9 volts, less than 8 volts, less than 7 volts, less than 6 volts, less than 5 volts or less than 4 volts. In one embodiment, a potential of about 0.5 volt to about 4 volts is applied to the filtration apparatus. In another embodiment, a potential of about 2 volts to about 4 volts is applied to the filtration apparatus. In some embodiments, the potential can be constant and in other embodiments, the potential can be alternating. It should be appreciated that the voltage applied during operation of the filtration apparatus can be adjusted accordingly, based upon the preference of an user/operator. For example, if a higher reduction efficiency of the method described herein is desirable, a higher potential/voltage can be applied.

As a voltage applied to the filtration apparatus can be consumed by both the cathode and anode of the filtration apparatus described herein, in some embodiments, the filtration apparatus described herein can be applied with a sufficient voltage such that the filtration apparatus is operated at an anode potential of at least about 0.5 volts, at least about 1 volt, at least about 1.5 volt, at least about 2 volts or more.

In alternative embodiments, the filtration apparatus of the invention can be powered by solar (photovoltaic) energy, e.g., for point-of-use water purification in developing countries.

In the presence of an applied potential, an aqueous fluid can be introduced through the inlet 104 of the filtration apparatus. The fluid can be pumped through the filtration apparatus using various pumps according to the volume and/or flow rate of the fluid to be processed. Non-limiting examples of pumps include micromachined pumps, reciprocating pumps, peristaltic pumps, diaphragm pumps, syringe pumps, volume occlusion pumps and other pumping means known to those skilled in the art. In some embodiments, the aqueous fluid can be introduced through the filtration apparatus by applying a positive force, or by vacuum suction. In some embodiments of the invention, the aqueous fluid can be forced through the filtration apparatus using the forces of gravity.

In some embodiments, for example, a portable filtration apparatus, a syringe loaded with an aqueous fluid can be connected to the inlet of the filtration apparatus. A positive force can then be manually applied to the syringe to push the aqueous fluid through the filtration apparatus into a fluid collection container. In alternative embodiments, the inlet of the filtration apparatus can be connected to a peristaltic pump 120, e.g., via a tubing 122 (e.g., FIG. 1B) to introduce the aqueous fluid through the filtration apparatus.

In some embodiments, the aqueous fluid can be drawn through the filtration apparatus by vacuum suction via the outlet of the filtration apparatus. A skilled artisan is well aware of filtering apparatus and methods in the art that utilize vacuum suction for passing a sample through a filter. Thus, any such apparatus and/or method can be used in accordance with the invention.

In accordance with various embodiments of the invention, an aqueous fluid can be flowed through a filtration apparatus at any rate, which can be determined according to the application, the characteristics of the input fluid and the desired characteristics of the output fluid. For example, in accordance with one embodiment of the invention, the flow rate of an aqueous fluid can range from about 500 μL/min to about 10 mL/min, from about 1 mL/min to about 8 mL/min, or from about 1 mL/min to about 5 mL/min. It should be appreciated that a higher or a lower flow rate can be accommodated with various designs of the filtration apparatus, e.g., by increasing or reducing the surface area of the carbon nanotube filter material as well as the filtration apparatus housing and the treatment chamber. Accordingly, in other embodiments, the flow rate of an aqueous fluid can range from about 10 mL/min to about 1000 L/min, from about 50 mL/min to about 500 L/min, or from about 100 mL/min to about 100 L/min. In embodiments involving a large-volume processing such as in a wastewater treatment plant, an aqueous fluid can flow at a rate of up to about 1000 million gallon per day (MGD), up to about 900 MGD, up to about 800 MGD, or about 700 MGD.

In some embodiments, the flow rate can also be normalized to the filter surface area using units of liter per square meter per hour (LMH), or normalized to both surface area and pressure such as liters per square meter per hour per bar (LMH-bar). For example, microfiltration membranes with pore sizes of about 100 nm to about 1000 nm can operate at a normalized flow rate of about 100 LMH to about 1000 LMH. One of skill in the art can readily convert volumetric flow rate as described herein to normalized flow rate with known filter surface area and/or operating pressures.

It is to be understood that the flow rate of an aqueous fluid through the filter apparatus can be adjusted based on a number of factors such as physical properties of the carbon nanotube filter material (e.g., thickness, pore size, porosity, and filter surface area), possible back pressure build-up during filtration, and desired reduction efficiency. For example, in some embodiments, the flow rate of an aqueous fluid can be reduced when a significant back-pressure accumulates at a higher flow rate. In some embodiments, the flow rate of an aqueous fluid can be decreased to prolong the contact of the aqueous fluid with the carbon nanotube filter material, thus increasing filtration efficiency of the method. Alternatively, the thickness of the carbon nanotube filter material can be increased in a dimension parallel to the direction of fluid flow to provide increased contact and increased efficiency at high flow rates. One of skill in the art can readily determine optimal conditions for each filtration process.

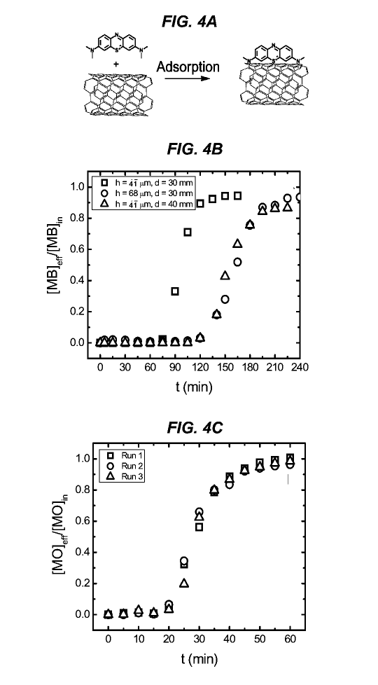

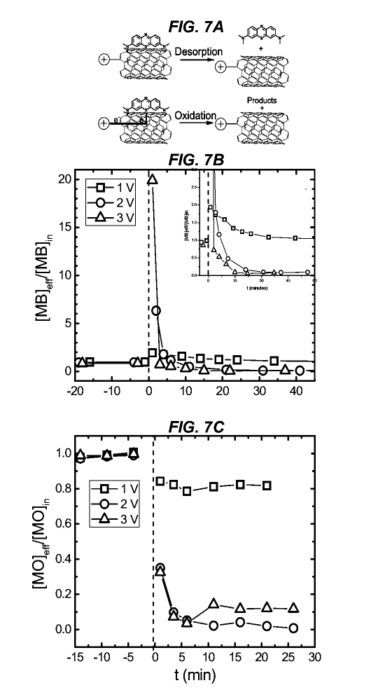

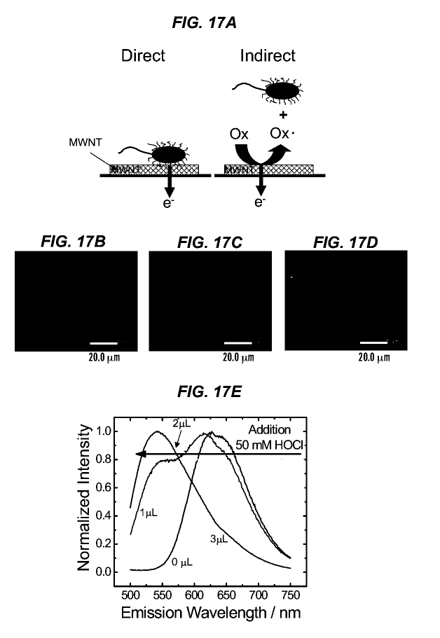

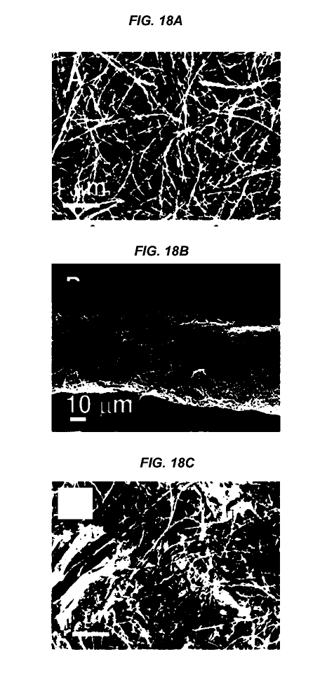

As an aqueous fluid flows from the inlet 104 to the outlet 106, at least one contaminant in the aqueous fluid will be reduced, e.g., by at least about 5%, at least about 10%, at least about 20%, at least about 30%, at least about 40%, at least about 50%, at least about 60%, at least about 70%, at least about 80%, at least about 90%, at least about 95%, at least about 96%, about 97%, about 98%, about 99%, or 100%, relative to the amount in the absence of filtration. Without wishing to be bound by theory, in some embodiments, the contaminant can be reduced in the aqueous fluid by having the contaminant attached to the carbon nanotube filter material (e.g., by adsorption as shown in FIG. 4A, or trapping within filter pores). In further embodiments, the contaminant can be reduced in the aqueous fluid by being oxidized or inactivated (e.g., as shown in FIG. 7A and left panel of FIG. 17A). In some embodiments, the contaminant can react with an oxidizing agent produced during the electrochemical filtration process and be oxidized or inactivated (e.g., as shown in the right panel of FIG. 17A). It should be appreciated that since the filtration apparatuses and/or methods described herein can oxidatively inactivate and/or degrade contaminants in an aqueous fluid, the occurrence of adsorption breakthrough observed in the previously-reported carbon nanotube filters (in the absence of an applied potential) can be lowered, resulting in an improved life-time and efficiency of the filtration process. Further, the ability to inactivate biological contaminants in an aqueous fluid by the filtration apparatuses and/or methods described herein can decrease biohazards, e.g., bacterial or viral infection.

After the aqueous fluid has passed through the filtration apparatus, the output fluid from the outlet 106 of the apparatus can be collected. In some embodiments, the output fluid can be collected into a collection container 124 as shown in FIG. 1B. In some embodiments, the outlet 106 of the filtration apparatus can be fitted over a collection container, e.g., a bottle. In some embodiments, the output fluid can be directed to another process, e.g., via a tubing, for additional treatment.

Without limitations, the filtration apparatuses or methods of the invention can be combined with other techniques for processing an aqueous fluid. For example, the filtration apparatuses and/or methods described herein can be utilized downstream of a pre-treatment process, e.g., a pre-filtration step to remove large debris and particulates present in an aqueous fluid or to change the physical or chemical characteristics of the fluid to be treats, for example, to adjust the temperature or pH of the fluid. On the other hand, an output fluid collected from the filtration apparatuses and/or methods described herein can be subjected to further processing. In some embodiments, an aqueous fluid can pass through a series of the filtration apparatuses using various embodiments of the methods (e.g., different flow rate or applied potential), wherein each filtration apparatus can be specifically designed for removal of one or more components in the aqueous fluid. In addition, two or more filtration apparatus according to the present invention can be used in parallel to increase the volume of fluid processed.

In some embodiments, the filtration apparatus can be cleaned and/or sterilized before use by various methods known to one of skill in the art. Exemplary sterilization methods include, but not limited to, heat sterilization (e.g., autoclaving), chemical sterilization (e.g., ethylene oxide or alcohol), and radiation sterilization (e.g., UV irradiation or gamma rays).

In some embodiments, the filtration apparatus can be disposable after single use or recycled. In accordance with the invention, the carbon nanotube filter material can be cleaned after use, e.g., by running a contaminant-free fluid through the filtration apparatus at an applied potential. In some embodiments, the contaminant adsorbed on the carbon nanotube filter material can be electrostatically desorbed and washed away in a collection fluid. As shown in FIG. 7B, organic molecules, such as positively-charged organic molecules, adsorbed on the carbon nanotube filter material can be desorbed and collected as a more concentrated solution (e.g., for further analysis) at an appropriate potential, while simultaneously regenerating the carbon nanotube filter material. Alternatively, a higher potential can be applied to oxidatively degrade the contaminant adsorbed on the carbon nanotube filter material.

In some embodiments, at least a portion of the first conducting material (e.g., a titanium ring) of the filtration apparatus described herein can be regenerated when needed, e.g., when at least a portion of the first conducting material becomes passivated and/or the filtration efficiency is reduced after it has been used in an electrochemical filtration process for a period of time. An exemplary method for regenerating the first conducting material can include polishing the surface of the first conducting material that contacts the carbon nanotube filter material. See, e.g., Example 13. Alternatively, the first conducting material (e.g., a titanium ring) of the filtration described herein can be simply replaced with a fresh first conducting material (e.g., a fresh titanium ring).

The term “regenerate” as used herein in reference to electrodes, e.g., the first conducting material and/or the CNT filter material, as discussed below, means increasing, reactivating, or restoring the activity or performance of an passivated electrode in an electrochemical filtration process. The performance of the electrode can be reduced or deactivated over time during electrochemical filtration when the electrodes are passivated. The term “passivated” or “passivation” generally means the alteration of a reactive surface to a less reactive state. Passivation of an electrode surface can refer to a process, for example, which can decrease the chemical reactivity (e.g., oxidative performance) of an electrode surface, decrease the number of active reaction sites on an electrode surface, or decrease the affinity of an electrode surface for a molecule to be filtered. Examples of processes or mechanisms that can passivate an electrode (e.g., the first conducting material and/or the CNT filter material) include, but are not limited to, oxidative passivation (e.g., formation of metal oxide on the surface of the first conducting material such as titanium ring, formation of polymer such as aromatic polymer on the surface of CNT filter material, and/or CNT surface oxidation), and/or electrolyte precipitation. Methods for characterizing the performance of the electrode in an electrochemical filtration process are known in the art, including, but not limited to, measuring the current flowing through the filtration apparatus (e.g., with linear sweep voltammetry), measuring the total organic carbon (TOC) content of the output fluid and/or measuring the electrochemical impedance (e.g., with electrochemical impedance spectroscopy). For example, in some embodiments, a passivated electrode (e.g., the first conducting material such as a titanium ring) after regeneration can increase the current flowing through the filtration apparatus. In some embodiments, a passivated electrode (e.g., the carbon nanotube filter material) after regeneration can further decrease the TOC content of the output fluid, and/or decrease electrochemical impedance of the electrochemical filtration process. See, e.g., Example 13, for exemplary methods to monitor electrochemical and passivation processes.

In some embodiments, at least a portion of the carbon nanotube filter material of the filtration apparatus described herein can be regenerated when needed, e.g., when at least a portion of the carbon nanotube filter material becomes passivated and/or the filtration efficiency is reduced after it has been used in an electrochemical filtration process for a period of time. Methods to regenerate at least a portion of the carbon nanotube filter material can include, but are not limited to, flowing an acidic alcohol solution (e.g., acidic ethanol-water mixture) through the carbon nanotube filter material and optionally accompanied with cyclic voltammetry, redispersing or resuspending the carbon nanotube filter material in an organic solvent, with or without sonication (e.g., ultrasonication), followed by subsequent reproduction of the carbon nanotube filter material, calcinating the carbon nanotube filter material at a high temperature (e.g., at 400° C. or higher) and any other art-recognized methods for regenerating the carbon nanotube filter material. Examples of the organic solvent that can be used to resuspend the carbon nanotube filter material for regeneration include, but are not limited to, DMSO, NaOH, HCl, n-methylpyrrolidone, ethanol, toluene and hexane. In some embodiments, the organic solvent can comprise a detergent such as SDS, e.g., NaOH containing about 0.1% SDS.

Depending on the identity and/or amounts of the passivants (e.g., electrolyte precipitation and/or electropolymer passivant) coated on the carbon nanotube surface, one of skill in the art can determine an appropriate regeneration method. For example, in some embodiments, an acidic alcohol wash (e.g., an ethanol-water mixture with a pH value between pH 1 and pH 4) can be sufficient to, at least partially or completely, remove electrolyte precipitates from the carbon nanotube filter material. In some embodiments, calcination (e.g., at 400° C.) can be used to, at least partially or completely, remove an electropolymer passivant from the carbon nanotube filter material. In some embodiments, an acidic solution (e.g., HCl) can be used to, at least partially or completely, remove electropolymer passivant from the carbon nanotube filter material. If the electropolymer passivant appears to be non-polar, non-polar organic solvents are preferably used. For example, in some embodiments, a toluene wash can be used to, at least partially or completely, remove an electropolymer passivant from the carbon nanotube filter material. In some embodiments, a combination of different regeneration methods described herein can be used to remove one or more passivants from the carbon nanotube filter material. See, e.g., Example 13 for different regenerations methods that can be used to regenerate at least a portion of the carbon nanotube filter material.

### Contaminant

As used herein, the term “contaminant” refers to any molecule, cell or particulate to be removed from an aqueous fluid. Representative examples of contaminants include, but are not limited to, biological microorganisms (e.g., mammalian cells, pathogens, viruses, bacteria, fungi, yeast, protozoan, microbes, parasites, and combinations thereof), organic molecules, and ions.

In some embodiments, the contaminant is a biological microorganism or pathogen selected from the group consisting of living or dead cells (prokaryotic and eukaryotic, including mammalian), viruses, bacteria, fungi, yeast, protozoan, microbes, parasites, and combinations thereof. As used herein, a pathogen is any disease-causing microorganism.

Exemplary fungi and yeast include, but are not limited to, Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae, Rhodotorula mucilaginosa, Aspergillus fumigatus, Aspergillus flavus, Aspergillus clavatus, Cryptococcus neoformans, Cryptococcus laurentii, Cryptococcus albidus, Cryptococcus gattii, Histoplasma capsulatum, Pneumocystis jirovecii (or Pneumocystis carinii), Stachybotrys chartarum, and any combinations thereof.

Exemplary bacteria include, but are not limited to: anthrax, campylobacter, cholera, diphtheria; enterotoxigenic E. coli, giardia, gonococcus, Helicobacter pylori, Hemophilus influenza B, Hemophilus influenza non-typable, meningococcus, pertussis, pneumococcus, salmonella, shigella, Streptococcus B, group A Streptococcus, tetanus, Vibrio cholerae, yersinia, Staphylococcus, Pseudomonas species, Clostridia species, Myocobacterium tuberculosis, Mycobacterium leprae, Listeria monocytogenes, Salmonella typhi, Shigella dysenteriae, Yersinia pestis, Brucella species, Legionella pneumophila, Rickettsiae, Chlamydia, Clostridium perfringens, Clostridium botulinum, Staphylococcus aureus, Treponema pallidum, Haemophilus influenzae, Treponema pallidum, Klebsiella pneumoniae, Pseudomonas aeruginosa, Cryptosporidium parvum, Streptococcus pneumoniae, Bordetella pertussis, Neisseria meningitides, and any combination thereof.

Parasites include organisms within the phyla Protozoa, Platyhelminthes, Aschelminithes, Acanthocephala, and Arthropoda. Exemplary parasites include, but are not limited to: Entamoeba histolytica; Plasmodium species, Leishmania species, Toxoplasmosis, Helminths, and any combination thereof.

Exemplary viruses include, but are not limited to, HIV-1, HIV-2, hepatitis viruses (including hepatitis B and C), Ebola virus, West Nile virus, and herpes virus such as HSV-2, adenovirus, dengue serotypes 1 to 4, ebola, enterovirus, herpes simplex virus 1 or 2, influenza, Japanese equine encephalitis, Norwalk, papilloma virus, parvovirus B19, rubella, rubeola, vaccinia, varicella, Cytomegalovirus, Epstein-Barr virus, Human herpes virus 6, Human herpes virus 7, Human herpes virus 8, Variola virus, Vesicular stomatitis virus, Hepatitis A virus, Hepatitis B virus, Hepatitis C virus, Hepatitis D virus, Hepatitis E virus, poliovirus, Rhinovirus, Coronavirus, Influenza virus A, Influenza virus B, Measles virus, Polyomavirus, Human Papilomavirus, Respiratory syncytial virus, Adenovirus, Coxsackie virus, Dengue virus, Mumps virus, Rabies virus, Rous sarcoma virus, Yellow fever virus, Ebola virus, Marburg virus, Lassa fever virus, Eastern Equine Encephalitis virus, Japanese Encephalitis virus, St. Louis Encephalitis virus, Murray Valley fever virus, West Nile virus, Rift Valley fever virus, Rotavirus A, Rotavirus B. Rotavirus C, Sindbis virus, Human T-cell Leukemia virus type-1, Hantavirus, Rubella virus, Simian Immunodeficiency viruses, and any combination thereof.

In accordance with the invention, the contaminants can be non-biological substances, e.g., organic molecules. Exemplary organic molecules include any molecules that can be adsorbed on the carbon nanotube filter material or be oxidized. In some embodiments, the organic molecules can be positively-charged. In some embodiments, the organic molecules can be negatively-charged. In some embodiments, the organic molecules can be structurally-planar chemical molecules, e.g., aromatic molecules or sp²-conjugated molecules.

In some embodiments, the contaminants include any aqueous ions (e.g., anions) that can be adsorbed on the carbon nanotube filter material or be oxidized. Exemplary anions include, but are not limited to, include iodides, chlorides, chlorites, bromide, bromates, sulfates, sulfites, oxides, nitrates, nitrites, and combinations thereof. In some embodiments, the contaminants can include any aqueous metals that fall into the class of oxyanions. For example, arsenite and arsenate are the two major aqueous arsenic species, which can be found as anions in solutions.

In some embodiments, the contaminants can include other metals, polymer, and/or chemical molecules such as haloactic acids, trihalomethanes, chloramines, chlorine, chlorine dioxide, antimony, arsenic, mercury (inorganic), selenium, thallium, Acrylamide, Alachlor, Atrzine, Benzene, Benzo(a)pyrene (PAHs), Carbofuran, Carbon, etrachloride, Chlordane, Chlorobenzene, 2,4-D, Dalapon, 1,2-Dibromo-3-chloropropane (DBCP), o-Dichlorobenzene, p-Dichlorobenzene, 1,2-Dichloroethane, 1,1-Dichloroethylene, cis-1,2-Dichloroethylene, trans-1,2-Dichloroethylene, Dichloromethane, 1,2-Dichloropropane, Di(2-ethylhexyl) adipate, Di(2-ethylhexyl) phthalate, Dinoseb, Dioxin (2,3,7,8-TCDD), Diquat, Endothall, Endrin, Epichlorohydrin, Ethylbenzene, Ethylene dibromide, Glyphosate, Heptachlor, Heptachlor epoxide, Hexachlorobenzene, Hexachlorocyclopentadiene, Lead, Lindane, Methoxychlor, Oxamyl (Vydate), Polychlorinated, biphenyls (PCBs), Pentachlorophenol, Picloram, Simazine, Styrene, Tetrachloroethylene, Toluene, Toxaphene, 2,4,5-TP (Silvex), 1,2,4-Trichlorobenzene, 1,1,1-Trichloroethane, 1,1,2-Trichloroethane, Trichloroethylene, Vinyl chloride, Xylenes or combinations thereof.

In some embodiments, the contaminant can include any compound present in wastewater.

### Aqueous and Non-Aqueous Fluids

In accordance with the invention, any fluid can pass through the filtration apparatus described herein. The fluid can be liquid, supercritical fluid, solutions, suspensions, gases, gels, and combinations thereof. In some embodiments, the input fluid can be aqueous or non-aqueous.

In some embodiments, the input fluid can be non-aqueous. As used herein, the term “non-aqueous fluid” refers to any flowable water-free material that comprises at least one contaminant described herein. Accordingly, in some embodiments, a non-aqueous fluid can be an organic solvent, e.g., acetone, or an inorganic solvent, e.g., SOCl₂ and SO₂. The term “solvent” as used herein refers to a liquid, solid, or gas that dissolves another solid, liquid, or gaseous solute, e.g., contaminant as described herein.

In some embodiments, non-aqueous fluids can be non-polar solvents, polar aprotic solvents, polar protic solvents, or a combination thereof. Exemplary non-polar solvents include, but are not limited to, pentane, cyclopentane, hexane, cyclohexane, benzene, toluene, 1,4-dioxane, chloroform, and diethyl ether. Exemplary polar aprotic solvents include, but are not limited to, dichloromethane, tetrahydrofuran, ethyl acetate, acetone, dimethylformamide, acetonitrile, and dimethyl sulfoxide. Exemplary polar protic solvents include, but are not limited to, formic acid, n-butanol, isopropanol, n-propanol, ethanol, methanol, and acetic acid.

In some embodiments, the input fluid can be an aqueous fluid. As used herein, the term “aqueous fluid” refers to any flowable water-containing material that comprises at least one contaminant described herein.

In some embodiments, the aqueous fluid is a biological fluid. Exemplary biological fluids include, but are not limited to, blood (including whole blood, plasma, cord blood and serum), lactation products (e.g., milk), amniotic fluids, sputum, saliva, urine, semen, cerebrospinal fluid, bronchial aspirate, perspiration, mucus, liquefied feces, synovial fluid, lymphatic fluid, tears, tracheal aspirate, and fractions thereof.

Another example of a group of biological fluids are cell culture fluids, including those obtained by culturing or fermentation, for example, of single- or multi-cell organisms, including prokaryotes (e.g., bacteria) and eukaryotes (e.g., animal cells, plant cells, yeasts, fungi), and including fractions thereof.

In some embodiments, the aqueous fluid is a non-biological fluid. As used herein, the term “non-biological fluid” refers to any aqueous fluid that is not a biological fluid as the term is defined herein. Exemplary non-biological fluids include, but are not limited to, water, salt water, brine, buffered solutions, saline solutions, sugar solutions, carbohydrate solutions, lipid solutions, nucleic acid solutions, hydrocarbons (e.g. liquid hydrocarbons), acids, gasolines, petroleum, liquefied samples (e.g., liquefied samples), and mixtures thereof.

In some embodiments, the aqueous fluid is a media or reagent solution used in a laboratory or clinical setting, such as for biomedical and molecular biology applications. As used herein, the term “media” refers to a medium for maintaining a tissue or cell population, or culturing a cell population (e.g. “culture media”) containing nutrients that maintain cell viability and support proliferation.

As used herein, the term “reagent” refers to any solution used in a laboratory or clinical setting for biomedical and molecular biology applications. Reagents include, but are not limited to, saline solutions, PBS solutions, buffered solutions, such as phosphate buffers, EDTA, Tris solutions, and any combinations thereof. Reagent solutions can be used to create other reagent solutions. For example, Tris solutions and EDTA solutions are combined in specific ratios to create “TE” reagents for use in molecular biology applications.

In some embodiments, the aqueous fluid can be a water-containing fluid comprising organic molecules, anions, biological microorganisms, or a mixture thereof described herein.

In some embodiments, the aqueous fluid can be a salt solution comprising organic molecules, anions, biological microorganisms, or a mixture thereof described herein.

In one embodiment, the aqueous fluid is wastewater.

In some embodiments of the invention, the aqueous fluid can include at least one electrolyte. As used herein, the term “electrolyte” refers to any substance containing free ions that make the substance electrically conductive. An electrolyte that can be used for the purpose of the invention can be an ionic solution, but molten electrolytes and solid electrolytes can also be used. In some embodiments, the electrolyte can normally or inherently be present in the aqueous fluid. In some embodiments, the electrolyte can be added to the aqueous fluid before, or during the filtration process.

Generally, electrolytes are solutions of acids, bases or salts. Furthermore, some gases may act as electrolytes under conditions of high temperature or low pressure. Electrolyte solutions can also result from the dissolution of some biological (e.g., DNA, polypeptides) and synthetic polymers (e.g., polystyrene sulfonate), termed polyelectrolytes, which contain charged functional groups.

In one embodiment, the electrolyte is a salt solution, e.g., sodium chloride (NaCl), sodium iodide (NaI), sodium sulfate (Na₂SO₄).

In various embodiments, the concentration of electrolytes in an aqueous fluid can range from about 0.01 mM to about 1000 mM, from about 0.1 mM to about 500 mM or from about 0.5 mM to about 250 mM. In accordance with the invention, the current generated during the filtration process generally increases with increasing electrolyte concentration at an applied potential. In one embodiment, the electrolyte concentration is between 5 mM and 50 mM. In some embodiments, the concentration of electrolytes, e.g., salts, in an aqueous fluid can be greater than 500 mM, greater than 1 M, greater than 5 M, greater than 10 M, greater than 25 M, or greater than 50 M.

The present invention may be defined in any of the following numbered paragraphs:
1. A filtration apparatus, comprising:
   a housing forming a chamber, the chamber including an inlet for receiving an input fluid and an outlet for releasing an output fluid;
   a porous carbon nanotube filter material positioned between the inlet and the outlet, wherein at least a portion of the porous carbon nanotube filter material is in contact with a first conducting material; and
   a second conducting material positioned between the inlet and the outlet.
2. The filtration apparatus of paragraph 1, wherein the housing has at least two openings for a first and a second conducting leads, wherein the first conducting lead contacts the first conducting material and the second conducting lead contacts the second conducting material.
3. The filtration apparatus of paragraph 1 or 2, wherein the second conducting material and the first conducting material are spaced apart.
4. The filtration apparatus of paragraph 1 or 2, wherein the second conducting material and the porous carbon nanotube filter material are spaced apart.
5. The filtration apparatus of any of paragraphs 1-3, wherein the first conducting material includes titanium.
6. The filtration apparatus of any of paragraphs 1-4, wherein the second conducting material is permeable to an input fluid.
7. The filtration apparatus of any of paragraphs 1-4, wherein the second conducting material includes stainless steel.
8. The filtration apparatus of any of paragraphs 1-3, wherein the first conducting material is connected to a negative pole of a voltage source.
9. The filtration apparatus of any of paragraphs 1-3, wherein the first conducting material is connected to a positive pole of a voltage source.
10. The filtration apparatus of any of paragraphs 1-4, wherein the second conducting material is connected to a negative pole of a voltage source.
11. The filtration apparatus of any of paragraphs 1-4, wherein the second conducting material is connected to a positive pole of a voltage source.
12. The filtration apparatus of any of paragraphs 8-11, wherein the voltage source produces a potential of less than 10 volts.
13. The filtration apparatus of paragraph 12, wherein the voltage source produces a potential of at least about 1 volt.
14. The filtration apparatus of paragraph 13, wherein the voltage source produces a potential of at least about 2 volts.
15. The filtration apparatus of paragraph 1, wherein the carbon nanotube filter material includes a network of carbon nanotubes.
16. The filtration apparatus of paragraph 15, wherein the carbon nanotubes are multi-walled carbon nanotubes.
17. The filtration apparatus of any of paragraphs 1-16, wherein at least a portion of the carbon nanotubes are doped with at least one atom.
18. The filtration apparatus of paragraph 17, wherein said at least one atom is nitrogen, boron, fluorine or a combination thereof.
19. The filtration apparatus of any of paragraphs 1-18, wherein at least a portion of the carbon nanotubes are surface modified by at least one processing treatment.
20. The filtration apparatus of paragraph 19, wherein said at least one processing treatment comprises heating said at least a portion of the carbon nanotubes to a high temperature.
21. The filtration apparatus of paragraph 20, wherein the high temperature is at least about 200° C.
22. The filtration apparatus of paragraph 21, wherein the high temperature is at least about 400° C.
23. The filtration apparatus of any of paragraphs 19-22, wherein said at least one processing treatment comprises contacting said at least a portion of the carbon nanotubes with an acid.
24. The filtration apparatus of paragraph 23, wherein the acid is selected from a group consisting of hydrochloric acid; nitric acid, hydrofluoric acid, hydrobromic acid, hydroiodic acid, sulfuric acid, oleum, citric acid, oxalic acid, chlorosulfonic acid, phosphoric acid, trifluoromethane sulfonic acid, glacial acetic acid, monobasic organic acids, dibasic organic acids, and any combinations thereof.
25. The filtration apparatus of any of paragraphs 1-24, wherein said at least a portion of the carbon nanotubes comprise a polymer coating.
26. The filtration apparatus of paragraph 25, wherein the polymer coating comprises sulfonated tetrafluoroethylene based fluoropolymer-copolymer, polyvinylidene fluoride (PVDF), polyethersulfone, polyamide, polysulfone, cellulose acetate, polytetrafluoroethylene (PTFE), polystyrene, or any combinations thereof.
27. The filtration apparatus of any of paragraphs 1-26, wherein the carbon nanotube filter material includes a catalyst.
28. The filtration apparatus of paragraph 27, wherein the catalyst is an electrocatalyst with a high O2 overpotential.
29. The filtration apparatus of any of paragraphs 27-28, wherein the catalyst is dispersed within the carbon nanotubes.
30. The filtration apparatus of any of paragraphs 27-29, wherein the catalyst is present in a coating of the carbon nanotubes.
31. The filtration apparatus of any of paragraphs 27-30, wherein the catalyst is selected from metal, metal alloy, metal oxide, doped metal oxide, or any combination thereof.
32. The filtration apparatus of paragraph 31, wherein the metal is selected from platinum, silver, nickel, iron, antimony, or any combination thereof.
33. The filtration apparatus of paragraph 31 or 32, wherein the metal oxide is selected from tin oxide, titanium oxide or a combination thereof.
34. The filtration apparatus of any of paragraphs 31-33, wherein the doped metal oxide is selected from doped tin oxide or doped titanium oxide.
35. The filtration apparatus of paragraph 34, wherein the dopant present in the doped metal oxide comprises antimony.
36. The filtration apparatus of any of paragraphs 1-35, wherein said at least a portion of the carbon nanotubes are subjected to at least two processing treatments comprising heating to the high temperature and contacting with the acid.
37. The filtration apparatus of any of paragraphs 1-36, wherein said at least a portion of the carbon nanotubes are subjected to said at least three processing treatments comprising heating to the high temperature, contacting with the acid, and coating with doped metal oxide.
38. The filtration apparatus of any of paragraphs 1-37, wherein the carbon nanotube filter material has a porosity of at least about 10%.
39. The filtration apparatus of any of paragraphs 1-38, wherein the carbon nanotube filter material has an average pore size of at least about 0.5 nm.
40. The filtration apparatus of any of paragraphs 1-39, further comprises a vent to release gas accumulated within the chamber during a filtration process.
41. The filtration apparatus of any of paragraphs 1-40, wherein at least a portion of the carbon nanotubes are functionalized with one or more functional groups or molecules.
42. The filtration apparatus of paragraph 41, wherein said one or more functional groups comprise pyrene, naphthalene or other aromatic-type molecules.
43. A method for reducing at least one contaminant in an aqueous fluid, the method comprising:
   providing at least one filtration apparatus of any of paragraphs 1 to 42;
   connecting the first conducting material to a positive pole of a voltage source; connecting the second conducting material to a negative pole of the voltage source;
   applying a voltage from the voltage source;
   flowing the aqueous fluid through the porous carbon nanotube filter material from the inlet of the filtration apparatus, wherein the porous carbon nanotube filter material separates said at least one contaminant from the aqueous fluid; and
   collecting the output fluid from the outlet of the filtration apparatus, thereby reducing said at least one contaminant from the aqueous fluid.
44. The method of paragraph 43, wherein the aqueous fluid includes an electrolyte.
45. The method of paragraph 43 or 44, wherein the aqueous fluid includes the at least one contaminant selected from organic molecules, ions, biological microorganisms, or a combination thereof.
46. The method of paragraph 45, wherein the ions are anions.
47. The method of paragraph 45, wherein the biological microorganisms are selected from cells, viruses, bacteria, fungi, yeast, protozoan, microbes, parasites, or a combination thereof.
48. The method of any of paragraphs 43-47, wherein the aqueous fluid is water.
49. The method of any of paragraphs 43-48, wherein the voltage generated by the voltage source is not greater than 10 volts.
50. The method of any of paragraphs 43-49, wherein the voltage generated by the voltage source is at least about 1 volt.
51. The method of any of paragraphs 43-50, wherein the voltage generated by the voltage source is at least about 2 volts.
52. The method of any of paragraphs 43-51, wherein the at least one contaminant in the aqueous fluid is reduced by at least about 5%.
53. The method of any of paragraphs 43-52, further comprising regenerating at least the first conducting material of the filtration apparatus or the carbon nanotube filter material.
54. The method of paragraph 53, wherein the first conducting material of the filtration apparatus is regenerated by polishing a surface of the first conducting material.
55. The method of paragraph 53, wherein the carbon nanotube filter material of the filtration apparatus is regenerated by contacting the carbon nanotube filter material with an organic solvent.
56. The method of paragraph 53, wherein the carbon nanotube filter material is regenerated by contacting the carbon nanotube filter material with an acid.
57. The method of paragraph 53, wherein the carbon nanotube filter material is regenerated by calcination.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

Other than in the operating examples, or where otherwise indicated, all numbers expressing quantities of ingredients or reaction conditions used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

The term “alkyl” as used herein includes both linear and branched chain radicals, for example, but not limited to, methyl, ethyl, propyl, isopropyl, butyl, t-butyl, isobutyl, pentyl, hexyl, isohexyl, heptyl, 4,4-dimethylpentyl, octyl, 2,2,4trimethylpentyl, nonyl, decyl, undecyl, dodecyl, and any various branched chain isomers thereof. The chain can be linear or cyclic, saturated or unsaturated, containing, for example, double and/or triple bonds. The alkyl chain can be substituted with, for example, one or more halogen, oxygen, hydroxy, silyl, amino, or other art-recognized substituents.

The term “acyl” as used herein refers to carbonyl groups of the formula —COR wherein R can be any suitable substituent such as, for example, alkyl, aryl, aralkyl, halogen; substituted or unsubstituted thiol; unsubstituted or substituted amino, unsubstituted or substituted oxygen, hydroxy, or hydrogen.

The term “aryl” as used herein refers to monocyclic, bicyclic or tricyclic aromatic groups containing from about 6 to about 14 carbons in the ring portion, such as phenyl, naphthyl substituted phenyl, or substituted naphthyl, wherein the substituent on either the phenyl or naphthyl can be for example C₁₋₄ alkyl, halogen, C₁₋₄ alkoxy, hydroxy or nitro.

The term “aralkyl” as used herein refers to alkyl groups having an aryl substituent, such as benzyl, p-nitrobenzyl, phenylethyl, diphenylmethyl and triphenylmethyl.

The term “substituted amino” as used herein refers to an amino, which can be substituted with one or more substituents, for example, alkyl, acyl, aryl, aralkyl, hydroxy, and hydrogen.

The term “substituted thiol” as used herein refers to a thiol which can be substituted with one or more substituents, for example, alkyl, acyl, aryl, aralkyl, hydroxy, and hydrogen.

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and combinations thereof can be performed without altering the spirit or scope of the invention, and such modifications and variations are encompassed within the scope of the invention as defined in the claims which follow. The following examples do not in any way limit the invention.

### EXAMPLES

The examples presented herein relate to one or more embodiments of the filtration apparatuses and/or methods described herein for reducing at least one contaminant from an aqueous fluid. In particular, an electrochemically-active multi-walled carbon nanotube (MWNT) filter has been demonstrated for adsorption, desorption, and oxidation of the aqueous dyes; oxidation of the aqueous anions iodide (I⁻) and chloride (Cl⁻); and adsorption and/or inactivation of pathogens such as viruses and bacteria.

### Materials and Methods for Examples 1-6

Chemicals and Materials. Methylene blue (0.05% in water), methyl orange (>95%), sodium iodide (>99.9%), and sodium chloride (>99.0%) were purchased from Sigma-Aldrich. The multi-walled carbon nanotubes (MWNTs) were purchased from Nanotech Labs in preformed sheets of a range of depths; thin (˜40 μm), medium (˜70 μm), and thick (˜100 μm). The thinnest MWNT sheets, determined to be 41±8 μm by SEM analysis, were used in all experiments unless noted otherwise. All aqueous solutions were made with water from a Barnstead Nanopure Infinity purification system that produced water with a minimal resistivity of 18 MΩ cm⁻¹. All solutions contained 10 mM NaCl as a background electrolyte to normalize ionic strength and conductivity unless otherwise noted. For experiments, a methylene blue input fluid was made to a concentration of 7.0±1.0 μM, a methyl orange input fluid was made to a concentration of 25.0±2.0 μM, and an iodide input fluid was made to a concentration of 1 or 10 mM.

Electrochemical Filtration. All filtration experiments were completed using the modified electrochemical filtration casing as described in the Examples. First, a 5-μm pore PTFE membrane was placed on the bottom piece of the casing and wetted. Next, the 47 mm diameter multi-walled carbon nanotube (MWNT) filter (Nanotech Labs) was placed on top of the PTFE membrane and wetted. Then, a layer of water was spread on the MWNT filter and allowed to sit for 10-15 minutes until the water had seeped through the filter. The filtration casing was then sealed and the top half of the casing was primed with deionized water using a needle syringe to remove any air that could restrict flow. Water was then peristaltically pumped (Masterflex) through the filter at 1.5±0.1 mL min⁻¹ to compact and rinse the MWNT filter and to calibrate the flow rate, which was measured gravimetrically (Pinnacle, Denver Instruments). After the water rinse was complete, the pump was first primed with the appropriate input fluid solution and then the experiment was started. Sample aliquots were collected directly from the filter casing outlet and analyzed immediately after collection.

UV-Vis Analysis. The quantification of aqueous methylene blue, methyl orange, and triiodide was completed on an Agilent 8453 UV-Visible spectrophotometer. Aliquots (0.5-0.75 mL) of an output fluid were collected from the filter into a 1 mL glass cuvette with a 1 cm pathlength. Methylene blue was quantified by its absorption at λₘₐₓ=665 nm (∈=74,100 M⁻¹ cm⁻¹). For high concentration of methylene blue solutions, absorption at 550 nm (∈=6,190 M⁻¹ cm⁻¹) was used for quantification. Methyl orange was quantified by its absorption at λₘₐₓ=464 nm (∈=26,900 M⁻¹ cm⁻¹). Triiodide was quantified by its adsorption at 287 nm (∈=40,000 M⁻¹ cm⁻¹) or 353 nm (∈=26,400 M⁻¹ cm⁻¹) for low concentrations. High aqueous triiodide concentrations were diluted 10 times with deionized water prior to analysis.

BET Surface Area Analysis. The specific surface area of the MWNT nanotube filters was measured with a Beckman Coulter SA 3100 Surface Area and Pore Size Analyzer. Approximately 0.1 g of filter sample was placed into a glass analysis tube. The sample was dried at 120° C. for 1 hour prior to analysis.

SEM Analysis. Scanning electron microscopy was completed in Harvard's Center for Nanoscale Systems on a Zeiss FESEM Supra55VP. Scanning electron micrographs were analyzed with ImageJ software.

### Example 1

### Design and Operation of the Electrochemical Filter

FIGS. 1A to 1G show images of one embodiment of the electrochemical filtration apparatus and set-up. A commercial 47 mm polycarbonate filtration casing (Whatman) as shown in FIG. 1C was modified to allow for simultaneous electrochemistry. Two holes were drilled in the upper piece of the filtration casing as openings for the cathodic and anodic leads. The main components of the electrochemical filter casing are the perforated stainless steel cathode (1) separated with an insulating silicone rubber seal (2) from the titanium (Ti) anodic ring-connector (3) (FIG. 1D). When the filtration casing is sealed, the anodic Ti ring (3) is pressed into the carbon nanotube filter (4) (FIG. 1E) for electrical connectivity. FIGS. 1F and 1G show images of the MWNT filters mats prior to and after electrochemical filtration, respectively.

FIG. 2A to 2F show both aerial and cross-section SEM images of the MWNT filter. The MWNT mat is composed of randomly-oriented MWNTs (<d>=15 nm, <l>=100 μm, 4-5% residual Fe catalyst, Nanotech Labs). The SEM images were analyzed by ImageJ to determine average pore size, 115.2±46.7 nm, and height, 41.1±7.6 μm. The MWNT network has an effective filtration area of 706 mm². The total volume of the filter (not excluding CNTs) is 0.029 mL, thus an upper limit for liquid residence time at 1.5 mL min⁻¹ in the filter is τ≦1.2 s. The density of the filter is 0.36 g cm⁻³ and the bulk density of the MWNTs is 2.3-2.4 g cm⁻³ resulting in ˜85% pore volume. The specific surface was measured to be 88.5±4.3 m² g⁻¹, thus each filter of 41-μm thickness has ˜1.05 m² of total MWNT surface area.

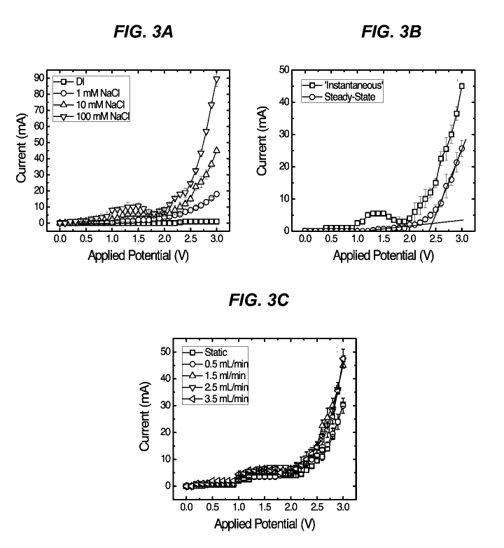

FIGS. 3A to 3C show I-V curves for sodium chloride electrolyte solutions. In FIG. 3A, the instantaneous current of the aqueous solution flowing at 1.5 mL min⁻¹ is plotted as a function of applied voltage and NaCl concentration where ‘instantaneous’ is defined as the initial current value displayed. At all potentials, the current increases with increasing electrolyte concentration. When NaCl is present, the current increases linearly with increasing potential above 2.3 V. This corresponds to the one-electron oxidation of chloride; Cl⁻+h⁺→Cl. (E⁰=2.4 V) (31). At the higher NaCl concentrations (10 and 100 mM), there is broad current peak from 0.7 to 1.7 V. In one embodiment, the MWNTs utilized contain 4-5% residual iron catalyst (Nanotech Labs). Thus, this broad peak can correspond to iron oxidation. This is consistent with FIG. 3B that compares the ‘instantaneous’ to ‘steady-state’ current where ‘steady-state’ is the current after 10 s at a chosen potential. In the ‘steady-state’ I-V curve, the broad peak has disappeared indicating that there is finite amount of a current generating species at the MWNT surface, such as the residual iron catalyst. The electrochemical filtration process at 3 V decreases the unbuffered input fluid pH ˜6.3 slightly to ˜5.3. The effect of liquid flow rate on the electrochemical MWNT filter I-V curves is presented in FIG. 3C. The current is observed to slightly increase with increasing flow rate, but the magnitude of the effect is relatively small.

### Example 2

### Dye Adsorption to the MWNT Filter in the Absence of an Applied Voltage

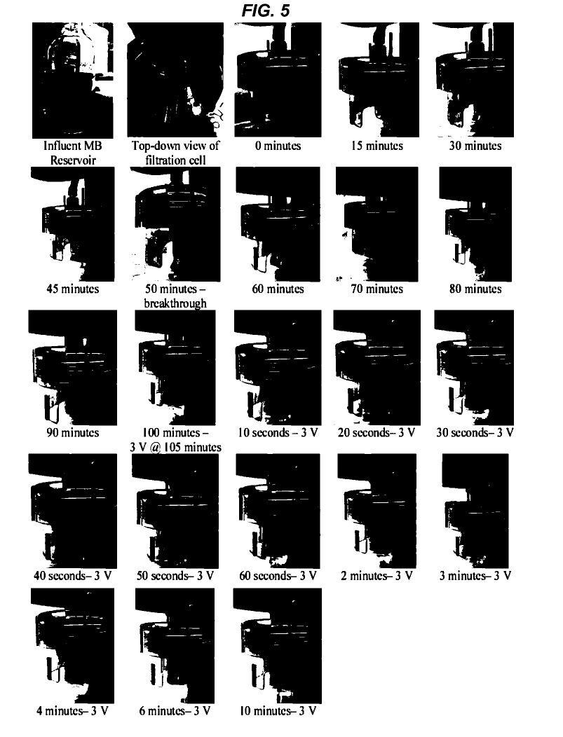

FIG. 4A shows a schematic diagram of dye adsorption to the MWNT filter and FIG. 4B shows the methylene blue (MB) adsorption breakthrough curve, [MB]_{eff}/[MB]ᵢₙ vs. t, in the absence of electrochemistry for three MWNT filters of varying physical dimensions ([MB]ᵢₙ=7.0±1.0 μM, [NaCl]ᵢₙ=10 mM, J=1.5±0.1 mL min⁻¹). The squares, circles, and triangles represent filters having average height (h) and diameter (d) of h=41 μm and d=30 mm, h=68 μm and d=30 mm, and h=41 μm and d=40 mm, respectively. In all cases, the methylene blue concentration of the output fluid was below the limit of detection prior to breakthrough, indicating that all MB molecules had at least one collision that could result in sorption with the MWNT surface during a single pass through the filter of ≦1.2 s. Images of the filtration set-up during the MB adsorption process are shown in FIG. 5. The MB sorption capacities of the three filters were 28.5 mg g⁻¹, 29.0 mg g⁻¹, and 26.4 mg g⁻¹, lower than previous reports for dye adsorption to MWNTs (7). The specific BET surface area of the MWNT filter was independent of filter physical dimensions and determined to be 88.5±4.3 m² g⁻¹ and the area per MB molecule adsorbed for the three filters was 163, 161, and 176 Å² per molecule. The molecular area of methylene blue has been estimated to be 160 Å² (32), indicating that MB adsorption to the MWNT filters occurs until monolayer coverage.

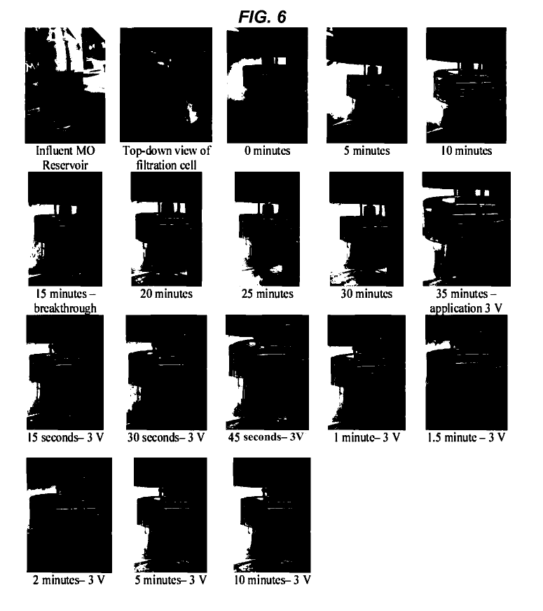

FIG. 4C shows the methyl orange (MO) adsorption breakthrough curve, [MO]_{eff}/[MO]ᵢₙ vs. t, in the absence of electrochemistry for three MWNT filters of similar physical dimensions ([MO]ᵢₙ=25.0±2.0 μM, [NaCl]ᵢₙ=10 mM, J=1.5±0.1 mL min⁻¹). The squares, circles, and triangles represent adsorption experiments completed on three different MWNT filters having average height (h) and diameter (d) of h=41 μm and d=30 mm to display the repeatability of the procedure. In all cases, the methyl orange concentration of the output fluid was below the limit of detection prior to breakthrough indicating that all MO molecules had at least one collision that could result in sorption with the MWNT surface during a single pass through the filter of ≦1.2 s. The results of the three runs were quite similar showing the reproducibility of the adsorption process. The filtration set-up during the MO adsorption process is similar to that for MB adsorption process and is shown in FIG. 6. The lower MWNT sorption capacities observed in one embodiment are likely due to a lower MWNT filter specific surface area, 88.5 m² g⁻¹, as compared to other carbon nanotubes that can have >500 m² g⁻¹ (3). The filter surface area per adsorbed MO molecule was 144 Å² per molecule, slightly less than observed for methylene blue, and also indicative of monolayer formation. In addition, the filter MO sorption capacity was 30.0 mg g⁻¹, slightly higher than the MB, but still lower than the range of dye adsorption to MWNTs (80-250 mg g⁻¹) previously reported in Fugetsu B et al. (7). Unlike embodiments of the invention, Fugetsu B. et al.'s configuration (7) involves carbon nanotubes made into a composite with a biopolymer, e.g., alginate, and the CNT-alginate composite was solely used as an adsorbate material. The CNT-alginate composite was put into the aqueous solution with chemical contaminants and stirred until all of the contaminants adsorbed to the CNTs. Hence, no filtration or electrochemistry was involved in Fugetsu B. et al.'s process (7).

The complete removal of methylene blue and methyl orange from the input fluids during a single pass (≦1.2 s) through the thin (h=41 μm, d=30 mm) MWNT filter demonstrates the ability of the filter for adsorptive removal of aquatic contaminants from solution. Without wishing to be bound by theory, the efficient adsorptive removal at microfiltration flow rates (130 L m⁻² h⁻¹) is due to strong affinity of the dyes to the MWNT surface (7), the large MWNT surface area (specific surface area=88.5 m² g⁻¹, surface area=1.05 m²), and the MWNT filter pore size. For example, the average MWNT filter pore diameter is 115±47 nm, thus if a dye molecule is at the center of the largest pore, the maximum distance to an MWNT surface is (115+47)/2=81 nm. The maximum dye diffusion time to the MWNT surface can be estimated by t_{d}=l_{d}²/(2D) using the aforementioned maximum distance and a diffusion coefficient (D=10⁻⁵ cm² s⁻¹) and t_{d} is determined to be 10³ nm² μs⁻¹ (33). Thus, a dye molecule in the input fluid will collide with an MWNT surface in the filter with a maximal characteristic time of 3.3 μs, and thus during the filter residence time (τ≦1.2 s), a single dye molecule could have 100's of collisions with an MWNT interface. FIGS. 4B and 4C show that there was very little or zero contaminant (dye molecules) in the output fluid for the first 60 and 20 minutes, respectively. Without wishing to be bound by theory, since no electrolysis was taking place, the dye molecules in the input fluid were reduced or removed by adsorption to the CNT surface. This indicates that during this time period, every dye molecule going through the filter should be removed by adsorption to the CNT surface. Adsorption to the CNT first requires a collision with the CNT surface (and there could be many collisions), and second requires that one of these collision be adsorption. Accordingly, due to the affinity of planar dye for the MWNT surface, one of these collisions will be adsorptive, in agreement with results presented in FIGS. 4B and 4C.

### Example 3

### Electrochemical Desorption and/or Oxidation of Adsorbed Dye

Due to the thin film nature of the filter, the total adsorptive capacity of the MWNT filter is relatively low, i.e., dye breakthrough occurs in <2 h. Therefore, there is a strong need to improve the filtration efficiency of MWNT filter. In some embodiments of the invention, the adsorbed dye and/or the dye in the input fluid is oxidized by application of a voltage potential of 1 to 3 volts after a dye monolayer on the MWNTs has been formed. FIG. 7A shows a schematic diagram of electrochemical desorption and/or oxidation of adsorbed dye on the MWNT filter. FIG. 7B shows the electrochemically-mediated desorption and/or oxidation of adsorbed methylene blue (MB) as a function of an applied potential where the squares, circles, and triangles represent 1 volt, 2 volts, and 3 volts, respectively. Images of the filtration set-up during MB desorption at an applied potential of 3 volts are shown in FIG. 5. MB was initially run through the filter for at least 150 minutes to form an MB monolayer on the MWNT filter surface. At t=0 and marked by the dashed line in FIG. 7B, a potential was applied to the electrochemical cell during MB filtration. At all potentials, the first aliquot of the collected output fluid contained a greater concentration of MB than in the input fluid, i.e., [MB]_{eff}/[MB]ᵢₙ>1, suggesting that the adsorbed MB is electrostatically desorbed. Without wishing to be bound by theory, anodic operation of the MWNT filter can result in accumulation of positively charged holes at the anode surface and/or generation of protons near the MWNT interface. Accordingly, positively-charged methylene blue at the unbuffered pH 6.3 used for the experiments described herein can be electrostatically desorbed. The increase in MB concentration of the output fluid was correlated with the applied potential, i.e., ([MB]_{eff}/[MB]ᵢₙ at about 3 volts=˜20)>([MB]_{eff}/[MB]ᵢₙ at about 2 volts=˜6)>([MB]_{eff}/[MB]ᵢₙ at about 1 volt=˜2), which is consistent with an electrostatic desorption mechanism. In all cases, upon continued electrolysis, the [MB]_{eff}/[MB]ᵢₙ quickly decreased until it achieved an equilibrium value of about ˜1 for ˜1 volt and <0.02 for 2 volts or 3 volts (see the inset of FIG. 7B). Thus, in the cases of 2 volts or 3 volts, the MB was not only desorbed electrostatically, but was also electrochemically oxidized to yield a colorless species.

FIG. 7C shows the electrochemical oxidation of adsorbed methyl orange (MO) as a function of an applied potential where the squares, circles, and triangles represent 1 volt, 2 volts, and 3 volts, respectively. Images of the filtration set-up during MO desorption at an applied potential of 3 volts are shown in FIG. 6. MO was initially run through the filter for at least 60 minutes to form an MO monolayer on the MWNT filter surface. At t=0 and marked by the dashed line in FIG. 7C, a potential was applied to the electrochemical cell during the MO filtration. In contrast to the methylene blue results, no desorption of the methyl orange is observed upon application of potential to the electrochemical cell. This is consistent with an electrostatic desorption mechanism since the sulfonated methyl orange will be negatively charged over all solution conditions used in these experiments and will thus be attracted to the positively-charged MWNT anodic filter. In all cases, there is an immediate decrease in [MO]_{eff}/[MO]ᵢₙ, which continues for ˜5 minutes when the [MO]_{eff}/[MO]ᵢₙ reaches an equilibrium value of [MO]_{eff}/[MO]ᵢₙ=˜0.8 for ˜1 volt, [MO]_{eff}/[MO]ᵢₙ<0.02 for ˜2 V, and [MO]_{eff}/[MO]ᵢₙ=˜0.1 for ˜3 V. While application of a greater potential should result in more significant oxidation of organics in the input fluid, the equilibrium [MO]_{eff}/[MO]ᵢₙ value for ˜3 V is determined to be greater than that for ˜2 volts. However, increased electrolytic gas bubble formation (anode-O₂/cathode-H₂) at a higher potential may disrupt the filtration process by clogging pores and thus electrocatalytic sites, or by breaking MWNT-MWNT contacts, which in turn reduces electrical connectivity and thus results in a loss of electrochemical activity. This phenomenon will be discussed below in greater detail in Example 5 on iodide oxidation where it is more prominent. It should be also noted that the characteristic time for the electrochemical oxidation of MO to reach steady-state (˜5 min) is shorter than that for MB (˜15 min), indicating that the electrostatic attraction/repulsion of the dye to the MWNT surface can also affect the dye oxidation efficiency.

The images in FIG. 6 yield insight into near-surface charging effects that may account for the electrostatic desorption process. Methyl orange is a pH indicator that gradually turns from yellow to red as the pH is decreased below 4.5 (34). Upon application of 3 V to an adsorbed MO monolayer, the output fluid solution in FIG. 6 takes on a pink to red color, indicating a decrease in pH below 4.5, and thus there is a significant production of protons at the MWNT anode surface. This decrease in pH is greater than observed for 10 mM NaCl alone (pHᵢₙ 6.3 and pH_{eff} 5.3). In some embodiments, this decrease in pH can be due to fast multi-electron oxidation of the adsorbed MO monolayer yielding protons. Accordingly, without wishing to be bound by theory, a quick and significant increase in proton concentration near the MWNT anode surface can mediate the desorption of a positively-charged dye such as methylene blue, consistent with observations in FIGS. 5 and 7B.

The electrochemical desorption and oxidation of adsorbed dyes and dyes in the input fluid occurs quite rapidly with equilibrium oxidation of ≧90% of the input fluid dye at ˜2 volts and ˜3 volts being achieved within 10 minutes. The electrostatic desorption and oxidation of dyes shows the ability of the electrochemical MWNT filter as a self-cleaning filter. By applying the appropriate potential, an adsorbed compound can be electrostatically desorbed and collected as a more concentrated solution while simultaneously regenerating the adsorbent material, the reverse of electro-filtration (35). Alternatively, if the adsorbed species is an undesirable contaminant, a higher potential can be applied to oxidatively degrade the adsorbed compound. However, the electrochemical oxidation of the dyes in the input fluid can be decreased by adsorbed dye or its oxidation by-products consuming all of the reactive MWNT surface sites.

### Example 4

### Electrochemical Dye Filtrations

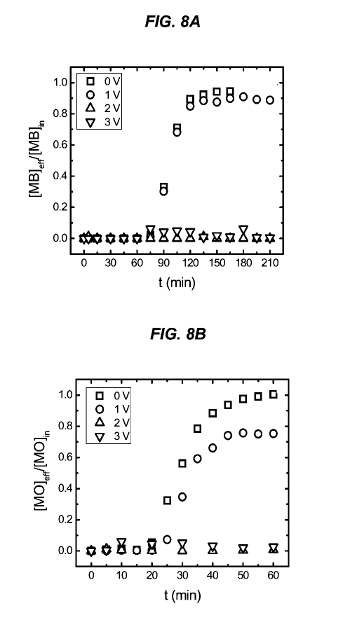

Accordingly, it was sought to evaluate only oxidation of dyes in an input fluid by applying a potential of 1 volt, 2 volts, or 3 volts prior to flowing any dye solution through the filter. FIG. 8A shows the results of the electrochemical filtration of methylene blue over a range of applied potentials (0-3 V) under conditions of [MB]ᵢₙ=7.0±1.0 μM, [NaCl]ᵢₙ=10 mM, and J=1.5±0.1 mL min⁻¹. The application of ˜1 V results in an adsorption isotherm that is nearly identical to the isotherm in the absence of potential. The lack of MB oxidation at ˜1 V is in agreement with the one-electron oxidation potential of MB (MB+H⁺→MB.⁺, E⁰=˜1.1 V) (36). The identical adsorption isotherms observed at 0 volt and 1 volt indicate that the MB desorption observed at ˜1 volt (FIG. 7B) is also a function of the extent of dye monolayer formation on the MWNT filter surface. The application of ˜2 volts or ˜3 volts results in the removal and/or oxidation of >98% and >93% of the dye in the input fluid at all points in time, respectively. The absence of dye breakthrough at 2 volts and 3 volts indicates that the primary MB loss mechanism is oxidation. As discussed earlier, ˜2 volts is observed to be more effective than ˜3 volts towards dye oxidation, indicating that application of ˜3 volts may be detrimental to the operation of the electrochemical MWNT filter.

FIG. 8B shows the results of the electrochemical filtration of methyl orange over a range of applied potentials (0-3 V) under conditions of [MO]ᵢₙ=25.0±2.0 μM, [NaCl]ᵢₙ=10 mM, and J=1.5±0.1 mL min⁻¹. The application of ˜1 V results in a slight delay in the dye breakthrough as compared to the 0 V conditions and a slight decrease in [MO]_{eff}/[MO]ᵢₙ=0.8. This is similar to the equilibrium MO concentration of the output fluid as shown in in FIG. 4B. A recent study (37) evaluated the MO oxidation potential as a function of pH, which was observed to increase with decreasing pH (0.3 volts at pH 7 to 0.7 volts at pH 3). The MO input fluid solution is unbuffered at pH 6.3 and the estimated MO oxidation potential, E^{pH 6.3}=0.37, is at variance with the observed extent of MO oxidation, i.e., most of MO in the input fluid should have been oxidized at pH 6.3 and at 1 volt. The variance between the theoretical and experimental results suggests that the solution near the anodic MWNT surface has a lower effective pH than the bulk water and is consistent with the observed pH decrease during electrochemical MO monolayer oxidation in FIG. 6. There was no shift in the MO UV-Vis adsorption peak of the output fluid, suggesting that this is a surface phenomenon. The application of ˜2 volts and ˜3 volts during MO filtration resulted in the removal and/or oxidation of >98% and >93% of the dye in the input fluid at all time points, respectively. The absence of dye breakthrough at ˜2 volts and ˜3 volts indicates that the primary MO loss mechanism during electrochemical filtration is oxidation. The results are in agreement with the methylene blue electrochemical filtration results.

The >90% oxidation of methylene blue and methyl orange in an input fluid during a single pass through the MWNT filter (h=˜41 μm, d=˜30 mm) is an impressive result since the characteristic solution residence time within the filter is ≦˜1.2 s. The efficient oxidation of these dyes shows the ability of the electrochemical MWNT filter for degradation of aqueous organic contaminants. In some embodiments, the efficacy of the anodic MWNT filter towards dye oxidation can be enhanced by the strong affinity of planar aromatic molecules for the sp²-conjugated nanotube surface (6,7).

### Example 5

### Electrochemical Anion Filtration

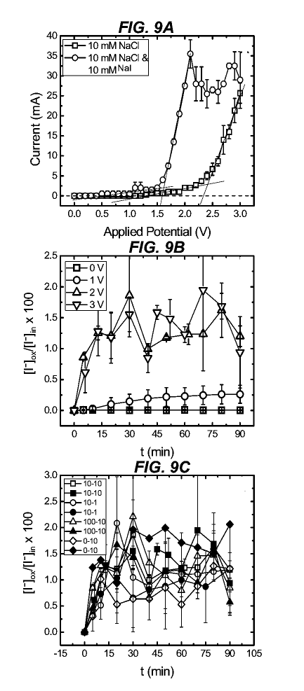

Next, to investigate the importance of adsorption to the oxidation process, it was sought to compare the reactivity of organic dyes, e.g., MB and MO, to aqueous species that can have a weaker affinity for the MWNT surface. Presented herein is the electrochemical filtration of the aqueous anions chloride (Cl⁻) and iodide (I⁻). FIGS. 9A to 9C show I-V curves and the electrochemical filtration of the aqueous chloride and iodide solutions. The steady-state I-V curves for 10 mM NaCl (squares) and 10 mM NaCl-10 mM NaI (circles) flowing at 1.5 mL min⁻¹ in FIG. 9A can both be described with two straight lines. Regarding the ‘steady-state’ I-V curve for NaCl, the first line crosses zero mA at 1.25 V representing the onset of the two-electron oxidation of chloride to chlorine (2Cl⁻+2H⁺→Cl₂, E₀=1.36 V) (38), and the second line crosses the zero mA at 2.3-2.4 V representing the one-electron oxidation of chloride to Cl-atom (Cl⁻+H⁺→Cl.). Similar to chloride, the first iodide line represents a two-electron oxidation process yielding iodine (2I⁻+2H⁺→I₂, E⁰=0.55 V) (38), and the second line represents a one-electron oxidation process yielding I-atom (I⁻+H⁺→I., E⁰=1.5 V) (31). The point where the extrapolation of these lines crosses 0 mA represents the threshold potential for anodic MWNT oxidation of ions. In both cases, there is minimal oxidation overpotential at the MWNT anode. The current peak for the NaCl—NaI solution occurs at ˜2.0 V indicating an optimal potential for iodide oxidation during electrochemical filtration. Upon increasing the applied potential above 2 V, the NaCl—NaI current decreases until the onset of Cl⁻ oxidation at 2.5 V where the current begins to increase again.

FIG. 9B shows the results of the electrochemical MWNT filtration at 1.5 mL min-1 of the 10 mM NaCl-10 mM NaI solution over a range of applied potentials (0-˜3 V). The percent iodide oxidized, [I⁻]ₒₓ/[I⁻]ᵢₙ×100, is plotted as a function of time where [I⁻]ₒₓ=2[I₃⁻]. In the absence of applied potential, I⁻ is not oxidized during filtration. Application of ˜1 volt results in the gradual increase of iodide oxidation with time until a plateau of ˜0.3% oxidation is achieved after 60 minutes of filtration. At ˜1 volt, the two-electron process is the only thermodynamically allowed oxidation pathway and thus requires 2 I⁻ to be in close proximity to each other on the MWNT filter surface. Thus, the lag in achieving the steady-state oxidation value can be a result of the slow adsorption of I⁻ to the MWNT surface. Application of 2 volts or 3 volts results in the steady-state oxidation of 1% to 2% (or 100 to 200 μM) of the iodide in the input fluid. At ˜1.5 mL min⁻¹, the maximum rate of I⁻ oxidation is 3×10¹⁵ molecules s⁻¹, which can be compared to the average current (3-6 mA at ˜2 V, 5-10 mA at ˜3 V) to determine average anodic iodide oxidation current efficiencies of 8 to 16% at ˜2 volts and 5 to 10% at ˜3 volts. The MWNT area per I⁻ oxidation site can be estimated by dividing the total MWNT surface area of 1.05 m² by the maximum iodide oxidation rate and multiplying by the liquid retention time of ˜1.2 s to yield ˜45,500 Å² per molecule. This is significantly greater than areas observed for adsorption of MB (165 Å²) and MO (144 Å²), and the estimated iodide molecular area (33) of 20 Å². The significant difference between electrocatalytic site area (˜45,500 Å²) and molecular area (20 Å²) indicates that only a fraction of the MWNT surface sites are active towards iodide oxidation. To confirm this, the electrochemical filtration of various NaCl—NaI mixtures (10 mM NaCl-1 mM NaI, 100 mM NaCl-10 mM NaI, and 10 mM Nap were performed and investigated (FIG. 9C). In all cases, the steady-state percent of iodide oxidized fell between 0.5-2.0%, confirming that F oxidation is limited by electrocatalytically-active MWNT surface sites.

It is of note that in all cases in FIG. 9B, there is variation in the steady-state iodide oxidation values. This was correlated with observations of oscillations in both the flow rate of the output fluid and the steady-state current. At ˜2 volts, the steady-state current oscillated between 5 and 20 mA and at ˜3 volts the steady-state current oscillated between 0 and 25 mA. The low current values corresponded to points in time when the output fluid flow was significantly reduced and the high current values corresponded to points in time when the output fluid flowed as expected. It was next assessed whether the oscillating flow rate may have been due to electrolytic gas formation that resulted in blockage of MWNT filter pores. Accordingly, the gas was vented by removing the tubing of the input fluid, which resulted in a jet or spray of liquid out of the filter casing. After replacement of the tubing, a significantly higher current value of ˜30-50 mA at ˜2 V and ˜80-100 mA at ˜3 V was observed for a brief period, e.g., <5 s, and soon thereafter the current and flow oscillation resumed. To resolve the issue of electrolytic gas accumulation blocking MWNT filter pores, one solution can be the incorporation of a pressure release valve to continually vent electrolytically produced gas. Alternatively, the system can be operated gravimetrically such that the top of the system was open to atmosphere for gas release. In another embodiment, the cathode can be placed after the anode such that, hydrogen produced at the cathode can be hydrodynamically carried out of the system rather than driven into the porous MWNT anode.

### Example 6

### Comparison of One Embodiment of the Invention with the Previously Reported Electrochemical Wastewater Treatment Systems

Yang et. al. (30) reported on an activated carbon felt-carbon nanotube electrochemical seepage filter for the oxidation of Brilliant Red X-3B, which is compared herein to the electrochemical filter of the invention and oxidation of methyl orange demonstrated herein.

TABLE 1
Comparison of Yang et.al.'s electrochemical filter properties,
solution conditions, and dye oxidation performance to experimental
conditions and results of one embodiment of the invention

| Filter Property or | Yang et.al., | One embodiment |
|---|---|---|
| Operational Condition | ES&T, 2009 (30) | of the invention |
| Cathode Composition | MWNT-powder packed | Perforated |
| | between activated | stainless-steel |
| | carbon felt | |
| Anode Composition | MWNT-powder packed | Free-standing |
| | between activated | MWNT network |
| | carbon felt | |
| Mass CNT | 0.5 g | 0.02 g |
| Flux Area Filter | 2,800 mm² | 700 mm² |
| Mass CNT per Filter | 178.5 g m⁻² | 28.5 g m⁻² |
| Area | | |
| Filtration Configuration | Recirculating | Single-Pass |
| Reservoir Size | 300 mL | n/a |
| Volumetric Liquid Flow | 80 mL min⁻¹ | 1.5 mL min⁻¹ |
| Rate | | |
| Volume Flow Rate per | 1,700 L m⁻² h⁻¹ | 130 L m⁻² h⁻¹ |
| unit Surface Area | | |
| Input Fluid pH | 7.0 | 6.3 |
| Electrolyte Species and | [Na₂SO₄] = 20 mM | [NaCl] = 10 mM |
| Conc. | | |
| Applied Potential | 10 V | 2 V |
| Target Species | Brilliant Red X-3B | Methylene Blue |
| | (50 mg L⁻¹, 60 μM) | (8 μM) |
| | | Methyl Orange |
| | | (24 μM) |
| Performance | >95% decolorization | >98% decolorization |
| | after 90 minutes | after single pass |

As shown in Table 1, there are a number of differences between the two experimental set-ups (Yang et. al. vs. one embodiment of the invention) including (1) cathode (MWNT-packed activated carbon felt vs. perforated stainless steel), (2) anode (MWNT-packed activated carbon felt vs. free-standing porous MWNT network), (3) filter area (2,800 mm² vs. 700 mm²), (4) CNT mass per area (178.5 g m⁻² vs. 28.5 g m⁻²), (5) configuration and flow rate (recirculating/300 mL reservoir/80 mL min⁻¹ vs. single-pass/1.5 mL min⁻¹), and (6) applied potential and steady-state current (10 V/Not Available vs. ˜2 V/˜1 mA). Accordingly, the flow rate used herein was normalized by the relative areas to yield an equivalent flow rate of 6 mL min⁻¹, assuming that flow rate is proportional to filter area. Yang et. al. reported that after 90 minutes >95% of the initial 300 mL of 60 μM X-3B had been decolorized or a total of 18 μmoles of X-3B had been partially oxidized. In a single-pass in the system described herein, >98% of the 24 μM methyl orange had been decolorized, or stated in another way, after 90 minutes of a flow rate at 6 mL min⁻¹, a total of 13 μmoles of methyl orange had been partially oxidized, which is slightly less than Yang et. al.'s system. The lower extent of oxidation demonstrated by the filtration apparatus described herein can be due to the lower applied potential (2 V vs. 10 V), and the lower mass of CNTs per filter area (28.5 g m⁻² vs. 178.5 g m⁻²) indicative of reducing active surface area.

The filtration apparatus of the invention can be improved, e.g., by modifying MWNT material and/or structure. For example, boron-doped diamond (BDD) anodes have been previously reported to be superior to platinum and glassy carbon towards phenol and formate oxidation (39) and are able to mineralize the atrazine (51), a recalcitrant pesticide. Improvements in BDD anode performance towards 2,4-dichlorophenoxyacetate oxidation and mineralization are also previously reported when the BDD is coated with Sb-doped SnO₂ nanoparticles due to their superior electrocatalytic properties (41). BDD methanol electrooxidative performance has also been previously improved by addition of a porous, 3D platinum (Pt) structure perpendicular to the BDD surface (40). The high-surface area porous Pt increases the number of electrocatalytically-active surface sites, while the BDD anodic surface acts to limit Pt passivating products. Accordingly, the design of new anode materials and structures based on boron-doped diamond (BDD) (39-41), Sb-doped SnO₂ (42,43) and Bi-doped TiO₂ (44,45) can be used to improve the electrochemical CNT filter presented herein. These anode materials are exemplary due to a combination of properties such as high O₂ overpotential, oxidative/corrosion stability, high conductivity, and high yield of surface-bound hydroxyl radicals. For example, one strategy is to coat the MWNT filter described herein with doped-SnO2 nanoparticles to improve its electrocatalytic activity. Alternatively, the electrocatalytic activity of the MWNT filter described herein can be enhanced by addition of porous Pt. Further, hybrid electrooxidation technologies such as microwave-assisted BDD electrooxidation (46), photoelectrocatalysis (47,48) and electro-Fenton processes (49,50) can be integrated into the filtration apparatus of the invention.

In summary, an electrochemical MWNT filter demonstrated herein is effective for the adsorptive removal and electrochemical desorption and oxidation of the aqueous dyes, e.g., methylene blue and methyl orange. At an applied voltage of ˜2 volts or ˜3 volts, a single pass through the ˜41-μm thin, ˜30-mm diameter MWNT filter in ≦1.2 s can result in oxidation of >90% of the dye in the input fluid. Without wishing to be bound by theory, the efficient removal and oxidation of these dyes is due to their planar aromatic structure that promotes adsorption to anodic MWNT surface. The aqueous anions chloride and iodide were also oxidized while passing through the anodic MWNT filter with minimal overpotential. The electrochemical oxidation of the anions in the input fluid was limited by the number of MWNT active surface sites towards their oxidation. These results demonstrate the ability of an electrochemical carbon nanotube filter described herein for the removal and oxidation of aqueous contaminants.

### Materials and Methods for Examples 7-10

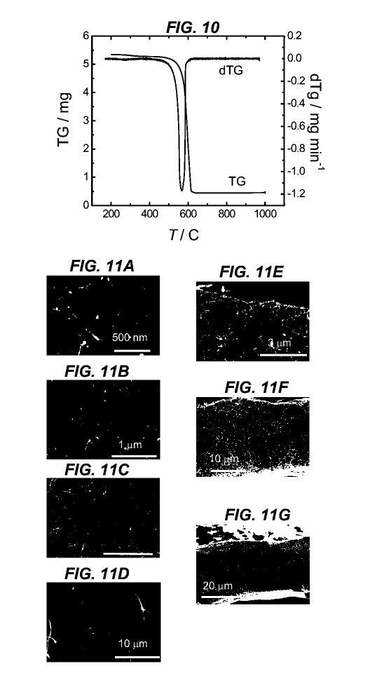

Electrochemical MWNT Filter Preparation and Characterization. The multiwalled carbon nanotubes (MWNTs) were used as received from NanoTechLabs, Inc. (Yadkinville, N.C.). The MWNTs were characterized previously in Kang et al. [30] and have a diameter distribution of 17±9 nm and a length distribution of 91±21 μm. Thermogravimetric analysis of the MWNTs (FIG. 10) showed they are composed of 1-1.5% amorphous carbon and 8-9% residual metal catalyst, which was mostly Fe as determined by EDX. The MWNT filters were produced by first dispersing the MWNTs in dimethylsulfoxide (DMSO) at 0.5 mg/mL and probe sonicating (Branson, Sonifier S450) for 15 min. Then, 6 mL of the sonicated MWNTs in DMSO were vacuum filtered onto a 5-μm PTFE membrane (Millipore, Omnipore, JMWP), resulting in filter loadings of 0.31 mg/cm² for the bacteria and bacteriophage experiments. The MWNT filters were washed sequentially with 100 mL ethanol (EtOH), 100 mL 1:1 DI-H2O:EtOH, and 250 mL DI-H2O to remove DMSO before use. Scanning electron micrographs of the MWNT filters at various length scales are presented in FIGS. 11A to 11G.

Solution and Electrochemistry. NaCl and Na₂SO₄ (EMD Chemicals) were selected as the background electrolytes for all experiments. They are both ubiquitous in aquatic systems and are commonly utilized for electrolytic water treatment. All of the virus electrolysis experiments were completed at 10 mM NaCl. To investigate the effect of ionic strength on bacterial toxicity and electrochemical bacterial inactivation, experiments were carried out at 1 mM, 10 mM, and 155 mM NaCl. Bacterial inactivation experiments were also performed with 10 mM Na₂SO₄ to evaluate the importance of reactive chlorine species formation. The electrochemistry was driven by an Agilent E3646A DC power supply. In all cases, electrolysis was completed at a constant voltage of ˜1 volt, ˜2 volts, or 3 volts for a duration of either 10 or 30 seconds. Current as a function of time was recorded during these experiments.

Preparation and Quantification of Bacteriophage MS2. MS2 viruses were purchased, along with their bacterial host Escherichia coli 15597, from the American Tissue Culture Collection (ATCC). The MS2 bacteriophage, commonly used as a conservative viral tracer in aquatic environments, was selected as a model virus for its relative ease of quantification and non-infectivity toward humans. The plaque formation unit (PFU) method was used to quantify the number of viruses (EPA Method 1601) as described in Brady-Estevez et al. [3]. Each MS2 sample to be measured was first diluted four times with DI water. Then, 1 mL of the E. coli host and 1 mL of viral sample were added to 4 mL of molten soft agar, thoroughly mixed, and then poured onto a TSA agar plate. Each analysis was completed in at least duplicate. As a control, the original MS2 solution was diluted six times and then quantified.

Bacteriophage MS2 Removal, Inactivation, and Determination of Viability. MS2 bacteriophage, at a starting concentration of 10⁶ PFU mL⁻¹, was used for all viral experiments. The viral suspension (10 mL, 10 mM NaCl) was pumped through the MWNT filter at a flow rate of 4 mL min⁻¹ (250 L m⁻² h⁻¹) using a peristaltic pump. Filter permeate samples were collected in an autoclaved glass tube and the virus concentration was determined by the PFU method.

To evaluate the viability of the viruses adsorbed on the MWNT filter, the filter was rinsed with 10 mL of virus-free 10 mM NaCl after the viral filtration. Next, the MWNT filter with adsorbed viruses was removed from the electrochemical cell and transferred into an autoclaved glass vial containing 10 mL of 10 mM NaCl. The vial was bath sonicated for 2 min to remove the MWNTs from the PTFE filter and suspend them in solution. The viruses in the suspended MWNTs (adsorbed to MWNTs and in solution) were then quantified by the PFU method.

Preparation of E. coli. Escherichia coli K12 was selected as the model organism for the electrochemical inactivation experiments. E. coli K12 were grown in LB medium at 37° C. and harvested at mid-exponential growth phase. Cells were washed twice and resuspended in saline solution (0.9% or 155 mM NaCl) before exposure to the MWNT samples. Cells were enumerated by their optical density at 600 nm.

Electrochemical Inactivation and Determination of E. coli Viability. A fluorescence-based assay that quantifies cells with compromised membrane permeability was used to evaluate bacterial viability. Isotonic saline solution (30-40 mL, 155 mM NaCl) containing 10⁷ E. coli cells was first flowed through the MWNT filter. For the non-electrochemical experiments (i.e. MWNT filter with no applied voltage), the sieved bacteria were immediately stained. For the electrochemical experiments, the MWNT-filter with bacteria was moved to the electrochemical filtration casing. The electrochemical filter cell was then filled with the appropriate salt solution and electrolyzed. After the electrochemistry was complete, the MWNT filter was immediately rinsed with 155 mM NaCl and stained for the viability assay.

For the fluorescence-based, nucleic acid assay, E. coli cells were stained with propidium iodide (PI, 50 μM) for 15 min at 37° C., and subsequently counter-stained with 4′,6-diamidino-2-phenylindole (DAPI, 4 μM) for 5 min in the dark. The stained bacteria were imaged with an epifluorescence microscope (Olympus) with a U-filter (364 nm) for imaging cells stained with both PI and DAPI and an IB filter (464 nm) for detecting cells stained with only PI. Eight to ten representative images from different locations on each filter were captured for subsequent data analysis through direct counting methods. At least 1,000 cells were counted for each experiment. The percentage of inactivated cells was determined by the ratio of cells stained with PI to those stained with DAPI plus PI (i.e., all stained cells).

Cell Fixation and Scanning Electron Microscopy (SEM). SEM was performed to examine the effects of electrochemistry on cell morphology of E. coli on the MWNT filters. After completion of the electrolysis, the filters were first rinsed with 155 mM NaCl and subsequently fixed with glutaraldehyde and osmium tetroxide. SEM samples were coated with Pt and imaged using a Hitachi SU-70 HR-SEM.

Dye Oxidation and Fluorescence Shift by Reactive Chlorine Species. Propidium iodide (PI) fluorescence emission scans (λₑₓ=450 nm, λₑₘ=500-750 nm) were completed on a Jvon Yobin FluoroMax spectrofluorimeter. PI (1.2 mL, 50 μM) was placed into a fluorescence cuvette. Hypochlorous acid (HOCl, 50 mM) was added to the PI solution in 1 μL aliquots and thoroughly mixed. Fluorescence emission scans were completed after each addition of HOCl.

Presented herein is the design and operation of a novel electrochemical multiwalled carbon nanotube (MWNT) microfilter for the simultaneous removal and inactivation of viral and bacterial pathogens. Experiments with both viruses (bacteriophage MS2) and bacteria (E. coli) demonstrated effective inactivation by the electrochemical MWNT microfilter at relatively low potentials (˜1 volt to ˜3 volts) and short electrolysis times (≦30 s). The electrochemical mechanism of enhanced pathogen removal and inactivation was investigated by determination of a loss in bacterial viability over a range of potentials and solution compositions, and by observations of aqueous oxidant production.

### Example 7

### Design and Operation of the Electrochemical MWNT Filter

A similar multi-walled carbon nanotube filter has been developed for removal of virus and bacterial as described in Example 1. A schematic and images of the multiwalled carbon nanotube (MWNT) electrochemically active filter set-up are presented in FIGS. 1A to 1F. The MWNT filter is operated anodically and is electrically connected via a titanium ring 3 and wire (FIG. 1D) to the DC power supply. A perforated stainless steel sheet 1 (FIG. 1D) is operated as the cathode, with an insulating silicone rubber o-ring 2 (FIG. 1D) separating the electrodes. The electrochemically active elements are incorporated into a polycarbonate 47-mm filter casing (Whatman).

FIGS. 11A to 11D present the top down SEM images of the MWNT filter in various length scales. The nanoporous filter had an aerial average pore diameter of 93±38 nm as determined from analysis of SEM images (ImageJ). The pore shape was quite heterogeneous. The side view SEM images of the MWNT filter thickness are presented in FIGS. 11E to 11G. The MWNT filter is observed to have an average thickness of 22±2 μm (ImageJ) for the MWNT loading of 0.31 mg cm⁻² used in this example.

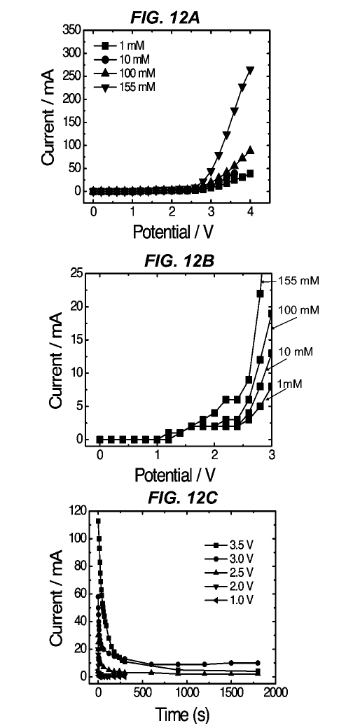

The electrochemical experiments in this example were run at a constant applied voltages or potentials of ˜1 volt, ˜2 volts, or ˜3 volts. The general operating conditions in the absence of pathogens are shown in FIGS. 12A to 12C. FIGS. 12A and 12B show current versus voltage curves over a range of NaCl ionic strengths (1-155 mM). At all ionic strengths, a small current began to flow at ˜1.3 V, indicating either four-electron water oxidation (2H₂O+4 h⁺→4H⁺+O₂, E₀=1.23 V) or two-electron oxidation of chloride (2Cl⁻+2 h⁺→Cl₂, E⁰=1.4 V) is occurring at the CNT anode [24, 25]. The threshold potential for the electrochemical system was around 2.3-2.4 V, above which the current increased linearly with increasing voltage and the slope of this increase was proportional to the ionic strength (FIG. 12B). The threshold electrochemical potential observed in FIG. 12B is in agreement with previous reports that also utilized NaCl as electrolyte, indicating that anodic Cl⁻ oxidation is the limiting half-cell reaction [25, 26]. Current versus time curves over a range of applied potentials (1.0-3.5 V) are shown in FIG. 12C. At all potentials, the current initially decreased with time and then leveled off with continued electrolysis. The majority of the current drop was within the first 5-10 s of operation, indicating that there is some component of the MWNT filter that was easily corroded, e.g., the residual elemental iron in the MWNTs.

### Example 8

### Removal of Bacteria and Virus by the Electrochemical MWNT Filter

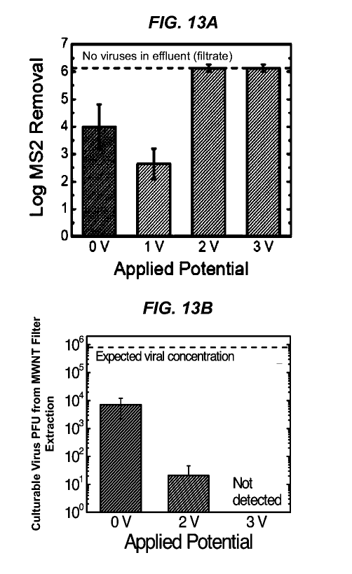

The removal of E. coli and bacteriophage MS2 by the MWNT filter was first evaluated in the absence of an applied potential. For E. coli removal, ˜10⁷ cells in 25 mL of 155 mM NaCl were gently vacuum filtered through ˜3 mg of MWNT (˜0.31 mg cm⁻²). A small volume (e.g., 100 μL) of the filtrate was spread over an agar plate and incubated overnight. No E. coli colonies formed indicating that all of the bacteria were removed by a sieving mechanism, consistent with the ˜100 nm aerial pore size of the MWNT filter (FIGS. 12A to 12G) and previous reports [2, 27]. For MS2 removal, ˜10⁷ viruses in 10 mL of 10 mM NaCl were filtered at ˜4 mL min⁻¹ (250 L m⁻² h⁻¹) through a ˜3 mg (˜0.31 mg cm⁻²) MWNT filter and the filtrate was analyzed by the plaque forming unit (PFU) method described in the earlier Materials and Methods. Under these conditions, the MWNT filter achieved on average 4.0±0.8 log removal of MS2 (FIG. 13A, 0 V), similar to previously reported SWNT and MWNT filters [2, 15]. These CNT filters remove viruses by a depth filtration mechanism [3].

The effect of concomitant electrolysis on virus (bacteriophage MS2) removal during filtration was carried out at ˜2 volts or ˜3 volts (FIG. 13A) by filtering 10 mL of ˜10⁶ viruses per mL at 4 mL min⁻¹ (250 L m⁻² h⁻¹) in 10 mM NaCl. The virus concentrations of the input and output fluids were quantified using the PFU method. At an applied potential of ˜2 volts and ˜3 volts, the log MS2 removal was determined to be greater than 6 and complete. In all electrochemical virus filtration experiments using an applied potential of ˜2 volts or ˜3 volts, no culturable PFU viruses were detected in the output fluid. The complete removal of viruses during a single pass through the electrochemical MWNT filter is significant in terms of pathogenic virus removal from drinking water as ingesting a single or more viral particle is sufficient to infect humans.

Without wishing to be bound by theory, the electrochemical enhancement of viral filtration can be explained by two mechanisms. The first mechanism could involve physicochemical filtration, where the MWNT anode electrochemically acquires a positive charge, resulting in a deposition (attachment) efficiency of ˜1 [28]. An attachment efficiency of ˜1, i.e., there are no repulsive electrostatic interactions between viruses and CNT filter media, has been previously reported for SWNT and MWNT filters under high ionic strength or low pH (below the MS2 virus isoelectric point) solution conditions [2, 15]. The second mechanism would involve electrochemical inactivation of viruses via oxidation at the MWNT interface. This would be similar to results reported for electrochemical bacteria inactivation at anodic elemental carbon interfaces [12, 13]. These prior-art anodic materials were either black carbon or activated carbon-based, which were formed into fibers or cloths. The carbon nanotubes as used herein are believed to be a substantially better anode material than the prior-art forms of elemental carbon-based materials, because carbon nanotubes can be used to easily produce porous thin films. In addition, such porous thin films have high mechanical and chemical stability, and are conductive. As the virus is filtered through the MWNT membrane, the viral capsid or possibly even the RNA can be electrochemically oxidized during a collision with the MWNT surface, thus effectively inactivating the virus.

The enhanced electrochemical removal of virus demonstrated herein is significant; however, adsorbed viruses could be released during continued filtration and/or concentrated in the filter backwash solution. Therefore, the effectiveness of electrochemical inactivation of viruses adsorbed to the MWNT filter was evaluated. Viruses were first adsorbed on the MWNT filter in the absence of an applied potential by filtering 10 mL of ˜10⁶ viruses per mL in 10 mM NaCl at ˜4 mL min⁻¹ (250 L m⁻² h⁻¹). Once the viruses were adsorbed onto the MWNT filter, the filter was either analyzed immediately for PFU (i.e., 0 V condition), or after a potential of ˜2 volts or ˜3 volts was applied for ˜30 s (FIG. 13B). It should be noted that the application of potential for ˜30 seconds is much less than the ˜150 seconds required for the filtration of 10 mL at ˜4 mL min⁻¹. Hence, these experiments should be considered as a lower limit of the electrochemical inactivation occurred during the actual filtration experiments (FIG. 13A).

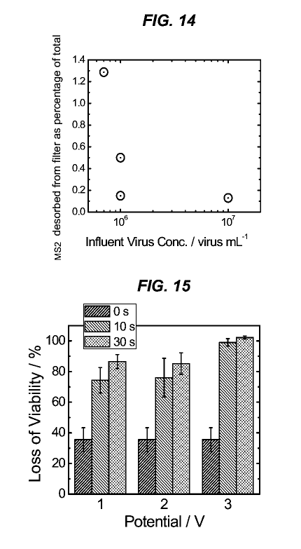

The viruses adsorbed to the MWNT filter were desorbed by ultrasonication into 10 mM NaCl and the resulting solution, which included the suspended MWNTs, was then quantified by the PFU method. FIG. 14 shows the culturable MS2 desorbed from the MWNT filter as a percentage of total MS2 adsorbed on the filter, where total MS2 adsorbed is calculated from the difference in viral concentrations between the output and input fluids. It is of note that on average only ˜0.5% of the total viruses adsorbed to the filter were detected by the PFU analyses after ultrasonic desorption. Since non-culturable viruses could not be measured, a viral mass balance could not be achieved. Therefore, the virus PFU in FIG. 13B represents the culturable viruses adsorbed to MWNTs plus the culturable viruses released from MWNTs due to sonication and the dashed line represents the total MS2 adsorbed.

Application of either ˜2 volts or ˜3 volts for ˜30 seconds resulted in significant inactivation of viruses adsorbed to the MWNT filter: 7,100±5,000 PFU were detected when no potential was applied; 21±25 PFU were detected when ˜2 volts was applied, and 0 PFU were detected in all experiments when ˜3 volts was applied (FIG. 13B). The significant reduction in culturable viruses adsorbed to the MWNT filter after electrolysis at ˜2 volts or ˜3 volts indicates that electrochemistry not only enhances virus removal, but also electrochemically inactivates the adsorbed viruses. Multi-log virus inactivation after ˜30 seconds of electrolysis is faster than previously-reported electrochemical virus inactivation rates [5-7]. The fast inactivation kinetics of adsorbed viruses also suggest that viruses that collide with MWNTs via convective-diffusion during filtration, but do not adsorb, can also be electrochemically inactivated.

The E. coli were completely removed from the input fluid by a sieving mechanism as demonstrated earlier. Accordingly, the application of a potential to the MWNT filter will have no significant effect on bacterial removal. The electrochemical E. coli inactivation experiments were performed in multiple steps to reduce time spent outside of isotonic saline (155 mM NaCl) and to reduce toxic effects that may occur due to osmotic stress [29]. First, ˜10⁷ cells in 30-40 mL of 155 mM NaCl were deposited onto the MWNT filter. Next, the MWNT filter with deposited cells was placed in the electrochemical casing, filled with 10 mM NaCl solution, and electrolyzed for ˜10 s or ˜30 s at ˜1 volt, ˜2 volts, or ˜3 volts. Immediately after electrolysis, the MWNT filter was removed, washed with 155 mM NaCl, and stained with DAPI and PI for determination of cell membrane permeability. The results of the electrochemical inactivation of E. coli are shown in FIG. 15.

The baseline loss of E. coli membrane integrity on the MWNT filter in the absence of an applied voltage was determined to be 35.6±7.7%, which is slightly greater than previous reports with MWNTs and E. coli utilizing the same viability assay [30]. In all cases, electrolysis significantly increased the inactivation of bacteria deposited on the MWNT filter. The findings also demonstrated that bacterial inactivation increased upon increasing electrolysis time (from 10 s to 30 s) and/or the applied potential (from 0 V to ˜3 V). It is of note that the losses of bacterial viability at ˜1 V and ˜2 V were nearly identical. This finding suggests that the electrolytic inactivation mechanism occurring at these two voltages is similar and likely involves electrolytic oxidation of a specific biomolecule and/or electrolytic interruption of a vital cellular process. Previous reports on electrolytic bacterial inactivation on the elemental carbon cloth and fiber anodes at ˜1 V (vs. Normal Hydrogen Electrode NHE) suggested that oxidation of coenzyme A was the electrochemical process leading to cell death [12, 31]. Coenzyme A and its derivatives are important thiol-containing biomolecules involved in fatty acid synthesis [32] and the regulation of metabolism and cell signaling [33]. A recent study on SWNT bacterial cytotoxicity reported the correlation of toxicity with oxidation of glutathione [18], a common thiol-containing biomolecular antioxidant [34]. Without wishing to be bound by theory, a similar oxidation mechanism of a thiolated biomolecule can occur in the MWNT filter system described herein at an applied voltage of ˜1 volt or ˜2 volts, which are high enough to oxidize most thiols [35].

The bacterial inactivation by electrolysis at ˜3 volts for a duration of ˜10 s or ˜30 s was significantly greater (15-20%) than that observed with ˜1 volt or ˜2 volts (FIG. 15). This finding indicates that at a higher applied potential, another bacterial inactivation mechanism may become active. The determined inactivation values (99.0% and 102.2%) at an applied voltage of ˜3 volts indicate an almost 100% or a complete inactivation of bacteria. However, these values are at the limit of the accuracy or range of the bacterial viability assay (99% or 2-log inactivation), and any value >99% is considered herein only as >99%. Regardless, the extent of electrolytic bacterial inactivation by the MWNT filter after 30 s was significant—85-87% inactivation at ˜1 volt or ˜2 volts, and >99% inactivation at ˜3 volts.

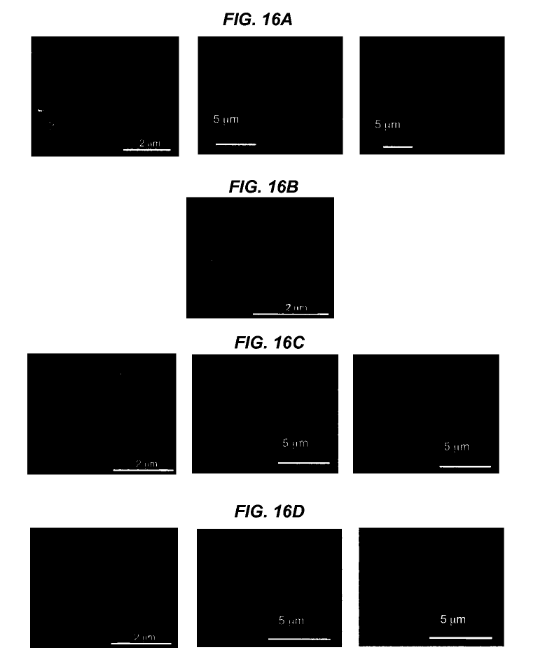

Representative scanning electron microscopy (SEM) images of E. coli in contact with MWNTs after no electrolysis and electrolysis at ˜1 volt, ˜2 volts, or ˜3 volts for ˜30 s in 10 mM NaCl are shown in FIGS. 16A to 16D. After 15 min of incubation on the MWNTs and no electrolysis, the majority of the cells was still intact and maintained the expected morphology for viable E. coli. The E. coli electrolyzed on the MWNTs at ˜1 volt or ˜2 volts for 30 s had similar morphological changes, where the majority of the E. coli cells had become elongated, but were not dehydrated and flattened as with observations of cells in contact with SWNTs previously reported in Kang et al. (2007), and Liu et al. (2009) [16, 36]. Electrolysis at ˜1 volt and ˜2 volts was able to permeabilize the cell walls enough to allow passage of molecules such as PI across the membrane, but the permeabilization was not enough to allow for release of the larger cellular contents such as proteins and DNA that result in misshapen cells [16, 30]. This finding indicates that electrolysis at ˜1 volt or ˜2 volts oxidatively interrupts specific, localized regions of the cell membrane, but does not disrupt the macroscopic cell membrane structure. It is also of note that a light-colored aggregated material appeared on the surface of the cells after electrolyzed at ˜1 volt and ˜2 volts.

The majority of the E. coli cells electrolyzed at ˜3 volts were significantly degraded and lost all cell membrane integrity. The membranes of cells electrolyzed at ˜3 volts were very rough and looked as if the cells were dehydrated and shriveled (as opposed to flattened). The extensive loss of cell membrane structure at ˜3 volts indicates that electrolysis at ˜3 volts can chemically degrade or oxidize the membrane molecular components, as compared to ˜1 volt and ˜2 volts, at which the oxidation may have been more specific and localized. The observed large discontinuities of the cell membrane in regions not in direct contact with the MWNTs can indicate production of aqueous chemical oxidants near the MWNT surface. This observation is consistent with potentials required (>2.3 V) to produce homogeneous oxidants from H₂O and Cl⁻, which will be discussed in detail in the following paragraphs.

Without wishing to be bound by theory, the electrochemical inactivation of E. coli and MS2 can occur through two primary mechanisms: (1) the direct oxidation of pathogen (P) in contact with the MWNT anode, and (2) the indirect oxidation of pathogen via anodic production of an aqueous oxidant (e.g., Cl2.⁻, HO., or SO4.⁻), as illustrated in FIG. 17A.

The first step in the direct oxidation mechanism involves deposition or adsorption of the pathogen onto the MWNT filter:

MWNT+P→MWNT . . . P (1)

The second step involves oxidation of the pathogen adhered to the MWNT filter, which can be a multi-electron process:

MWNT(nh⁺) . . . P(ne⁻)→MWNT . . . P_{Ox} (2)

The indirect oxidation of pathogens also involves two steps, the first being the anodic one-electron production of an oxidant:

MWNT(h⁺)+Ox⁻[H₂O(2.7), Cl⁻(2.5), SO₄²⁻(2.4)]→MWNT+Ox.[HO.,Cl.,SO₄.] (3),

wherein examples of specific oxidants are listed within brackets in eq (3) and their reduction potentials in volts are listed within parentheses [35]. Over a range of aqueous NaCl concentrations (1-155 mM), the threshold potential was observed to be around 2.3-2.4 V (FIG. 12A), indicating that anodic Cl⁻ oxidation (eq 3) was the limiting half-cell process. The pathogen was subsequently oxidized and inactivated by the produced oxidant:

Ox.+P→+Ox⁻+P_{Ox} (4)

This reaction of pathogen and oxidant may have occurred in solution, or one or both of the reactants may adsorb to the MWNT surface.

As discussed herein, the MWNT filter design promoted contact between pathogen and MWNTs (eq 1), with effective sieving of E. coli and multi-log removal MS2 viruses. This can be advantageous since direct pathogen oxidation may interrupt specific processes of the pathogens at lower driving potentials than those required to produce an oxidant. For example, thiols, such as the antioxidant glutathione [34], coenzyme A [32, 33], and the amino acid cysteine [34], are vital to cellular processes. The oxidation of various thiols has a reduction potential at cellular conditions in the range of 0 to ˜1.5 V [35], which is much lower than the potential required to produce a chemical oxidant (eq 3), namely 2.4 to 2.7 V, as evidenced by the minimal steady-state current (≦1 mA) at all solution conditions (FIGS. 12A to 12C). Accordingly, direct oxidation may result in a much lower power requirement than indirect oxidation.

### Example 9

### Investigation of the MWNT Electrochemical Oxidation Mechanism

The predominant MWNT electrochemical oxidation mechanism, direct versus indirect, is examined herein by investigating E. coli inactivation and changes in dye fluorescence over a range of solution and electro-chemistries. FIGS. 17A to 17E indicate a negligible production of oxidants at ˜1 volt and ˜2 volts. FIGS. 17B, 17C, and 17D are epifluorescent microscope images using a 400-nm cut-off excitation filter of propidium iodide (PI)-stained bacteria electrolyzed at ˜1 volt, ˜2 volts, and ˜3 volts, respectively. At ˜1 volt (FIG. 17B) and ˜2 volts (FIG. 17C), the PI was observed to emit red fluorescence due to the presence of bacteria with compromised cell membranes. This was observed for all solution chemistries and electrolysis times. At ˜3 volts (FIG. 17D), the PI was observed to emit yellow fluorescence, which was shifted to a lower wavelength. The blue-shift in the PI fluorescence emission peak after electrolysis at ˜3 volts occurred at all solution chemistries and electrolysis times. To determine the source of the shift in the PI fluorescence emission peak, aqueous PI (1.2 mL, 50 μM) was sequentially reacted with 1 μL aliquots of the oxidant hypochlorous acid (HOCl, 50 mM). Upon sequential additions of the HOCl, the PI fluorescence emission peak gradually shifted from around 625 nm to 540 nm (FIG. 17E). Further addition of HOCl over 3 μL did not result in any further peak shifts. Thus, without wishing to be bound by theory, the observation of a shift in PI epifluorescence emission at ˜3 volts is due to the production of a relatively high local concentration of oxidant. In one embodiment, the oxidant can be derived from pathogen (eq 2 in Example 8). In another embodiment, the oxidant can be derived from the electrolyte (eq 3 in Example 8). The lack of PI fluorescence shift at ˜1 volt and ˜2 volts indicated negligible chemical oxidant production at these potentials, and thus the primary electrochemical inactivation mechanism at ˜1 volt and ˜2 volts can be direct oxidation.

The electrochemical inactivation mechanism is further evaluated by examination of E. coli inactivation via DAPI and PI staining over a range of solution chemistries (1 mM NaCl, 10 mM NaCl, 155 mM NaCl, and 10 mM Na₂SO₄), electrochemical conditions (1 V, 2 V, 3 V), and electrolysis times (10, 30 s) as summarized in Table 2. The total electrons flowed (mC) and final current (mA) for the corresponding experiments are presented in Table 3.

TABLE 2
Percent loss of E. coli viability after electrolysis over a range of
solution chemistries, applied potentials, and electrolysis times

| Po- | Elec- | | | | 155 |
|---|---|---|---|---|---|
| tential | trolysis | | 10 mM | 10 mM | mM |
| (V) | Time (s) | 1 mM NaCl | Na₂SO₄ | NaCl | NaCl |
| 1 V | 10 s | 68.8 ± 8.1 | 67.1 ± 6.9 | 74.3 ± 8.3 | 66.3 ± |
| | | | | | 11.3 |
| | 30 s | 76.0 ± 4.0 | 79.6 ± 13.3 | 86.5 ± 4.6 | 86.5 ± |
| | | | | | 11.7 |
| 2 V | 10 s | 70.8 ± 8.4 | 78.6 ± 8.3 | 76 ± 12.7 | 69.0 ± |
| | | | | | 15.1 |
| | 30 s | 75.4 ± 17.4 | 84.3 ± 4.6 | 85.2 ± 7.1 | 78.9 ± |
| | | | | | 14.9 |
| 3 V | 10 s | 97.6 ± 8.4 | 90.7 ± 8.2 | 99 ± 2.5 | 79.6 ± |
| | | | | | 16.0 |
| | 30 s | 101.4 ± 7.6 | 97.4 ± 2.2 | 102.2 ± 1 | 97.1 ± |
| | | | | | 18.2 |

TABLE 3
Total electrons flowed* (mC) and final current (mA) over a range
of solution chemistries, potentials, and electrolysis times

| | | 1 mM | 10 mM | 10 mM | 155 mM |
|---|---|---|---|---|---|
| Potential | Electrolysis | NaCl | Na₂SO₄ | NaCl | NaCl |
| (V) | Time (s) | mC-(mA) | mC-(mA) | mC-(mA) | mC-(mA) |
| 1 V | 10 s | 9-(0) | 11-(0) | 8-(0) | 15-(1) |
| | 30 s | 13-(0) | 15-(0) | 9-(0) | 18-(1) |
| 2 V | 10 s | 29-(1) | 32-(1) | 39-(2) | 45-(2) |
| | 30 s | 49-(1) | 55-(1) | 67-(1) | 59-(1) |
| 3 V | 10 s | 124-(10) | 138-(7) | 198-(16) | 360-(25) |
| | 30 s | 405-(10) | 505-(12) | 474-(12) | 815-(21) |

*[1C (Coulomb) = 6.242 × 10¹⁸ electrons]
The average number of bacterial cells deposited on the filter was 10⁷.

For reference, the baseline MWNT toxicity (no electrochemistry) was 35.6±7.7%. In all cases, the bacterial inactivation was significantly increased (>66%) by the application of direct current. An extended electrolysis time (30 s vs. 10 s) resulted in a greater degree of inactivation for all solution and electrochemical conditions. The percent inactivation tended to increase with increasing voltage following the trend: ˜3 V>˜2 V=˜1 V>0 V. The results at ˜1 V and ˜2 V were usually within error of each other, indicating that the electrolytic inactivation mechanism was similar at potentials of ˜1 V and ˜2V. Since these potentials (˜1 V and ˜2 V) are lower than that required to produce oxidant (eq 3 in Example 8 and FIGS. 17A to 17E), the electrochemical inactivation at ˜1 V and ˜2 V was direct pathogen oxidation at the MWNT surface.

There was an increase in bacterial inactivation upon increasing the applied potential to ˜3 V, and application of ˜3 V for 30 s resulted in >97% inactivation. As previously noted, all values >99% in Table 2 should be considered only as >99% since that is the limit of the viability assay. Without wishing to be bound by theory, the increased E. coli inactivation at ˜3 V can be due to the production of oxidants (eq 3 in Example 8), which becomes thermodynamically favorable at this driving potential as evidenced by the >0 A current in FIG. 12A. Alternatively, the increased driving potential can open up a large number of one-electron direct oxidation pathways for the organics and biomolecules composing the cell membrane [35]. The increased toxicity at ˜3 V is consistent with SEMs of electrolyzed bacteria (FIG. 16D) that display extensive damage to the cell membrane structure.

It was next sought to investigate the effect of various solution conditions (1 mM NaCl, 10 mM NaCl, 155 mM NaCl, and 10 mM Na₂SO₄) on the electrolytic inactivation mechanism. The three NaCl concentrations were selected to evaluate the inactivation over a range of solution conductivities, and these were compared to Na₂SO₄ electrolyte for evaluation of any possible specific electrolyte effects, which could in turn determine aqueous oxidant speciation (eq 3 in Example 8). As shown in Table 2, there was a negligible effect of NaCl concentration on E. coli inactivation at all electrochemical potentials. A potential of ˜1 volt or ˜2 volts can be too low to generate aqueous oxidants (FIGS. 17A to 17E and FIG. 12A), and this supports the hypothesis that direct oxidation was predominant at those potentials. In contrast, at ˜3 volts, the current increases monotonically with increasing NaCl concentration (Table 3 and FIG. 12B), indicating increased homogeneous oxidant/electron shuttle production (e.g., the null cycle; anode: 2Cl⁻+h⁺→+Cl2.⁻; cathode: Cl2.⁻+e⁻→2Cl⁻) [25, 26]. However, as previously stated, there is no systematic effect of NaCl concentration on bacterial inactivation. In fact, the observed results indicate the opposite trend, i.e., at ˜3 V, E. coli inactivation decreases with increasing NaCl concentration. The decrease in loss of bacterial viability with increasing NaCl concentration can be due to inhibition of direct pathogen oxidation on MWNTs by competition with oxidant production. Alternatively, the high ionic strength isotonic solution (155 mM NaCl) can provide a more robust bacterial environment through reducing osmotic stress [29] and thereby increasing bacterial survival. Either way, the decreasing E. coli inactivation with increasing NaCl concentration at ˜3 V does not support an indirect oxidation mechanism.

Previous studies have discussed that choice of electrolyte strongly affects electrochemical oxidation kinetics. For example, electrochemical organic oxidation kinetics were reported to be at least an order of magnitude faster using NaCl versus Na₂SO₄ as an electrolyte, due to significantly lower production of aqueous oxidants [25]. Accordingly, if bacterial inactivation occurred via an indirect oxidation, specific electrolyte effects should be observed. However, the findings indicate there is no significant difference between the electrochemical loss of bacterial viability using Na₂SO₄ as compared to NaCl as the electrolyte at all applied potentials and electrolysis times (Table 2). This finding provides additional support for a direct pathogen oxidation mechanism.

The evidence from the solution- and electrochemistry-dependent E. coli inactivation supports direct oxidation of bacteria adsorbed to the MWNT filter surface as the primary mechanism at all driving potentials. This finding is in agreement with the observation of a complete removal of the bacteria by a sieving process that results in direct contact of bacteria with the MWNT filter surface. Furthermore, the finding is in agreement with previous results using carbon cloth and carbon fiber anodes [12-14].

### Example 10

### Comparison of the Electrochemical Bacterial and Viral Inactivation Described Herein with the Prior Art

The comparison of the electrochemical bacterial and viral inactivation described herein to previous reports is difficult due to incomplete reporting of conditions. For example, if the electrochemistry was driven under constant current conditions, the voltage was not reported. Therefore, a more generalized comparison is presented herein and the results of those reports are summarized in Table 4.

TABLE 4
Tabulation of Previosuly Published Work Completed on Electrochemical Viral and Bacterial Inactivation

| | | Anode | | | |
|---|---|---|---|---|---|
| | V-I | Material- | | | |
| Substrate | Reaction Time | Config. | Results | Mechanism | Ref. |
| Reactive | 10 V | Flow through; | >99% degraded | Direct oxidation | Yang et al., |
| Brilliant dye | 90 min | MWNT | after 90 min | | 2009 [43] |
| E. coli | 0.7 V vs. SCE | Flow through; | 6.0 × 10² cells | Direct oxidation | Matsunaga, |
| | (or ~1 V vs. NHE) | carbon-cloth | inactivated per | | et al., 1992 |
| | | | cm³ per h | | [12] |
| E. coli, | 2.8-3.1 V vs. SCE | Batch; | Nearly 100% | Indirect oxidation via | Polcaro, et |
| enterococci, | (~3-3.4 V vs. | boron-doped | removed after 2 min | reactive oxygen | al., 2007 [11] |
| coliforms | NHE) 20 to 120 s | diamond | | | |
| M. aeruginosa | 3.5-9.2 V | Batch; | Up to 96% | Indirect oxidation via | Liang, et al., |
| | 52 min | Ti/RuO₂ | removal of | reactive oxygen | 2005 [8] |
| | | | chlorophyll | | |
| E. coli, | 25-350 mA | Batch; | Bacteria | Indirect oxidation via | Drees et al., |
| P. aeruginosa, | 5 s pulses | copper wire | inactivation > | reactive chlorine or | 2003 [5] |
| MS2, PRD1 | | | bacteriophage; | electrochlorination | |
| | | | up to 4-log | | |
| | | | removal of | | |
| | | | P. aeruginosa | | |
| Hepatitis B; | 3 A; 45 min | Electrolyzed | Complete | Indirect oxidation via | Morita et al., |
| HIV | | water to viral | (>99%) | reactive chlorine or | 2000 [7] |
| | | suspension | Inactivation | electrochlorination | |

Electrochemical bacterial inactivation processes can be divided into three primary categories. The first involves indirect oxidation by reactive chlorine species or electrochlorination [6, 8] (eq 3 in Example 8: Cl⁻+h⁺→Cl., >2.5 V) (eq. 5). The second category involves indirect oxidation by reactive oxygen species using boron-doped diamond anodes [10, 11] (eq 3 in Example 8: H₂O+h⁺→HO.+H⁺, >3.0 V) (eq. 6). The third category is direct electrochemical oxidization of bacteria deposited on high surface area carbon electrodes (eqs 1 and 2, 1 V-2 V) [12-14].

The MWNT anodic filter investigated herein falls into the third class. Significant bacterial inactivation and negligible oxidant production were observed at ˜1 V and ˜2 V, indicating direct oxidative pathogen inactivation. While the increased inactivation at ˜3 V can be due to oxidant production or new direct oxidation pathways, the findings presented herein indicate towards the latter. The ability of the MWNT filter to directly oxidize pathogens at lower potentials can focus energy towards the desired process and/or greatly reduce the production of undesirable disinfection by-products.

The MWNT anodic filter described herein has a number of advantages over other previously reported carbon-based anodes. These advantages include (i) the nano-dimensional MWNTs have an inherent antimicrobial activity [17, 30] and may allow for more intimate contact with the pathogen due to perturbation of the cell membrane; (ii) the nanoporous MWNT filter structure can sieve all bacteria and remove most viruses by depth filtration, thereby mediating any mass transfer limitations to the anode surface [2, 15]; and (iii) the high MWNT surface area provides a large number of electrochemically active sites per unit volume. Previous reports discuss that CNT-based anodes have increased electrochemical utility over traditional carbon-based anodes since CNTs can catalyze the oxidation of thiol-containing biomolecules [37] and have increased corrosion stability [22].

An alternative to electrochemistry for inactivation of filtered bacteria and viruses is the addition of the strongly antimicrobial nanosilver [38]. Incorporation of nanosilver into or onto the surface of filters has been observed to yield strong antimicrobial [39-41] and antiviral activity [41]. However, the lifetime of these filters is reduced/limited, due to oxidative dissolution and leaching of the nanosilver into the output fluid, resulting in loss of filter antimicrobial/antiviral activity [41]. A recent study [39] utilized a composite filter composed of cotton, nanosilver, and carbon nanotubes, and applied an electric field to sterilize water at high flow rates via electroporation (not electrochemistry). However, the composite filter required high potentials (±20 V) to achieve results of bacterial inactivation similar to those of the MWNT filter demonstrated herein at much lower aquatic potentials (˜1 V-˜3 V).

To summarize, in developing countries where no water purification is practiced prior to consumption, or where access to clean water is limited, waterborne pathogens are the cause of millions of deaths per year [1]. Thus, there is a strong need to develop new, efficient point-of-use water treatment technologies. Nanotechnology may offer a solution. For example, the novel electrochemical MWNT filter presented herein can be applied as a drinking-water purification technology for pathogen (bacterial and viral) removal and inactivation. At applied potentials of ˜2 V and ˜3 V, the electrochemical MWNT filter reduced the number of pathogens in the output fluid to ˜0 (i.e., almost or all bacteria sieved, and almost or all virus removed and/or inactivated). Application of these potentials for 30 seconds inactivated >75% of the sieved bacteria and >99.6% of the adsorbed virus. A recent study on various point-of-use technologies reported filtration to be the preferred method due to ease of use, even though it did not perform as well as other methods [42]. As demonstrated herein, at applied potentials of ≧2 V, the electrochemical carbon nanotube filter of the invention reduced the bacteria and viruses in the input fluid, ˜10⁶/mL each, to below the limit of detection in the output fluid. The extent of bacterial and virus removal and inactivation attained by the electrochemical filter of the invention meets the minimal drinking water treatment requirements suggested by the World Health Organization (WHO) of 5 log reduction of bacteria and 4 log reduction of virus. Photovoltaics (PV), which can be used remotely, generate direct electric current and could drive the electrochemical filtration device. Hence, the electrochemical MWNT filter described herein could be used remotely for point-of-use drinking water treatment, displaying the potential of nanotechnology to solve problems encountered in the developing world.

### Example 11

### Electrochemical Carbon Nanotube Filter Oxidative Performance as a Function of Surface Chemistry

Electrochemistry, the interrelation of electrical and chemical effects, has been used for a wide-range of applications including electrophoretic separations, corrosion control, electroanalytical sensors, electroplating, batteries, and fuel cells (1). There are also opportunities for environmental applications of electrochemistry including wastewater treatment, metal recycling, and environmental sensing (2). In regards to electrochemical water treatment, the development of anodes with optimal geometries, high electrocatalytic activity, and extended operational lifetimes has resulted in electrooxidation efficiencies that are energetically comparable to conventional wastewater treatment (3) and disinfection (4) technologies. An electrochemical waste-to-energy process involving simultaneous anodic wastewater treatment and cathodic hydrogen production can lead to greater energy efficiencies (5).

Previous reports on electrooxidation for water treatment has focused on the design of novel anode materials and structures based on boron-doped diamond (BDD) (Refs. 6-8), Sb-doped SnO₂ (Refs. 9, 10) and Bi-doped TiO₂ (5, 11). These anode materials represent a combination of properties including high O₂ overpotential, corrosion stability, conductivity, and surface-bound hydroxyl radical yield. For example, BDD anodes are superior to platinum and glassy carbon toward phenol and formate oxidation (6) and are able to mineralize atrazine (12). Three-dimensional anode nanoarchitectures can also result in increases in electrooxidation. For example, the electrooxidative performance of BDD toward methanol has been improved by addition of a porous, three-dimensional (3D) platinum structure perpendicular to the BDD surface (7). BDD anode electrooxidative performance enhancements toward 2,4-dichlorophenoxyacetate oxidation and mineralization are reported when the BDD is coated with Sb-doped SnO₂ nanoparticles (8). In both cases, the enhancements arise from the high surface area Pt/Sb—SnO₂ that increases the number of electrocatalytic surface sites in combination with the strongly oxidizing BDD that acts to limit Pt/Sb—SnO₂ passivating products.

Presented herein is the use of carbon nanotubes (CNTs), e.g., multiwalled CNTs, as 3D electrode nanoarchitecture material in electrochemical filters described herein that can be used for adsorptive removal and electrooxidation of aqueous dyes and anions (19) and for removal and inactivation of bacteria and viruses (20). Due to CNTs' physical (13), electrical (14), mechanical (15), and electrochemical (16) properties, CNTs can be formed into stable, porous, and electrochemically active networks (17) or filters (18). To increase the oxidative capacity of the electrochemical CNT filter described herein or to enhance the anodic CNT filter electrooxidative performance, surface chemistry of the CNTs can be modified, which has been previously reported to affect chemical adsorption (21), colloidal properties (22), antimicrobial properties (23), catalyst support performance (24), photocatalytic nanocomposite performance (25).

Accordingly, presented herein are some exemplary treatment methods used to generate multiwalled carbon nanotubes with varying surface chemistry including CNT (raw or untreated), C-CNT (˜400° C. for ˜1 h), CNT-HCl (HCl at ˜70° C. for ˜12 h), CNT-HNO₃ (HNO₃ at ˜70° C. for ˜12 h), C-CNT-HCl, C-CNT-HNO₃, and C-CNT-SS(C-CNT-HNO₃ coated with Sb-doped SnO₂ particles) for use in electrochemical filtration of molecules. The CNT materials (untreated or surface-treated) can be characterized by any methods known in the art, e.g., scanning electron microscopy (SEM), X-ray photoelectron spectroscopy (XPS), and thermogravimetric analysis (TGA). The electrooxidative performance of the CNTs has been evaluated over a range of applied voltages by using the electrochemical filter with 1 mM methyl orange (MO) in 100 mM sodium sulfate (Na₂SO₄) and other organic molecules. Changes in surface chemistry of the CNTs of the electrochemical filters described herein are determined to significantly affect electrooxidative performance as detailed below. Electrochemical parameters such as steady-state current, anode potential, and impedance as well as effluent (i.e., output fluid) pH, back pressure, and product mass spectrum were also determined, as detailed below, to relate CNT surface chemistry to electrochemical results.

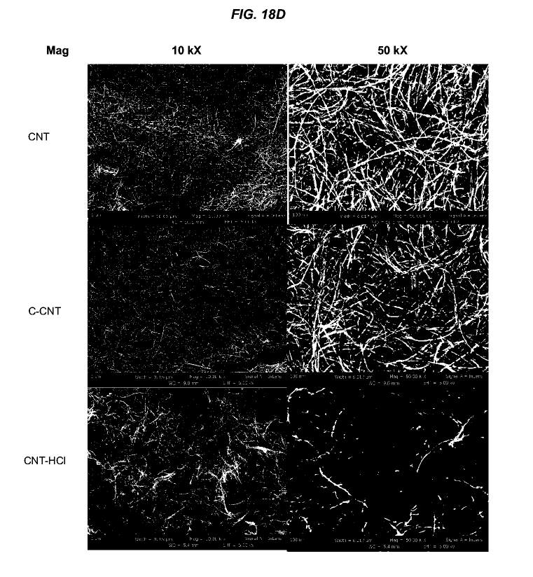

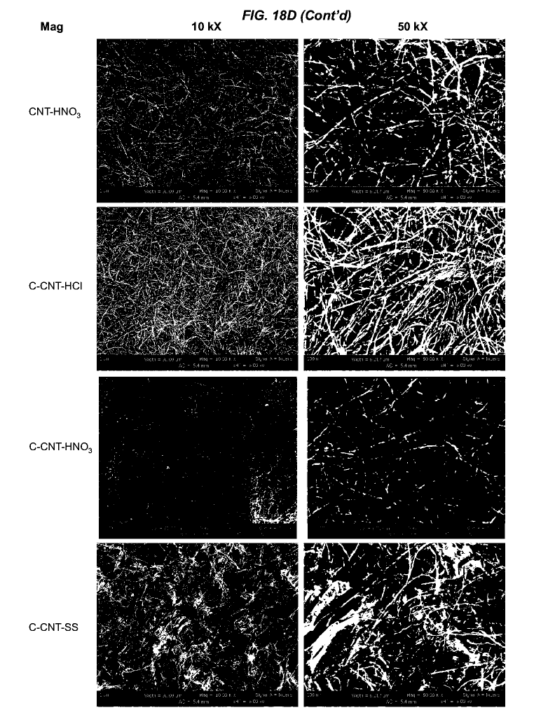

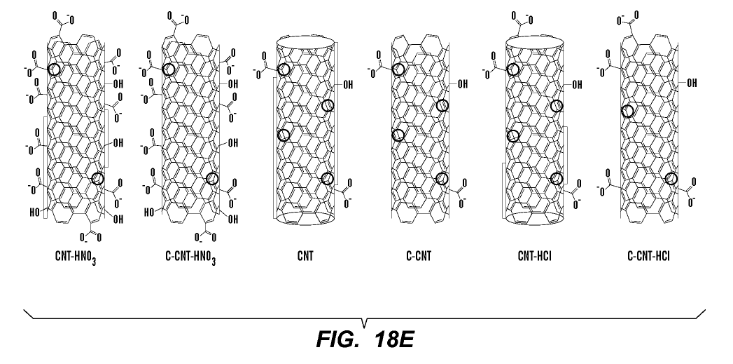

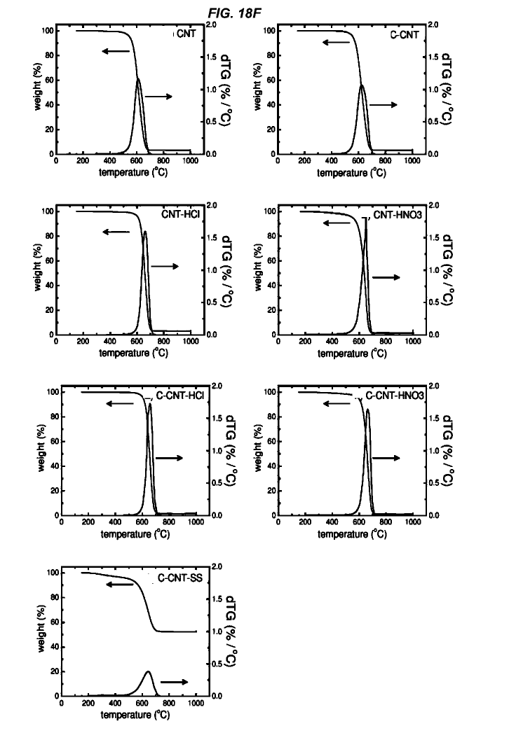

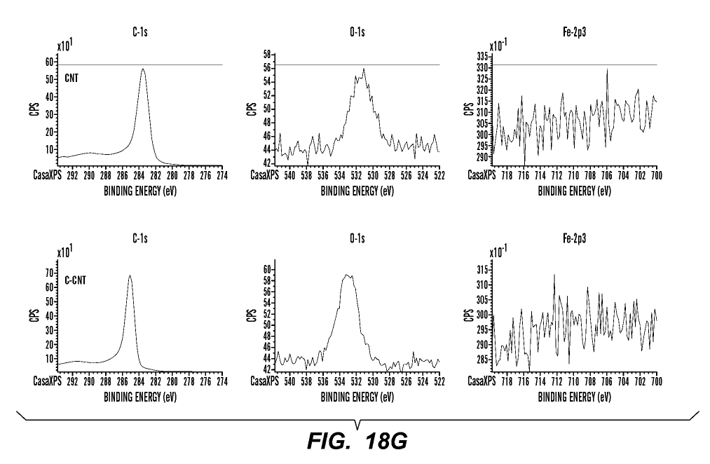

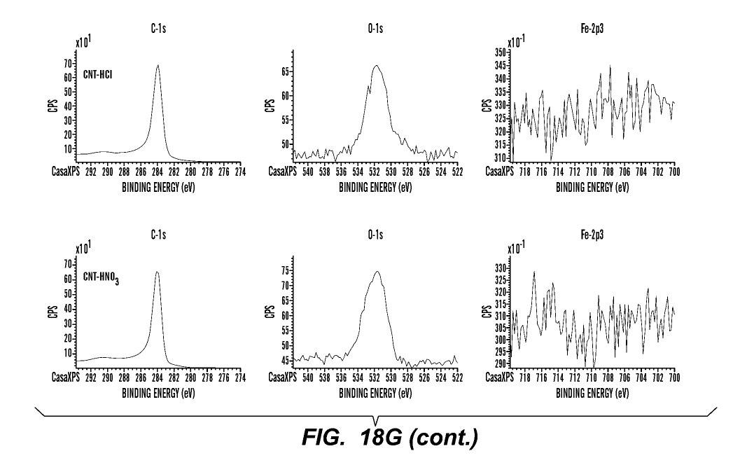

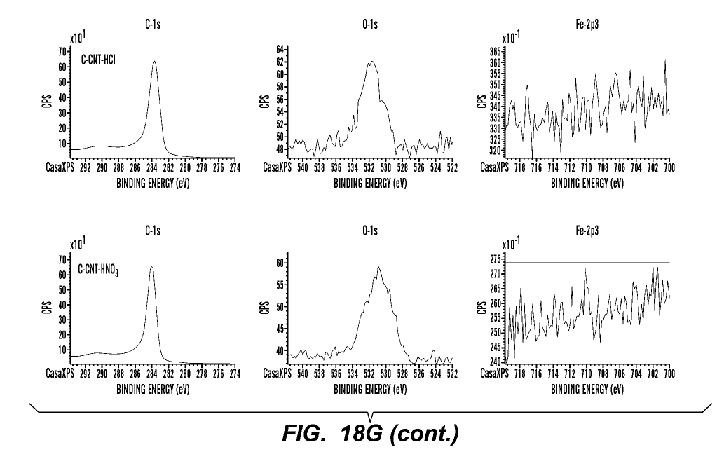

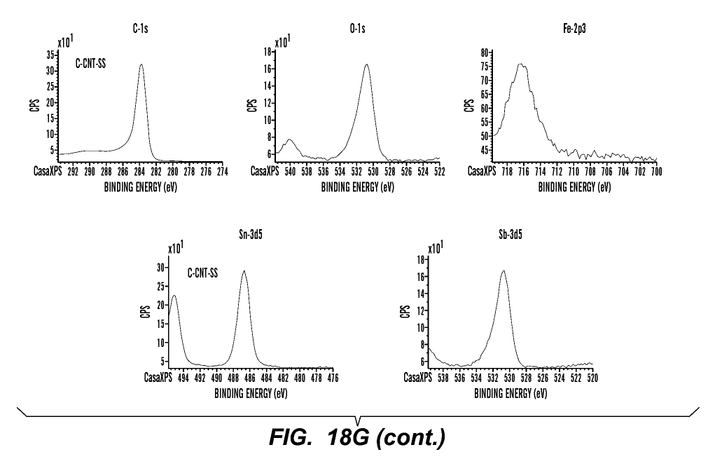

Physical Properties of Electrochemical CNT Filters. The physical properties of the CNT networks were generally similar for all the filter samples except the C-CNT-SS, as shown in Table 5. The CNT network mass was in the range of 14 mg-19 mg, and the C-CNT-SS mass was 35 mg-40 mg. The CNT network depth was in the range of 55 μm-65 μm, and the C-CNT-SS depth was 80 μm-85 μm. The Sb—SnO₂ particles were coated onto the CNTs prior to film formation; thus, these additional particles could hinder the CNTs from forming a tightly packed network during vacuum filtration. FIGS. 18A-18G show exemplary SEM images of the CNT networks with different surface chemistry. The images generally look similar for all the samples except C-CNT-SS, FIGS. 18C-18D, where micrometer-sized metal oxide particles are embedded in the CNT network, resulting in a more loosely packed CNT network. The pore size, as measured from SEM images, was also affected by the particle addition. The CNT networks generally had pore diameters in the range of 100 nm-120 nm, whereas the C-CNT-SS had an average pore diameter of about 136 nm. In all cases, the pore diameter was quite heterogeneous with a standard deviation of ±50 nm-60 nm and a range from about 25 nm to about 350 nm.

TABLE 5
Representative Carbon Nanotube Network Properties

| CNT type | weight (mg) | depth (μm)^{a} | pore (d) (nm) | residual mass (%)^{b} | low-T mass (%)^{c} | O/C (%)^{d} | ΔMO - 2 V (%) |
|---|---|---|---|---|---|---|---|
| CNT | 18.8 | 62 | 98.2 | 4.03 | 0.49 | 1.88 | 30 |
| C-CNT | 13.8 | 56 | 104.3 | 3.96 | 0.07 | 2.30 | 36 |
| CNT-HCl | 16.1 | 57 | 114.9 | 3.94 | 0.19 | 2.53 | 54 |
| CNT-HNO₃ | 15.1 | 58 | 118.3 | 2.64 | 1.19 | 4.67 | 24 |
| C-CNT-HCl | 14.8 | 65 | 109.5 | 2.36 | 0.11 | 2.24 | 72 |
| C-CNT-HNO₃ | 14.6 | 59 | 112.2 | 2.16 | 0.76 | 4.08 | 28 |
| C-CNT-SS | 38.5 | 82 | 136.1 | 52.8 | 3.02 | 12.6^{d} | 64 |

^{a}Measured by microcaliper.
^{b}Measured by TGA and representative of percent metal catalyst impurity.
^{c}Measured by TGA Mass loss between 150 and 400° C. representative of amC or functionalization.
^{d}Measured by XPS;
no surficial Fe was detected in any of the samples;
Sb and Sn detected in C-CNT-SS.

Surface Chemistry of CNT Filters. In contrast to the CNT physical properties, the CNT surface chemistry was greatly affected by the treatments (Table 5, and FIGS. 18E-18G). The residual mass, as determined by TGA, is a measure of the residual metal (e.g., iron oxide) catalyst (manufacturer specifications) (31,32). In all cases, there was negligible Fe detected by XPS (33), indicating the Fe₂O₃ is attached to the inner CNT surface and thus beyond the X-ray analytical depth. The raw (i.e., surface-untreated) CNT samples had a residual mass around 4%, in agreement with manufacturer specifications. The C-CNT and CNT-HCl samples had similar, ˜4%, residual mass content. However, the C-CNT-HCl sample had a reduced residual mass, ˜2.4%, indicating that amorphous carbon may have been blocking HCl from entering the ends of the CNT-HCl tubes to remove any metal residual catalyst impurities including residual iron oxide catalyst. For comparison, the CNT-HNO₃ sample also had a reduced residual content, ˜2.6%, likely due to the ability of HNO₃ (NO₂⁺) to oxidize the amorphous carbon. The sample with the lowest residual content was C-CNT-HNO₃ at ˜2.2%, and the sample with the highest residual content was C-CNT-SS at >50% due to addition of noncombustible metal.oxide.

The mass loss over the temperature range of 150-400° C. during thermogravimetric analysis can be an indicator of the amorphous and other non-sp²-bonded carbon content of the CNTs (32). As shown in Table 5, The raw CNT sample had ˜0.5% mass loss over this temperature range. The C-CNT, CNT-HCl, and C-CNT-HCl had reduced mass loss, 0.05-0.2%, over this temperature range indicating these treatments reduced the amorphous carbon content. The CNT-HNO₃ and C-CNT-HNO₃ had increased mass loss over this temperature range, 0.8-1.2%, due to oxidative formation of easily combusted surface oxy-groups (34). The increased mass loss in the C-CNT-SS sample can be due to metal oxide catalyzed CNT oxidation.

The CNT surface O/C ratios as determined by XPS are in agreement with the mass loss data. The raw CNT had an O/C ratio of 1.9%, which was only increased slightly in the C-CNT, CNT-HCl, and C-CNT-HCl samples to 2.2-2.5%. The CNT-HNO₃ and C-CNT-HNO₃ samples had O/C ratios of ˜4.7% and ˜4.1% indicating significant formation of carbonyl, hydroxyl, and carboxy groups on the CNT surface (22, 28). The C-CNT-SS sample had an even greater O/C ratio due to addition of metal oxide particles. Significant amounts of antimony and tin were also detected on the surface of the C-CNT-SS sample.

The surface chemistry effect of the CNT treatments utilized herein is in agreement with previous studies (22, 31, 32, 34, and 35) and is reported in Pan and Xing (21). For example, the three main surface features affected by the treatments are amorphous carbon, internal Fe₂O₃ nanoparticles, and surface oxy-groups that are represented by thin gray surface coating, rust-colored internal spheres, and hydroxy and carboxy groups, respectively (FIG. 18E). The CNT network depictions in FIG. 18E are placed in order of increasing electrooxidative performance. The best performing CNT is the one with the most number of these features minimized (e.g., all of these features) as will be discussed later.

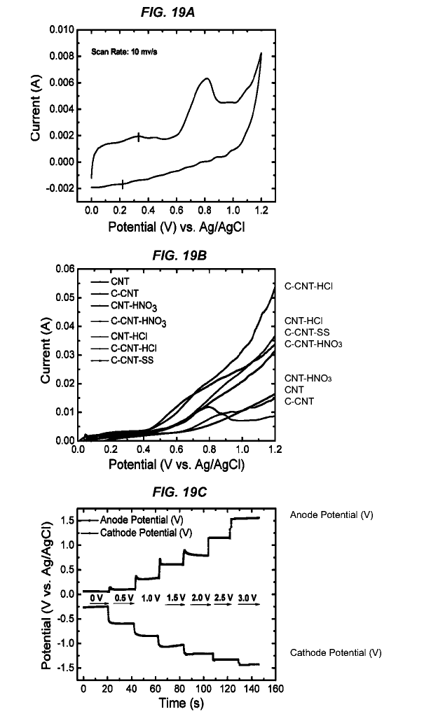

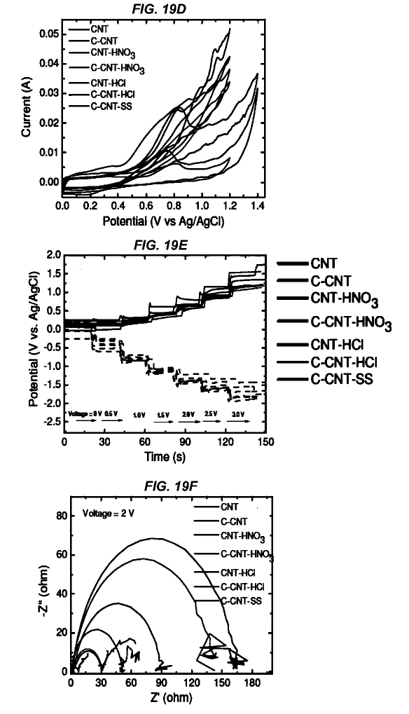

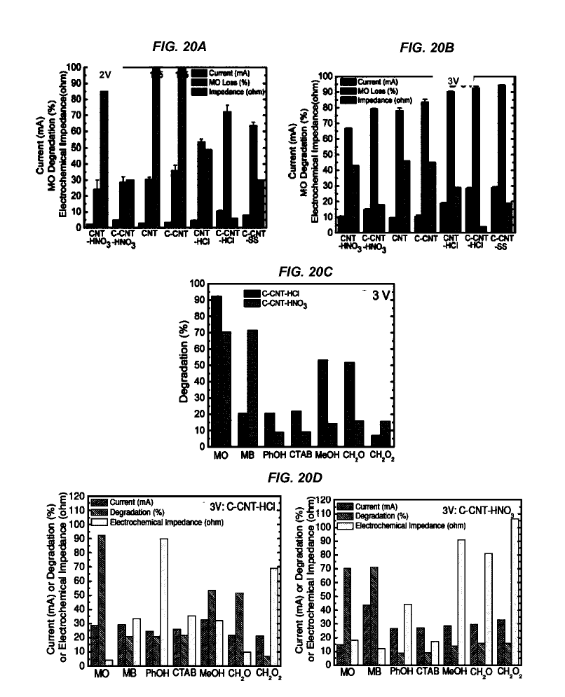

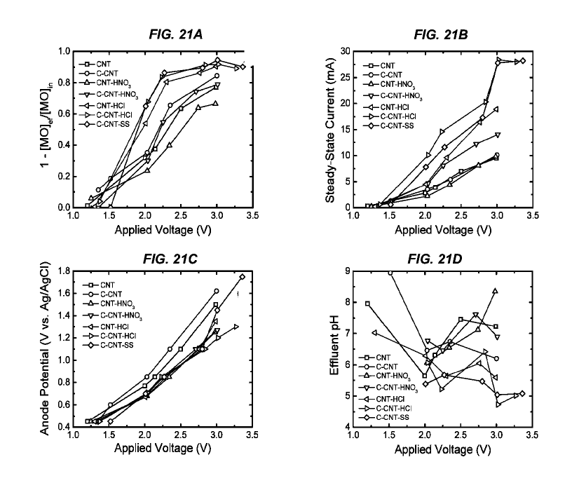

Electrochemical CNT Filter Characterization. A representative cyclic voltammogram, linear sweep voltammogram and, open circuit potential versus time for the C-CNT sample are displayed in FIGS. 19A-19C. Identical measurements were completed for all CNT samples under influent (i.e., input fluid) conditions of 1 mM methyl orange, 100 mM Na2SO4, and flow rate of 1.5 mL min⁻¹ (FIGS. 19D-F). The cyclic voltammogram in FIG. 19A has two primary features. The first feature is the irreversible oxidation peak of methyl orange around 0.8 V versus Ag/AgCl, and the second feature is water oxidation (2H₂O+4h+→O₂+4H⁺) around 1.2 V versus Ag/AgCl. Without wishing to be bound by theory, the electrochemical irreversibility of the anodic CNT filter can be amplified over conventional bipolar electrodes since the electrooxidation products can be permanently carried away from the anode surface by the incident fluid flow. The MO oxidation potential indicates that the near-surface pH of the CNT anode is ˜3 (Ref. 36), significantly lower than the input fluid pH ˜6. In the majority of the linear sweep voltammograms in FIG. 19B, there is no distinct oxidation peak. Assuming a current similar to the C-CNT peak is representative of peak potential, in all cases the near-surface pH can be <4. A decreased anode surface pH is also supported by the reversible Fe₂O₃ redox cycle at E_{1/2}˜0.25 V in FIG. 19A (black dashes). Extrapolation of pH-dependent CV of α-Fe₂O₃ nanoparticles (37) indicates a near-surface pH of 3-4 supporting the MO data. Thus, the pH near the hydrophobic CNT interface can be significantly lower than that of the bulk solution, in agreement with recent reports of an increased proton activity near the air-water interface (38, 39).

The open circuit potential of both the cathode and the anode as a function of applied voltage and time is displayed in FIG. 19C. At applied voltages of both 0.5 and 1.0 V, the cathodic potential dominates over the anodic potential, in agreement with the findings that a negligible amount of MO is oxidized under these conditions. At 1.0 V applied voltage, the cathode potential is around −0.8 V, near the two-electron reduction potential of water to hydrogen (2H₂O+2e⁻→H₂+2OH⁻; E⁰=−0.83 V) (Ref. 1). Further increases in applied voltage to 1.5 V, 2.0 V, 2.5 V, and 3.0 V results in greater increases to the anode potential as compared to cathode potential. Immediately after each increase in applied voltage up to 2.0 V, an exponential decay in anode potential is observed indicating the formation of a capacitive double layer and adsorption MO pseudocapacitance (40, 41). While a low applied potential is required for the anodic oxidation of MO, in some embodiments, a high fraction of applied potential, e.g., at least 50% at all the applied voltages (e.g., −1.5 V at an 3.0 V applied voltage) is put toward the cathode when proton (E⁰=−0.83 V), oxygen (O₂+e⁻→O2.⁻; E^{pH7}=−0.33 V) (42), and water reduction (2H⁺+2e⁻→H₂; E⁰=0 V) should occur at significantly lower potentials. Without wishing to be bound by theory, the energy put toward the cathode can be due to the disparity in surface area between the cathode and anode. The cathode has a surface area of at most 15 cm² and a current density of 0.2-2.0 mA cm⁻². The anode has an approximately 5000 cm² of surface area (19) and a current density of 0.006-0.0006 mA cm⁻². The significant difference between the cathode and anode current density indicates that an increase in cathode surface area can increase the extent of electrooxidation.

Electrooxidative Performance of CNT Filters. The electrooxidative performance of the CNTs was evaluated under conditions of 1 mM MO, 100 mM Na₂SO₄, and J=1.5 mL min⁻¹ and is displayed in FIGS. 20A-20B, for applied voltages of 2 V and 3 V, respectively. The current (mA; blue bars), MO degradation (%; red bars), and electrochemical impedance (ohm; gray bars; x-axis arc length in FIG. 19F) are plotted versus CNT sample in order of their increasing electrooxidative performance: CNT-HNO₃<C-CNT-HNO₃˜CNT<C-CNT<C-CNT-HCl˜C-CNT-SS. The performance order is similar at 2 V and 3 V with the range of percent MO degradation being greater at 2 V (24-72%) as compared to 3 V (66-95%). It is noted that the liquid residence time in the electrochemical CNT filter is ≦1.2 s, and for C-CNT-HCl and C-CNT-SS, ˜95% of the MO is oxidized. The steady-state current also roughly follows the MO degradation trend indicating that most of the anodic current is toward MO oxidation. Both CNT-HNO₃ and C-CNT-HNO₃ have slightly greater currents than the current value corresponding to a known number of electrons transferred during MO oxidation, indicating there can be another anodic process contributing to the current such as corrosive elimination of the oxy-functional groups and/or increased O₂ production. In contrast, the C-CNT-SS has a lower current than the current value corresponding to a known number of electrons transferred during MO oxidation, due to SnO₂'s high O₂Overpotential of 2.2 V versus SCE (43, 44). In terms of electrooxidation, the CNT sample with the most surface sp²-bonded carbon, e.g., C-CNT-HCl, and the sample modified with an electrocatalyst, e.g., C-CNT-SS, had the greatest efficacy. Generally, a “perfect” carbon nanotube should only contain hexagonally sp²-bonded carbon that has been rolled into a nanotube. However, imperfections or defects in the carbon nanotube can arise when the CNT is oxidized and the specific carbon atoms that are oxidized can then go from sp² to sp³ bonding. Oxidation of CNTs can be induced by a common oxidant such as oxygen. Accordingly, a higher O/C ratio of the CNTs, e.g., as shown in Table 5, indicates a higher amount of oxygen atoms at the CNT surface, which can in turn correspond to a greater degree of CNT oxidation and thus fewer sp²-bonded carbons in the CNTs. Since aromatic molecules such as MO generally prefer to adsorb to a sp2-bonded surface, and the presence of more sp2 bonding can generally increase the conductivity of the material, the CNTs with more sp²-bonded carbon (e.g., indicated by a lower O/C ratio), e.g., C-CNT-HCl, is thus generally more efficient for electrooxidation of aromatic molecules such as MO from an aqueous fluid, as compared to the CNTs with fewer sp²-bonded carbon, e.g., C-CNT-HCO₃.

In contrast to current, the electrochemical impedance seems to have minimal correlation to electrooxidative performance. However, the measurement can indicate how the various CNT impurities and functionalizations affect resistance to electron transfer. At both 2 V and 3 V, the raw (i.e., untreated) CNT has the greatest impedance, and the CNT treatment methods can reduce the impedance following the order C—<—HNO₃<—HCl indicating that interfacial amorphous carbon, oxy-functional groups, and metal oxides all can act to impede electron transfer with amorphous carbon giving the least impedance. The greater improvement with —HCl as compared to —HNO₃ treatment indicates that the oxidatively formed oxy-functional groups and defects also impede electron transfer likely by reducing the conductivity of the CNT network (14, 45). The combined treatments used in C-CNT-HNO₃ and C-CNT-HCl result in impedance reductions greater than the sum of the individual treatments. Since calcination was completed first, the impedance result indicates that the ends of the raw CNTs are not initially open, e.g., covered by amorphous carbon, and the acid cannot get inside the tubes to dissolve the internal Fe₂O₃. Thus, the CNT surface chemistry greatly affects the electrochemical resistance toward interfacial charge transfer reactions; however, this resistance does not seem to have a great effect on electrooxidative performance. The high sensitivity of electrochemical impedance toward CNT surface chemistry can be used for CNT surface analysis.

The effects of surface chemistry on electrooxidative performance may not be solely due to the electrochemical effects since the adsorption of MO, which is a first step for direct electrooxidation, can also be affected by surface chemistry (21, 28). Previous studies have reported that aromatic molecules similar to methyl orange can strongly sorb to the extended sp²-CNT surface (46, 47). Since a CNT network with the greatest electrooxidation, C-CNT-HCl, has the greatest percentage of surficial sp²-bonded carbon, to further assess the importance of adsorption toward electrooxidative performance, the C-CNT-HCl and C-CNT-HNO₃ networks were performed at 3 V with a number of organics: methyl orange (negative aromatic), methylene blue (positive aromatic), phenol (neutral aromatic), CTAB (long-chain aliphatic), and methanol, formaldehyde, and formate (small, polar molecules). The percent degradation in terms of decolorization (MO and MB), TOC removal (phenol), and TIC formation, i.e., conversion to carbon dioxide (CTAB, MeOH, formaldehyde, and formate) is presented in FIGS. 20C-20D.

Both networks were able to degrade some fraction of all of the organics, and the C-CNT-HCl network performed better than the C-CNT-HNO₃ in most cases with the exceptions being the positively charged MB and formate. Although 10-20% of the phenol TOC is removed during electrochemical filtration, there was no increase in effluent (i.e., output fluid) TIC indicating an electropolymerization mechanism is active (48). The complete electrochemical conversion of the small, polar organics to TIC and thus carbon dioxide can be, at least in part, due to the relatively low number of electron transfers required for mineralization. For example, a 28-electron transfer is required to completely oxidize phenol, whereas a six-electron transfer is required to completely oxidize methanol. The minimal oxidation of formate can be, at least partly, due to its high one-electron reduction potential, E⁰˜1.9 V (49). The varied extent of oxidation toward the target molecules indicates that there can be a number of factors affecting electrochemical filtration performance including, for example, CNT surface chemistry, molecule-CNT interactions, and molecule oxidation potential.

The two CNT networks evaluated are determined to perform better toward the molecules they adsorb stronger. The oxidative performance of the C-CNT-HCl network toward MO oxidation is, at least partly, due to positive-charging of the CNT anode resulting in enhanced adsorption of the negatively charged MO (19). The strong performance of the C-CNT-HNO₃ network toward MB oxidation is, at least partly, due to the electrostatic attraction between the negatively charged surface oxy-groups and the positively charged MB (28). Without wishing to be bound by theory, a strongly adsorbed molecule can have a longer effective retention time in the electrochemical CNT filter resulting in a greater number of chances to be electrochemically oxidized.

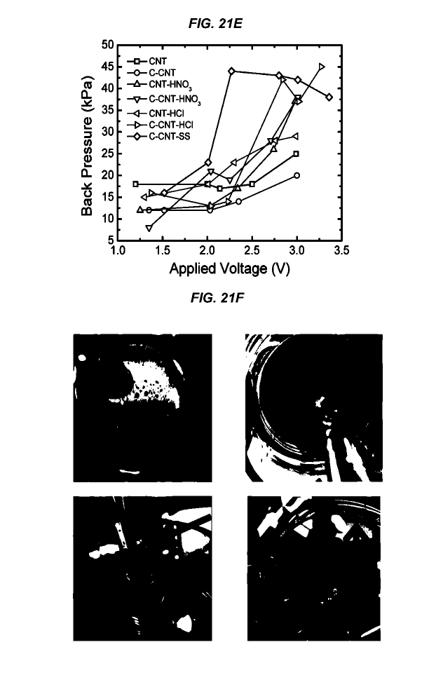

Electrochemical and Effluent Characteristics versus Surface Chemistry and Voltage. To further assess the dependence of electrochemical CNT filter performance on surface chemistry, the extent of MO degradation (1-[MO]_{ef}/[MO]ᵢₙ), steady-state current (mA), anode potential (V), effluent pH, and back pressure (kPa) are plotted as a function of applied voltage (V) and CNT in FIGS. 21A-21F. For most samples, the extent of MO oxidation, steady-state current, and anode potential increased monotonically with increasing applied voltage. Over the applied voltage range of 2.0 V to 3.0 V, the CNT surface chemistry is determined to strongly affect both the extent of MO oxidation and the steady-state current. For the three CNT filters that performed the best, CNT-HCl, C-CNT-HCl, and C-CNT-SS, the extent of MO oxidation reached a plateau around 2.2 V. However, the steady-state current, which is also highest for these three filters, continues to increase indicating either an increase of anodic O₂ production or a greater degree of molecular MO oxidation, i.e., a greater number of oxidized electrons per MO molecule. The anode potential is similar over the range of assessed voltages for all CNT materials except the CNT and C-CNT samples that are higher by 0.1-0.2 V. CNT and C-CNT were the filter materials with the greatest electrochemical impedance indicating there can be some threshold value below which the impedance can no longer affect the electrooxidation kinetics, which is in agreement with the lack of correlation between impedance and extent of electrooxidation as discussed earlier.

The effluent pH (i.e., output fluid pH) is a strong function of both applied voltage and CNT surface chemistry. At 1.0 V, the effluent pH (i.e., output fluid pH) is increased over the influent pH (i.e., input fluid pH) indicating that cathodic processes such as water reduction to hydrogen releasing hydroxide anions can control the pH, in agreement with FIG. 19C where the cathodic potential dominates at ≦1.0 V. As the applied voltage is increased to 2.0 V, the effluent pH (i.e., output fluid pH) approaches the influent pH (i.e., input fluid pH) indicating that the cathodic and anodic processes can neutralize each other. As the applied voltage is increased further to 3.0 V, the effect on effluent pH (i.e., output fluid pH) is CNT surface chemistry-dependent. For CNT, CNT-HNO₃, and C-CNT-HNO₃, the effluent pH (i.e., output fluid pH) tends to increase, whereas for the rest of the filter materials as shown in FIG. 21D, the effluent pH (i.e., output fluid pH) tends to decrease indicating that anodic processes can be dominant. The increase in effluent pH (i.e., output fluid pH) for the HNO₃-treated CNTs indicates that electrooxidative cleavage of oxy-functional groups can result in a pH increase.

The potential-dependent back pressure is determined to increase above baseline at applied voltages >2.0 V (FIG. 21E), similar to the steady-state current response (FIG. 21B), indicating the back pressure can be, at least in part, due to an electrochemical process. For example, both cathodic hydrogen production and anodic oxygen production and subsequent bubble formation within the filtration device can be responsible for the increased back pressure. Images of bubbles being released into both the input and output fluids and bubbles being formed on the electrodes are displayed in FIG. 21F. In some embodiments, collection of cathodic hydrogen can result in increased energy efficiency of the electrochemical CNT filtration process (50).

Electrooxidative Mechanism. The electrochemical CNT filter, as demonstrated herein, is able to oxidize at least 95% of a 1 mM MO solution in a single-pass through the filter (τ<1.2 s). To evaluate the degree of molecular MO oxidation and the oxidation products, an estimation of the maximum oxidation can be performed by comparing the MO molecular flux to the electron flux. For example, a 1 mM MO solution flowing at 1.5 mL min⁻¹ can result in 10¹⁶ molecules s⁻¹ flowing through the filter, and a current of 28 mA corresponds to 17×10¹⁶ e⁻ s⁻¹ flowing through the anode. Thus, a maximum of 17 e⁻ can be anodically oxidized per MO molecule. Since there is a total of 80 e⁻ per MO molecule, only partial oxidation of an MO molecule is possible. Further, cathodic oxygen reduction to O2.⁻, H₂O₂, and HO. can increase the degree of oxidation while anodic water oxidation to O₂ can decrease the degree of oxidation.

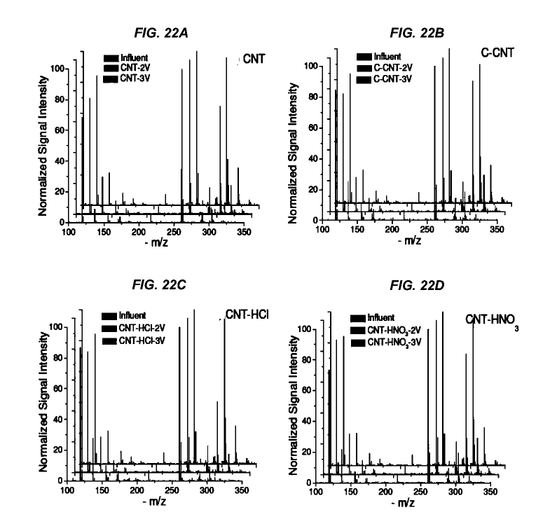

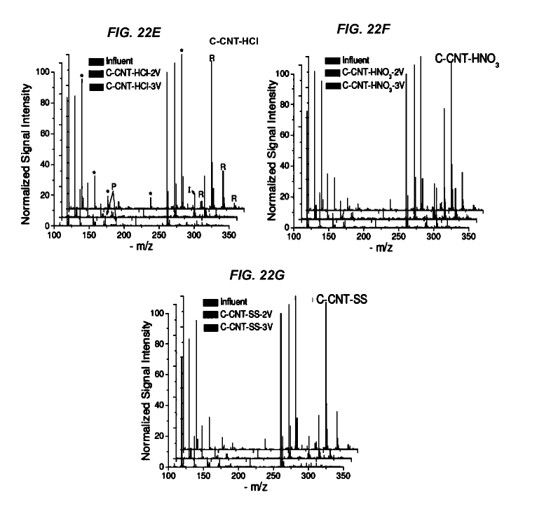

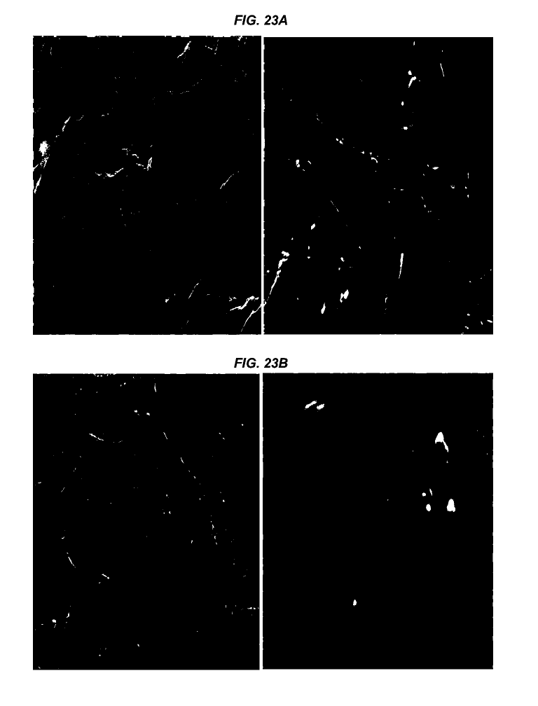

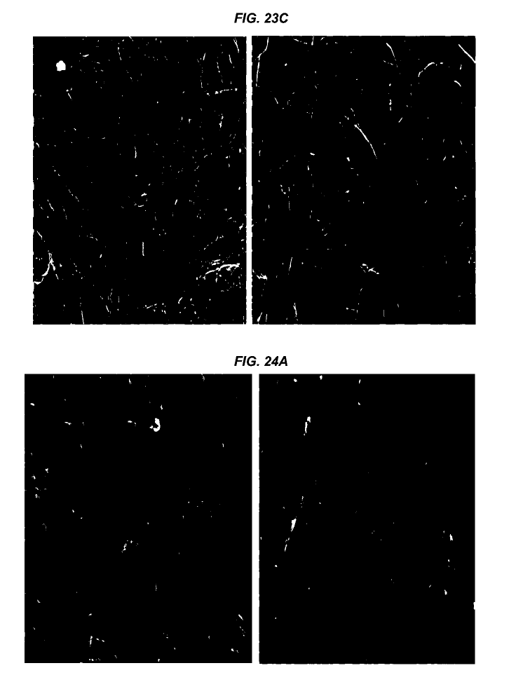

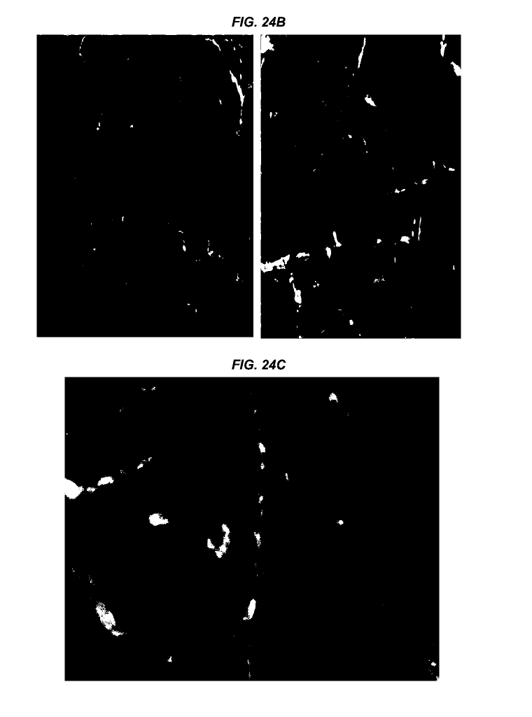

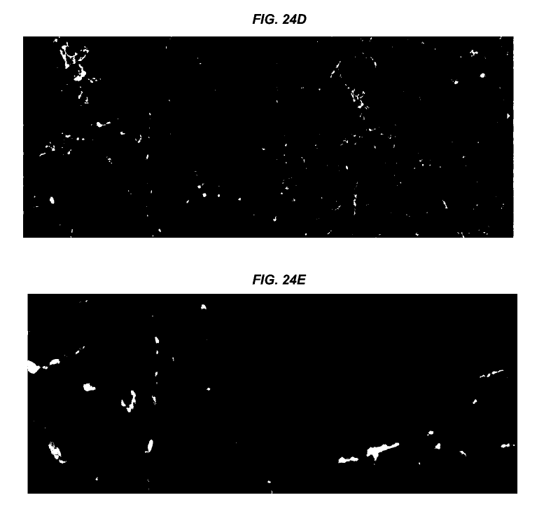

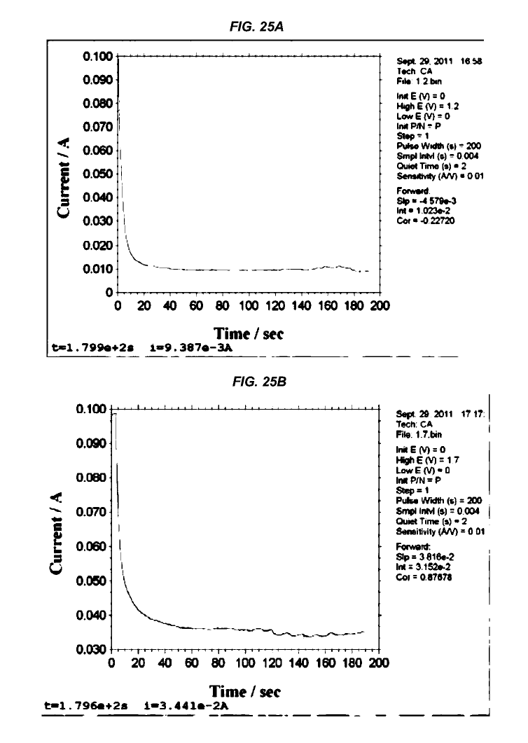

To identify major MO electrooxidation products, influent (i.e., input fluid) and effluent (i.e., output fluid) samples for all CNTs run at 2 and 3 V were analyzed by negative-ion direct injection mass spectrometry (FIGS. 22A-22G). A large number of the peaks did not change during electrooxidation. For example, peaks at m/z=119/121 and m/z=261/263 are characteristic of salt clusters NaSO₄⁻ and Na₃(SO₄)₂⁻. The parent MO ion (m/z=304/306), parent MO−16 (m/z=288/289/290), parent MO+16 (m/z=320/322), and parent MO+32 (m/z=336/338) are determined in the influent sample and decrease significantly in the 2 V and 3 V samples indicating the parent MO molecule has been destroyed. Three new peaks in the 2 V and 3 V samples appear. For example, a peak at m/z=290 representative of either CH₂ or N loss appears at 2 V and disappears at 3 V. Two peaks at m/z=173 and 189, indicated by arrows in the spectrum, appear at 2 V and grow further at 3 V. Without limitations, these peaks can correspond to aminobenzenesulfonate and hydroxyaminobenzenesulfonate. All three intermediates indicate that an electrooxidative bond-breaking process is active.

Environmental Implications. An electrochemical carbon nanotube filter has been shown herein to be effective for the oxidation of methyl orange and other organics. The energy efficiency of MO electrochemical filtration can be calculated in kW·hr kg⁻¹ COD assuming 17 electrons transferred per molecule to be 4 (2 V) and 15 (3 V) for C-CNT-SS; and 5 (2 V) and 16 (3 V) for C-CNT-HCl; and these values are similar to state-of-the-art electrochemical oxidation processes that are generally in the range of 5-100 kW·hr kg⁻¹ COD (Ref. 3). Alternatively, the energy per volume treated can be calculated in kW·hr m⁻³ to be 0.17 (2 V) and 0.93 (3 V) for C-CNT-SS; and 0.22 (2 V) and 0.96 (3 V) for C-CNT-HCl, and these values are similar to other nanostructured electrodes at ˜0.7 kW·hr m⁻³ (Ref. 8). The efficiency and extent of degradation are both voltage-dependent with a greater efficiency at lower voltages and greater degradation at higher voltages. The efficiency and extent of degradation are also determined to be dependent on the CNT surface chemistry and the target molecule's physical chemical properties. Thus, in some embodiments, electrooxidation can be increased by adding an electrocatalyst with a high O₂ overpotential, e.g., C-CNT-SS, to increase the electron-transfer rate and reduce energy toward null reactions such as water oxidation. In some embodiments, the CNT surface can be tailored toward strong adsorption of target molecules, e.g., C-CNT-HCl for MO molecules or C-CNT-HNO₃ for MB molecules, to increase the effective residence time of that molecule within the filter and in turn increase the oxidation.

### Exemplary Materials and Methods for Example 11

Chemicals. Methyl orange (MO), hydrochloric acid (HCl; 36.5-38.0%), nitric acid (HNO₃; 69.8%), sulfuric acid (H₂SO₄; 95.0-98.0%), phosphoric acid (H₃PO₄; ≧85.0%), tin chloride pentahydrate (SnCl₄(H₂O)₅), antimony chloride (SbCl3), sodium hydroxide (NaOH), ethyl alcohol (EtOH; ≧95.0%), dimethyl sulfoxide (DMSO; ≧99.9%), potassium hydrogen phthalate (KHP), sodium sulfate (Na₂SO₄), sodium persulfate (Na₂S₂O₈), sodium bicarbonate (NaHCO₃), methylene blue (MB), cetylammonium bromide (CTAB), phenol (PhOH), methanol (MeOH), formaldehyde, formate, and sodium carbonate (Na₂CO₃) were purchased commercially, e.g., from Sigma-Aldrich. All chemicals were reagent grade except the DMSO that was spectrophotometric grade.

Carbon Nanotube (CNT) Selection. The multiwalled carbon nanotubes could be purchased from NanoTechLabs, Inc. (Yadkinville, N.C.). The CNTs were characterized previously in Kang et al. (2008) (Ref. 26) to have a diameter distribution of 17±9 nm and a length distribution of 91±21 μm, in agreement with the manufacturer specifications of 5-7 walls, <d>=15 nm, and <1>=100 μm.

CNT Calcination. To remove any amorphous or other carbon impurities (27), about 1 g of as-received CNTs was first calcinated in a tube furnace (e.g., Thermolyne, 21100) by increasing from room temperature to about 400° C. at a rate of 5° C./min and holding for 60 min at 400° C. If multiple CNT treatment steps were used, calcination could be completed first and the sample is given the C-prefix in the Examples.

CNT Acid Treatment. Different types of acid treatment can be completed depending on various applications. For example, the CNTs can be treated with concentrated HCl to remove any residual metal catalyst impurities (27), and/or treated with concentrated HNO₃ for oxidative formation of surface carbonyl, hydroxyl, and carboxyl groups (27, 28). Both acid treatments could be completed as follows: for example, 0.5 g of CNT was placed into 0.5 L of respective acid and heated to 70° C. in a round-bottom flask with stirring and a condenser for at least 12 h. After heating, the sample was cooled to room temperature and vacuum-filtered through a 5 μm PTFE membrane (Omnipore, Millipore) to collect the CNTs. The CNTs were then washed with Milli-Q deionized water (DI) until the filter effluent pH was near DI's pH. The sample was then oven-dried at 100° C. before use. Materials treated with HCl are labeled with the —HCl suffix in the Examples, and materials treated with HNO₃ are labeled with the —HNO₃ suffix in the Examples unless coated with metal oxide nanoparticles, see the following section.

Sb-Doped SnO2 Particle Coatings. The Sb-doped SnO₂ CNT were prepared by the hydrothermal method (29,30). Briefly, 50 mg of C-CNT-HNO₃ was added to 30 mL of ethanol and 15 mL of DI water and dispersed by ultrasonication (Branson, Sonifier S450) for 5 min at an applied power of 400 W/L. Then, 27 mg of NaOH was added to the stirred mixture. Once dissolved, 117 mg of tin chloride pentahydrate (SnCl₄(H₂O)₅) and 7.6 mg of antimony chloride (SbCl₃) were slowly added to the stirred mixture. The final solution was then transferred to a Teflon-lined stainless steel autoclave and heated to 160° C. for at least 12 h. CNTs prepared by this method are labeled C-CNT-SS in the Examples.

Electrochemical CNT Filter Preparation. The CNT filters were produced by first dispersing the CNTs in DMSO at 0.5 mg/mL and probe-sonicating (Branson, Sonifier S450) for 15 min at an applied power of 400 W/L. Then, 30 mL of the sonicated CNTs in DMSO was vacuum-filtered onto a 5 μm PTFE membrane (Millipore, Omnipore, JMWP), resulting in filter loadings of 1.5-1.6 mg/cm². The CNT filters were washed with 100 mL of EtOH, 100 mL of 1:1 DI-H₂O/EtOH, and 250 mL of DI-H₂O to remove DMSO. Finally, the prepared filter was loaded into a filtration casing modified for electrochemistry, as described in Vecitis et al. 2011 (19, 20) and FIGS. 1A-1G.

Solution and Electrochemistry. Sodium sulfate (Na₂SO₄; 100 mM) was utilized as the background electrolyte, and methyl orange (MO; 1 mM) was used as the model pollutant unless otherwise noted. The input fluid MO-electrolyte solution was peristaltically pumped (Masterflex) through the electrochemical CNT filter (FIGS. 1A-1G), and the electrochemistry was driven by a dc power supply (Agilent). Perforated stainless steel was used as the cathode, and an insulating silicone rubber O-ring separated the electrodes. The electrochemically active elements were incorporated into a modified polycarbonate 47 mm filter casing (e.g., Whatman). Before every experiment, the titanium ring could be polished with sandpaper to optimize the electrical connectivity between the titanium and the CNTs.

Bulk electrochemical filtration of MO was completed at a number of selected applied voltages, 2 and 3 V for comparison to previous reports by the inventor (19,20) before the cyclic voltammetry (CV) peak, at the CV peak, and after the CV peak. The MO electrochemical filtration experiments were completed for at least 30 min with at least three output fluid samples analyzed over this time period to ensure steady-state electrochemical filtration was achieved. A number of parameters including output fluid pH (e.g., measured by Corning 345), output fluid MO concentration (e.g., measured by Agilent 8453 spectrophotometer; λₘₐₓ=464 nm; ∈=26, 900 M⁻¹ cm⁻¹), steady-state current, anodic potential, and back pressure were all recorded.

Bulk electrochemical filtration at 3 V was also completed for methylene blue, phenol, CTAB, methanol, formaldehyde, and formate. Sodium sulfate at 100 mM was used as an electrolyte, and the input fluid concentration for all compounds was 1 mM with the exception of CTAB at 0.1 mM. Similar to MO, the electrochemical filtration experiments were completed for at least 30 min with at least three output fluid samples analyzed over this time period to ensure steady-state electrochemical filtration was achieved. The MB concentration was measured by spectrophotometer (λₘₐₓ=665 nm; ∈=74 100 M⁻¹ cm⁻¹). The phenol concentration was measured by UV-vis and total organic carbon (TOC). The extent of electrochemical transformation of CTAB, methanol, formaldehyde, and formate to carbon dioxide was measured by total inorganic carbon TIC in the output fluid (input fluid TIC was ˜0).

The CNT samples were also evaluated using a potentiostat (CHI604D) with the prepared sample as the working electrode, a stainless steel cathode as the counter electrode, and 1 M Ag/AgCl as the reference electrode in a flow cell configuration. Cyclic voltammetry, linear sweep voltammetry (LSV), and alternative current impedance (ACI) methods were used to electrochemically characterize the samples.

SEM Analysis. Scanning electron microscopy was performed on a Zeiss FESEM Supra55VP. Micrographs were analyzed with ImageJ software to determine aerial pore size that was an average of at least 100 measurements.

TGA Analysis. Thermogravimetric analysis was performed on a Q5000-IR thermogravimetric analyzer (TA Instruments). Samples were heated from room temperature to 150 at 10° C. min⁻¹, held at this temperature for 30 min, then heated to 1000 at 10° C. min⁻¹ and held at this temperature for 30 min. A second run was completed immediately after the first and used as a background. The percent amorphous carbon and low-T combustibles was determined as the fraction burned between 150 and 400° C. The percent residual catalyst was determined using the initial mass and mass remaining after a complete thermal cycle.

XPS Analysis. X-ray photoelectron spectroscopy was performed on an ESCA SSX-100. For all samples, survey spectrum (0-1000 eV), C-1s (274-294 eV), O-1s (522-542 eV), and Fe-2p3 (700-720 eV) scans were performed. For the C-CNT-SS, Sn-3d5 (476-496 eV) and Sb-3d5 (520-540 eV) were also performed. Data was analyzed using CasaXPS.

Mass Spectrometry Analysis. The input and output fluid MO samples oxidized at applied voltages of 2 and 3 V for all CNTs were analyzed by direct injection electrospray time-of-flight mass spectrometry (ESI-TOF-MS; Waters LCT Premier XE). The instrument was operated in negative-ion high-resolution mode (W−) with a capillary voltage of 3.5 kV. Every sample was continuously injected for at least 5 min at a flow rate of 10 μL min⁻¹.

TOC and TIC Analyses. Both TOC and TIC analyses were performed with a TOC analyzer (TOC-V; Shimadzu) with thermal persulfate oxidation. TOC measurements were used to analyze the extent of phenol removal. TIC measurements were used to analyze the electrochemical formation of carbon dioxide.

### Example 12

### Nafion and Metal Oxide Nanoparticles on Carbon Nanotubes for Water Treatment or Purification

Synthesis of CNT containing Nation and metal oxide nanoparticles. The CNT filters or films were produced as described in earlier Examples. A Nafion coating can then be applied on the CNT films to form CNT/Nafion films. Addition of the Nafion coating to the CNT films can enhance the CNT film strength and/or durability, and also provide a capability to wrap nanoparticles (NPs), e.g., metal oxide nanoparticles, to the CNT if needed. Accordingly, in some embodiments, metal oxide nanoparticles can be deposited on the CNT/Nafion films to form CNT/Nafion/NP films, e.g., for electrochemical catalysis.

The CNT/Nafion films were prepared in various ratios of Nafion to CNT. FIGS. 23A-23C show SEM images of CNT/Nafion films with different ratios of Nafion to CNT. It was determined that the ratio of Nafion to CNT is preferably less than 1:5 due to permeability issues with the CNT/Nafion films. In some embodiments, the ratio of Nafion to CNT is no more than 1:6.

Different metal oxide nanoparticles such as SnO₂, TiO₂ and Sb-doped SnO₂ can be evaluated. In some embodiments, SnO₂ can be deposited on the CNT/Nafion films. In one embodiment, SnO₂ nanoparticles can be deposited uniformly on CNT film or a CNT/Nafion film. For example, a CNT film or a CNT/Nafion film can act as a cathode in a solution of 1 mg/ml SnCl₂.2H₂O acidic solution and a titanium strip can act as an anode. A potential of about 1V can be applied to the process for a period of time, e.g., about 1 hour. The film can then be rinsed, for example, with a small amount of water to remove excess SnCl₂ and be heated in a water bath at 70° C., e.g., for about 1 hour, for hydrolysis. Using this approach, a uniform layer of SnO₂ nanoparticles of 4 nm-5 nm can be deposited on the CNT walls. FIGS. 24A-24E show SEM images of Nafion-coated CNT with SnO₂ deposition where the ratio of Nafion to CNT is 1:6.

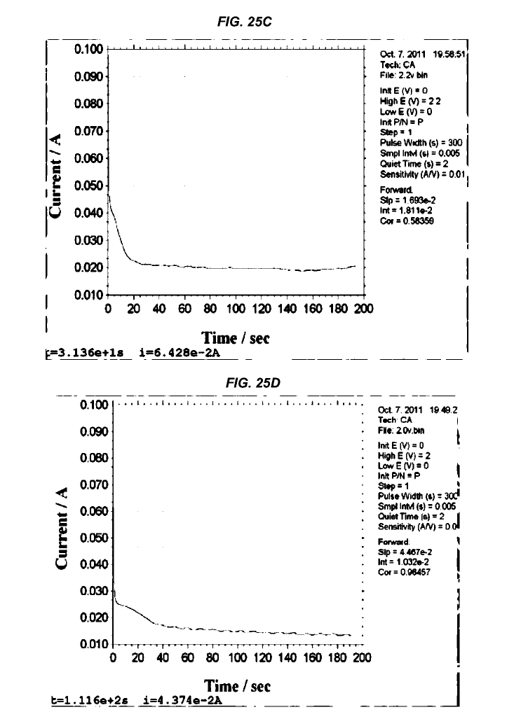

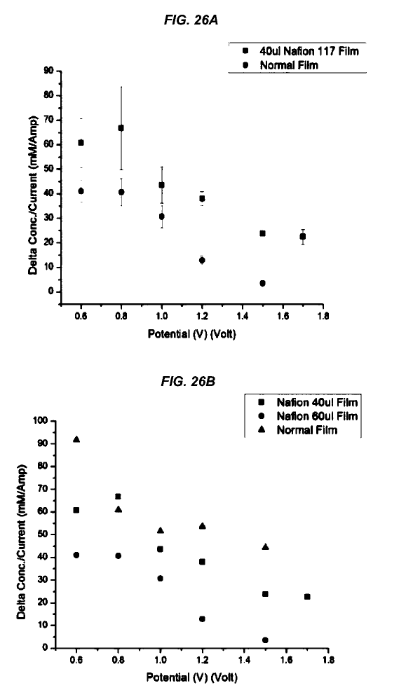

Durability of Nation-coated films. Mechanical strength and durability of the CNT films coated with Nafion were significantly higher than the uncoated CNT films. In some embodiments, the Nafion-coated CNT films, and/or Nafion-coated CNT films with SnO₂ deposition can last higher potentials without self-oxidation than the uncoated CNT films (FIGS. 25A-25D).

Electrochemical filtration performance of the Nafion-coated CNT with SnO₂ deposition. The electrochemical filtration performance of the Nation-coated CNT films and/or the Nafion-coated CNT films with SnO2 deposition were assessed using methyl orange (e.g., at a concentration of 1000 μM) as a model compound to be removed in an input fluid. The presence/amount of methyl orange in the output fluid was analyzed by UV-Vis spectrometry, and the electrochemical characterization of the filtration process was analyzed by different methods known in the art, e.g., but not limited to cyclic voltammetry, chronoamperometry, and open circuit potential time.

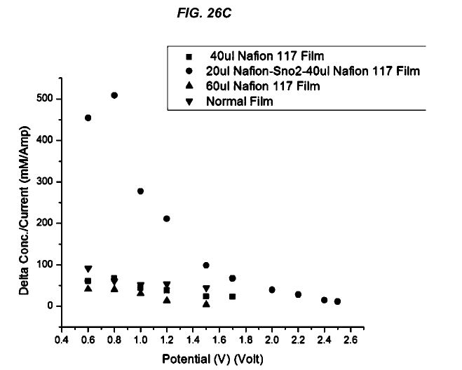

First, energy efficiency and oxidation of the Nafion-coated CNT films were evaluated. At anode potentials beyond 1.2 volt, about 40 μL Nafion-coated CNT films were determined to be more energy-efficient, e.g., 6 times more energy-efficient, than an uncoated CNT film (FIG. 26A). Additionally, increasing the Nafion content in the CNT films can result in further improvement in current and thus energy efficiency at higher anode potentials (FIG. 25B. FIG. 26C shows that the addition of SnO₂ nanoparticles into Nafion-coated CNT films can further increase the energy efficiency and/or oxidative performance of the Nafion-coated CNT films. In some embodiments, at least one additional Nafion coating can be applied after SnO₂ deposition on the Nafion-coated CNT films. Thus, the SnO₂ nanoparticles can be protected or enclosed between the Nafion coatings.

### Example 13

### Electrochemical Filtration of Aromatic Wastewater: Passivation and Regeneration

Aqueous aromatic compounds are toxic and refractory to conventional biological wastewater treatment. Phenol is frequently used as a model aromatic compound in wastewater treatment studies and millions of tons are produced every year as a plastics and pharmaceutical precursor [1-3]. A number of alternative aqueous phenol treatment methods have been previously reported including adsorption [4], advanced oxidation process (AOP) [5], and catalytic wet air oxidation [6-9]. Another treatment process that has been reported to be effective for aqueous phenol is electrochemical oxidation [10-13]. Electrochemistry has the advantages of simple operation, no chemical additives and high energy efficiency. However, improvements are needed to improve oxidation rates and efficiencies and to extend the lifetime of the electrodes.

Electrochemical oxidation kinetics of classical bipolar systems is limited by diffusional mass transfer since convection becomes negligible within a few millimeters, e.g., between 1 mm and 3 mm or between 1 mm and 2 mm, of the electrode surface. Thus, electrochemical oxidation kinetics can be increased by using three-dimensional electrode nanoarchitectures where the liquid to be treated can flow through the electrode, thus enhancing mass transport. The production of a three-dimensional nanoporous electrode requires the material to be electrically-conducting, mechanically-sound, and corrosively-stable. Three-dimensional carbon nanotube networks can fulfill all of these requirements. For example, wastewater seepage electrodes and electrochemical carbon nanotube filters have been reported to increase current densities by 3-fold and 6-fold as compared to the classical bipolar configuration. Electrochemical carbon nanotube network, as described herein, can be effective as an anodic water filter for the oxidation of dyes, anions, aromatic organics, and small polar and aliphatic organics as well as bacteria and virus removal and inactivation [18-23].

There are a number of passivation processes that can reduce electrode activity. In electrochemical aromatic treatment, a major passivation mechanism is oxidative polymerization and subsequent electrode passivation by the polymer coating [14-17]. One strategy to reduce such polymerization and thus passivation can be development of dimensionally-stable electrodes with high oxygen overpotentials. For example, the boron-doped diamond electrode is stable and produces minimal oxygen at potentials >2.0 V where phenol is completely mineralized to CO₂ and H₂O. However, the cost of boron-doped diamond electrodes has limited their large-scale use. Another strategy can be to develop simple methods for passivant removal and electrode regeneration.

As presented herein, purified and characterized carbon nanotube networks were utilized for the electrochemical filtration of phenol as the model aromatic pollutant in 100 mM sodium sulfate (Na₂SO₄). Electrochemical methods such as chronoamperometry, electrochemical impedance spectroscopy (EIS), and linear sweep voltammetry (LSV) were used to monitor the electrochemical and passivation processes and to evaluate the electrodes before and after phenol electrolysis. Total organic carbon measurements of the influent (input fluid) and effluent (output fluid) were utilized to monitor phenol removal. Scanning electron microscopy and image analysis were used to determine the extent of polymer formation on the carbon nanotube electrode. As discussed in detail below, titanium oxidation, electrolyte precipitation, phenol polymerization, and carbon nanotube oxidation were identified as possible passivation mechanisms. Various methods to regenerate the electrode activity were evaluated, including Ti polishing, aqueous precipitant dissolution, acidic and basic polymer removal, organic solvent polymer removal, and electrochemical polymer removal. Application of an anode potential ≧2.0 V was also evaluated for the reduction or prevention of polymer formation.

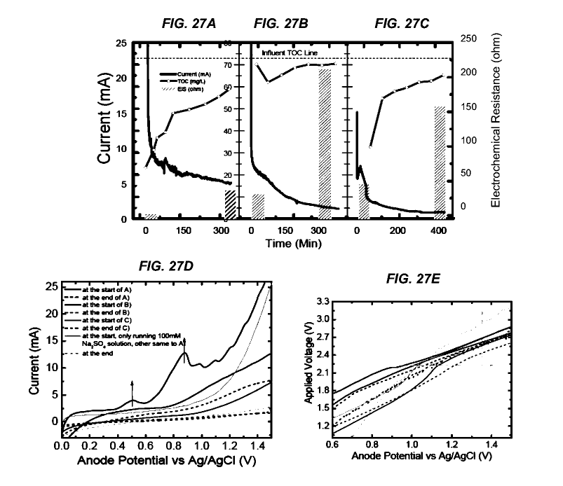

Titanium versus CNT Passivation. To investigate the effect of both titanium ring and carbon nanotube passivation, the CNT filtration apparatus described herein was passivated by running 72 mgC L⁻¹ phenol in a 100 mM sodium sulfate electrolyte through the CNT network of the filtration apparatus, e.g., at an anode potential of 1.6 V for 6 hours. The current (mA) and effluent TOC (mgC L⁻¹) versus time (min) and the electrochemical impedance (ohm) before and after passivation are shown in FIG. 27A. At the start of the passivation process, the current is near 50 mA and the effluent TOC is 23 mgC L⁻¹ and over the first two hours the current decreases sharply and exponentially to around 7 mA and the effluent (output fluid) TOC increases linearly to near 50 mgC L⁻¹. Over the next four hours the current decreases slowly and linearly to 5 mA and the effluent (output fluid) TOC increases to 60 mgC L⁻¹. The electrochemical impedance increased from 2 Ohm for the fresh CNT network to 37 Ohm after 6 hours of electrolysis. The significant decrease in current, and increase in effluent (output fluid) TOC and electrochemical impedance indicate that the electrochemical CNT network has been passivated.

To determine the source of the passivation, the titanium ring and/or the CNT network from the previous passivation experiment were polished and replaced, respectively, and then the passivation experiment was continued. After polishing the titanium ring (FIG. 27B), the current increased immediately close to about 50 mA when the fresh electrode was initially used (as shown in FIG. 27A) and the electrochemical impedance was slightly reduced to ˜30 Ohm. However, the effluent (output fluid) TOC was unchanged. Such findings indicate that oxidative passivation of the titanium can, at least partly, contribute to the decrease in current, but that an active CNT network can be necessary for electrochemical reaction and TOC removal. This is in agreement with previous reports of electrochemical oxidation of conductive titanium to the semiconductive titanium oxide (TiO₂) [24-29].

After the titanium ring was polished, the passivation experiment was continued under similar conditions, but this time the CNT network was replaced with a fresh network (FIG. 27C). The replacement of the CNT network results in an increase in current from 2.5 mA to 15 mA, which is less than the improvement resulted from polishing the titanium ring, indicating that oxidation of the titanium ring is primarily responsible for the reduction in steady-state current. In contrast, the effluent (output fluid) TOC is significantly decreased from 70 mgC L⁻¹ to 30 mgC L⁻¹ and the electrochemical impedance is reduced from ˜215 Ohm to ˜45 Ohm after replacement of the CNT network. This result indicates that an active CNT network is critical to organic oxidation and removal and that modifications to and/or coatings on the CNT network are, at least partly, responsible for the increase in electrochemical impedance. The coatings can be due to electrolyte precipitation and phenol precipitation, which were previously reported to occur to a significant extent, e.g., equivalent to a greater mass than the CNT network itself.

Linear sweep voltammograms (LSV) were also performed, in similar conditions as the electrochemical impedance spectroscopy experiments, on the CNT network before passivation, after passivation, after regeneration, and before and after running only 100 mM sodium sulfate electrolyte as a control. Comparing the LSV of a fresh CNT network in the presence (black solid line) and absence of phenol (gray solid line) a number of peaks are present with the most predominant peak at 0.85 V (indicated by the red arrow) that corresponds to the one-electron oxidation of phenol (Eq. 1)

C₆H₆O→C₆H₅O.+e⁻+H⁺; E⁰=0.86V (1)

Without wishing to be bound by theory, continued oxidation could first result in the formation of quinones and hydroquinones, which could be further oxidized to small organic acids such as formic acid, maleic acid, oxalic acid, and finally mineralized to carbon dioxide and water. If the anode potential is not sufficiently high, the intermediate phenolic free-radicals adsorbed to the electrode surface can polymerize as reported in previous studies [11, 30-35]. These other oxidative reactions are likely responsible for the other peaks observed in the LSV of the fresh CNT film. Distinct peaks are not observed in the LSV of other conditions indicating that either a wide-distribution of electron transfer site energies has been produced and/or a wide-distribution of intermediate organics has been produced as both can be expected after multi-hour electrolysis.

After each multi-hour electrolysis, the current at all voltages in the linear sweep voltammogram has been significantly reduced indicating that the electrode has been passivated. Both the polishing of the titanium (black dash to blue solid line) and replacement of the CNT network (blue dash to red solid line) results in an increase in current over the range of voltages. Even for the more passivated films (blue dash, red dash, and gray dash), the CNT network never becomes completely passivated because once the anode potential becomes greater than 0.6 V the current becomes greater than zero. FIG. 27E illustrated that the anode potential distribution varies with different reaction conditions with the same applied voltage, and that (along the gray horizontal arrow direction shown in the figure) higher anode potential are required for producing the equal current to the stable cathode in cases of the used titanium ring and/or the used CNT film system. This indicates that CNT film and titanium ring are primarily responsible for the electrochemical performance and its passivation. The findings indicate that titanium ring can be regenerated by polishing the surface of the titanium ring that contacts the CNTs. In terms of the efficacy of phenol removal or other organic removal, it is more important to ensure that the CNT network does not become passivated.

Two CNT network regeneration procedures were first evaluated: the EtOH—HCl method is to flow 60-mL of an acidic (pH 1.7) 1:1 ethanol:water solution over the electrode and the DMSO-redisperse method is to redisperse the passivated CNT network in DMSO and re-produce the network by filtration. These regeneration procedures were selected since there'can be electrolyte precipitation and/or polymer formation occurred on the CNT network in significant amounts as comparable to the CNT mass. The EtOH—HCl method can be used for the precipitate removal and the DMSO-redisperse method can be used for the polymer removal.

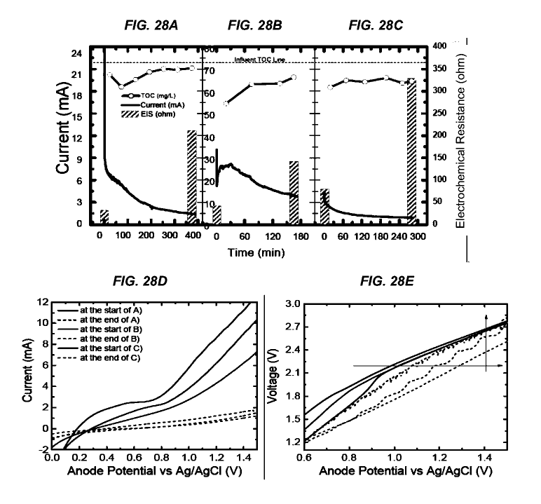

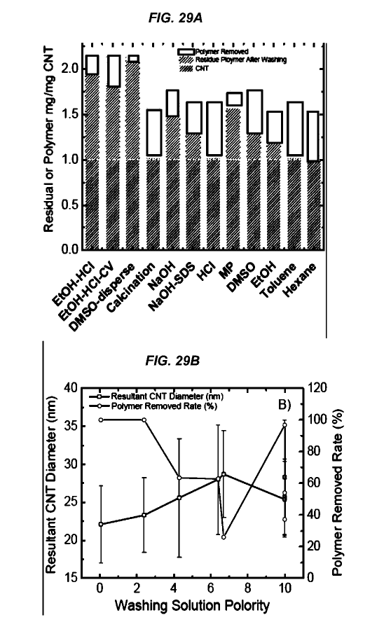

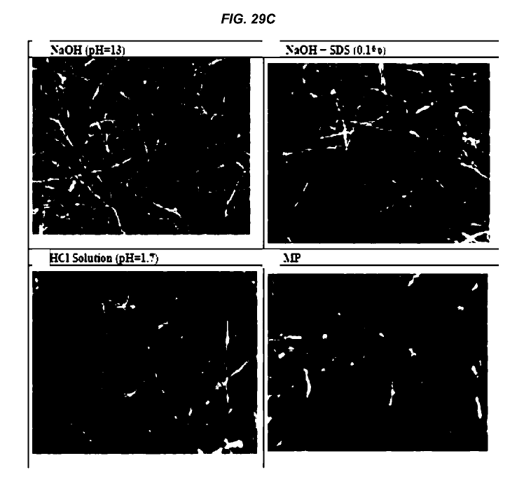

As shown in FIG. 28B, the EtOH—HCl regeneration method decreases the electrochemical impedance, increases the current, and decreases the effluent (output fluid) TOC. While the electrochemical performance of the EtOH—HCl-regenerated CNT network is improved as compared to the passivated one, its performance is still below the performance of a fresh CNT film (FIG. 27A). The significant decrease in effluent (output fluid) TOC and electrochemical impedance, yet relatively small increase in current indicate that, as discussed earlier, oxidation of the titanium ring is more responsible for the changes in steady-state current whereas modifications to and coatings of the CNT network are responsible for changes in electrochemical impedance and efficacy of TOC removal. The EtOH—HCl method can remove any electrochemically-precipitated salts on the CNT network and the efficacy of this regeneration technique indicates that the insulating precipitates can coat and passivate the electrochemically-active CNT surface sites.

As shown in FIG. 28C, the DMSO-redisperse method results in a 50% decrease in electrochemical impedance, but no significant improvement in effluent (output fluid) TOC removal or in steady-state-current. The minimal effect of re-dispersing the passivated CNT network in DMSO on the CNT network passivants indicates that the CNT network passivants can be insoluble in DMSO and/or they can be permanent modifications to the CNTs. Significant electrolyte precipitation and non-polar aromatic polymer formation, both of which would only be slightly soluble in the polar, aprotic DMSO, has also been previously reported. Previous reports on inefficient removal of the passivating polymers formed during phenol electrolysis with the polar solvents isopropanol and EtOH [36] also indicate that aromatic electropolymers are non-polar. The linear sweep voltammograms in FIG. 28D show that the improvement in current at all voltages after the EtOH—HCl treatment (black dash to blue solid) is greater than the DMSO-redisperse treatment (blue dash to red solid) by 50% to 100%. This result indicates that the electrochemical formation of insulating salt precipitates can passivate the CNT network electrode and that the DMSO-redisperse method is not as ineffective as the EtOH—HCl method for the regeneration of the electrode. Similar to FIG. 27D, the CNT networks did not completely passivated since the current becomes greater than 0 when the anode potential is greater than 0.6 V. In summary, the electrochemical CNT network passivation is most likely due to both electroprecipitation and electropolymerization coating the CNT network electrode. While the precipitants can be removed with an acidic ethanol-water wash, neither the EtOH—HCl method nor the DMSO-redisperse method was effective for the removal of the non-polar electropolymer. Since electropolymerization is one of the most common passivation mechanisms, methods to prevent electropolymerization and/or to regenerate polymer-coated electrodes, e.g., by more intense washing methods including highly acidic/basic aqueous solutions and non-polar organic solvents, were next evaluated.

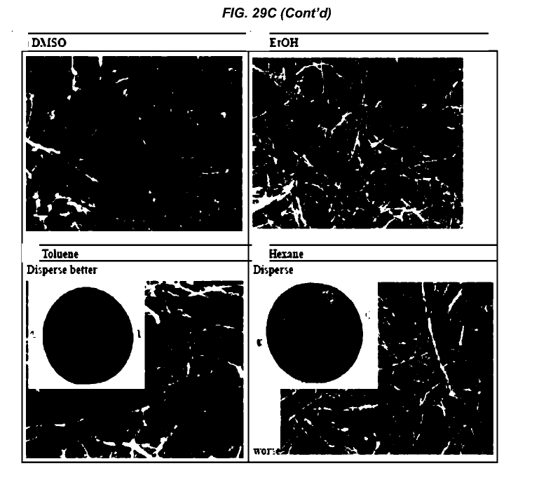

Electrode Regeneration Methods for Polymer Removal. As discussed earlier, neither the EtOH—HCl method nor the DMSO-redisperse method was effective for electropolymer removal. Different electrode regenerate methodologies were evaluated, including acidic ethanol-water wash with cyclic voltammetry (EtOH—HCl-CV), calcination, redispersion with highly basic or acidic waters, and redispersion with organic solvents over a range of polarities. The pre- and post-regeneration polymer mass for all of the regeneration methods and the apparent CNT diameter and percent polymer removal as a function of organic solvent polarity are shown in FIGS. 29A-29B, and the SEM images of the various CNT filters after different washing solution are shown in FIG. 29C. As discussed earlier, the EtOH—HCl and DMSO-redisperse methods only removed 16% and 3% of the total polymer, respectively. The combined wash and electrochemical methods of EtOH—HCl-CV improved the efficacy and removed 25% of the formed polymer. Calcination of the passivated CNT network at 400° C. for about 1 hour after washing with water to remove the precipitant resulted in ≧97% of polymer being removed, indicating that this approach can be used to remove the passivating polymer on the CNT network. However, precaution should be taken with this high-temperature method in order to avoid oxidizing the CNT network itself, which will be discussed in detail later.

Three aqueous solutions of extreme pH: NaOH (pH 13), NaOH (pH 13)+SDS (1%), and HCl (pH 1.7) were assessed for their ability to remove the CNT electropolymer coating. Among these three solutions, the acidic solution was the most effective as it removed ≧97% of the polymer. The basic-detergent solution removed 54% of the polymer, and the basic-only solution removed 37% of the polymer. Without wishing to be bound by theory, the efficacy of these extreme pH aqueous solutions to remove polymer from the CNT network can rely on polymer hydrolysis catalyzed by the acidic or basic solution, thus yielding water soluble monomers. In other embodiments, the efficacy of the basic and acidic solutions to remove polymer from the CNT network can likely rely on a depolymerization mechanism.

A number of common organic solvents over a range of polarities, e.g., n-methylpyrrolidone (NMP), DMSO, ethyl alcohol (EtOH), toluene, and hexane, were also evaluated for their ability to remove the CNT electropolymer coating. Toluene and hexane, the most non-polar solvents, were both able to remove ≧97% of the polymer coating from the CNT network electrode. The extent of polymer removal increased with the increasing non-polar nature of the solvent indicating that the polymer was also non-polar. The electropolymer coating the CNT network can be polyphenoxide or polyphenyleneoxide, which is highly aromatic and non-polar.

In summary, the methods of calcination and redispersion in HCl (pH 1.7), toluene, or hexane are effective for >95% removal of the electropolymer passivant coating. However, the methods of calcination and redispersion in HCl (pH 1.7) or toluene are preferably used for regenerating the passivated CNT network as the CNTs can be poorly dispersed in the hexane resulting in mechanically-unstable networks post-filtration.

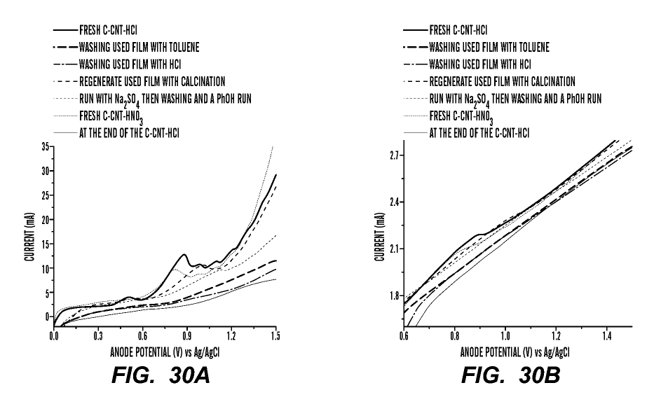

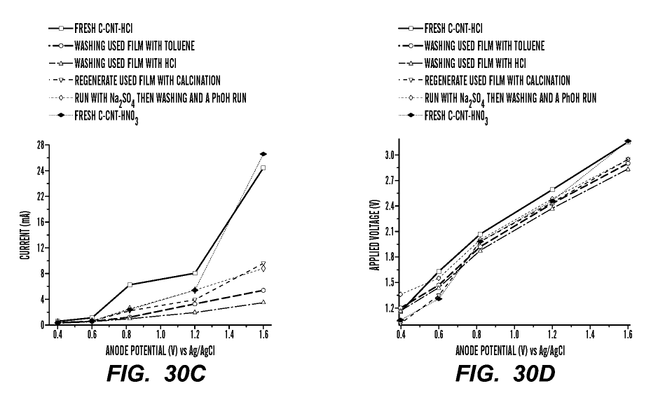

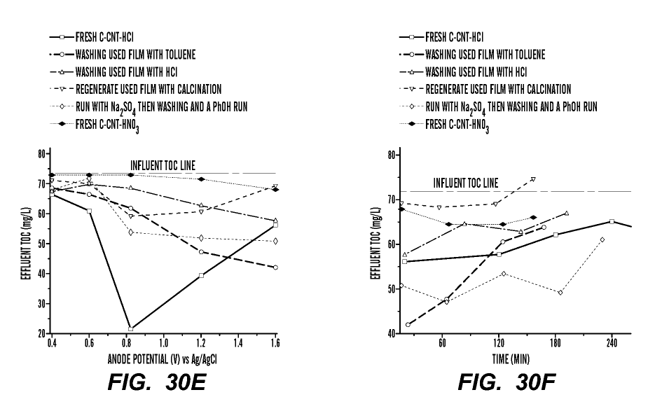

Post-regeneration CNT Network Performance. To assess the efficacy of the various CNT network regeneration methods with respect to electrochemical performance, the regenerated CNT films were evaluated using a number of methods including linear weep voltammogram, steady-state current versus anode potential, anode potential versus applied voltage, and effluent (output) TOC versus potential and time. The results of these experiments are shown in FIGS. 30A-30F for seven CNT networks of different conditions: a fresh CNT network, a passivated CNT network, a calcination-regenerated CNT network, a HCl-regenerated CNT network, and a toluene-regenerated network, and a CNT network run with only sodium sulfate electrolyte and a CNT network treated with HNO₃ as examples of oxidized CNTs. In regards to the current versus anode potential as shown in FIGS. 30A-30C, all of the regenerated CNT networks show improved performance over the passivated network, but none of them achieve the performance as a fresh CNT network. There is a distinct electron transfer peak only for the calcinated CNT network in the linear sweep voltammogram and this peak is shifted to a higher potential as compared to the fresh CNT network, indicating that there can be a tightly bound CNT surface coating that can be removed, among all the tested method, only by calcinating the CNTs at higher temperatures and that this coating can cause the energy of the CNT electron transfer sites to be broadened and the rate of electron transfer to be reduced. This can be supported by the LSV of the CNT films reactivated or regenerated with toluene or HCl wash as their current is lower at all potentials and there are no obvious phenol oxidation peak. At the same time anode potential-voltage relation as shown in FIG. 30B can also support the data of FIG. 30A. The steady-state current versus anode potential as plotted in FIG. 30C is in agreement with the LSV as shown in FIG. 30A. Thus, in terms of the electrochemical current, calcination is seemingly the optimal CNT network regeneration method. However, it should be noted that if the current efficiency towards a desired reaction is low then energy is only being wasted. Thus, an analysis of the regenerated networks toward phenol TOC removal was also performed.

The electrochemical filtration performance of the regenerated CNT networks towards phenol removal as measured by the difference in TOC between the influent and the effluent as function of anode potential and time is shown in FIGS. 30E and 30F, respectively. Although the calcinations method was the most optimal method in regards to improving the total current, the calcinated CNT network did not perform well in regards to TOC removal, especially at anode potentials ≧1.2 V that are necessary to completely oxidize phenol. After 130 minutes at an anode potential of 1.6 V, the calcinated CNT network lost structural integrity and yielded the effluent (output fluid) TOC equivalent to the influent (input fluid) TOC. The breakdown of the calcinated CNT film at higher potentials can be, at least partly, due to oxidative cutting and shortening of the CNTs during the calcination process, which can in turn generate more defect sites for further oxidation and led to a CNT network of a lower mechanical stability. In contrast, the CNT films reactivated or regenerated by toluene or HCl wash exhibited better performance towards the electrochemical oxidation and removal of phenol as compared to the calcination method, even though their instantaneous and steady-state currents were only slightly improved. This finding indicates that a toluene or HCl wash can regenerate the most active CNT electron-transfer sites that are typically found at the ends of the nanotubes. In particular, the CNT network reactivated or regenerated by the toluene wash method displayed at least a similar, if not better, performance on phenol oxidation and removal as compared to a fresh CNT network when the anode potential was ≧1.6 V. Accordingly, the CNT network can be regenerated for phenol oxidation and removal with a simple toluene wash.

It was next sought to determine why the toluene regeneration method could not improve the current and why the specific oxidation peaks were not detected using the toluene regeneration method. As discussed earlier, there could be some surface impurity or coating that covers a highly active, but weakly oxidative electron-transfer site resists removal during the strong non-polar washing. For example, the two primary electron-transfer sites present on a CNT are the oxidized ends and the sidewall defects of the CNTs. Aromatics are known to strongly sorb to the CNT sidewalls due to pi-pi interactions and thus if they are not removed during washing, aromatics could continue to passivate the sidewall defect electron transfer sites. Alternatively, during the initial electrolysis and passivation, the CNT surface could be oxidized along with the phenol. For example, it was previously reported that the surficial CNT O/C ratio increased from 0.026 for fresh CNTs to 0.045 for CNTs used as an electrochemical filter. If CNT oxidation could contribute to passivation, the passivation could be permanent unless the oxidized CNTs could be reduced to their original state. Calcination can increase the O/C ratio and thus may not less effective to treat oxidized CNT network.

As such, it was next sought to determine whether phenol absorption on the CNT network and/or CNT oxidation could contribute to CNT passivation. In the first experiment, the CNTs were pre-oxidized with a concentrated nitric acid solution (denoted by HNO₃-CNTs) at 70° C. for 12 h and the O/C ratio of the HNO₃-CNTs is increased to 4.1%. If oxidation were the primary cause of passivation, then the regenerated CNT networks should perform comparably to the HNO₃-CNTs networks. In the second experiment, a fresh CNT network was used to electrochemically filter 100 mM Na₂SO₄ electrolyte without phenol (denoted by CNT-Na₂SO₄) and then washed with HCl for reactivation or regeneration. If there were an aromatic organic coating that cannot be removed by the toluene wash, then this coating should not be present on theses CNTs after regeneration since no phenol was used during the electrochemical filtration. The CNT-Na₂SO₄ network can be more oxidized than the fresh network as the surficial O/C ratio is around 4.5%.

The LSV and steady-state current versus voltage plots in FIGS. 30A and 30C show that the CNT-HNO₃ curves are quite similar to the fresh CNT network curves with a slightly smaller current from 0.7 V to 1.2 V. On the other hand, the CNT-Na₂SO₄ curve looked more like the passivated CNT network or washed CNT network curves in that the current increased rather linearly with potential and only one slight peak was present in the LSV. However, similar to the calcinations versus wash results, the CNT-Na₂SO₄ network performed significantly better in regards to phenol oxidation and removal as compared to the HNO₃-CNT even though the former had lower steady-state current. This finding indicates that external CNT oxidation methods such as calcinations and concentration nitric acid can result in the formation of a large number of weakly-oxidizing electron-transfer sites. This is in agreement with the reduced performance of the HNO₃-CNTs as compared to the CNTs with other surface modification with respect to its electrochemical filtration and oxidation of a number of organics such as methyl orange, methanol, and CTAB [19]. It is also of note that at higher potentials and longer electrolysis times, the CNT-Na₂SO₄ network performed better than the fresh CNT network with respect to phenol removal and oxidation. While both the CNT-Na₂SO₄ (O/C=0.045) and the CNT-HNO₃ (O/C=0.041) are both oxidized to a greater extent than the fresh CNTs (O/C=0.022), the CNT-Na₂SO₄ and the CNT-HNO₃ networks performed in opposite direction from the control (fresh CNT network). One possibility is that since they are oxidized in different manners the resulting surface functional groups can be quite different, i.e., oxidation by thermal HNO₃ (NO₂⁺) and electrochemically-produced persulfate S₂O₈²⁻ (SO_{4.}⁻) can result in a different distribution of functional groups on the CNT surface. For example, a previous report indicates that the capacitor of CNT-oxi-Na₂SO₄ is 31.4 uF and higher than 16.9 uF of CNT-HNO₃, and higher capacitor is useful to transfer electron quickly in double layers, which is important feature for electrochemical reaction.

In summary, among different regeneration methods evaluated herein, a wash with toluene can reactivate a polymer-passivated CNT filter electrode more effectively with respect to aromatic oxidation and removal performance. However, the LSV and steady-state current measurements indicate that a fraction of the CNT electron-transfer sites can remain passivated. An HCl wash was also effective for >95% polymer removal, however, the electrochemical performance was lower than a fresh CNT network. Calcination of the polymer-passivated CNTs also resulted in >95% polymer removal, however, the calcinated CNT network could lose a significant amount of its mechanical and electrochemical stability, thus resulting in breakdown during subsequent use. Without wishing to be bound, hybrid methods can also be used to remove polymer from electrochemical CNT networks.

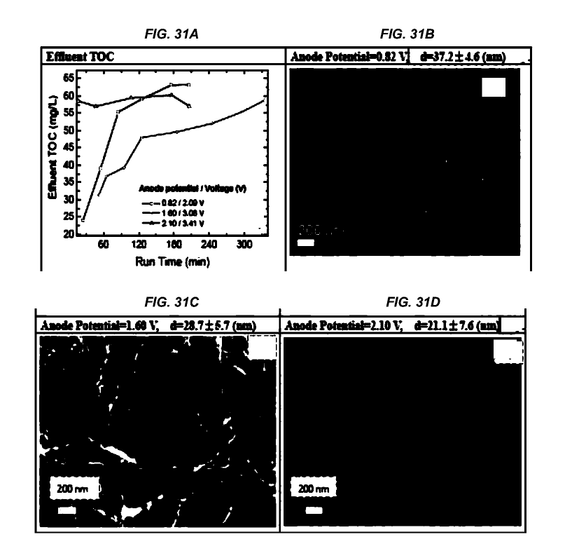

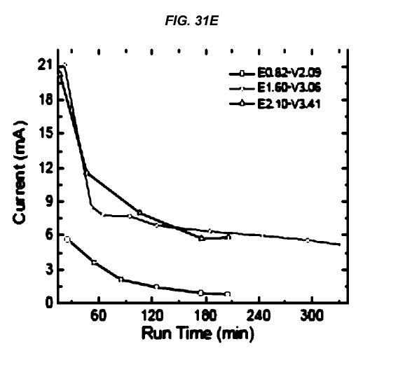

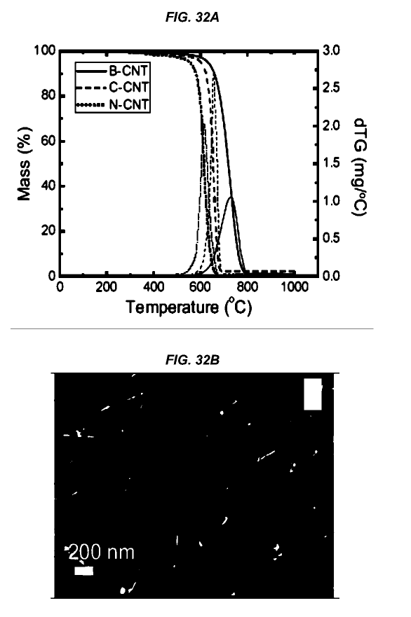

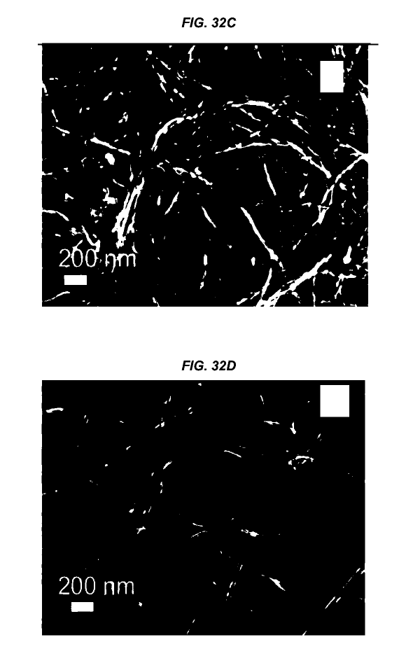

Alternatives—How to Reduce or Prevent Polymer Formation: Instead of removing passivating polymer completely from the CNT surface, an alternative method is to reduce or prevent such polymer from depositing on the carbon nanotubes in the first place. Thus, it was next sought to determine if running the filtration system at high potentials could prevent formation of the polymer that passivates the CNT network. Three anode potentials 0.82 V, 1.60 V and 2.10 V, corresponding to voltages 2.09 V, 3.06 V and 3.42 V, respectively, were applied to electrochemical oxidation of phenol. As shown in FIGS. 31A-31D, the apparent removal efficiency, as indicated by effluent (output fluid) TOC, at an anode potential of 0.82 V and 1.60 V is better than that at an anode potential of 2.10 V. At lower anode potentials, phenol is apt to form polymer by emitting one electron (C₆H₆O→C₆H₅O.+e⁻+H⁺), but at higher anode potentials, such as 2.10 V, phenol can be oxidized completely to CO₂ and H₂O by .OH etc. in which 28 e⁻ is involved in the reaction (C₆H₆O+7O₂→6CO₂+3 H₂O+28e⁻). The complete oxidation requires more electrons because at higher anode potentials there are some side reaction such as oxygen evolution, which can consume the current. The current at the anode potential of 2.1 V is about 1˜4 times (rather than 28 e⁻/1 e⁻=28 times) higher than that at the anode potential of 0.82 V or 1.60 V (FIG. 31E). However, the effluent (output fluid) TOC at the anode potential of 2.1 V maintained stable over time, while the effluent (output fluid) TOC at the anode potential of 0.82 V and 1.60 V increased gradually and exceeded the level observed at the anode potential of 2.1 V around 150 min and 360 min, respectively, probably because the CNT surface at low potentials were occupied near fully by the polymer and their electrochemical oxidation thus became limited. The effluent (output fluid) TOC at the anode potential of 1.60 V was lower than that at the anode potential of 0.82 V for a longer period of time, because both polymerization and electrochemical oxidation of phenol can occur at the anode potential of 1.60 V, while polymerization is the major reaction at the anode potential of 0.82 V, thus resulting in earlier passivation. FIGS. 31B-31D show the SEM images of the CNT network operated at different anode potentials and their corresponding diameters (37.2±4.6 nm at 0.82 V, 28.7±5.7 nm at 1.60 V and 21.1±7.6 nm at 2.10 V). The CNTs at the anode potentials of 0.82 V and 1.60 V appeared to be coated with polymer, but the latter appeared to have a thinner coating than the former, whereas at the anode potential of 2.10 V, some salt particles other than polymer was formed on the CNT film. The salt particles can come from Na₂SO₄, Na₂S₂O₈ (2SO₄²⁻→S₂O₈²⁻+2e⁻) and/or Na₂CO₃ (CO₂+H₂O→CO₃²⁻+2H⁺), which, unlike polymer, can be washed out easily. However, too high potentials can result in CNT oxidation and even destroy the CNT network, so an optimal potential should be selected.

Accordingly, in some embodiments, higher potentials can be used to reduce polymer formation on the CNT network during electrochemical filtration. In some embodiments, the passivated CNT networks can at last partially regenerated by the methods described herein, e.g., a toluene wash. In some embodiments, CNT surface performance can be improved by pre-coating or doping or mixing the CNT network with an active material to form synthetic composites with at least one performance feature including but not limited to high anti-oxidation, anti-pollution, self-cleaning, high oxygen evolution potential, high film strength and any combinations thereof.

### Exemplary Materials and Methods for Example 13

Chemicals. Phenol (PhOH), hydrochloric acid (HCl; 36.5-38.0%), nitric acid (HNO₃; 69.8%), sulfuric acid (H₂SO₄; 95.0-98.0%), phosphoric acid (H₃PO₄; ≧85.0%), sodium hydrate (NaOH; ≧99.9%), ethyl alcohol (EtOH; ≧95.0%), dimethylsulfoxide (DMSO; ≧99.9%), potassium hydrogen phthalate (KHP), sodium sulfate (Na₂SO₄), sodium persulfate (Na₂S₂O₈), sodium bicarbonate (NaHCO₃), sodium carbonate (Na₂CO₃), n-methylpyrrolidone (NMP; ≧99.9%), sodium dodecyl sulfate (SDS), toluene (C₇H₈) and hexane (C₆H₁₄) were purchased from Sigma-Aldrich. All chemicals were reagent grade except DMSO, which was spectrophotometric grade.

CNT Selection and Purification. The multi-walled carbon nanotubes were purchased from NanoTechLabs, Inc. (Yadkinville, N.C.) and then purified for optimal electrochemical performance. To remove non-CNT carbon impurities, about 1 g of CNTs was calcinated, e.g., in a tube furnace, by increasing from room temperature to about 400° C. at a rate of 5° C. per min and holding for about 60 min (Thermolyne, 21100). To remove the residual metal catalyst impurities, about 0.5 g of calcinated CNT was placed into 0.5 L of concentrated hydrochloric acid and heated to about 70° C. in a round-bottom flask with stirring and a condenser for at least about 12 hours. After heating, the sample was cooled to room temperature and vacuum filtered through a 5-μm PTFE membrane (Omnipore, Millipore) [19]. The CNTs were then washed with MilliQ deionized water (DI) until the filter output fluid pH was neutral. The sample was then oven dried at 100° C.

Electrochemical CNT Filter Preparation. The CNT filters were produced by first dispersing the CNTs in DMSO at about 0.5 mg/mL by probe sonication (Branson, Sonifier S450) for 15 min at an applied power of 400 W/L. Then, 30 mL of the CNTs in DMSO were vacuum filtered onto a 5-μm PTFE membrane (Millipore, Omnipore, JMWP), resulting in filter loadings of 1.5 to 1.6 mg/cm². The CNT filters were washed with 100 mL EtOH, 100 mL 1:1 DI-H₂O:EtOH, and 250 mL DI-H₂O to remove DMSO. Finally, the prepared filter was loaded into an electrochemistry modified filtration casing, as described herein. See also, e.g., Ref. 19.

Passivation and Regeneration of the CNT Network. The passivation experiments were completed by flowing an input fluid solution (or an influent solution) of 1 mM or 72 mgC L⁻¹ phenol and 100 mM sodium sulfate through the electrochemical CNT network described herein at 1.5 mL min⁻¹. Then, an applied voltage of approximately 3 V was applied to achieve an anode potential of 1.6 V. The solution was then flowed through the electrochemical filtration apparatus described herein until the effluent (i.e., output fluid) total organic carbon (TOC) became similar to the influent (i.e., input fluid) TOC (usually 6 to 12 hours) as an indicator that the electrode was passivated. To determine the source of passivation within the filtration apparatus, either the used CNT network was replaced with a fresh CNT network or the titanium ring was polished. To remove the precipitant and polymer passivants from the carbon nanotubes, two regeneration methods were assessed. The first method (EtOH—HCl) involved flowing 60 mL of an acidic 1:1 ethanol:water solution at pH 1.76 at a flow rate of 1.0 mL min⁻¹. The second method (DMSO-disperse) involved redispersing the CNTs in DMSO and reproduction of the CNT filter as described earlier. Chronoamperometry and TOC removal versus time can be used to monitor the passivation process and the efficacy of the regeneration methods. Electrochemical impedance spectroscopy, linear sweep voltammograms, and open circuit anode potential versus applied voltage (CHI Inc., CHI604D) can be used to evaluate the electrodes before passivation, after passivation, and after regeneration.

Additional Regeneration Methods. Three additional regeneration methods were developed to gain further insight into the optimal process. First, an electrochemical regeneration method (EtOH—HCl-CV) was performed by flowing an acidic 1:1 ethanol:water solution with concomitant cyclic voltammetry (CV) at a scan rate, e.g., of 10 mV s⁻¹. Second, the passivated films were calcinated, e.g., in a tube furnace, by increasing from room temperature to 400° C. for at a rate of 5° C. per min and holding for about 60 min. Third, the passivated films were redispersed by ultrasonication in 30-mL of 8 different solutions: NaOH (pH 13), NaOH (pH 13)+SDS (0.1%), HCl (pH 1.76), n-methylpyrrolidone, DMSO, EtOH, toluene, and hexanes. The CNT solutions were then placed in an oven, e.g., set to 50° C., for at least 24 hrs before preparing the new CNT network. The electrochemical methods and scanning electron microscopy as described earlier and CNT network weights were used to evaluate the CNT networks before passivation, after passivation, and after regeneration.

SEM Analysis. Scanning electron microscopy was performed on a Zeiss FESEM Supra55VP. Micrographs were analyzed with ImageJ software to determine CNT diameter. Measurements were an average of at least 100 measurements from at least 2 network images.

### Example 14

### Doped Carbon Nanotube Networks for Electrochemical Filtration of Aqueous Phenol: Polymerization and Precipitation

As described herein, a CNT network, which is electrically-conducting, mechanically-sound, and corrosively-stable^{7, 11}, and provides high surface area for increasing the number of electrochemically-active surface sites and high porosity for enhanced ion and molecular transport¹⁰, can be utilized as an anodic water filter for chemical removal and oxidation^{6, 12} and bacterial and virus removal and inactivation.⁹ Accordingly, CNT networks of different physical or chemical properties can be utilized as three-dimensional electrode structures for advanced water treatment. For example, varying physical and chemical properties of the CNTs such as diameter, chirality, and doping can affect the electrochemical activity of the CNT network.

CNT doping with boron (B-CNT, p-type) or nitrogen (N-CNT, n-type) has been reported to effect the CNT electronic structure and in turn will likely also effect the CNT electrochemical activity. As compared to undoped carbon nanotubes (C-CNT), both the B-CNT and N-CNT have been reported to have a greater conductivity¹³⁻¹⁵ and a higher specific capacitance^{16, 17}—two properties that are critical to electrochemical performance. The primary difference between the two dopants is their specific effect on the nanotube work function, i.e., the distance from the material Fermi level to the vacuum level. The work function is 4.6 eV for C-CNT, 5.2 eV for B-CNT, and 3.9 eV-4.4 eV for N-CNT^{18, 19}. The greater B-CNT work function indicates that B-CNT can be the optimal material for driving oxidative processes. Due to their improved electronic properties as compared to undoped CNTs, both B- and N-doped CNTs can be used for electrochemical applications. The higher B-CNT work function makes it useful for sensing of electron-rich gases²⁰ and electroanalysis of biomolecules.²¹ The lower N-CNT work function makes it useful as a reduction catalyst.²² For example, N-CNTs have been reported to be used for oxygen reduction in fuel cells and for reactive oxygen species production.²³ Accordingly, it was sought to determine if utilization of anodic B- and N-doped CNT networks can result in an increase in electrochemical filtration performance towards wastewater treatment.

As presented herein, purified and characterized undoped (C-CNT), boron-doped (B-CNT), and nitrogen-doped (N-CNT) carbon nanotube networks were utilized for the electrochemical filtration of an aromatic wastewater. Phenol (PhOH) was selected as the model aromatic pollutant as it is a common industrial solvent and often found in petroleum wastewaters. The electrochemical filters were exposed to 0.0 mM, 0.2 mM, and 1.0 mM phenol in 100 mM Na₂SO₄ electrolyte. The electrochemical oxidation efficiency was monitored by measurement of steady-state current and effluent total organic carbon (TOC) concentrations to determine apparent TOC removal efficiency and to compare the efficacy of the three CNT networks. SEM, TGA, and XPS analysis of the CNT networks before and after electrochemical filtration can, at least partly, determine the electrode passivation mechanisms of electrochemical phenol polymerization and electrochemical electrolyte precipitation.

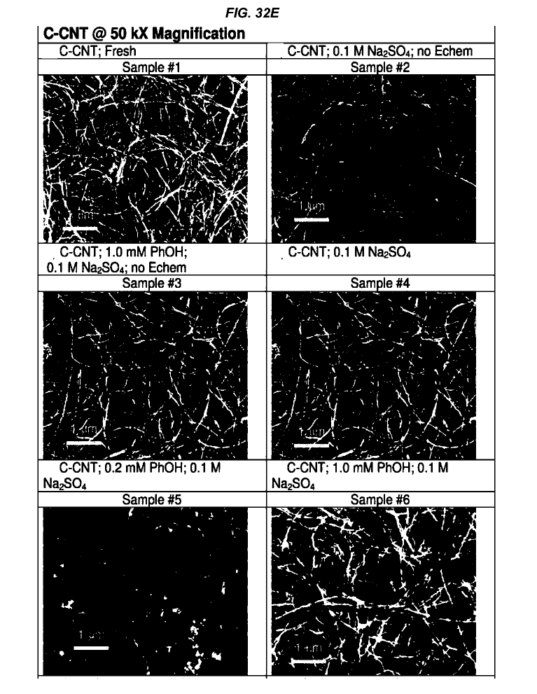

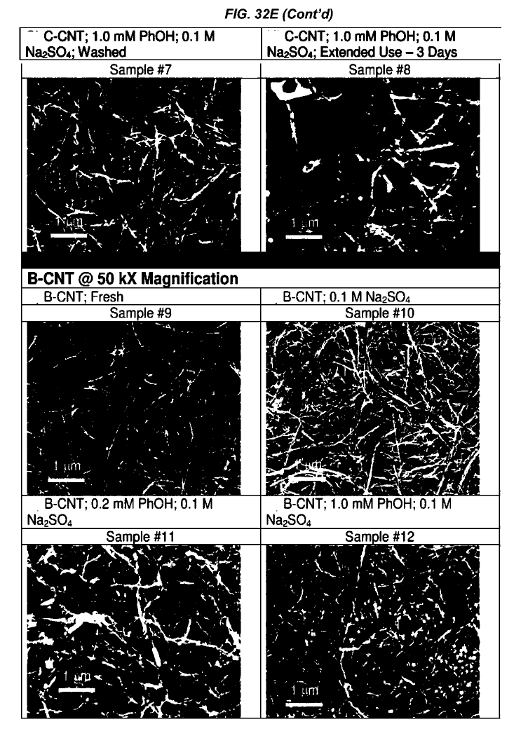

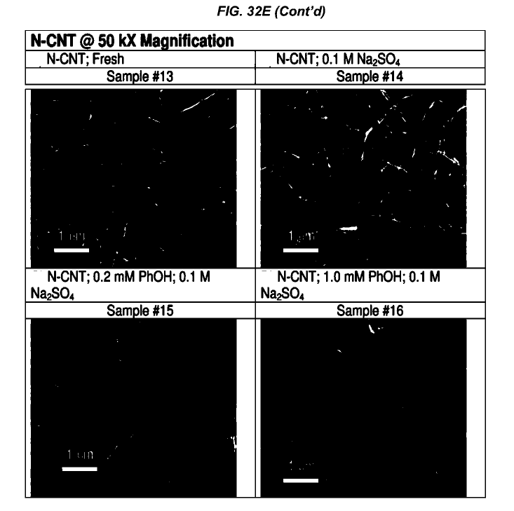

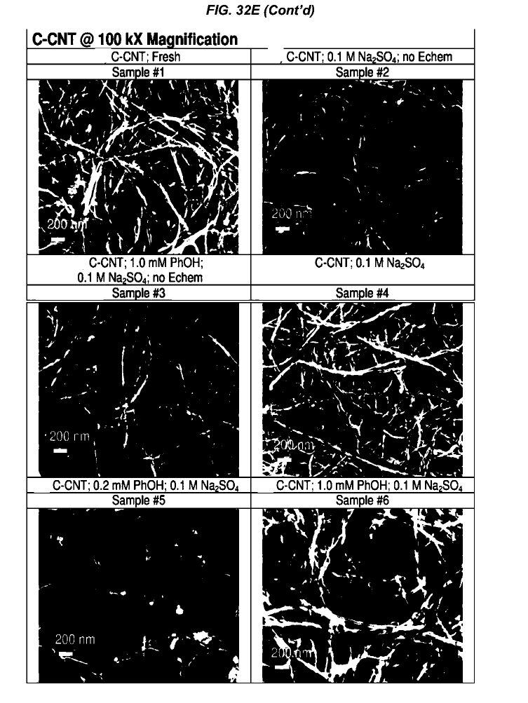

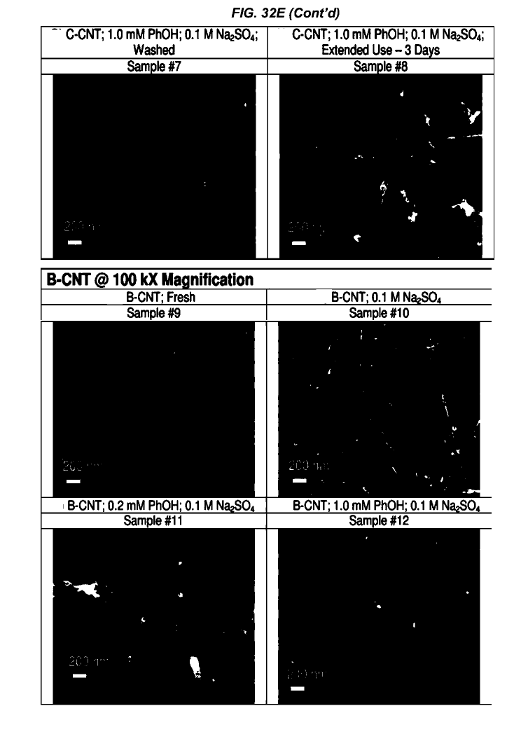

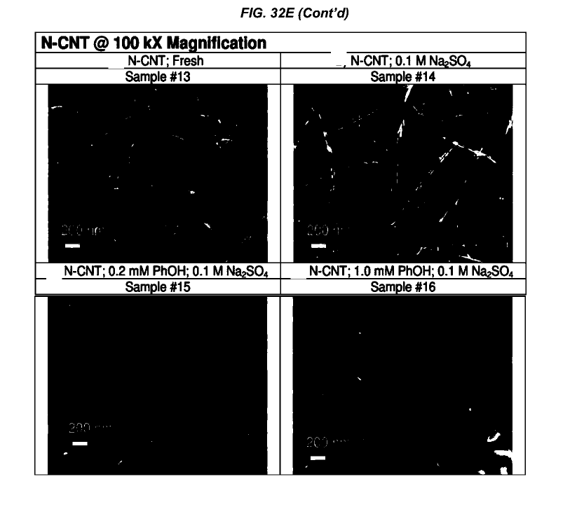

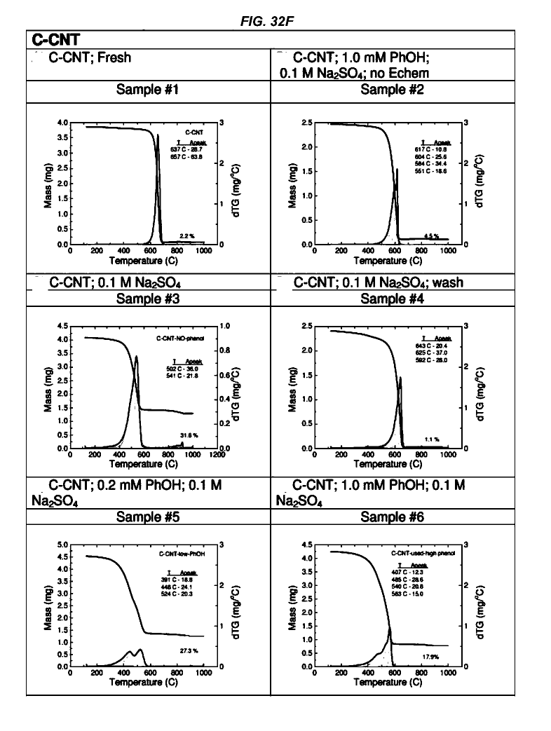

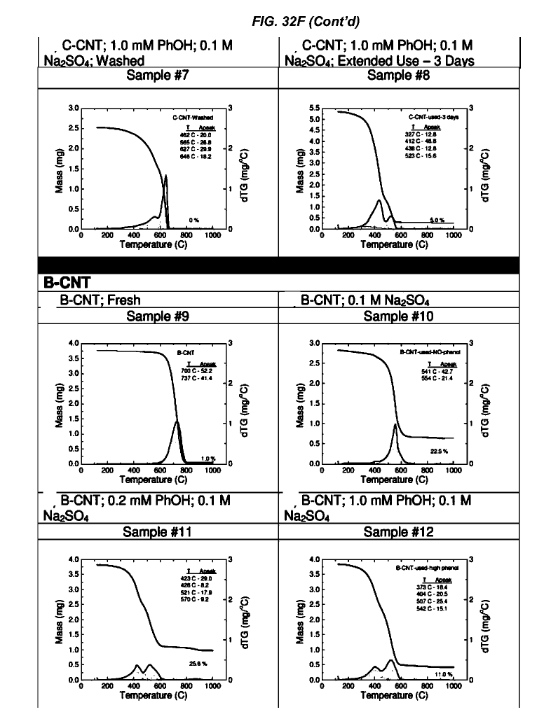

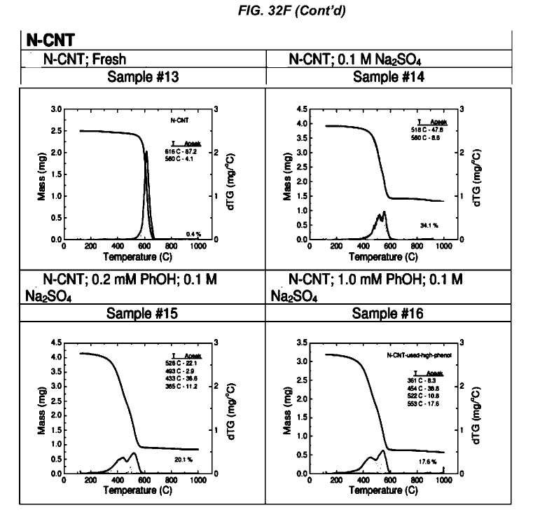

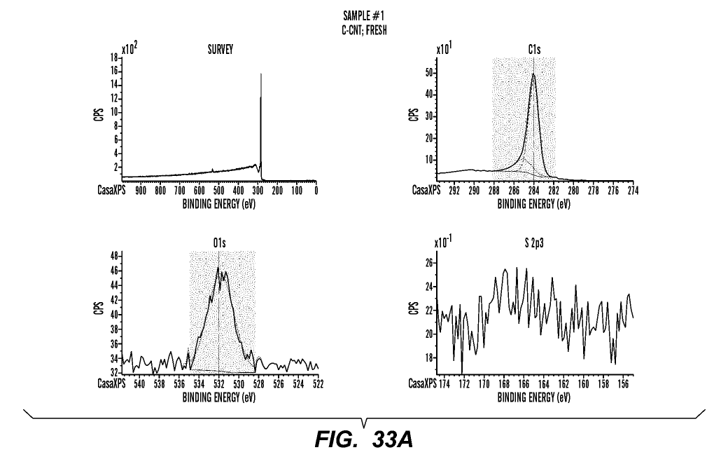

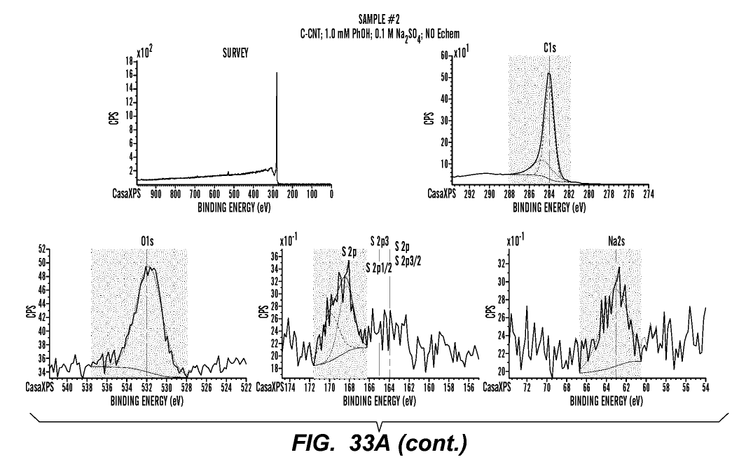

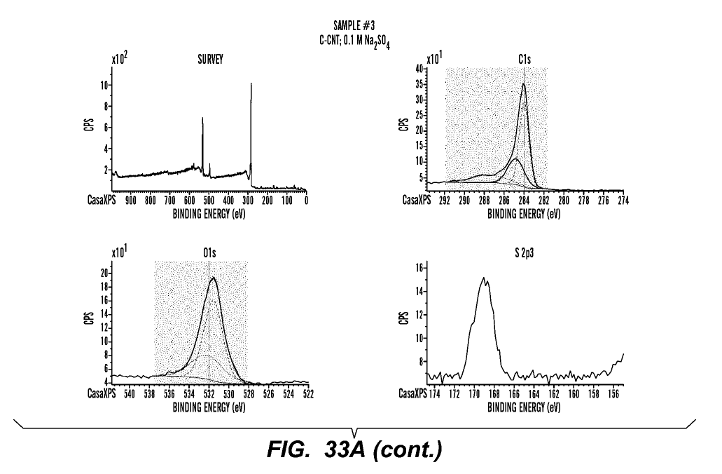

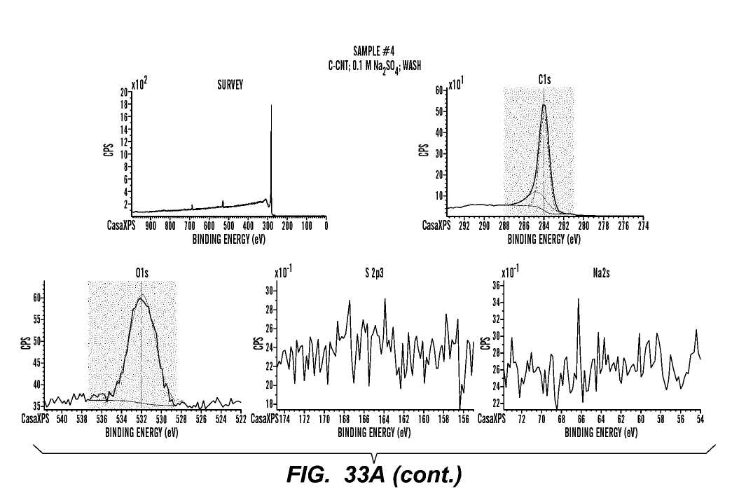

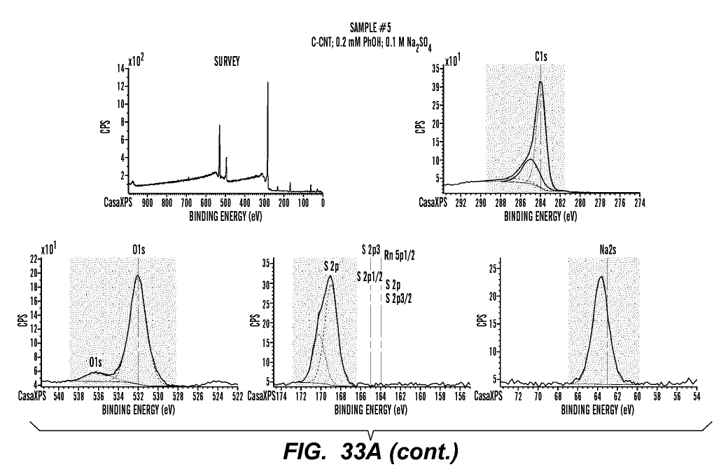

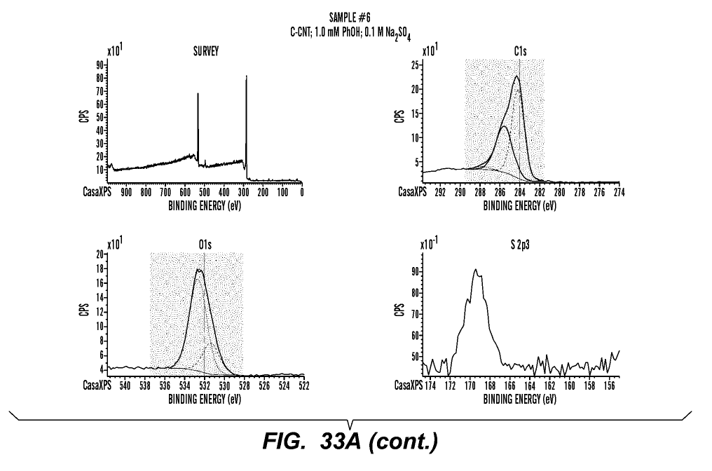

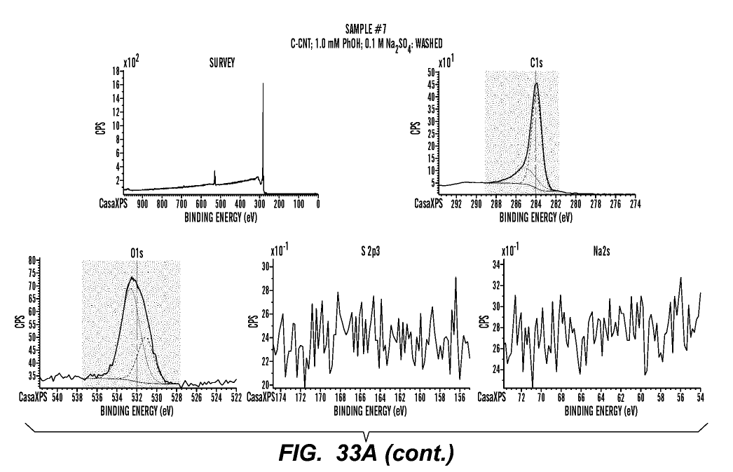

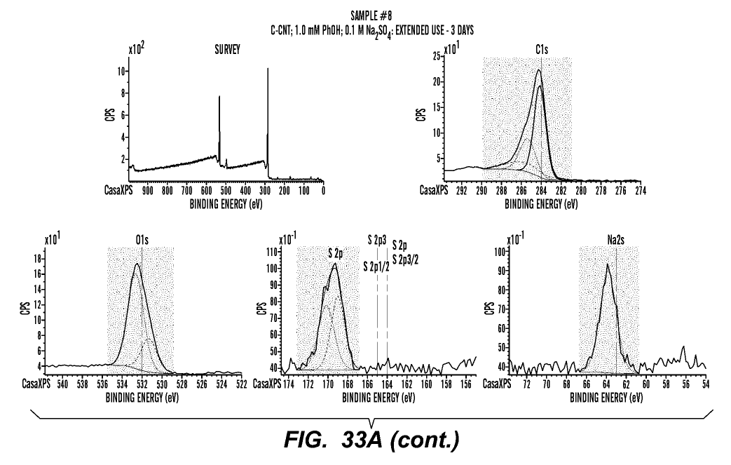

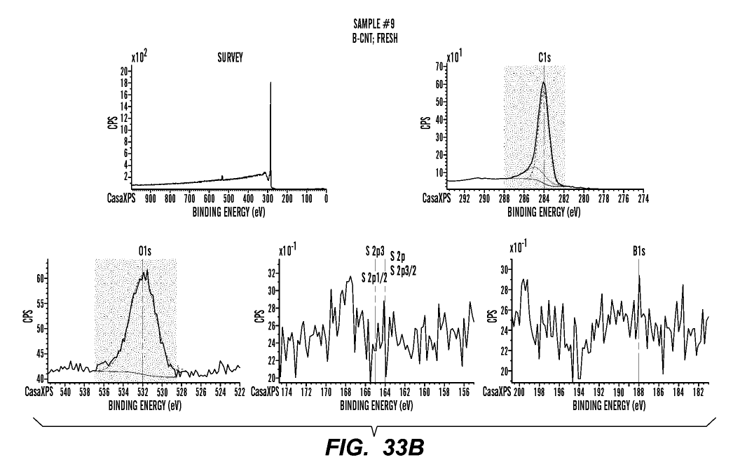

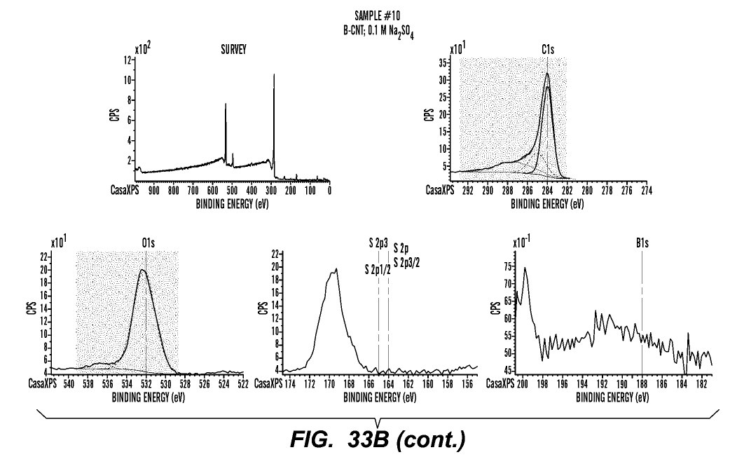

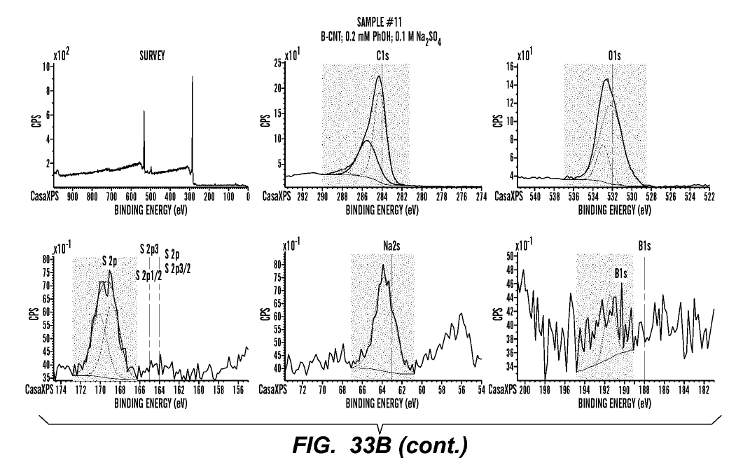

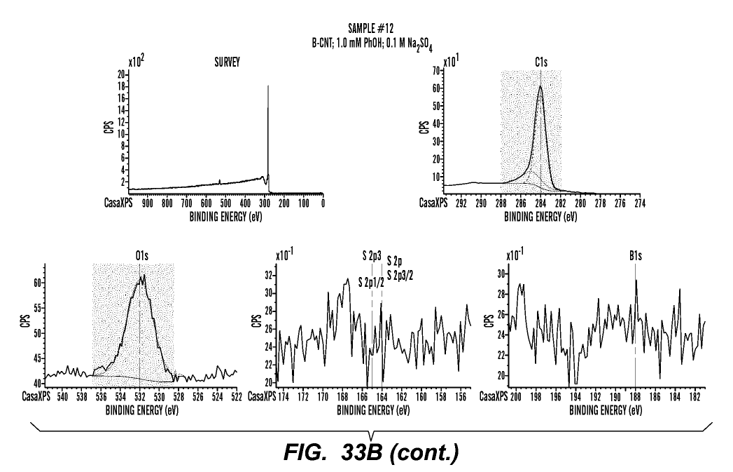

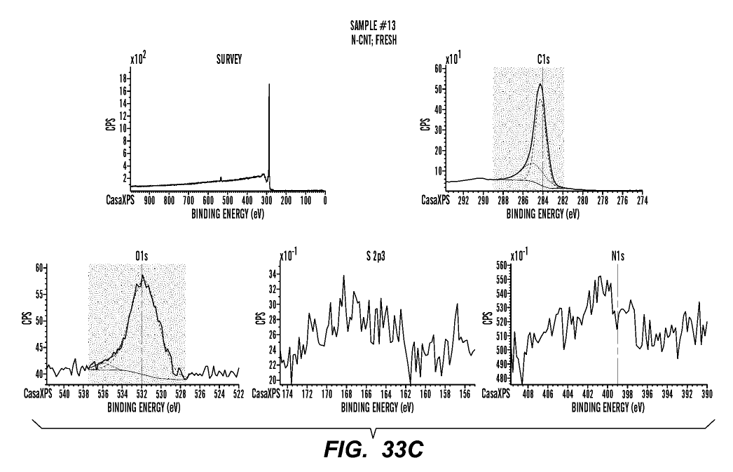

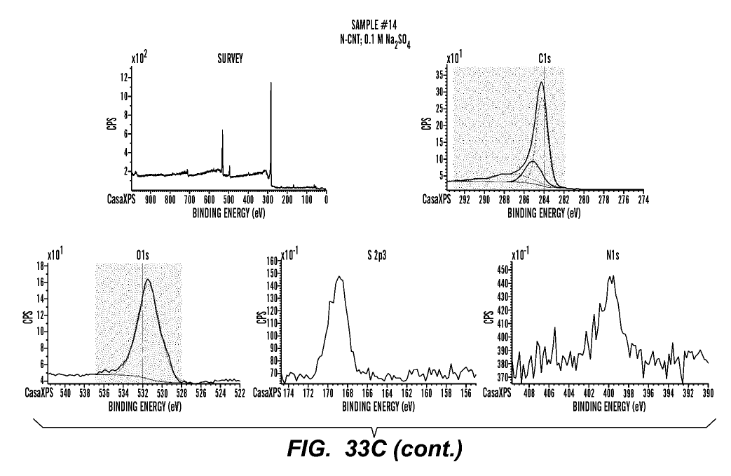

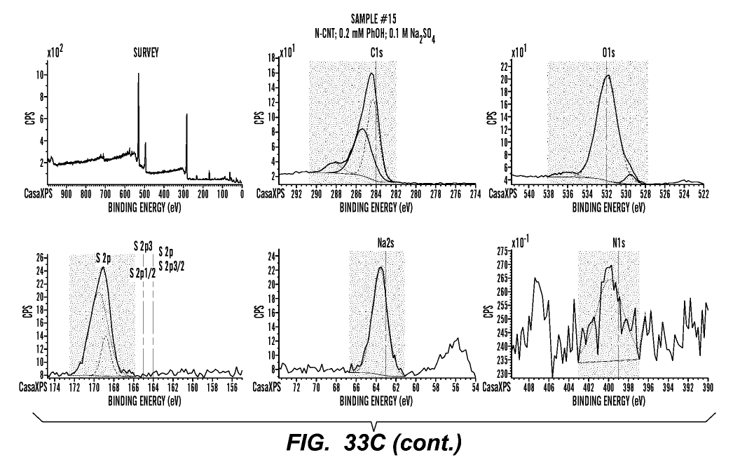

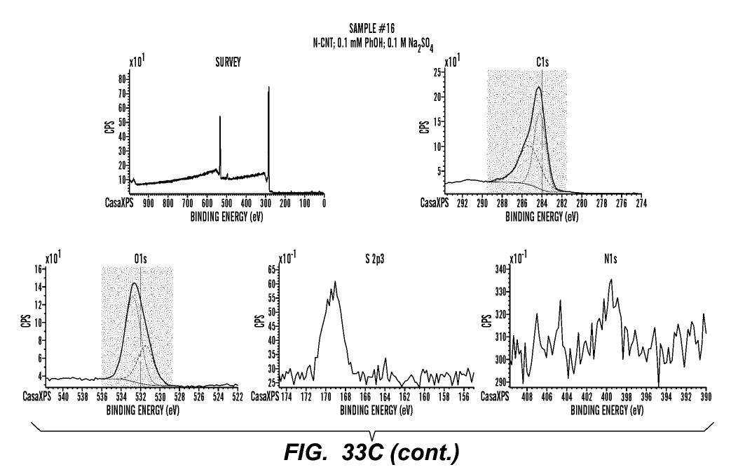

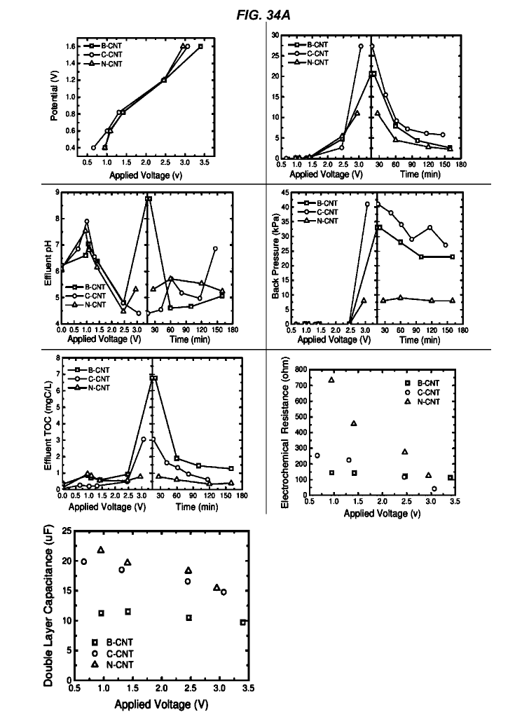

Characterization of Doped CNT Networks. The three carbon nanotube (CNT) samples assessed included undoped (C-CNT), boron-doped (B-CNT), and nitrogen-doped (N-CNT). The three CNT samples were formed into filter materials or networks by vacuum filtration. The CNT networks were then characterized by thermogravimetric analysis (TGA), scanning electron microscopy (SEM), and X-ray photoelectron spectroscopy (XPS), with the results presented in FIGS. 32A-32F, FIGS. 33A-33C and Table 6 below. The TGA burn temperatures in FIG. 32A indicates that the B-CNT are the most oxidatively stable CNT followed by C-CNT and then N-CNT, in agreement with previous reports that B-doped CNTs have increased graphitization.²⁵ All three CNT samples were at least 97.5% CNT and the doped CNTs were ≧99.0% CNT. SEM of the C-CNT, B-CNT, and N-CNT networks are shown in FIGS. 32B, 32C, and 32D, respectively. The B-CNT and C-CNT have a similar average diameter of 17 nm to 19 nm. In contrast, the N-CNTs are larger with an average diameter of ˜25 nm. The N-CNTs are also notably more flexible than the B- or C-CNTs with CNT circles visible in the micrograph (FIGS. 32A-32D). The pore size distribution of the three networks is similar with an average pore diameter of around 105 nm and a standard deviation of ˜45 nm. The surficial O/C ratio as determined by XPS for all three CNT samples is between 0.025 and 0.035. The surficial B- and N-doping as determined by XPS is around 1%. A primary difference between the three materials is their previously reported work functions^{18, 19} that correspond to Fermi level redox potentials (vs. NHE) of about −0.1 V for the N-CNT, about 0.1 V for the C-CNT, and about 0.8 V for B-CNT.

TABLE 6
Physical and Chemical Properties of Fresh and Electrolyzed Electrochemical Carbon Nanotube Networks (shown on the next page)

| | | | | | | Mass- | | d(pore)- | % | % | % | | | | | B-N/ | |
|---|---|---|---|---|---|---|---|---|---|---|---|---|---|---|---|---|---|
| # | Sample | Phenol | | Echem-t | | mg | d(CNT)-nm^{a} | nm^{a} | CNT^{b} | Res^{b} | Poly^{b} | Burn Peak T^{b} | O/C^{c} | S/C^{c} | O/S^{c} | C^{c} | Na/S^{c} |
| 1 | C-CNT | 0 | | 0 | | 15.4 | 17.1 ± 6.6 | 104 ± 39 | 97.8 | 2.2 | 0.0 | 657, 637 | 0.026 | 0 | 0 | n/a | |
| 2 | C-CNT | 1 | mM | 0 | | 17.1 | 18.2 ± 7.4 | 96 ± 43 | 95.5 | 4.5 | 0.0 | 617, 604, 584, | 0.030 | 0.003 | 10.7 | n/a | 3.15 |
| | | | | | | (16.4) | | | | | | 551 | | | | | |
| 3 | C-CNT | 0 | | 5 | h | 41.7 | 18.9 ± 7.2 | 100 ± 42 | 68.4 | 31.6 | 0.0 | 541, 502 | 0.283 | 0.020 | 14.5 | n/a | |
| 4 | C-CNT | 0 | | 5 | h-Wash | | 17.9 ± 8.4 | 106 ± 50 | 98.9 | 1.1 | 0.0 | 643, 625, 592 | 0.045 | 0 | 0 | n/a | |
| 5 | C-CNT | 0.2 | mM | 5 | h | 52.3 | 34.2 ± 11.5 | 115 ± 55 | 23.3 | 27.3 | 40.4 | 524, 448, 391 | 0.309 | 0.070 | 4.5 | n/a | 2.50 |
| 6 | C-CNT | 1 | mM | 5 | h | 46.8 | 29.9 ± 10.3 | 109 ± 52 | 38.3 | 17.9 | 43.7 | 563, 540, 485, | 0.293 | 0.014 | 20.4 | n/a | |
| | | | | | | | | | | | | 407 | | | | | |
| 7 | C-CNT | 1 | mM | 5 | h-Wash | 29.5 | 25.1 ± 8.1 | 114 ± 54 | 50.9 | 0.0 | 49.1 | 646, 627, 565, | 0.075 | 0 | 0 | n/a | |
| | | | | | | | | | | | | 462 | | | | | |
| 8 | C-CNT | 1 | mM | 20 | h | 55.9 | 46.4 ± 12.5 | 140 ± 77 | 31.5 | 5.0 | 63.4 | 523, 438, 412, | 0.289 | 0.019 | 15.3 | n/a | 2.70 |
| | | | | | | | | | | | | 327 | | | | | |
| 9 | B-CNT | 0 | | 0 | | 15.6 | 18.6 ± 5.9 | 112 ± 46 | 99.0 | 1.0 | 0.0 | 737, 700 | 0.032 | 0 | 0 | 0.007 | |
| 10 | B-CNT | 0 | | 5 | h | 33.8 | 20.1 ± 7.9 | 102 ± 41 | 77.5 | 22.5 | 0.0 | 554, 541 | 0.300 | 0.041 | 7.3 | 0.022 | |
| 11 | B-CNT | 0.2 | mM | 5 | h | 50.2 | 29.5 ± 8.4 | 108 ± 48 | 31.4 | 25.6 | 43.0 | 570, 521, 426, | 0.275 | 0.013 | 21.4 | 0.012 | 3.24 |
| | | | | | | | | | | | | 423 | | | | | |
| 12 | B-CNT | 1 | mM | 5 | h | 34.8 | 29.4 ± 7.7 | 117 ± 62 | 45.4 | 11.0 | 43.6 | 542, 507, 404, | 0.272 | 0.009 | 30.3 | 0.004 | |
| | | | | | | | | | | | | 373 | | | | | |
| 13 | N-CNT | 0 | | 0 | | 15.6 | 25.1 ± 13.6 | 99 ± 42 | 99.6 | 0.4 | 0.0 | 616, 560 | 0.033 | 0 | 0 | 0.013 | |
| 14 | N-CNT | 0 | | 5 | h | 48.2 | 24.7 ± 8.7 | 123 ± 50 | 65.9 | 34.1 | 0.0 | 560, 518 | 0.224 | 0.016 | 13.7 | 0.020 | |
| 15 | N-CNT | 0.2 | mM | 5 | h | 52.1 | 39.3 ± 13.6 | 118 ± 53 | 27.4 | 20.1 | 52.5 | 526, 493, 433, | 0.561 | 0.062 | 9.1 | 0.018 | 2.98 |
| | | | | | | | | | | | | 365 | | | | | |
| 16 | N-CNT | 1 | mM | 5 | h | 47.1 | 33.4 ± 10.2 | 115 ± 53 | 31.0 | 17.6 | 51.4 | 553, 522, 454, | 0.252 | 0.010 | 24.6 | 0.015 | |
| | | | | | | | | | | | | 361 | | | | | |

^{a}determined by SEM.
^{b}determined by TGA.
^{c}determined by XPS

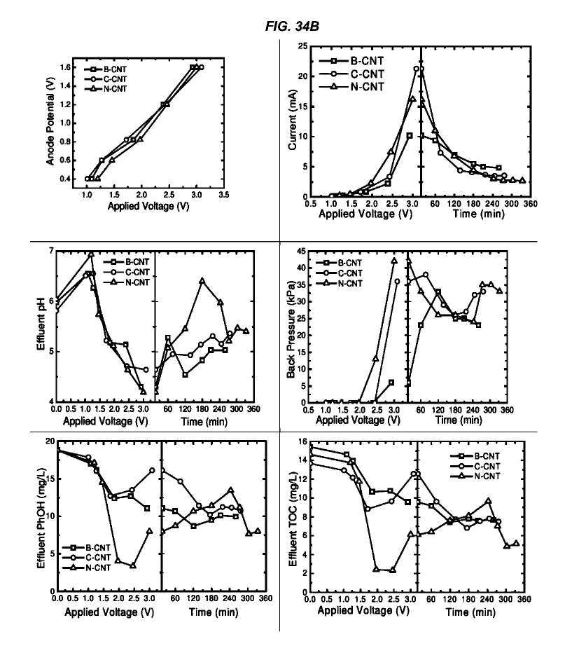

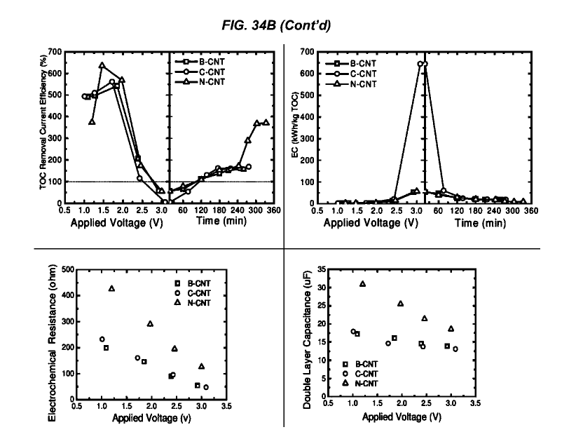

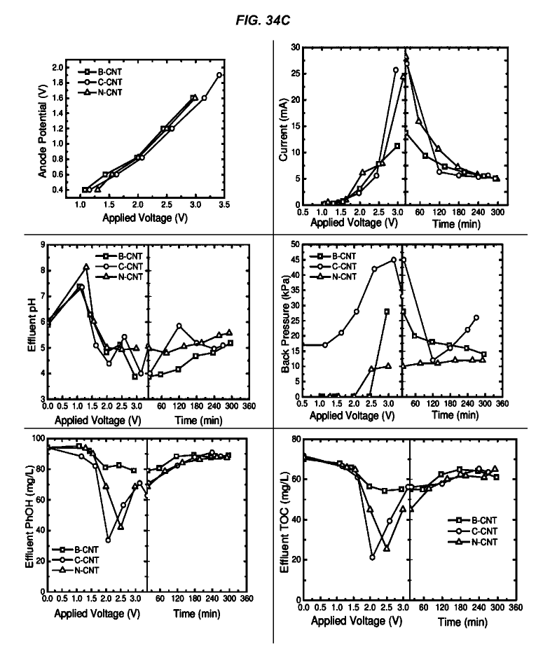

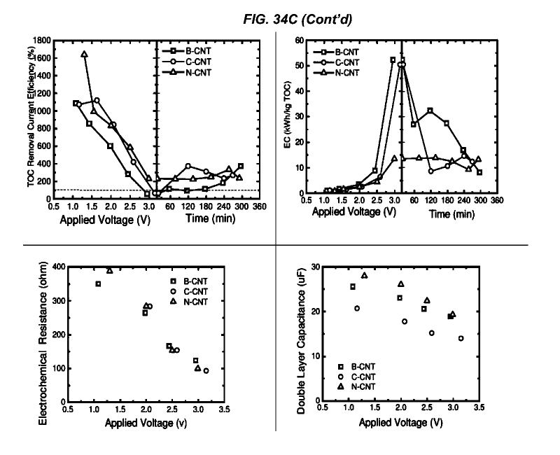

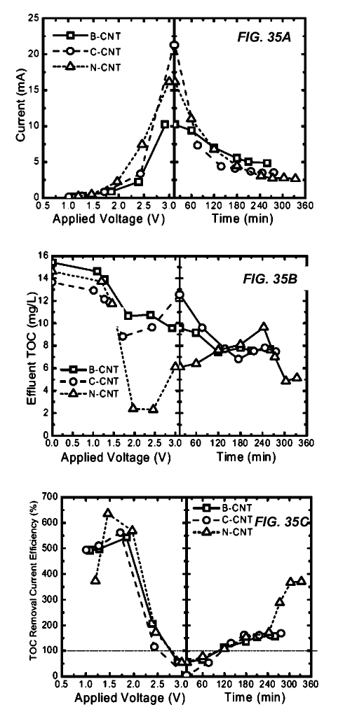

Electrochemical Filtration Performance Towards Phenol Removal. The electrochemical filtration performance of the CNT networks was evaluated at a liquid flow rate of J=1.5 mL min⁻¹ and an influent electrolyte concentration of 100 mM Na₂SO₄. The filter performance was assessed with phenol (PhOH), a model aromatic wastewater, at three influent (input fluid) concentrations of 0.0 mM, 0.2 mM, and 1.0 mM as shown in FIGS. 34A-34C, respectively. At 0.2 mM and 1.0 mM influent phenol concentrations, the CNT surface is immediately saturated with phenol due to the strong^{26, 27} and fast¹² adsorption of aromatics to the CNTs. The steady-state current (mA) of the 0.2 mM PhOH in 100 mM Na₂SO₄ as a function of voltage, 1.0 V to 3.0 V, and time, 0 min to 300 min, is shown in FIG. 35A. For all three CNT networks, the current becomes >0 mA once the applied voltage is increased to >1.5 V and increases monotonically with increasing voltage. Similarly, the anode potential also increases monotonically and linearly with increasing applied voltage (FIGS. 34A-34C), with approximately 50% of the applied voltage going towards the anode potential. The aqueous electrochemical phenol filtration was continued at an anode potential of 1.6 V, corresponding to an applied voltage of 3.0 to 3.3 V, at which the system was stable for an extended period, e.g., longer than 6 hours. At an anode potential of ˜1.6 V, the current decreases for the first 2 to 3 hours until a steady-state current value is achieved. The decreasing current with time can indicate that the CNT electrodes are partially passivated. The B-CNT network is more resistant towards electrochemical passivation, i.e., it has a greater steady-state current at 5 mA as compared to 3.5 mA for C-CNT and 2.5 mA for N-CNT. The B-CNT network also has a smaller decrease in current during electrolysis at −5 mA as compared to −13 mA for the C-CNT network and −19 mA for the N-CNT network. The B-CNT network resistance towards electrooxidative passivation indicates that, in some embodiments, the B-CNT can be the optimal CNT for anodic processes such as wastewater treatment.

The effluent (output fluid) total organic carbon (TOC) concentration is plotted versus voltage and time in FIG. 35B. The influent (input fluid) phenol TOC is about 15±1 mgC L⁻¹. The effluent (output fluid) TOC trend is similar for B-CNT and C-CNT, in which the TOC decreases with increasing voltage until ˜2 V when [TOC]_{ef}=9 mgC L⁻¹-11 mgC L⁻¹ and then decreases with time for the first 2 hours of electrolysis until a steady-state effluent (output fluid) TOC concentration of 7 mgC L⁻¹-8 mgC L⁻¹ (i.e., ˜50% of influent TOC) is achieved. In contrast, over the applied voltage range of 2.0 V to 3.0 V, the N-CNT effluent TOC is significantly lower than the B-CNT and C-CNT and in the range of 2 mgC C-6 mgC. However, after ˜2 hours of electrolysis, the N-CNT effluent TOC achieves to a steady-state value similar to the B-CNT and C-CNT networks. The large decrease in effluent (output fluid) TOC is also observed for both the C-CNT and N-CNT networks when the influent phenol concentration is 1 mM (FIG. 34C). Without wishing to be bound by theory, the strong decrease in effluent TOC over the applied voltage range of 2.0 V to 3.0 V is likely due to electrochemical polymer formation.²⁸

The electrochemical oxidation mechanism of phenol has been studied and follows the general reaction of eq. 1 below, where n is the number of electrons oxidized from phenol with n=28 for complete mineralization.²⁹⁻³¹

C₆H₆O+nh⁺→products (1)

There are three primary classes of phenol oxidation products listed here in order of increasing extent of oxidation: the quinones and corresponding radicals that polymerize, small organic acids such as bioxalate, and the complete mineralization product—carbon dioxide. The one-electron redox potential at pH 7 of phenol is 0.8 V, of the quinone family is 0.0 V-0.8 V, and of small organic acids is 1.0-2.0 V.³² Without wishing to be bound by theory, the extent of phenol oxidation in terms of n electrons removed per molecule can increase with both increasing anode potential and/or increasing material work function, i.e., Fermi level redox potential. Thus, although similar TOC removal are measured for all three CNT networks, the extent of phenol oxidation can be dissimilar. A shift in reaction products with increasing applied voltage can explain the strong decrease in effluent phenol at intermediate applied voltages, 2.0 to 2.5 V, for the N-CNT (0.2 and 1 mM) and C-CNT (1 mM) where the polymer-forming quinone radicals can be dominant. The resulting increase in effluent phenol at applied voltages >2.5 V can then indicate a shift to more oxidized products that cannot polymerize. The absence of a strong decrease in phenol concentration for the B-CNT network at both 0.2 mM and 1.0 mM can indicate that the B-CNTs' greater work function can result in a greater extent of phenol oxidation to yield a greater fraction of products that cannot polymerize.

The steady-state current and TOC removal from the influent solution were used to calculate the apparent TOC removal current efficiency assuming that any TOC loss is representative of electrochemical phenol combustion to carbon dioxide (FIG. 35C) and n=28 for eq. 1 above. For all three CNT networks, the current efficiency is >100% when the applied voltage is <2.5 V and when time was ≧120 minutes. For the B-CNT and C-CNT networks, the current efficiency did not drop below 50%. Even greater TOC removal current efficiencies, e.g., 60% to 1,200%, can be measured when the influent phenol concentration is 1 mM, as shown in FIG. 34C. The >100% current efficiency can indicate that electrochemical combustion to CO₂ may not be complete and, as stated earlier, electrochemical phenol polymerization can be active. Although the influent phenol is not completely oxidized, the electrochemical polymerization process can be energy efficient towards phenol removal, e.g., when the applied voltage is <2.5 V and [PhOH]ᵢₙ=0.2 mM, the energy required is <25 kWh kgTOC⁻¹, and when [PhOH]ᵢₙ=1.0 mM, the required energy is <10 kWh kgTOC⁻¹ (FIGS. 34B-34C).⁴ The extent of electrochemical phenol removal is significant after the influent aqueous solution spends ˜1 s within the electrochemical CNT network.¹²

While the three CNT network's electrochemical filtration performance towards aqueous phenol removal can be relatively similar, the B-CNT network, in some embodiments, can be preferably used as an anodic substrate since it displayed a lower extent of electrochemical passivation than the other CNT networks; and the N-CNT network, in some embodiments, can be preferably used for electrochemical phenol polymerization. The extent of electrochemical passivation is reported to be inversely proportional to the CNT work function.¹⁸⁻¹⁹ This indicates that although the performance of the three CNT materials towards phenol removal is similar, the B-CNT can oxidize the individual phenol molecules to a greater extent, i.e., the n in eq. 1 is the greatest for the B-CNT and lowest for the N-CNT. The greater extent of oxidation can bypass the formation of polymerizing organic free radicals.³⁰ The anode potential, electrochemical impedance, and double-layer capacitance were measured as a function of applied voltage and shown in FIGS. 34A-34C. The anode potentials for the three CNT samples increased linearly with applied voltage and were nearly identical. The electrochemical resistance and capacitance both decreased linearly with increasing applied voltage and at all potentials the N-CNT values were greater than both the B-CNT and C-CNT values, which were similar. The greater N-CNT capacitance is in agreement with previous reports and indicates a larger number of electrochemically-active sites¹⁷ consistent with the greater electropolymerization TOC removal by the N-CNT network. The greater N-CNT resistance can indicate that more phenol may be adsorbed to the N-CNTs, as evidenced by the convergence of resistance for all three samples at the higher influent phenol concentration (FIG. 34C). A greater N-CNT phenol surface concentration can promote electrochemical polymerization and TOC removal.

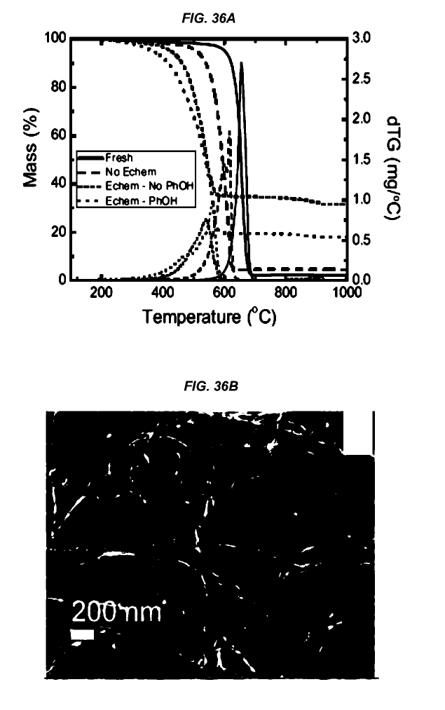

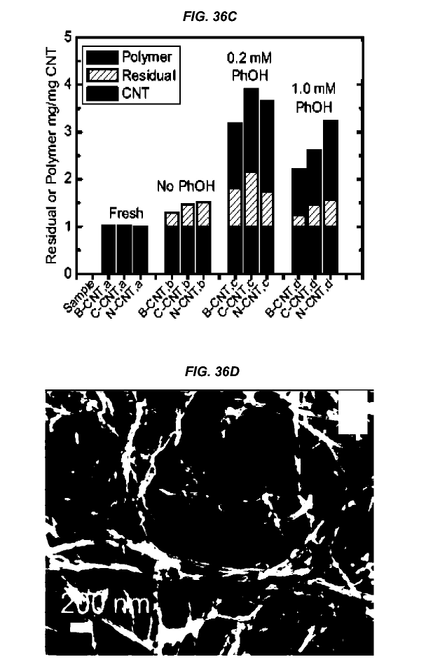

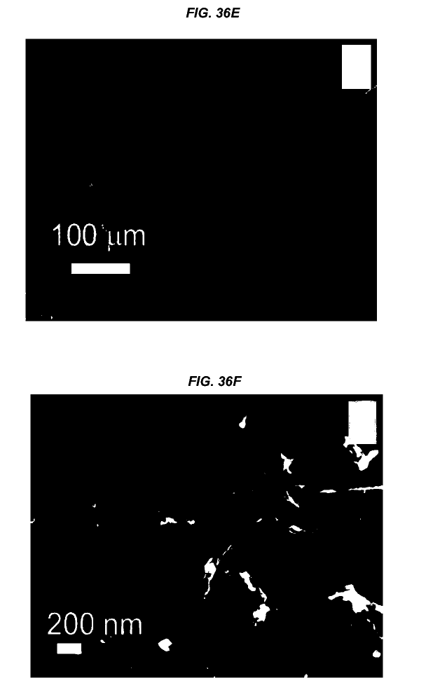

Electrochemical Phenol Polymerization and Electrolyte Precipitation. The findings of decreasing current with time and >100% TOC removal current efficiencies are both indicative of electrochemical polymer formation on the CNT anode resulting in passivation. The polymer formation is also evidenced by significant increases in CNT network weight post-electrolysis (Table 6 above). To further determine the mechanism of polymer formation, TGA, SEM, and XPS were performed on all of the electrolyzed CNT samples (Table 6 and FIGS. 32E-32F, FIGS. 33A-33C). The TGA data indicates that electrochemical polymer formation was active, and also electrochemical electrolyte or salt precipitation was also active, as shown in FIGS. 36A and 36C. In FIG. 36A, the mass percent and dTG versus T was plotted for a fresh C-CNT network, a C-CNT network that filtered phenol in the absence of electrochemistry, an electrolyzed C-CNT network with 0.0 mM influent phenol, and an electrolyzed C-CNT network with 1.0 mM influent phenol. For both electrolyzed CNT networks, the TGA results showed that the residual mass percent increased to ≧15% as compared to ˜2% for the fresh CNT network and ˜4% for the non-electrolyzed C-CNT network, indicating electrochemically-mediated electrolyte precipitation. For the C-CNT networks electrolyzed with phenol, a large low T burn shoulder appears in the dTG curve due to polymer formation. Gaussian multi-peak fitting of the dTG curve was used to calculate the percent polymer of the electrolyzed samples. The analyzed TGA data for the majority of the electrolyzed CNT samples is shown in FIG. 36C with the precipitate and polymer mass normalized to the CNT mass. Electrochemically-mediated precipitate formation was detected for all electrolyzed CNT networks and polymer formation was detected for all CNT networks electrolyzed in the presence of phenol. The electrochemically-mediated polymer and precipitate formation is confirmed by aerial SEM images of the electrolyzed CNT networks presented in FIGS. 36B, 36D-36F. FIGS. 36B, 36D, and 36F are SEM images, respectively, of a fresh C-CNT network, a C-CNT network electrolyzed with phenol for 5 h, and a C-CNT network electrolyzed with phenol for 20 h. The apparent CNT diameter is visibly detected to grow with time during phenol electrolysis and a similar extent of CNT diameter growth is detected for the N-CNT and B-CNT networks as shown in Table 6. This growth can be, at least partly, attributed to electrochemical polymer formation and/or is, at least partly, due to incomplete phenol oxidation which in turn results in the formation of organic radicals that take part in a free-radical chain polymerization process.³¹ Visual evidence of electrochemical precipitate formation is shown in FIG. 36E for an N-CNT sample electrolyzed for 5 h. A significant amount of salt crystals have obviously coated the N-CNT network surface. The electrochemical precipitation can be driven by the increased ion activity within the CNT electrical double layer of the electrolyte or electrochemically-produced salts. An alternative precipitation mechanism can be the electrochemical oxidation of sulfate to persulfate³³ whose sodium salt is significantly less soluble in water at 20° C. than sodium sulfate, i.e., 23 mM for Na₂S₂O₈ versus 900 mM for Na₂SO₄.

The B-CNT network as compared to the C-CNT and N-CNT networks is determined to have a lower extent of electrochemical polymer and precipitate formation under all influent aqueous conditions (FIG. 36C). The extent of both electrochemical polymer and precipitate formation can increase with decreasing CNT work function. Both the polymer and precipitate can in turn coat the electrochemically-active surface with an insulating material and passivate the electrode. Thus, the polymer and precipitate formation results indicate that the B-CNT is more resistant to electrochemical passivation in agreement with chronoamperometry results (FIG. 35A), as well as previous reports of the higher B-CNT work function and hole transport properties.^{18, 19} The N-CNT network is determined to have the greatest extent of polymer and precipitate formation, in line with the increased TOC removal via polymer formation (FIG. 35B), and increased double layer capacitance (FIGS. 34A-34C).¹⁷

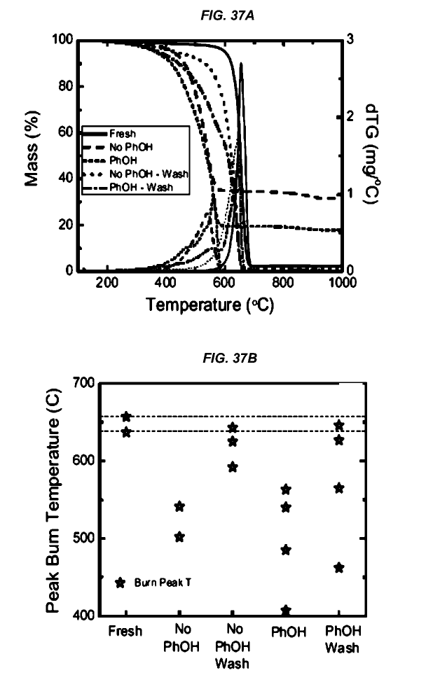

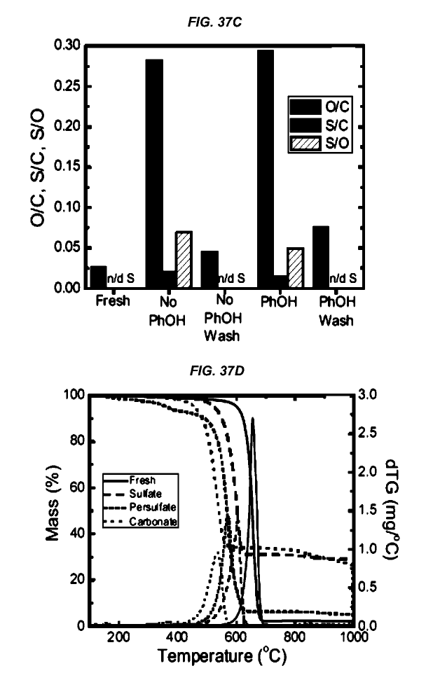

Electrochemical Salt Formation versus CNT Oxidation. The electrolyzed C-CNTs thermogravimetric burn temperature is significantly decreased from near 650° C. for the fresh C-CNT network to between 500° C.-550° C. for the electrolyzed C-CNT network and a similar result is determined for the electrolyzed N-CNT and B-CNT networks, as shown in FIG. 36A and Table 6. The reduction in burn temperature can be caused by significant electrochemical oxidation of the CNTs introducing more easily combustible sp³ defects into the normally sp²-bonded CNT surface.³⁴ Alternatively, CNT co-combustion with the precipitate or polymer can be due to thermal production of oxidizing radicals e.g., the thermolysis of persulfate to produce the strongly oxidizing sulfate radical.³⁵ To discern between these two possibilities, it was sought to determine if the precipitate and/or polymer from the electrolyzed CNT network could be washed with an acidic ethanol-water solution. The TGA results of the C-CNT networks electrolyzed in the absence and presence of phenol and the same samples after washing are shown in FIGS. 37A and 37B. The washed C-CNT networks have nearly all of the precipitate removed, i.e., <1.2% residual mass in both samples, and have TGA burn temperatures near that of a fresh C-CNT network. Only a small fraction of the polymer was removed by the wash indicating the decrease in burn T in the electrolyzed networks can be primarily due to the precipitate catalyzed CNT combustion.

To investigate the specific precipitate responsible for the decreased burn T, the O/C, S/C, and S/O ratios were determined from the XPS spectra of the electrolyzed and electrolyzed-then-washed C-CNT networks, and the corresponding results are shown in FIG. 37C. The large O/C ratio of the electrolyzed CNT networks indicates a highly oxygenated precipitate. The non-zero S/C ratio in these samples indicates that sodium sulfate or persulfate can be responsible for the determined O/C ratios. However, the S/O ratio for both salts is 0.25, which is much higher than the determined values of 0.07 and 0.04 indicating another salt was also present. In some embodiments, the salt can be sodium carbonate as there is evidence for Na₂CO₃ in the TGA of the electrolyzed samples (FIG. 37A), where mass loss is observed between 800° C.-900° C.³⁶ The washed samples have no sulfur signal and a significantly reduced O/C ratio, indicating that the XPS spectrum of the electrolyzed CNT networks is representative of the precipitate. The O/C ratio is slightly greater in the electrolyzed-then-washed CNT networks (0.045 to 0.075), as compared to the fresh C-CNT networks (0.026). Without wishing to be bound by theory, the increased O/C ratio can be due to electrochemical CNT oxidation and/or electrochemical polymer formation since only a small fraction of the polymer is removed during the wash step. To determine whether the increased O/C ratio is due to electrochemical CNT oxidation or electrochemical polymer formation, an estimation of the theoretical O/C ratio of the electrolyzed with phenol then washed C-CNT network was made assuming that the polymer has a similar O/C ratio to the phenol monomer of 0.17. The fresh C-CNT network has an O/C ratio of ˜0.025. The C-CNT network that were electrolyzed with phenol then washed comprises ˜50% polymer and ˜50% CNT, resulting in the estimated O/C ratio of 0.095, which is slightly greater than measured O/C ratio of 0.075 indicating that polymer formation is primarily responsible for the O/C ratio increase. However, in some embodiments, electrochemical CNT oxidation can still occur since the O/C ratio indeed increases slightly to 0.045 in the CNT network electrolyzed in the absence of phenol.

To further evaluate whether the presence of the precipitates can reduce the CNT burn temperature, they were individually mixed with fresh CNTs by ultrasonication, dried, and thermogravimetrically analyzed. As shown in FIG. 37D, in all cases, the CNT burn T decreased with the extent of decrease following the order carbonate (525° C.)>persulfate (550° C.)>sulfate (600° C.). The carbonate and persulfate induced-burn Ts are quite similar to the electrolyzed CNT burn Ts indicating carbonate and/or persulfate can be the electrochemical precipitates. Thus, the decreased electrolyzed CNT network burn temperature is, at least partly, due to precipitate formation. In some embodiments, CNT oxidation need not contribute to the decreased electrolyzed CNT network burn temperature.

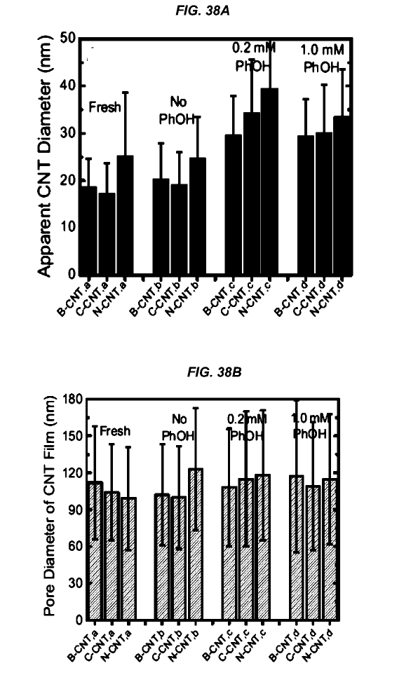

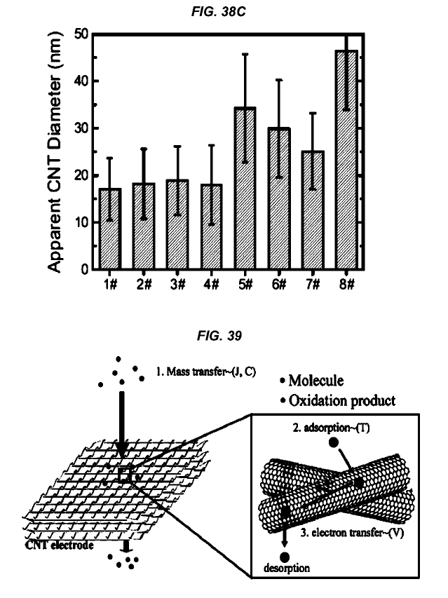

Electrochemical Polymerization. During the electrooxidation of aqueous aromatics such as phenol, if the anode potential is below 2.3 V, then polymerization forming species such as polyphenol or polyoxyphenylene can occur.^{29, 31} Since these polymers can be more insulating as compared to the anode, the electropolymer growth and coating can act to passivate the active electrode surface. Thus, it is of importance to investigate the electropolymerization process such that methods to prevent passivation and/or to regenerate the active electrode surface can be developed. As such, the time-dependent electrolysis was performed at an anode potential of 1.6 V or at an applied voltage of 3.0 V-3.3 V, at which the system is stable for an extended period of time. Both electrode passivation, i.e., the current decrease over the first two hours of electrolysis (as shown in FIGS. 35A-35C), and polymer formation (FIGS. 37A-37D) are detected. The extent of polymer formation was quantified by TGA and SEM of the electrolyzed CNT samples (Table 6 and FIGS. 38A-38C). There are two TGA polymer burn peaks detected in all of the electrolyzed CNT networks. Both peaks occur at a lower temperature as compared to the CNT burn peaks and the higher T peak corresponds to the major polymer peak. As the polymer burn T of the CNT network that was electrolyzed then washed can provide an accurate representation of the polymer material, then typical electropolymer burn Ts are ˜560° C. and 460° C. The higher burn T of 560° C. is typical of species with a conjugated π-bonded structure indicating the sp²-conjugation of the phenol monomer has been maintained.³⁷ The percent polymer mass of the electrolyzed CNT samples was similar for B-CNT and C-CNT at 40-44% and was greater for the N-CNT sample at 51-53%. The percent polymer mass was independent of influent phenol concentration likely due to the strong and fast adsorption of the aromatic phenol to the CNT surface.^{26, 27}

The apparent CNT diameter as determined by SEM for the fresh and electrolyzed CNT networks is presented in FIG. 38A. The formation of polymer was only detected when phenol was present in the influent solution. If phenol was present, the apparent CNT diameter generally grew by 8 nm to 17 nm. However, even though the apparent CNT diameter grew by >50% as compared to the initial diameter, there was negligible effect on the average network pore size (FIG. 38B). The polymer identity can be characterized by calculating the polymer density (ρ_{poly}) from the TGA polymer mass (m_{poly}) and SEM polymer volume (V_{poly}) using the equation: ρ_{poly}=m_{poly}/V_{poly}=(m_{f}*%_{poly}*rᵢ)/(SSA_{CNT}*mᵢ*(r_{f}²−rᵢ²)), where mᵢ and m_{f} are the initial and final CNT network mass, %_{poly} is the percent polymer by TGA, rᵢ and r_{f} are the initial and final apparent CNT radius by SEM, and SSA_{CNT} is the specific surface area of the CNT.¹² The average polymer density for all of the electrolyzed networks is ρ_{poly}=1.05±0.04 g cm⁻³. The calculated polymer density is quite similar to the density, 1.1 g cm⁻³, of polyphenylene ether and polyphenylene oxide, which can be products of the electrochemical polymerization of phenol and are in agreement with previous reports.²⁹⁻³¹

The diameter for all of the C-CNT networks (#1-#8) treated under conditions indicated in Table 6 is presented in FIG. 38C. The apparent diameter of the electrolyzed CNT networks grew by a significant amount only in the presence of phenol (#5 to #8). The acidic ethanol-water wash of an electrolyzed CNT network (#7) was able to remove a fraction of the polymer reducing the diameter by ˜5 nm; however, the post-wash diameter was still 6 nm-7 nm greater than the initial diameter. It was also determined that after extended electrolysis of 20 h (#8), the apparent CNT diameter (˜46 nm) grew even further to nearly 3-fold greater than the initial CNT diameter (˜17 nm), indicating that the polymer coating did not completely passivate the anodic CNT network. As described in Example 13, in situ methods can be used for CNT electrode regeneration such as increasing anode potentials to >2.3 V³⁰ and chemical washing with non-aqueous solvent similar to the acidic ethanol-water removal of the precipitate.

To extend and optimize the lifetime of anodic CNT networks, the efficacy of undoped (C-CNT), boron-doped (B-CNT), and nitrogen-doped (N-CNT) networks towards the electrochemical filtration treatment of aromatic wastewaters using phenol as a model aromatic pollutant was evaluated herein. In terms of steady-state total organic carbon removal, all three CNT networks were able to remove a similar amount of the influent phenol, e.g., ˜50% of 0.2 mM influent phenol at an anode potential of 1.6 V. The current as a function of time and voltage indicated that the B-CNT network was more resistant to electrochemical passivation and that the extent of passivation was inversely correlated to the CNT work function. The passivation of the anodic CNT networks was determined to occur through electrochemical formation of insulating precipitate and polymer coatings on the surface of the CNTs. SEM and TGA analysis of the electrolyzed CNT networks showed that the B-CNT network had a lower extent of electrochemical polymer and precipitate formation, thus being more resistant to electrochemical passivation. TGA and XPS analysis indicates that the predominant electrochemical precipitate can be a mixture of sodium persulfate and sodium carbonate, which can be removed with a simple acidic water-ethanol wash. SEM and TGA analysis indicates that the electrochemically-formed polymer can be either polyphenylene ether or polyphenylene oxide, which can be at least partially removed with the washing step.

### Exemplary Materials and Methods for Example 14

Chemicals. Phenol (PhOH), hydrochloric acid (HCl; 36.5-38.0%), nitric acid (HNO₃; 69.8%), sulfuric acid (H₂SO₄; 95.0-98.0%), phosphoric acid (H₃PO₄; ≧85.0%), ethyl alcohol (EtOH; ≧95.0%), dimethylsulfoxide (DMSO; ≧99.9%), potassium hydrogen phthalate (KHP), sodium sulfate (Na₂SO₄), sodium persulfate (Na₂S2O₈), sodium bicarbonate (NaHCO₃), and sodium carbonate (Na₂CO₃) were purchased from Sigma-Aldrich. All chemicals were reagent grade except DMSO, which was spectrophotometric grade.

CNT Selection. The undoped multiwalled carbon nanotubes (C-CNT), nitrogen-doped multiwalled carbon nanotubes (N-CNT) and boron-doped multiwalled carbon nanotubes (BCNT) were purchased from NanoTechLabs, Inc. (Yadkinville, N.C.). The CNTs were characterized in Table 6 below, and have a diameter distribution in agreement with the manufacturer specifications. In some embodiments, the CNTs were purified first by calcination and then with acid treatment prior to use.²⁴

CNT Calcination. To remove any amorphous or other non-CNT carbon impurities, about 1 g of CNTs was first calcinated, e.g., in a tube furnace, by increasing from room temperature to ˜400° C. (˜300° C. for N-CNTs) for at a rate of 5° C. per min and holding for ˜60 min (Thermolyne, 21100).

CNT Acid Treatment. To remove the metal impurities (e.g., metal catalyst impurities), ˜0.5 g of calcinated CNT was placed into 0.5 L of concentrated hydrochloric acid and heated to ˜70° C. in a round-bottom flask with stirring and a condenser for at least 12 hours. After heating, the sample was cooled to room temperature and vacuum filtered through a 5-μm PTFE membrane (Omnipore, Millipore) to collect the CNTs. The CNTs were then washed with MilliQ deionized water (DI) until the filter effluent pH was neutral. The sample was then oven dried at 100° C. before use.

Electrochemical CNT Filter Preparation. The CNT filters were produced by first dispersing the CNTs in DMSO at 0.5 mg/mL by probe sonication (Branson, Sonifier S450) for ˜15 min at an applied power of 400 W/L. Then, 30 mL of the CNTs in DMSO were vacuum filtered onto a 5-μm PTFE membrane (Millipore, Omnipore, JMWP), resulting in filter loadings of 1.5 mg/cm² to 1.6 mg/cm². The CNT filters were washed with 100 mL EtOH, 100 mL 1:1 DI-H₂O: EtOH, and 250 mL DI-H₂O to remove DMSO. Finally, the prepared CNT filter was loaded into a filtration casing modified for electrochemistry as described in FIGS. 1A-1G and Refs. 6, 9, and 12.

Solution and Electrochemistry. Sodium sulfate (Na₂SO₄; 100 mM) was utilized as the background electrolyte for all experiments. Phenol (PhOH) was used as the model aromatic pollutant as phenol is a common industrial solvent and is present in petroleum industry wastewater. The influent (input fluid) phenol-electrolyte solution was peristaltically pumped (Masterflex) through the electrochemical CNT filter and the steady-state electrochemistry was driven by a DC power supply (Agilent). The volumetric flow rate was 1.5 mL min⁻, which corresponds to a residence time in the electrochemical filter of ˜1 s.¹² Bulk electrochemical filtration was first completed at a number of applied voltages over the range of ˜0.5 to ˜3.5 V. Then, the applied voltage was held at a point that corresponded to ˜1.6 V anode potential for 3 hours to 5 hours. At every voltage or time point, at least 3 effluent samples (output fluid samples) were analyzed to ensure steady-state was achieved. A number of parameters including effluent pH (output fluid pH) (e.g., using Corning 345), effluent phenol concentration, total organic carbon (TOC) (e.g., using Shimadzu TOC-VW), steady-state current, anodic potential, and back pressure were all determined.

The apparent energy consumption (ECₐₚₚ) of removing one kilogram TOC was calculated with the following equation:

ECₐₚₚ(kWh/kgTOC)=(U*I*t/3.6*10⁶)/(t*J*ΔTOCₐₚₚ),

where U and I are applied voltage and steady-state current, respectively, t is reaction time, J is flow rate, and ΔTOCₐₚₚ is the apparent TOC removal.

The apparent mineralization current efficiency (MCEₐₚₚ) was calculated with the following equation:

MCEₐₚₚ(%)=(ΔTOCₐₚₚ/ΔTOCₜₕₑₒᵣ)*100,

where ΔTOCₜₕₑₒᵣ is theoretical TOC removal assuming all anodic current goes towards this process and is calculated using the following equation:

ΔTOCₜₕₑₒᵣ(mgC/L)=((I*t/nₑ*F)*n_{c}*M*)/(V*t),

where F is Faraday's constant, F=96485 C mol⁻¹; nₑ is the number of electrons removed during phenol mineralization, nₑ=28; n_{c} is the phenol carbon number, n_{c}=6; and M is carbon's atomic weight, M=12 g mol⁻¹.

The CNT networks were also characterized using electrochemical methods (CHI Inc., CHI604D) such as double-layer capacitance and electrochemical impedance spectroscopy. The prepared CNT network was used as the working electrode, a stainless steel cathode was used as the counter electrode, and 1 M Ag/AgCl was used as the reference electrode in a flow cell configuration. Aqueous conditions were the same as bulk electrolysis.

SEM Analysis. Scanning electron microscopy was performed on a Zeiss FESEM Supra55VP. Micrographs were analyzed with ImageJ software to determine CNT diameter and aerial pore size. Measurements were the average of at least 100 measurements from at least 2 network images.

TGA Analysis. Thermogravimetric analysis was performed on a Q5000-IR Thermogravimetric Analyzer (TA Instruments). Samples were heated from room temperature to 150° C. at 10° C. min⁻¹, held at this temperature for 30 minutes, then heated to 1000° C. at 10° C. min⁻¹, and held at this temperature for 30 minutes. A second run was completed immediately after the first and used as a background. The % residual catalyst was determined using the initial mass and the mass remaining after a complete thermal cycle. The % polymer was determined by multiple Gaussian peak fitting to the dTG curve assuming the two highest temperature burn peaks were CNTs and using the areas to determine percent weight.

### Example 15

### Reactive Transport Mechanism for Organic Oxidation During Electrochemical Filtration: Mass-Transfer, Physical Adsorption, and Electron Transfer

Due to a combination of unique electronic, mechanical, and chemical properties of the carbon nanotubes (CNTs),¹ CNT-based materials can be used in a variety of applications such as energy conversion,² biomedical devices,³ adsorptive water treatment,⁴ and CNT-based electrodes.⁵⁻⁸ As compared to conventional carbon electrodes, CNTs are reported to have better electrocatalytic properties toward many electrochemical reactions.⁹ For example, CNT modified glass carbon electrode were reported to exhibit significantly lower overpotential and higher peak current compared to bare glass carbon electrode for several molecules including ascorbic acid, uric acid, and dopamine.¹⁰ These superior electrocatalytic properties can be attributed to the small dimensions of the tubes and channels in the tubes, the unique electronic structure, and the topological defects present on the tube surface.¹¹ In addition, as described herein, utilizing CNTs as either a bulk electrode or to modify a working electrode can increase electron transfer rates toward dyes¹². The use of CNTs to increase electron transfer rates toward biomolecules has also been previously reported.¹³ Thus, CNT-based electrodes can be used toward advanced environmental applications including wastewater treatment¹⁴ and micropollutant sensors,¹⁵ where minimal oxidative overpotentials are desired.

The general electrochemical reaction mechanism is generally composed of four primary steps: (1) mass transfer to the electrode, (2) adsorption to and desorption from the electrode, (3) direct electron transfer at the electrode, and (4) bulk chemical reactions preceding and/or following electron transfer.¹⁶ While direct (3) or indirect (4) electron transfer is immediately responsible for electrochemical transformations, mass transfer (1) to the electrode surface is often found to limit the overall kinetics.¹⁷⁻¹⁹ Electrochemical mass transfer limitations arise since convection becomes negligible near the electrode-water interface, and the relatively slow molecular diffusion to the electrode surface cannot complete kinetically with electron transfer.¹⁶ Thus, developing methods and materials to increase mass transfer to the electrode surface can increase the extent of electrochemical transformation, and result in improved current efficiencies and reduced energy consumption. One strategy to overcome this limitation can include utilizing porous electrodes where the electrolytic solution flows through the electrode resulting in convection to the electrode surface (FIG. 39). For example, Yang et al.¹⁴ reported that a seepage electrochemical reactor, i.e., where the solution to be treated convectively flows through the electrodes, resulted in a mass transfer improvement of 1.6-fold, a current efficiency improvement of 3-fold, and an energy consumption reduction of 20% as compared to conventional bipolar reactors. Accordingly, a convective mass transfer enhancement can also be active for an electrochemical CNT filter described herein, which can be used for the removal and electrochemical oxidation of aqueous dyes¹² and microorganisms²⁰ (FIG. 39, step 1).

Along with mass transfer, there are other processes that can be also important to the overall electrochemical reaction kinetics and mechanism such as adsorption and electron transfer (FIG. 39, steps 2 and 3), respectively. For example, physical and chemical adsorption of species to an electrode surface can significantly affect the electron transfer kinetics by altering its surface structure and chemistry resulting in a shift in the Gibbs free energy of reactants and/or products.^{21,22} The adsorption-dependent reactivity is of importance to CNTs as they have a large specific surface area²³ and have been reported to adsorb many chemical species. For example, CNTs have been reported to strongly adsorb aromatic compounds²⁴ and natural organic matter²⁵ via a combination of strong π-π interactions and hydrophobic interactions.²⁶ In turn, a CNT-based filter for adsorptive chemical removal has been proposed as a water treatment technology.²⁶ An electrochemical CNT filter described herein can not only adsorptively remove, but also electrochemically degrade the target contaminant.

Following molecular adsorption to the electrode, direct electron transfer can occur upon application of a sufficiently high potential. The electron transfer mechanism and kinetics can also be significantly affected by the electrode surface structure and chemistry. An accurate electrode model requires taking into account the total number and specific types of surface reactive sites because of their ability to substantially affect the electrochemical mechanism,²⁷ kinetics,²⁸ and overpotential.²⁹ In regards to CNTs, the electrochemically reactive sites have been reported to be the conjugated sp² surface defect sites, similar to other elemental carbon-based electrodes. Specifically, some of these electrochemically reactive sites can be the edge-plane-like sites,³⁰ which for CNTs are primarily located at the ends of the nanotubes, but can also be found on the tube sidewalls. For example, a stable carboxylic acid group redox couple was reported to be the electrochemically active site on a CNT electrode.³¹ While specific surface chemistry effects on electrochemical processes are generally overlooked in kinetic modeling methods by assuming surface homogeneity and disregarding existence of specific reactive sites,³⁰ these kinetic methods can still provide insights into the maximum number of electrochemically active sites and their overpotentials.

To investigate the overall organic oxidative mechanism of an electrochemical CNT filter, the inventors proposed and evaluated a primary three-step electrochemical filtration reactive transport mechanism to describe the oxidation of the dyes methyl orange and methylene blue (FIG. 39): (1) mass transfer, (2) molecular adsorption, and (3) direct electron transfer. The hydrodynamically enhanced mass transfer of the electrochemical filtration system was studied by chronoamperometry and normal pulse voltammetry and was compared to a conventional batch bipolar electrochemical system. The physical adsorption of the dyes to the CNTs was investigated by temperature-dependent batch adsorption and electrochemical filtration experiments. The electron-transfer kinetics and mechanism during electrochemical filtration were studied by concentration- and voltage-dependent experiments. The electrochemical filtration oxidative efficiency was evaluated in terms of experimental parameters such as flow rate, temperature, and voltage that mediate the overall reaction kinetics.

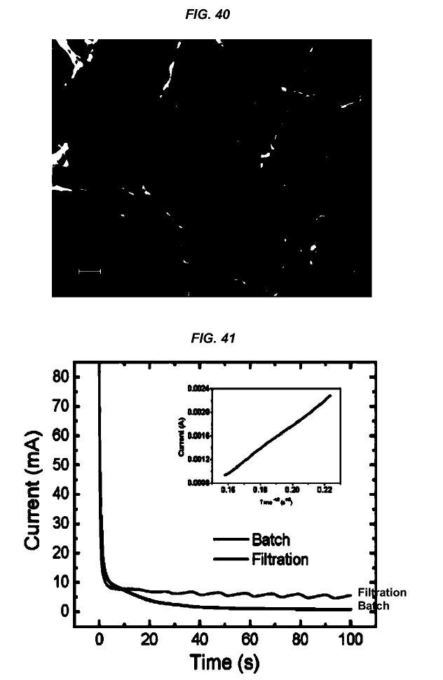

Electrochemical Filter Design and Operation. All filtration experiments described in this Example were conducted with one or more embodiments of the filtration apparatuses as described herein¹² and depicted in FIGS. 1A-1G. Briefly, a 47-mm diameter carbon nanotube (CNT) network (NanoTechLabs, Buckeye Composites) was placed on top of a wetted 5.0-μm pore PTFE membrane (Omnipore). The CNT network was utilized as an anode and connected to the DC power supply via mechanical contact to a titanium ring. A perforated piece of stainless steel shim was used as the cathode and an insulating silicone rubber O-ring was used to separate the electrodes and seal the device. A polycarbonate 47-mm filter casing (Whatman) was modified to incorporate both anode and cathode materials. Images of the electrochemical filtration device and the CNT networks are shown in FIGS. 1A-1G. An aerial SEM image of the CNT network is shown in FIG. 40. The macroporous filters had an average pore diameter of 90±40 nm and the pore shape was quite heterogeneous.

Porous CNT anodes were selected to study the reactive transport mechanism during electrochemical filtration as they have desirable physical chemical properties that can be useful for improved wastewater treatment performance. For example, an electrochemical CNT filter to operate with an energy efficiency of 4-16 kWh kg⁻¹ COD or <1 kWhm⁻³ (Ref. 32) has been previously reported,³² in addition to other state-of-the-art electrochemical oxidation processes.^{14,15,17,19} Similar to black carbon electrodes, CNTs have a high specific surface area²³ and are effective for the adsorptive removal of chemical contaminants.^{4,24-26} However, without wishing to be bound by theory, CNTs can show improved electrochemical performance as compared to traditional carbon materials due to their extended sp² structure¹ and reduced edge-like sites resulting in excellent 1-D conductivity and increased corrosion resistance. In regards to electrochemical filtration, the high-aspect ratio CNTs can be easily formed into free-standing, thin-film, 3D networks of high porosity (85-90%), as shown in FIGS. 1A-1G and 40, with liquid flow rates, in some embodiments, similar to microfiltration devices at 500 LMH-bar to 2000 LMH-bar.^{12,20,32} This porous microstructure can favor fast sorption and electrochemical oxidation due to the high number of easily accessible and reactive sites as compared to black carbon materials where many of the sites can be buried in the granules. Access to most or all of the surface sites within the anodic CNT network can be made by convectively flowing the liquid through the network. Thus, electrochemical filtration with porous CNT anodes can result in enhanced mass transfer and electrochemical energy efficiencies. As the liquid needs to be pumped through the filter, the pumping energy should also be considered to ensure overall improvement. If during electrochemical filtration V=2.0 V and I=5 mA, then the electrochemical energy necessary for 1 h of operation is 39 J. A common back pressure is 15 kPa³² at a flow rate of 90 mL h⁻¹ and assuming a pump efficiency of 75%, the total energy cost for pumping is 1.5 J or 3.8% of the electrochemistry. Therefore, if the electrochemical efficiency is significantly increased during electrochemical filtration, the overall energy efficiency will also be significantly increased.

Mass Transfer: Hydrodynamic Enhancements during Electrochemical Filtration. The effect of hydrodynamically enhanced mass transfer, FIG. 39, step 1, on the current density in the electrochemical filtration system versus a conventional batch electrochemical system was first compared by chronoamperometry over a series of anode potentials. Representative current (mA) versus time(s) plots for the filtration (red) and batch (black) systems obtained under the conditions of anode potential=0.85 V, [MO]ᵢₙ=300 μM, and [NaCl]=10 mM are shown in FIG. 41. The initial current of both filtration and batch systems was around 80 mA and decreased quickly over the first few seconds due to expansion of electrochemical diffusion layer.¹⁶ After the initial sharp decline, the current of the filtration system leveled-off and reached a steady-state value of 5.5 mA. It is of note that there was a periodic oscillation to the filtration current that is likely due to electrolytic gas formation within the CNT network that can effectively passivate a fraction of the electrochemically active sites. In contrast to the filtration system, the current of the batch system continually decreased to 0.8 mA after 100 s of electrolysis. The current of the filtration system was greater than the batch system for t>10 s indicating a significantly greater molecular flux to the electrode surface. The increased flux in the filtration system can be explained by the non-negligible convective mass transfer to the electrode surface due to the hydrodynamic flow through the anode.¹⁶

The Cottrell equation, eq 1 below, describes the current-time relationship for diffusion-limited electrochemical systems such as the batch system in this Example and can be used to estimate the molecular diffusion coefficient.^{33,34}

I=nFAD^{1/2}cπ^{-1/2}t^{-1/2} (1)

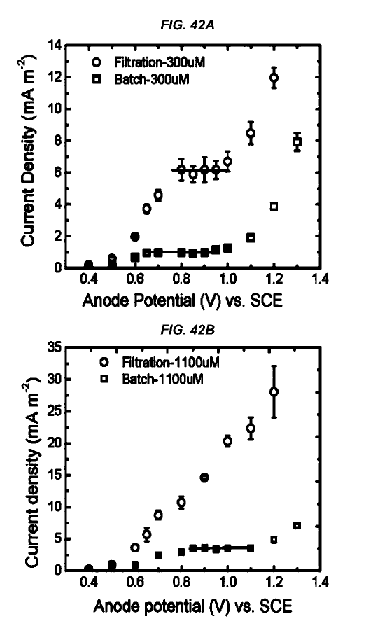

In eq 1, n is the number of electrons transferred, D is the diffusion coefficient (cm² s⁻¹), c is the bulk concentration of the molecule to be electrolyzed (mol cm⁻³), A is the geometric electrode area (7.1 cm²), and I is the current at time t. An estimation of the maximum number of electrons oxidized from MO, n in eq 1, can be made by comparing the MO molecular flux to the electron flux. It is assumed that anodicO₂ evolution is negligible at 0.85V vs. SCE, which is below the potential for the 4-electron water oxidation. This assumption is validated by normal pulse voltammetry, FIGS. 42A-42B, where oxygen evolution is observed at anode potentials ≧1 V. At an anode potential of 0.85 V and a flow rate of 1.5 mL min⁻¹, Δ[MO]=−130 μM and I_{SS}=5.5 mA corresponding to the oxidation of 3.3×10⁻⁹ moles of MO per second and 5.5×10⁻⁸ mol of electrons s⁻¹ flowing through the anode. Thus, a maximum of 17 electrons out of 80 total electrons could be oxidized from each MO molecule indicating incomplete oxidation. The current density versus time ^{-1/2} is plotted in the inset of FIG. 41 and exhibits a linear relationship (R²=0.998) over an intermediate at intermediate time range, i.e., 20-40 s. From the slope of this line, the diffusion coefficient, D, was calculated to be 8.5×10⁻⁵ cm² s⁻¹ for the batch system. An estimation of diffusion layer thickness, Δ, can be made using the following equation, eq 2 (Ref. 16)

Δ=(2Dt)^{1/2} (2)

After 100 s of electrolysis, the diffusion layer thickness in the batch system was estimated to be 1.3 mm. However, natural convection can arise and reduce this thickness. Thus, a calculation of the diffusion layer thickness under natural convection was carried out using eq 3 derived by Levich³⁵ for the mean value of diffusion layer thickness δ of a vertical plate electrode under natural convection.

$$δ \approx \frac{{Z}^{1 / 4}}{0.7 {{Sc}^{1 / 4} ( \frac{g Δ C}{4 {v}^{2}} )}^{1 / 4}} \qquad ( 3 )$$

where h stands for electrode height, Sc=v/D is the Schmidt number, with v and D being the solution kinematic viscosity and molecular diffusion coefficient, respectively, g is gravitational acceleration, and ΔC is the numerical value of the concentration decrease across the diffusion layer in g cm⁻³. For the batch system in the diffusion limited regime, the average MO concentration inside the CNT network is speculated to be near zero. Thus, the filter is acting like one planar electrode and eq 3 is applicable. The height of the electrode used herein is 3 cm, v=1×10⁻⁴ cm² s⁻¹, D=8.5×10⁻⁵ cm² s⁻¹, and ΔC=9.810⁻⁵ g cm⁻³, yielding a diffusion layer thickness from natural convection of δ=1.45 mm. Therefore, the 1.3 mm estimation of diffusion layer is reasonable and within the diffusion layer thickness limit associated with natural convection.

The thickness of diffusion layer in the filtration system is speculated to be lesser than batch system under the same experimental condition due to the hydrodynamic compression of the diffusion layer. In order to provide a quantitative estimation of the filtration system diffusion layer thickness, as it cannot be considered diffusion-limited, normal pulse voltammetry experiments was performed to provide more detailed and quantitative information about mass transfer in the filtration system. Accordingly, normal pulse voltammetry (NPV) was utilized to compare the mass transfer in the batch (square) and filtration (circle) systems as shown in FIGS. 42A-42B. For the NPV experiments, the current was recorded 100 s after each potential step over a range of anode potentials from 0.4 V to 1.3 V. FIG. 42A shows the NPV for the batch and filtration systems at an influent methyl orange (MO) concentration of 300 μM. In both systems, as the potential was increased, the current exhibited a sigmoid transition, i.e., at low potentials, <0.5 V, the current was near zero, then the current increased linearly with increasing potential from 0.5 V to 0.8 V, and finally the current achieved a potential-independent, mass transfer limited plateau at potentials >0.8 V. The linear increase in current with increasing potential is indicative of increasing direct electron transfer kinetics. Since MO electrooxidation is kinetically faster than MO diffusion, the CNT anode surface MO concentration can decrease resulting in the formation of a near surface concentration gradient. Eventually, the anode potential can increase to a point, in this case to >0.8 V, where the electrode surface MO concentration is zero and mass transfer to the interface becomes the limiting factor for MO electrooxidation. Thus, any further increase in anode potential should not lead to a further increase in current and a plateau should be observed due to mass transfer limitations.¹⁶ The observed current increase at anode potentials >1.1 V vs SCE, can be, at least partially, attributed to oxygen evolution³⁶, rather than direct MO oxidation, as electrolytic gas bubbles are visibly observed on CNT anode.

The mass transfer limited current regime, i.e., the current plateau in FIG. 42A, begins at a greater potential in the filtration system, 0.8 V, as compared to the batch system, 0.6 V, indicating a hydrodynamic mass transfer enhancement likely due to the fluid flux through the electrode. Quantitatively, the mass transfer limited current density in the electrochemical filtration system is 6.1 mA m⁻², and for comparison the mass transfer limited current density of conventional batch system is 0.97 mA m⁻². Thus, at a liquid flow rate of 1.5 mL min⁻¹ the electrochemical filtration design described herein can improve the current density and thus mass transfer by 6-fold as compared to the classical batch design under similar aqueous conditions. The thickness of the diffusion layer in the filtration system can be estimated to be approximately ⅙ of the batch system value, 1.3 mm, so a lower limit for estimation of diffusion layer thickness in the filtration system is 216 μm, about 5 times the thickness of porous CNT anode. The mass transfer is determined to be significantly enhanced in the filtration system as evidenced by both the delay in mass transfer limited NPV regime from ˜0.65 V anode potential in the batch system to >0.8 V in the filtration system and the 6-fold greater current density for the filtration system within the mass transfer limited regime (FIG. 42A).

The NPV for the electrochemical filtration (circle) system and the conventional batch (square) system at an MO concentration of 1,100 μM is shown in FIG. 42B. The current density of the batch system again exhibited a sigmoid transition from zero to the mass transfer limited value of 3.5 mA m⁻². The batch system mass transfer limited region was delayed from 0.65 V when [MO]ᵢₙ=300 μM to 0.85 V when [MO]ᵢₙ=1100 μM due to the increased diffusion rate at the higher MO concentration. In contrast, the current density of the electrochemical filtration system continually increased and did not appear to plateau and reach the mass transfer limited regime. This does not necessarily indicate the elimination of the mass-transfer limitation, just that the start of the regime was shifted past the oxygen evolution potential and masked by the O₂ current density. Thus for the 1100 μM case in FIG. 42B, the quantitative comparison was completed by using the current density values at 1.0 V, just prior to oxygen evolution. The current density at 1.0 V anode potential for the electrochemical filtration system is ˜20 mA m⁻² and for the batch system is 3.2 mA m⁻². The current density and thus mass transfer is enhanced 6-fold for the filtration system as compared to the batch system due to convection through the electrode. However, even with such a large hydrodynamic enhancement, the anode potential can still be increased to a point where the electrochemical kinetics is significantly faster than the molecular flux.

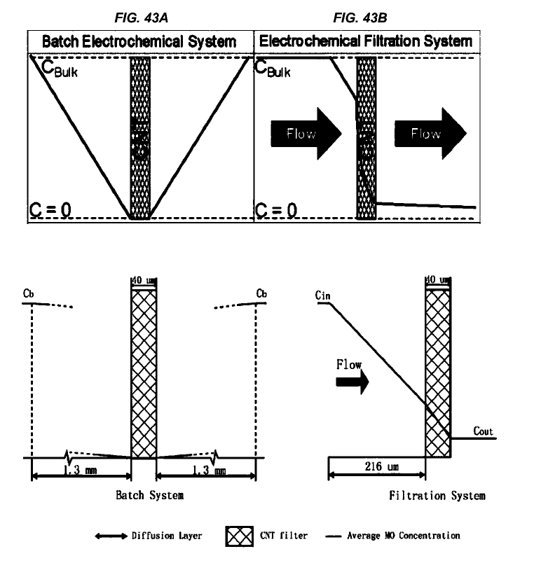

An exemplary schematic scheme of electrochemical diffusion layer profile is shown in FIGS. 43A-43B to illustrate and explain the interaction between convection, the microstructure of CNT anode in the filtration system, and the resulting 6-fold increase in mass transfer as compared to batch system. In the batch system (FIG. 43A), the diffusion layer is thicker than the anode, the concentration gradient is very low, and the MO concentration is zero within and at the surface of the CNT network. In this case, the microstructure of the porous CNT anode becomes irrelevant and the CNT network acts as a planar electrode due to averaging of the microstructure within the expanding diffusion layer.¹⁶ In contrast, during electrochemical filtration, the CNT anode microstructure is significant. As depicted in FIG. 43B, due to convective mass transfer through the CNT network, the average MO concentration at all of the filter cross sections is above zero, i.e., always above effluent (output fluid) concentration, even if the system is in mass transfer limited regime. The concentration gradient between pore center and CNT surface and thus mass transfer is expected to be high, since the characteristic length, the average pore radius, is only 45 nm. Therefore, the convective flow through the CNT network allows for electrochemical oxidation at both the surface and the inner CNT surfaces and produces a high local concentration gradient resulting in an observed 6-fold increase of target molecule mass transfer to electrode interface.

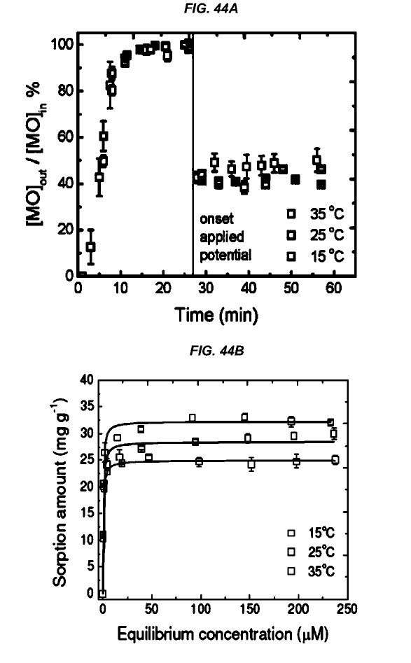

Physical Adsorption/Desorption: Temperature-Dependent Effects on Electrochemical Filtration. The nature of dye adsorption to the CNTs (FIG. 39, step 2), and the influence of adsorption on the electrooxidation kinetics were evaluated by temperature-dependent experiments as shown in FIG. 44. For the experiments indicated in FIG. 44, the temperature was maintained at 15 (blue), 25 (black), and 35° C. (red) and prior to electrolysis the CNT surface was first saturated with MO, i.e., 300 MO was flowed through the CNT network in the absence of applied potential until the effluent MO concentration was equivalent to the influent concentration. Then an applied voltage of 2.0 V corresponding to an anode potential of 0.8 V was applied to the electrochemical filtration cell until a steady-state effluent MO concentration was observed for 30 min. The steady-state [MO]_{ef}/[MO]ᵢₙ is determined to slightly decrease with decreasing temperature, indicating that the extent of electrochemical oxidation increases with decreasing temperature. However, according to the Arrhenius equation³⁷ or transition state theory³⁸, the reaction rate constant should generally increase with increasing temperature.

One possible explanation to this inverse reaction kinetics temperature dependence can lie in the temperature effect on MO adsorption and desorption to the CNT electrode surface. To investigate the nature of MO adsorption, batch temperature-dependent sorption experiments were conducted to investigate the adsorptive behavior of MO on CNTs. MO adsorption isotherms onto the CNTs at 15° C. (blue), 25° C. (black), and 35° C. (red) are shown in FIG. 44B. In all cases, the adsorption capacity increased with increasing MO concentration until a plateau is reached. The temperature-dependent MO adsorption to the CNTs is quantitatively examined using the Langmuir isotherm. The Langmuir adsorption isotherm model has been utilized to quantitatively describe monolayer sorption processes and determine sorption parameters such as the maximum sorption capacity, the partitioning coefficient and the adsorption thermodynamics via temperature-dependent isotherms.³⁹ Experiment data and fitting of data to the Langmuir isotherm are shown in FIG. 44B. In all cases, the Langmuir fitting had high correlation coefficients, i.e., R²>0.97, and the corresponding fitting parameters are listed in Table 7 below. The maximum sorption capacity decreases by 10-20% for every 10° C. increase in temperature. Thermodynamic parameters for MO adsorption onto the CNTs were also calculated. The negative ΔG° values indicate that sorption of MO onto the CNTs can be a spontaneous process under the experimental conditions. The ΔS° and ΔH° are calculated to be 0.085 kJ mol⁻¹K⁻¹ and −11.2 kJ mol⁻¹, respectively. The negative enthalpy value (ΔH°) indicates that the MO sorption process onto the CNTs can be exothermic. Similar results were reported by Al-Johani et al.⁴⁰ on aniline adsorption to CNTs, where low temperature was reported to favor physical adsorption with a negative enthalpy of −24 kJ mol⁻¹. The dominate interaction between MO and the CNTs is speculated to be π-π interaction as π-π interaction has been recently reported to be the strongest intermolecular interaction between aqueous aromatic compounds and CNTs.²⁶

TABLE 7
Langmuir Isotherm Parameters for MO Adsorption onto CNTs

| | | | | Thermodynamic parameters^{B} | | |
|---|---|---|---|---|---|---|
| | Langmuir Constants^{A} | | | | | ΔS° |
| T | b | qₘ | | ΔG° | ΔH° | (kJ (mol · |
| (° C.) | (L mg⁻¹) | (mg g⁻¹) | R² | (kJ mol⁻¹) | (kJ mol⁻¹) | K)⁻¹) |
| 15 | 2.81 | 32.2 | 0.977 | −35.6 | | |
| 25 | 2.33 | 28.5 | 0.983 | −36.3 | −11.2 | 0.0845 |
| 35 | 2.07 | 25.3 | 0.996 | −37.2 | | |

^{A}qₑ = qₘCₑ/(1/b + Cₑ);
^{B}ΔG° = −RTlnb ΔG° = ΔH° − TΔS°³⁵

According to the experimental adsorption isotherms and thermodynamic analysis, the equilibrium adsorption capacity decreases with temperature, in agreement with the determined results. However, electron transfer processes are too fast to assume equilibrium adsorption. Thus, an adsorption dynamics-based hypothesis can be used to provide a possible explanation. The equilibrium adsorption isotherm of methyl orange to CNTs (FIG. 44B) indicates an exothermic physical adsorption process. For physical adsorption processes, an increase in temperature generally results in an increase in desorption rate, thus reducing the residence time of molecules on the CNT surface and within the CNT network. Since the CNT electrocatalytic sites are predominantly found at the ends of the tubes,³⁰ not all sorption sites will be near electron transfer sites and an increased desorption rate will reduce the likelihood of an adsorbed molecule finding an electron transfer site. As a consequence, the overall rate of reaction is decreased. In summary, although temperature and adsorption effect the extent of oxidation during electrochemical filtration, the effect is relatively small at <10% per 10° C. as compared to the previously discussed hydrodynamic enhancement and the anode potential effects to be discussed below.

Electron Transfer: Concentration and Anode Potential Dependence. Although mass transfer and adsorption are important processes that affect the overall extent of oxidation during electrochemical filtration, the dye is ultimately transformed during the electron transfer step. Therefore, the nature and rate of electron transfer can be important. The effect of influent dye concentration and anode potential on the electrooxidation rate was investigated to determine the electron transfer kinetics and mechanism during electrochemical filtration. At high influent dye concentrations when the adsorption sites are saturated, the overall reaction rate can be limited by the electron transfer kinetics.

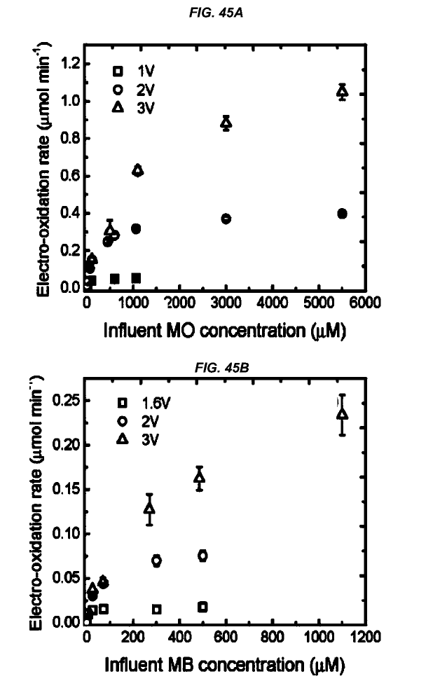

The concentration-dependent oxidation during electrochemical filtration of MO and MB at three different applied voltages; 1.0V/1.6V (black), 2.0V (red), and 3.0V (blue), are shown in FIGS. 45A and 45B, respectively. At each voltage, the electrochemical CNT filter was tested with a range of influent concentrations from 25 μM to 5500 μM for MO and from 7 μM to 1200 μM for MB at a flow rate of 1.5 mL min⁻¹. For each concentration and voltage combination, the steady-state effluent dye concentration was measured and the molecules oxidized per unit time was calculated and plotted against influent concentration. In FIG. 45A, the MO electrooxidation rate first increases with increasing influent concentration up to 110 μM for all three voltages. The voltage-independent increase in electrooxidation rate indicates that the reaction is mass transfer limited when [MO]ᵢₙ≦110 μM. The electrooxidation rate at 1 V reaches a maximum of 0.05 μmol min⁻¹ as indicated by the sharp transition when influent concentration exceeds 110 μM. The sharp transition indicates a shift from the mass transfer limited regime to the electron transfer limited regime. The 2 V and 3 V curves stay in mass transfer limited regime until [MO]ᵢₙ>500 μM. The greater transition concentration at 2 V and 3 V as compared to 1 V indicates that a new and kinetically faster direct MO oxidation pathway has been activated. At [MO]ᵢₙ=1000 μM the 2 V electrooxidation rate reaches a maximum of 0.37 μmol min⁻¹. The electrooxidation rate at 3 V did not achieve an upper limit over the experimental concentration range with a maximum oxidation rate of 1.04 μmol min⁻¹ at 5,500 μM MO. If it is assumed that each MO molecule were to transfer 17 electrons to the anode as previously estimated, the maximum electron transfer rate is calculated to be 8.5×10¹⁵ e⁻ per second at 1 V, 6.3×10¹⁶ e⁻ per second at 2 V. At 3 V, indirect oxidation pathways are activated such that the contribution of direct oxidation toward total oxidation needs to be determined. From FIG. 45B, at 3 V and an influent MO concentration of 300 μM, the Δ[MO]=190 μM and from FIG. 57 direct oxidation contributes 140 μM of this total or 74% of total oxidation. By challenging the filter with 5500 μM MO to remove mass transfer limitation and saturate direct oxidation, the contribution of direct oxidation in total oxidation rate can increase to >74%. Thus, by assuming 74% of the total is direct oxidation, a lower limit for the direct electron transfer rate can be estimated to be 1.3×10¹⁷ e⁻ per second at 3 V, which is still greater than 8.5×10¹⁵ e⁻ per second at 1 V and 6.3×10¹⁶ e⁻ per second at 2 V. Accordingly, the electron transfer kinetics can increase with increasing potential.

The sharpness of the transition from mass transfer limited to electron transfer limited regimes yields insight into the electron transfer mechanism, i.e., direct versus indirect. A direct electrooxidation would be speculated to have a sharper threshold than indirect electrooxidation as the direct mechanism has a stronger surface site dependence. Thus, from the relative sharpness of the curves in FIGS. 45A and 45B, the contribution of indirect oxidation is determined to be minimal at 1 V and to increase with increasing voltage, becoming significant at 3 V where a plateau is not observed. More quantitatively, the applied voltages of 1 V, 2 V, and 3 V correspond to anode potentials of 0.35 V, 0.77 V, and 1.50 V vs SCE. At 3 V, the anode potential is 1.5 V, which is greater than the required potential for the 2⁻electron Cl⁻ oxidation (E⁰=1.2 V vs SCE), producing reactive chlorine species that can indirectly oxidize MO.⁴¹ The coexistence of direct and indirect oxidation is also in agreement with the increased electrooxidation at 3 V.

A similar trend of methylene blue oxidation rate versus influent MB concentration is observed in FIG. 45B. A sharp transition region appears as early as 25 μM when 1.6 V was applied with a maximum oxidation rate of 0.016 μmol min⁻¹. Increasing the applied voltage to 2 V elevates the maximum electrooxidation reaction rate to 0.072 μmol min⁻¹ and a further increase of applied voltage to 3 V results in a maximum rate greater than 0.233 μmol min⁻¹. Despite the similar voltage- and concentration-dependent electrooxidation rate trend of MB and MO, the absolute reaction rate of MB is significantly lower at a similar voltage. Quantitatively, the maximum electrooxidation rates for MB are 3.1, 5.1, and 4.5 times lower than the corresponding MO oxidation rates at 1 V, 2 V, and 3 V, respectively. Without wishing to be bound by theory, the significantly lower extent of MB oxidation can be attributed to either a difference in reduction potential, i.e., lower MO E⁰ values and thus faster electron transfer rates, or the difference in molecular charge, i.e., MO is negatively charged and MB is positively charged and the resulting effects of electromigration on mass transfer. The E⁰ for MO oxidation at influent pH 6.3 is reported to be 0.37 V,⁴² lower than that of MB, 1.1 V,⁴³ indicating faster MO electron transfer kinetics at similar anode potentials. This is in agreement with the greater extent of MO oxidation at 1 V and 2 V where the anode potential is less than the MB redox potential. However, it does not agree with the 3 V results, since at an anode potential of 1.5 V, both MO and MB should be completely oxidized. This indicates that the difference in MO and MB oxidation can be due to electromigration since a positive potential applied to the anodic CNT network can result in the accumulation of positive surface charges.⁴⁴ Thus, the negatively charged MO can tend to diffuse more quickly to and be more favorably adsorbed onto the positively charged CNT anode than the positively charged MB molecule due to electromigration and electrostatic interactions, respectively. The electrostatic increase in MO diffusion and adsorption can increase the relative CNT electrode surface concentration of MO relative to MB and in turn increase the electron transfer rate. To investigate this further, voltage-dependent effects on MO and MB electrooxidation were performed and discussed below.

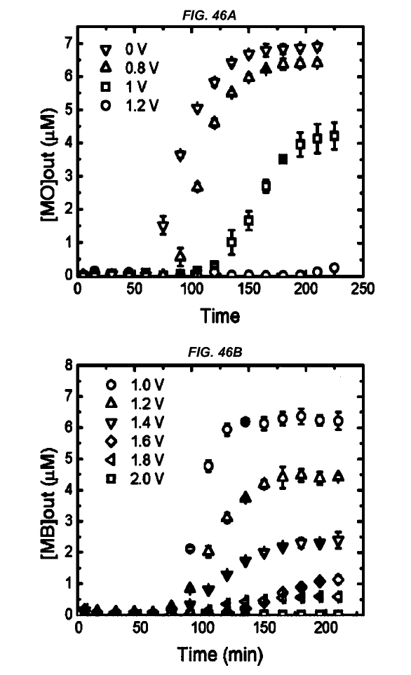

The voltage-dependent electrooxidation of low concentration MO and MB is shown in FIGS. 46A-46B, with the negatively charged methyl orange in FIG. 46A and the positively charged methylene blue in FIG. 46B. The influent concentration is 7 μM for both MB and MO and the minimum voltage applied is close to their reported E⁰'s and increased by units of 0.2 V. In FIGS. 46A-46B, it is determined that as the voltage is increased the steady-state effluent concentration after 200 min of electrolysis is decreased. As the applied voltage is increased above E⁰, the standard free energy gap between anode surface and molecules is increased, resulting in faster electron transfer between the electron donors, MO and MB, and the CNT anode.¹⁶ It is of note that for the negatively charged MO, the extent of oxidation (FIG. 46A), grows more with increasing voltage. For example, the steady state concentration difference between 0.8 and 1.0 V is 2.2 μM and the difference between 1.0 V and 1.2 V is 4.0 μM. In contrast, the inverse relationship is determined for the positively charged MB as the extent of oxidation grows less with increasing voltage. For instance, the concentration difference between 1.0 and 1.2 V is 2.2 μM and the difference between 1.4 V and 1.6 V is 1.2 μM. The opposite trends of MB and MO indicate that electromigration and electrostatic interactions can be responsible for the large difference in electrooxidation rates. Even though the rate of electron transfer is increased with increasing applied voltage in both cases, the effect of electrostatic interactions between the charged molecules and the positively charged CNT anode can become more prominent with increasing voltage due to the increased positive-charge of the anode.⁴⁴ Thus, electromigration and electrostatics are, at least partly, responsible for the large difference in MO and MB oxidation rates as shown in FIGS. 45A-45B.

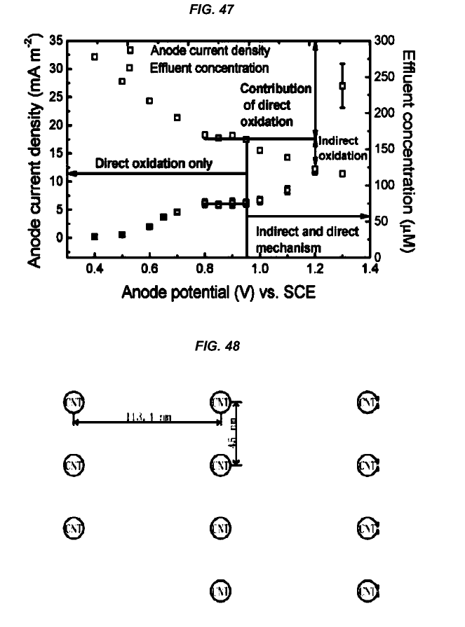

The effect of anode potential on anodic current and MO oxidation at an influent MO concentration of 300 μM is shown in FIG. 47. Such data can provide an insight of a predominant electron transfer pathway, i.e., direct electron transfer versus indirect electron transfer. The effluent MO concentration initially decreases with increasing anode potential until 0.8 V and reaches a plateau of 160 μM from 0.8 to 0.95 V. The current exhibits a corresponding increase until 0.8 V where it plateaus at a mass transfer limited current density of 6 mA m⁻² from 0.8 V to 1 V. Therefore, the findings indicate that the initial decrease of MO concentration up to 0.8 V is due to the increasing rate of direct electron transfer as there are negligible thermodynamically viable indirect pathways. The effluent concentration plateau from 0.8 V to 1.0 V, which overlaps with the mass transfer limited current plateau, is thus attributed to the mass transfer limited direct oxidation. In this regime, MO is oxidized only through direct oxidation pathway by CNT anode, eq 4.

MO⁻+nh−CNT→MOₒₓ(−nh⁺)+CNT (4)

If direct oxidation is the only electron transfer mechanism, then the effluent concentration will not decrease with increasing anodic potential >0.8 V. However, this is not the case. Once the anode potential is increased to >0.95 V, the effluent MO concentration begins to decrease with increasing potential indicating indirect and direct oxidation are occurring simultaneously. The activation of the indirect oxidation pathway negates the mass transfer limitation since the electrogenerated oxidants can diffuse to the bulk solution and react with MO molecules that are not directly oxidized. At 1.01 V vs SCE, the four electron water oxidation to produce oxygen, eq 5, can become viable.⁴¹

H₂O→4H⁺+O₂+4e⁻ (5)

The E⁰ of eq 5 is similar to the experimentally-determined anode potential, 0.95 V, at which indirect oxidation becomes active. The produced oxygen can immediately react with the radicals generated from direct oxidation of MO and form reactive oxygen species such as peroxy radicals that can indirectly oxidize MO.⁴⁵ At anode potentials >1.2 V vs SCE, the two-electron oxidation of Cl⁻ to Cl₂ becomes thermodynamically viable resulting in another possible indirect oxidation pathway. The contribution of the direct and indirect oxidation pathways can be determined from FIG. 47. For example, at an anode potential 1.2 V, the total MO oxidized is 180 μM and the contribution from the direct electron transfer pathway is 140 μM or 78% and the contribution from the indirect electron transfer pathway is 40 μM or 22%. In summary, at low potentials, ≦0.8 V, direct oxidation can be the dominant pathway and as the anode potential is increased above 1.0 V, the contribution from indirect oxidation can increase proportionally as new indirect pathways become viable.

Presented herein is an exemplary overall reaction mechanism for organic oxidation during electrochemical filtration. The overall electrochemical filtration process is described by a reactive transport mechanism consisting of three primary steps: (1) hydrodynamically enhanced mass transfer, (2) temperature-dependent physical adsorption/desorption, and (3) voltage-dependent direct electron transfer. One of the keys to effective oxidation in the electrochemical filtration system includes the 6-fold increase in mass transfer due to convection of the target molecule through the electrode. Following mass transfer in the overall mechanism is physical adsorption onto the CNT anode, which was determined to be an exothermic process with enthalpy of −11.2 kJ mol⁻¹. Higher temperatures were determined to decrease the overall rate of organic oxidation during electrochemical filtration possibly due to increased desorption kinetics and thus a decreased likelihood for oxidation. Once sorbed to the CNT anode, direct oxidation of the organic can occur and the rate of electron transfer can be proportional to the applied voltage. The electrooxidation rate is also determined to be a function of the molecular charge due to electromigration. Direct oxidation is determined to be the predominant electron transfer mechanism at all anode potentials evaluated with indirect oxidation making a fractional contribution at anode potentials V. The electrochemical filtration reactive transport mechanism presented herein provides an improved fundamental understanding of hydrodynamically enhanced electrochemical systems and can be utilized to optimize the design of the filtration apparatuses described herein and to construct an accurate model of the system. Effects of the liquid flow rate on the electrochemical diffusion layer can also be included in the design of the filtration apparatuses described herein.

### Exemplary Materials and Methods for Example 15

CNT Selection. Multiwalled carbon nanotubes that had been made into preformed porous networks with an average depth of 40-50 μm (NanoTechLabs, Buckeye Composites, Yadinkville, N.C.) were utilized. The CNTs were characterized previously¹² (e.g., in earlier Examples) and have a diameter distribution that agrees with the manufacturer specifications of <d>=15 nm-20 nm. Thermogravimetric analysis of the CNTs showed they are composed of about 1-1.5% amorphous carbon and 4-5% residual metal catalyst, which was mostly Fe.¹²

SEM Analysis. Scanning electron microscopy (SEM) was performed on a Zeiss FESEM Supra55VP. ImageJ (NIH) software was used to analyze the obtained scanning electron micrographs. The average CNT diameter was the average of at least 100 measurements from at least 2 images.

Chemicals. NaCl (EMD Chemicals, AR grade, >99%) was chosen as the background electrolyte and used at a concentration of 10 mM for all experiments. Methyl orange hydrate (MO; >95%) and methylene blue hydrate (MB; >97%) were purchased from Sigma-Aldrich. Methylene blue was quantified by its absorption at λₘₐₓ=665 nm (∈=74 100 M⁻¹ cm⁻¹). Methyl orange was quantified by its absorption at λₘₐₓ=464 nm (∈=26 900 M⁻¹ cm⁻¹).

Electrochemical Filtration. The CNT networks were supported by 5-μm PTFE membranes (Omnipore) and placed into the electrochemistry-modified filtration casing (Whatman), FIGS. 1A-1G. The weight of CNTs anode used in the experiments was about 10 mg. After sealing the filtration casing and priming with water, a peristaltic pump (Masterflex) was used to flow water through the filter at about 1.5±0.1 mL min⁻¹ to rinse and calibrate the CNT filter. The liquid flow rate was calibrated with a graduated cylinder. Once the water rinse and flow rate calibration was performed, the pump was primed with the appropriate influent solution and then the experiment was started. The electrochemistry was driven by an Agilent E3646A DC power supply and connected to the external electrode wires with alligator clips. Effluent aliquots were collected at various time-points and analyzed by spectrophotometer to determine the effluent (output fluid) concentration of the target molecule. The temperature-dependent experiments were carried out by putting the whole filtration set up including pump, filter, power supply, and influent container in an incubator set to the desired temperature. The temperature of influent (input fluid) was measured by a thermometer to confirm the temperature of solution consistent with experimental design.

Chronoamperometry and Normal Pulse Voltammetry. The chronoamperometry and normal pulse voltammetry experiments were performed with a CHI604D electrochemical workstation; Ag/AgCl was used as the reference electrode, the perforated stainless steel shim was used as the counter electrode, and the prepared CNT network was used as the working electrode. The time-dependent current was continuously recorded by the electrochemical analyzer. For the normal pulse voltammetry experiments, the current was recorded at 100 s after each potential step and this time period should be sufficient for the nonfaradaic current to become negligible. The electrochemical filtration system was operated at a flow rate of 1.5 mL min⁻¹ and the liquid flow was kept continuous for at least 5 min prior to a potential step. The batch system was operated in a beaker containing 0.5 L of 300 or 1000 μM methyl orange solution with 10 mM NaCl electrolyte. To ensure a consistent initial batch system state, the solution was stirred for at least 5 min prior to a potential step. The results were plotted as current density, which is calculated using the current recorded and the total surface area of CNT anode. The total CNT surface area is obtained by multiplying the mass of CNT anode by its specific surface area, 88 g m⁻² (Ref. 12).

Sorption Experiments. The sorption experiments were carried out in 250 mL glass Erlenmeyer flasks containing 100 mL of aqueous methyl orange solution, 5-250 μM, and 0.015 g CNT powder. The flasks were shaken at 150 rpm in an incubator (New Brunswick Scientific) at temperatures of 15° C., 25° C., and 35° C. for 24 h. Sample aliquots were filtered prior to analysis.

### Example 16

### Kinetics Modeling of Heterogeneous Electrocatalytic Dye Oxidation on Liquid-CNT Interface

Some embodiments of the electrochemical filters using porous CNT anode described herein can be used in dye oxidation and pathogen disinfection^{13, 14}. Presented herein is a combined experimental and simulation study on the coupling between convective-diffusive mass transfer and chemical reaction kinetics during methyl orange oxidation in a porous CNT anode. A steady state model was developed to resolve velocity and concentration spatial distribution, as well as spatially resolved reaction rate. Experimental and numerical simulation studies about reaction rate dependence on influent concentration and anode potential were performed and both results were compared for model accuracy. The mathematical model was further used to investigate mass transfer limited regime and oxidation kinetics limited regimes. Finally, the mathematical model was applied to a single cylinder CNT anode to study the reaction rate distribution around its perimeter.

### Exemplary Mathematical Modeling Approach and Numerical Simulation

CNT Filter Geometric Models. The SEM aerial image of the CNT filter has been shown in earlier Examples, e.g., FIG. 40. The porous filter is consisted of randomly oriented CNTs with a diameter of 15 nm, forming a complex 3D matrix with a pore size of 90±40 nm. For simulation purposes, CNTs are modeled as cylinders aligned along the direction that is perpendicular to the flow. In addition, CNTs in the filter are modeled as periodic arrays in which the distance between each two tubes is determined such that the specific area in the model agrees with the experimental value, 88.5 m² g⁻¹. The calculated distance is 45 nm between two rows and 113.4 nm between two columns as shown in FIG. 48.

Oxidation Kinetics Models. Langmuir-Hinshelwood mechanism is generally used in studies of electro-oxidation reactions where adsorptive species is adsorbed onto electrode surface and oxidized by electrode surface holes or other oxidants¹⁵. The adsorption behavior is described by Langmuir isotherm as follows:

$${q}_{s} = \frac{{q}_{m} {C}_{s}}{1 / b + {C}_{s }} \qquad ( 1 )$$

where qₛ is the adsorption amount on electrode surface and Cₛ is the MO concentration immediately near the electrode surface. qₘ is measured to be 0.0285 g g⁻¹ CNT and b=2.33 L umol⁻¹.

The electron transfer and oxidation rate constant can be modeled by Butler-Volmer (BV)¹ relation using:

K=kₐexp[αf(E−E₀)] (2)

where k₀ is the standard rate constant, α is the transfer coefficient, f=F/RT in which F is faraday constant and R is gas constant. E₀ and E stand for standard electrode potential for the reaction and anodic potential, respectively. Therefore, the rate of oxidation r is

$$r = {Kq}_{s} = \frac{{q}_{m} {C}_{s}}{1 / b + {C}_{s}} {k}_{0} exp [ α f ( E - {E}_{0} ) ] \qquad ( 3 )$$

In the system studied herein, k₀ and α are unknown parameters. By challenging the CNT filter with extremely high concentration, qₛ=qₘ and the logarithm of reaction rate measured in the experiment is linearly dependent on the anodic potential. Accordingly, both parameters can be estimated by linear fitting.

Hydraulic Models. In the 2D model, the 2D Navier-Stokes (eqn. 4) equation is solved, together with the mass conservation of incompressible fluid (eqn. 5).

$$\begin{matrix}ρ \frac{D \overline{u}}{Dt} = - ∇ p + ρ \overline{g} + μ {∇}^{2} \overline{u} & ( 4 ) \\ ∇ \cdot \overline{u} = 0 & ( 5 )\end{matrix}$$

where u is the velocity vector, ρ is the density of the fluid, and p is the pressure. g is a body force term, representing gravity. μ denotes the dynamic viscosity of the influent solution. Due to the low mass fraction of MO in the solution (<3×10⁻⁴), there is unlikely any substantial influence of the dissolved molecules on the fluid properties. Hence, the calculation of the flow field was based on the fluid properties of pure water. Because of the very small Reynolds number (˜2×10⁻⁷), the laminar flow model can be employed to calculate the velocity distribution. The average inlet flow rate of 35.4×10⁻⁶ m s⁻¹ was based on the volumetric flow rate of the experiment.

Species transfer models. Both convective and diffusive mass transfers take place in the filtration system described herein. Steady state mass transfer in the filter is determined by the following convective-diffusion equations, in which the velocity field from hydraulic models is used:

D∇²C=∇C· μ̅ in the filter

−D∇C· n̅=r in the electrode surface (6)

where D denotes the diffusion coefficient which is estimated to be 8.5×10⁻⁵ cm² s⁻¹ for methyl orange and \vec{n} is the normal vector of the cylinder surface. r is the oxidation rate on the CNT surface which is represented by eqn. 3. A finite element method can be applied to calculate the steady state velocity field and concentration field coupled with oxidation kinetics by COMSOL MULTIPHYSICS V 2.0. The overall model approach is shown in Table 8 below.

TABLE 8
An exemplary scheme of the model approach

| | |
|---|---|
| 1. | Hydraulics: Velocity Field |
| | Navier-Stokes equations and boundary conditions |
| | ∇ · u = 0 |
| 2. | Mass Transfer |
| | Convective-diffusion equations |
| | D∇²C(x, y) = \vec{u} · VC(x, y) |
| 3. | Oxidation Kinetics |
| | Inward flux on electrode surface equals to oxidation kinetics |
| | $- D ∇ {C}_{s} \cdot {n}^{->} = - {k}_{0} exp [ α f ( E - {E}_{0} ) [ \frac{{q}_{m} {C}_{s}}{1 / b + {C}_{s}} ]$ |

### Results

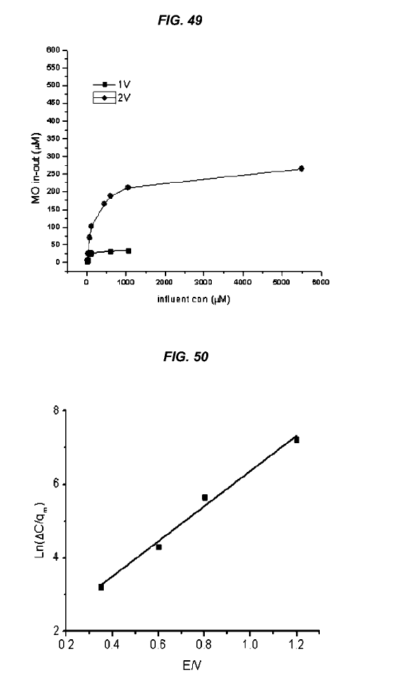

Oxidation Reaction Rate Coefficient. The measured overall reaction rates as a function of influent concentration is shown in FIG. 49. At high influent concentration the oxidation rate reaches a plateau which can be attributed to the saturation of surface reactive sites and a complete coverage by adsorbed molecules on the electrode surface.

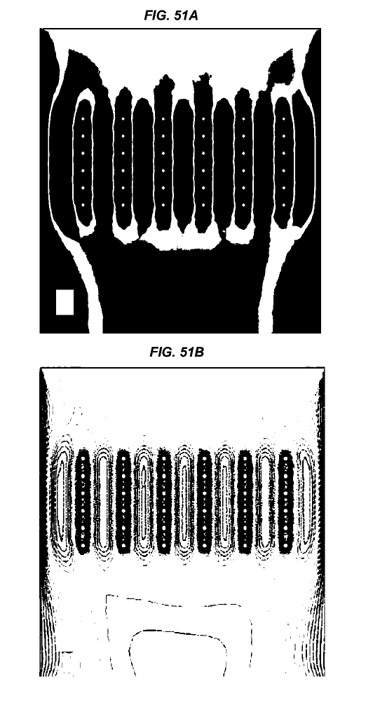

Therefore, the experimental measurement indicates that the Langmuir-Hinshelwood mechanism can be applied where adsorptive species is adsorbed onto electrode surface and oxidized by electrode surface holes or other oxidants. The maximum reaction rates at the indicated anodic voltage were measured and plotted against the anodic voltage in a logarithm scale as shown in FIG. 50. The data obtained at 0.35 V, 0.6 V, 0.8 V, 1.2 V show a good linear relationship with R²=0.988. According to eqn. 3, k₀=18.9 umol (s m³)⁻¹ and αf=5.43 V⁻¹. With the above oxidation reaction coefficient, the oxidation kinetics can be described and a numerical simulation of the overall reaction kinetics can be performed, taking into account mass transfer and oxidation kinetics on electrode surface.

Velocity and Concentration Field Simulation. The calculated velocity field is presented by velocity surface and velocity contour in FIGS. 51A and 51B. The red spots are areas with high velocity while blue spots are velocity minimums. The model correctly predicted the relative distribution of velocity field. As shown in FIG. 51A, the flow accelerates after entering the filter because of a shrink in cross-section area, and the flow is very slow near the CNT surface as well as walls of reactor. The velocity contour as shown in FIG. 51B also shows a trend that velocity decreases near the CNT surface. With the simulated velocity field, the concentration field can be resolved.

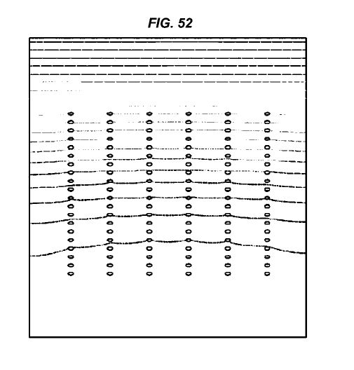

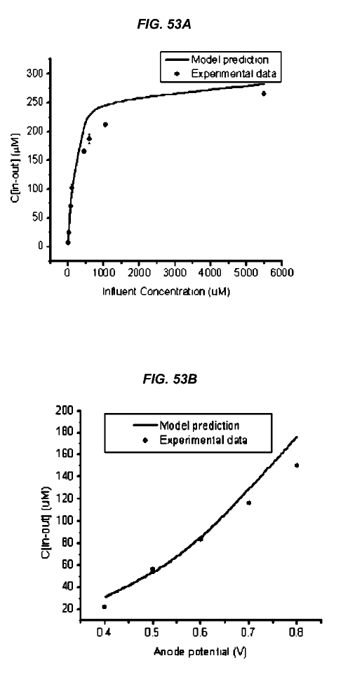

Overall Reaction Kinetics: Experimental Data and Simulation. A representative simulation concentration contour is shown in FIG. 52 and shows that that the model can qualitatively predict the spatial concentration distribution. The model correctly predicts a decreasing trend along the filtration depth. In addition, the model shows that the space between consecutive concentration contours becomes larger along filtration depth, indicating a decreasing concentration gradient and thus in turn a decreasing mass transfer rate and overall reaction rate.

While in the actual CNT filter total number of CNT rows is 1000, 20 rows of CNTs are incorporated in the model simulation. Therefore, the effluent concentration predicted by the model Cₚ is actually the concentration at 1/50 of total length. Nevertheless, the total oxidation rate or the final effluent concentration Cₒᵤₜ can be estimated by modeling the filter as a porous plug flow reactor, which is reasonable for electrochemical filtration and can be verified by the parallel shape of concentration contour in FIG. 52. The Cₒᵤₜ can be calculated by solving eqn. 7 as follows:

Cₚ=C₀e^{-20k}

CₒᵤₜC₀e^{-1000k} (7)

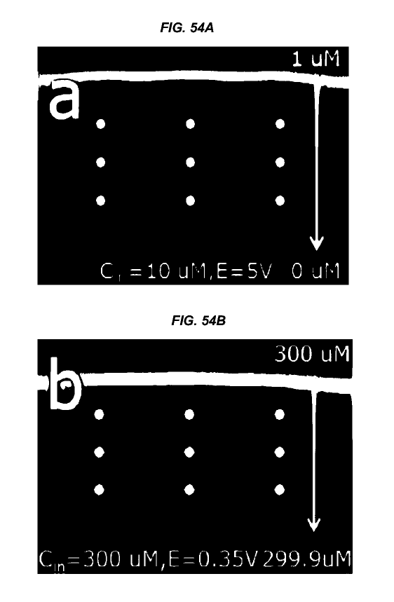

The accuracy of the model can be assessed and validated by influent concentration-dependent experiment (FIG. 53A) and potential-dependent experiment (FIG. 53B). The experimental data are represented by dots and simulation results are represented by lines in the figures. In FIG. 53A, effluent concentration is measured at the outlet after about 1.4 s of electrochemical filtration. FIG. 53A shows that the C[in-out] increases with influent concentration initially but gradually reaches a plateau. FIG. 53B shows that kinetics of reaction increases as anode potential rises due to faster electron transfer. In both cases the model can predict not only the general trend but also the absolute values at given condition. The maximum relative error of prediction during the experimental data range is about 15%.

Mass Transfer Limited and Oxidation Kinetics Limited Regimes. In heterogeneous reaction, the overall kinetics can be limited by mass transfer or electrode oxidation kinetics. Theoretically, the two different rate limiting regime can be distinguished by characteristics time calculation for each primary step. In the model presented herein, the mass transfer rate can be adjusted by changing influent concentration while the oxidation kinetics can be tuned by adjusting anodic potential. The simulation results for mass transfer limited regime and oxidation kinetics limited regime under representative conditions are shown in FIGS. 54A and 54B, respectively. In FIG. 54A, simulation is performed at very low influent concentration, 1 μM, and a high anodic voltage, 5 V. The resulting simulation gives a clear spatial concentration distribution which indicates overall kinetics is mass transfer limited. The concentration decreases sharply to almost zero after only the first row of CNTs electrode. Therefore, no or insignificant oxidation occurs in the remaining rows because of insufficient mass transfer to those electrodes, and thus overall kinetics is in mass transfer limited regime. In FIG. 54B, on the contrary, the influent concentration is as high as 300 but the anodic potential E is 0.35 V, slightly higher than the standard electrode potential of methyl orange oxidation, 0.3 V. Under this condition, the mass transfer is sufficient but the slow oxidation kinetics can become the rate limiting step, as evidenced by the spatial concentration distribution showing a slight change along filtration depth and a high concentration at the electrode surface. Theoretically, characteristic time of mass transfer and oxidation kinetics can be calculated and compared to determine the rate limiting step. The characteristic time of mass transfer is given by the following eqn. 8 (Ref. 1),

$${t}_{m} = \frac{{r}_{0}^{2} {e}^{\frac{δ}{{r}_{0}}}}{4 D} \qquad ( 8 )$$

where tₘ is the characteristic time for mass transfer, rₒ is the radius of cylinder electrode, D denotes the diffusion coefficient and δ is the diffusion layer thickness. δ is estimated to be 100 nm and 50 nm in FIGS. 54A and 54B, respectively.

The characteristic time of oxidation reaction can be derived by eqn. 9,

$${t}_{0} = \frac{C}{\frac{d C}{d t}} = \frac{C + 1 / b}{( {Kq}_{m} ) h} \qquad ( 9 )$$

where tₒ stands for the characteristic time for oxidation, while other variables are the same as stated previously. Based on eqn. 8 and eqn. 9, in FIG. 54A, tₘ=1 ms>>tₒ=1×10⁻⁷ s, indicating mass transfer limitation. In FIG. 54B, tₘ=1×10⁻⁶ s<<tₒ=9447 s, indicating oxidation kinetics limitation. The model simulation results agree well with theoretical calculation.

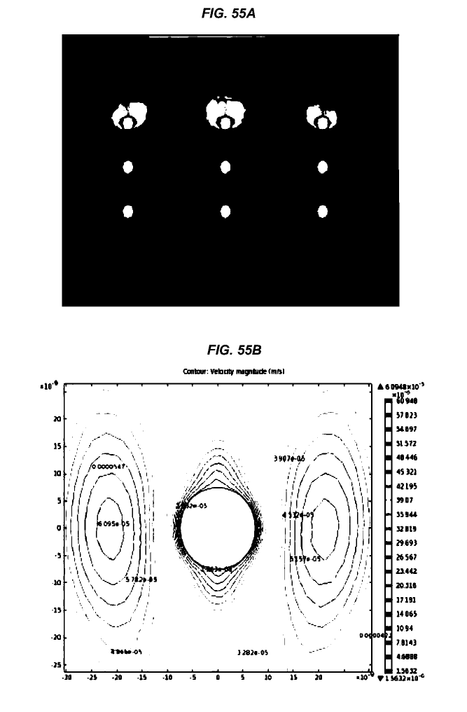

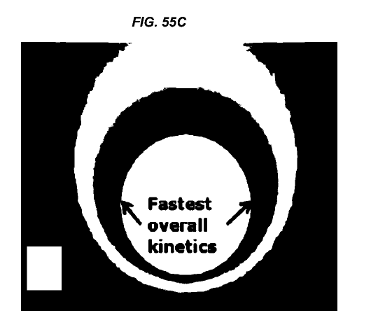

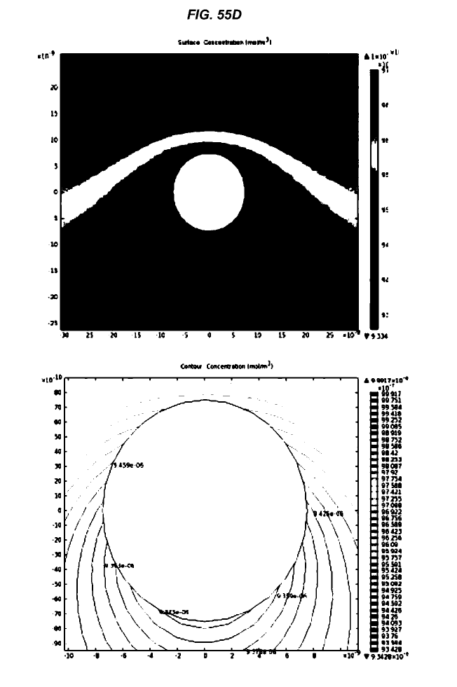

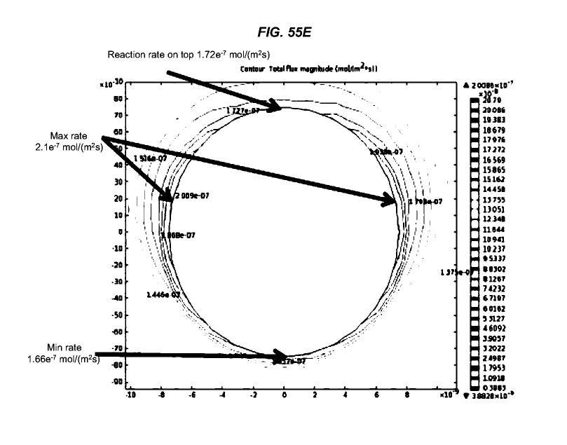

Variation of Reaction Kinetics along Filtration Depth and CNT Perimeter. Along filtration depth, molecules in the solution are oxidized and the bulk concentration changes. This change in bulk concentration in turn can affect the oxidation kinetics, thus varying reaction kinetics along filtration depth. The steady-state spatial flux simulation in FIG. 55A can provide a quantitative description of steady-state spatial changes in reaction rates. While the flux does not equal to the surface oxidation rate everywhere in the solution, on the CNTs surface, the inward flux does equal to the rate of reaction. Therefore, the changes in flux magnitude on the CNTs surface can be used to estimate local oxidation rate. FIG. 55A indicates that the reaction rate is faster on CNTs at the top surface than those at the bottom surface of the filter. The decreasing average reaction rate along the filtration depth can be attributed to the decrease in average bulk concentration. FIG. 55A also shows that the reaction rate is not homogenous along the perimeter of a single CNT electrode which gives the red “ears” on left and right sides of each CNT.

To closely investigate this kinetics variation along CNT perimeter, the simulation for a single cylinder CNT anode is performed. The diffusional flux on the CNT surface is substantially equal to local reaction due to minimum convection near CNT surface as indicated in the velocity contour of FIG. 55B. The computed flux surface is plotted in FIG. 55C. FIG. 55C indicates that the fastest reaction kinetics occurs at the left and right sides of CNT and is perpendicular to the direction of flow; the slowest reaction kinetics takes place downstream of the CNT anode while the upstream side of CNT shows an intermediate reaction rate. This distribution of reaction rates can be explained in terms of mass transfer because the simulation condition falls into the mass transfer limited regime. On the left and right side of CNT, the convection is faster in the adjacent regions associated with faster velocity thus resulting in a thinner diffusion layer and higher mass transfer rate. On the downstream side of the cylinder, the concentration in the nearby region (as shown in FIG. 55D) is significantly lower which indicates a small diffusion rate. In addition, the average velocity and the convection rate is lower. Therefore, the overall mass transfer rate is the slowest at the bottom surface. On the upstream side of the cylinder, although convection rate is as slow as observed on the bottom surface, the concentration field nearby is the highest (as shown in FIG. 55D), leading to an intermediate mass transfer rate and overall reaction rate. Quantitatively, as shown in FIG. 55E, the rate of reaction on the left and right is 2.01×10⁻⁷ mol (m² s)⁻¹, while the reaction rates on the upstream and downstream side are 1.72×10⁻⁷ and 1.66×10⁻⁷ mol (m² s)⁻¹. The rate of reaction varies 20% along the CNT anode perimeter.

The heterogeneous kinetics including electrocatalytical dye oxidation kinetics and mass transport in a porous carbon nanotubes (CNTs) anode is evaluated experimentally and numerically simulated. The numerical simulation resolves steady state concentration spatial distribution, velocities, flux, and spatial distribution of overall reaction rate. By concentration field and flux simulation, the mathematical model can qualitatively describe trend of reaction rate in both the mass transfer limited and oxidation kinetics limited regimes. The kinetic model is can also quantitatively agree with experiment data obtained from anode potential dependent and influent concentration dependent experiments. The model simulations shows that reaction rates vary along filtration depth. In a simulation of a single nanotube anode, the spatial distribution along the cylinder CNT perimeter shows that the maximum reaction rate occurs at which the direction is perpendicular to main stream flow whereas minimum reaction rate occurs on the downstream side of the cylinder due to mass transfer.

### Exemplary Experimental Materials and Methods for Example 16

CNT Selection. As described earlier, multiwalled carbon nanotubes that had been made into preformed porous networks with an average depth of 40 to 50 μm (NanoTechLabs, Buckeye Composites, Yadinkville, N.C.) were utilized. Please see, e.g., Example 15, for additional details.

SEM Analysis. Scanning electron microscopy (SEM) was performed on a Zeiss FESEM Supra55VP. ImageJ (NIH) software was used to analyze the obtained scanning electron micrographs. The average CNT diameter was the average of at least 100 measurements from at least 2 images.

Electrochemical Filtration. As described earlier, the CNT networks were supported by 5-μm PTFE membranes (Omnipore) and placed into the electrochemistry-modified filtration casing (Whatman) as shown in FIGS. 1A-1G. Please see, e.g., Example 15, for further details.

Various changes and modifications to the disclosed embodiments, which will be apparent to those of skill in the art, may be made without departing from the spirit and scope of the present invention. Further, all patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

### REFERENCES FOR EXAMPLES 1 TO 6

(1) Carbon Nanotubes: Advanced Topics in the Synthesis, Structure, Properties and Applications; 111 ed.; Jorio, A.; Dresselhaus, M. S.; Dresselhaus, G., Eds.; Springer-Verlag: Berlin, 2008.
(2) Iijima, S, Nature 1991, 354, 56-58.
(3) Peigney, A.; Laurent, C.; Flahaut, E.; Bacsa, R. R.; Rousset, A. Carbon 2001, 39, 507-514.
(4) Pantano, A.; Parks, D. M.; Boyce, M. C. J. Mech. Phys. Solids 2004, 52, 789-821.
(5) Ebbesen, T. W.; Lezec, H. J.; Hiura, H.; Bennett, J. W.; Ghaemi, H. F.; Thio, T. Nature 1996, 382, 54-56.
(6) Pan, B.; Xing, B. S. Environ. Sci. Technol. 2008, 42, 9005-9013.
(7) Fugetsu, B.; Satoh, S.; Shiba, T.; Mizutani, T.; Lin, Y. B.; Terui, N.; Nodasaka, Y.; Sasa, K.; Shimizu, K.; Akasaka, R. et al. Environ. Sci. Technol. 2004, 38, 6890-6896.
(8) Cai, Y. Q.; Cai, Y. E.; Mou, S. F.; Lu, Y. Q. J. Chromatogr. A 2005, 1081, 245-247.
(9) Hyung, H.; Kim, J. H. Environ. Sci. Technol. 2008, 42, 4416-4421.
(10) Cho, H. H.; Wepasnick, K.; Smith, B. A.; Bangash, F. K.; Fairbrother, D. H.; Ball, W. P. Langmuir 2010, 26, 967-981.
(11) Di, Z. C.; Ding, J.; Peng, X. J.; Li, Y. H.; Luan, Z. K.; Liang, J. Chemosphere 2006, 62, 861-865.
(12) Peng, X. J.; Luan, Z. K.; Ding, J.; Di, Z. H.; Li, Y. H.; Tian, B. H. Mater. Lett. 2005, 59, 399-403.
(13) Wang, J. X.; Jiang, D. Q.; Gu, Z. Y.; Yan, X. P. J. Chromatogr. A 2006, 1137, 8-14.
(14) Brady-Estevez, A. S.; Kang, S.; Elimelech, M. Small 2008, 4, 481-484.
(15) Brady-Estevez, A. S.; Nguyen, T. H.; Gutierrez, L.; Elimelech, M. Water Res. 2010, 44, 3773-3780.
(16) Brady-Estevez, A. S.; Schnoor, M. H.; Vecitis, C. D.; Saleh, N. B.; Elimelech, M. Langmuir 2010, 14975-14982.
(17) Li, X. S.; Zhu, G. Y.; Dordick, J. S.; Ajayan, P. M. Small 2007, 3, 595-599.
(18) Gui, X. C.; Cao, A. Y.; Wei, J. Q.; Li, H. B.; Jia, Y.; Li, Z.; Fan, L. L.; Wang, K. L.; Zhu, H. W.; Wu, D. H. ACS Nano 2010, 4, 2320-2326.
(19) Srivastava, A.; Srivastava, O. N.; Talapatra, S.; Vajtai, R.; Ajayan, P. M. Nat. Mater. 2004, 3, 610-614.
(20) Hinds, B. J.; Chopra, N.; Rantell, T.; Andrews, R.; Gavalas, V.; Bachas, L. G. Science 2004, 303, 62-65.
(21) Wang, X.; Li, W. Z.; Chen, Z. W.; Waje, M.; Yan, Y. S. J. Power Sources 2006, 158, 154-159.
(22) Li, J.; Cassell, A.; Delzeit, L.; Han, J.; Meyyappan, M. J. Phys. Chem. B 2002, 106, 9299-9305.
(23) Gao, B.; Kleinhammes, A.; Tang, X. P.; Bower, C.; Fleming, L.; Wu, Y.; Zhou, O. Chem. Phys. Let. 1999, 307, 153-157.
(24) Li, W. Z.; Liang, C. H.; Zhou, W. J.; Qiu, J. S.; Zhou, Z. H.; Sun, G. Q.; Xin, Q. J. Phys. Chem. B 2003, 107, 6292-6299.
(25) Girishkumar, G.; Vinodgopal, K.; Kamat, P. V. J. Phys. Chem. B 2004, 108, 19960-19966.
(26) Kongkanand, A.; Dominguez, R. M.; Kamat, P. V. Nano Lett. 2007, 7, 676-680.
(27) Park, J.; Choi, W. J. Phys. Chem. C 2009, 113, 20974-20979.
(28) Gooding, J. J.; Wibowo, R.; Liu, J. Q.; Yang, W. R.; Losic, D.; Orbons, S.; Mearns, F. J.; Shapter, J. G.; Hibbert, D. B. J. Am. Chem. Soc. 2003, 125, 9006-9007.
(29) Han, H. Y.; Tachikawa, H. Front. Biosci. 2005, 10, 931-939.
(30) Yang, J.; Wang, J.; Jia, J. P. Environ. Sci. Technol. 2009, 43, 3796-3802.
(31) Wardman, P. J. Phys. Chem. Ref. Data 1989, 18, 1637-1755.
(32) Graham, D. J. Phys. Chem. 1955, 59, 896-900.
(33) Israelachvili, J. N. Intermolecular and Surface Forces, 2 ed.; San Diego Academic Press: London, 1992.
(34) Tizard, H. T. J. Chem. Soc. 1910, 97, 2477-2490.
(35) Tsai, Y. T.; Lin, A. Y. C.; Weng, Y. H.; Li, K. C. Environ. Sci. Technol. 2010, 44, 7914-7920.
(36) Mrowetz, M.; Balcerski, W.; Colussi, A. J.; Hoffmann, M. R. J. Phys. Chem. B 2004, 108, 17269-17273.
(37) Liu, L.; Li, F. B.; Feng, C. H.; Li, X. Z. Appl. Microbiol. Biotechnol. 2009, 85, 175-183.
(38) CRC Handbook of Chemistry and Physics; 79 ed.; Lide, D. R., Ed.; CRC Press LLC: Boston, 1998.
(39) Zhi, J. F.; Wang, H. B.; Nakashima, T.; Rao, T. N.; Fujishima, A. J. Phys. Chem. B 2003, 107, 13389-13395.
(40) Tong, X. L.; Zhao, G. H.; Liu, M. C.; Cao, T. C.; Liu, L.; Li, P. Q. J. Phys. Chem. C 2009, 113, 13787-13792.
(41) Zhao, G. H.; Li, P. Q.; Nong, F. Q.; Li, M. F.; Gao, J. X.; Li, D. M. J. Phys. Chem. C 2010, 114, 5906-5913.
(42) Li, P. Q.; Zhao, G. H.; Cui, X.; Zhang, Y. G.; Tang, Y. T. J. Phys. Chem. C 2009, 113, 2375-2383.
(43) Matyasovszky, N.; Tian, M.; Chen, A. C. J. Phys. Chem. A 2009, 113, 9348-9353.
(44) Park, H.; Vecitis, C. D.; Hoffmann, M. R. J. Phys. Chem. A 2008, 112, 7616-7626.
(45) Park, H.; Vecitis, C. D.; Hoffmann, M. R. J. Phys. Chem. C 2009, 113, 7935-7945.
(46) Gao, J. X.; Zhao, G. H.; Liu, M. C.; Li, D. M. J. Phys. Chem. A 2009, 113, 10466-10473.
(47) Liu, Z.; Zhang, X.; Nishimoto, S.; Jin, M.; Tryk, D. A.; Murakami, T.; Fujishima, A. J. Phys. Chem. C 2008, 112, 253-259.
(48) Vinodgopal, K.; Hotchandani, S.; Kamat, P. V. J. Phys. Chem. 1993, 97, 9040-9044.
(49) Oturan, N.; Panizza, M.; Oturan, M. A. J. Phys. Chem. A 2009, 113, 10988-10993.
(50) Oturan, N.; Zhou, M. H.; Oturan, M. A. J. Phys. Chem. A 2010, 114, 10605-10611.
(51) Borras, N.; Oliver, R.; Arias, C.; Brillas, E. J. Phys. Chem. A 2010, 114, 6613-6621.

### REFERENCES FOR EXAMPLES 7 TO 10

[1] M. Elimelech, J. Water Supply Res Technol.-Aqua 2006, 55, 3.
[2] A. S. Brady-Estevez, M. H. Schnoor, C. D. Vecitis, N. B. Saleh, M. Elimelech, Langmuir 2010, 14975.
[3] A. S. Brady-Estevez, S. Kang, M. Elimelech, Small 2008, 4, 481.
[4] T. W. Ebbesen, H. J. Lezec, H. Hiura, J. W. Bennett, H. F. Ghaemi, T. Thio, Nature 1996, 382, 54.
[5] K. P. Drees, M. Abbaszadegan, R. M. Maier, Water Res. 2003, 37, 2291.
[6] Q. Fang, C. Shang, G. H. Chen, J. Environ. Eng.-ASCE 2006, 132, 13.
[7] C. Morita, K. Sano, S. Morimatsu, H. Kiura, T. Goto, T. Kohno, W. Hong, H. Miyoshi, A. Iwasawa, Y. Nakamura, M. Tagawa, O. Yokosuka, H. Saisho, T. Maeda, Y. Katsuoka, J. Virol. Methods 2000, 85, 163.
[8] W. Y. Liang, J. H. Qu, L. B. Chen, H. J. Liu, P. J. Lei, Environ. Sci. Technol. 2005, 39, 4633:
[9] C. A. Martinez-Huitle, E. Brillas, Angew. Chem.-Int. Edit. 2008, 47, 1998.
[10] J. Jeong, J. Y. Kim, J. Yoon, Environ. Sci. Technol. 2006, 40, 6117.
[11] A. M. Polcaro, A. Vacca, M. Mascia, S. Palmas, R. Pompei, S. Laconi, Electrochim. Acta 2007, 52, 2595.
[12] T. Matsunaga, S, Nakasono, T. Takamuku, J. G. Burgess, N. Nakamura, K. Sode, Appl. Environ. Microbiol. 1992, 58, 686.
[13] T. Matsunaga, S, Nakasono, Y. Kitajima, K. Horiguchi, Biotechnol. Bioeng. 1994, 43, 429.
[14] T. Matsunaga, S, Nakasono, S. Masuda, FEMS Microbiol. Lett. 1992, 93, 255.
[15] A. S. Brady-Estevez, T. H. Nguyen, L. Gutierrez, M. Elimelech, Wat. Res. 2010, 44, 3773.
[16] S. Kang, M. Pinault, L. D. Pfefferle, M. Elimelech, Langmuir 2007, 23, 8670.
[17] S. Kang, M. S. Mauter, M. Elimelech, Environ. Sci. Technol. 2008, 42, 7528.
[18] C. D. Vecitis, K. R. Zodrow, S. Kang, M. Elimelech, ACS Nano 2010, 5471.
[19] A. Kongkanand, R. M. Dominguez, P. V. Kamat, Nano Lett. 2007, 7, 676.
[20] Y. Ye, C. C. Ahn, C. Witham, B. Fultz, J. Liu, A. G. Rinzler, D. Colbert, K. A. Smith, R. E. Smalley, Appl. Phys. Lett. 1999, 74, 2307.
[21] W. Z. Li, C. H. Liang, W. J. Zhou, J. S. Qiu, Z. H. Zhou, G. Q. Sun, Q. Xin, J. Phys. Chem. B 2003, 107, 6292.
[22] X. Wang, W. Z. Li, Z. W. Chen, M. Waje, Y. S. Yan, J. Power Sources 2006, 158, 154.
[23] A. Peigney, C. Laurent, E. Flahaut, R. R. Bacsa, A. Rousset, Carbon 2001, 39, 507.
[24] A. J. Bard, M. A. Fox, Accounts Chem. Res. 1995, 28, 141.
[25] H. Park, C. D. Vecitis, M. R. Hoffmann, J. Phys. Chem. C 2009, 113, 7935.
[26] H. Park, C. D. Vecitis, M. R. Hoffmann, J. Phys. Chem. A 2008, 112, 7616.
[27] A. Srivastava, O. N. Srivastava, S. Talapatra, R. Vajtai, P. M. Ajayan, Nat. Mater. 2004, 3, 610.
[28] M. Elimelech, X. Jia, J. Gregory, R. Williams, Particle Deposition & Aggregation: Measurement, Modelling and Simulation, Reed Elsevier Group, Oxford, 1995.
[29] L. N. Csonka, Microbiol. Rev. 1989, 53, 121.
[30] S. Kang, M. Herzberg, D. F. Rodrigues, M. Elimelech, Langmuir 2008, 24, 6409.
[31] T. Matsunaga, Y. Namba, Anal. Chem. 1984, 56, 798.
[32] K. Magnuson, S. Jackowski, C. O. Rock, J. E. Cronan, Microbiol. Rev. 1993, 57, 522.
[33] N. J. Faergeman, J. Knudsen, Biochem. J. 1997, 323, 1.
[34] C. C. Winterbourn, D. Metodiewa, Free Radic. Biol. Med. 1999, 27, 322.
[35] P. Wardman, J. Phys. Chem. Ref. Data 1989, 18, 1637.
[36] S. B. Liu, L. Wei, L. Hao, N. Fang, M. W. Chang, R. Xu, Y. H. Yang, Y. Chen, ACS Nano 2009, 3, 3891.
[37] H. Y. Han, H. Tachikawa, Front. Biosci. 2005, 10, 931.
[38] I. Sondi, B. Salopek-Sondi, J. Colloid Interface Sci. 2004, 275, 177.
[39] D. T. Schoen, A. P. Schoen, L. B. Hu, H. S. Kim, S. C. Heilshorn, Y. Cui, Nano Lett. 2010, 10, 3628.
[40] W. Yuan, G. H. Jiang, J. F. Che, X. B. Qi, R. Xu, M. W. Chang, Y. Chen, S. Y. Lim, J. Dai, M. B. Chan-Park, J. Phys. Chem. C 2008, 112, 18754.
[41] K. Zodrow, L. Brunet, S. Mahendra, D. Li, A. Zhang, Q. L. Li, P. J. J. Alvarez, Water Res. 2009, 43, 715.
[42] J. Albert, J. Luoto, D. Levine, Environ. Sci. Technol. 2010, 44, 4426.
[43] J. Yang, J. Wang, J. P. Jia, Environ. Sci. Technol. 2009, 43, 3796.

### REFERENCES FOR EXAMPLE 11

(1) Bard, A. J.; Faulkner, L. R. Electrochemical Methods: Fundamentals and Applications, 2nd ed.; John Wiley & Sons: New York, 2001; p 833.
(2) Rajeshwar, K.; Ibanez, J. G.; Swain, G. M. Electrochemistry and the environment. J. Appl. Electrochem. 1994, 24 (11), 1077-1091.
(3) Panizza, M.; Cerisola, G. Direct and mediated anodic oxidation of organic pollutants. Chem. Rev. 2009, 109 (12), 6541-6569.
(4) Martinez-Huitle, C. A.; Brillas, E. Electrochemical alternatives for drinking water disinfection. Angew. Chem., Int. Ed. 2008, 47 (11), 1998-2005.
(5) Park, H.; Vecitis, C. D.; Hoffmann, M. R. Solar-powered electrochemical oxidation of organic compounds coupled with the cathodic production of molecular hydrogen. J. Phys. Chem. A 2008, 112 (33), 7616-7626.
(6) Zhi, J. F.; Wang, H. B.; Nakashima, T.; Rao, T. N.; Fujishima, A. Electrochemical incineration of organic pollutants on boron-doped diamond electrode. Evidence for direct electrochemical oxidation pathway. J. Phys. Chem. B 2003, 107 (48), 13389-13395.
(7) Tong, X. L.; Zhao, G. H.; Liu, M. C.; Cao, T. C.; Liu, L.; Li, P. Q. Fabrication and high electrocatalytic activity of three-dimensional porous nanosheet pt/boron-doped diamond hybrid film. J. Phys. Chem. C 2009, 113 (31), 13787-13792.
(8) Zhao, G. H.; Li, P. Q.; Nong, F. Q.; Li, M. F.; Gao, J. X.; Li, D. M. Construction and high performance of a novel modified boron-doped diamond film electrode endowed with superior electrocatalysis. J. Phys. Chem. C 2010, 114 (13), 5906-5913.
(9) Li, P. Q.; Zhao, G. H.; Cui, X.; Zhang, Y. G.; Tang, Y. T. Constructing stake structured TiO2-NTs/Sb-doped SnO2 electrode simultaneously with high electrocatalytic and photocatalytic performance for complete mineralization of refractory aromatic acid. J. Phys. Chem. C 2009, 113 (6), 2375-2383.
(10) Matyasovszky, N.; Tian, M.; Chen, A. C. Kinetic study of the electrochemical oxidation of salicylic acid and salicylaldehyde using UV/Vis spectroscopy and multivariate calibration. J. Phys. Chem. A 2009, 113 (33), 9348-9353.
(11) Park, H.; Vecitis, C. D.; Hoffmann, M. R. Electrochemical water splitting coupled with organic compound oxidation: The role of active chlorine species. J. Phys. Chem. C 2009, 113 (18), 7935-7945.
(12) Borras, N.; Oliver, R.; Arias, C.; Brillas, E. Degradation of atrazine by electrochemical advanced oxidation processes using a borondoped diamond anode. J. Phys. Chem. A 2010, 114 (24), 6613-6621.
(13) Peigney, A.; Laurent, C.; Flahaut, E.; Bacsa, R. R.; Rousset, A. Specific surface area of carbon nanotubes and bundles of carbon nanotubes. Carbon 2001, 39 (4), 507-514.
(14) Ebbesen, T. W.; Lezec, H. J.; Hiura, H.; Bennett, J. W.; Ghaemi, H. F.; Thio, T. Electrical conductivity of individual carbon nanotubes. Nature 1996, 382 (6586), 54-56.
(15) Pantano, A.; Parks, D. M.; Boyce, M. C. Mechanics of deformation of single- and multi wall carbon nanotubes. J. Mech. Phys. Solids 2004, 52 (4), 789-821.
(16) Wang, X.; Li, W. Z.; Chen, Z. W.; Waje, M.; Yan, Y. S. Durability investigation of carbon nanotube as catalyst support for proton exchange membrane fuel cell. J. Power Sources 2006, 158 (1), 154-159.
(17) Li, J.; Cassell, A.; Delzeit, L.; Han, J.; Meyyappan, M. Novel three-dimensional electrodes: Electrochemical properties of carbon nanotube ensembles. J. Phys. Chem. B 2002, 106 (36), 9299-9305.
(18) Brady-Estevez, A. S.; Kang, S.; Elimelech, M. A single-walled carbon-nanotube filter for removal of viral and bacterial pathogens. Small 2008, 4 (4), 481-484.
(19) Vecitis, C. D.; Gao, G. D.; Liu, H. Electrochemical carbon nanotube filter for adsorption, desorption, and oxidation of aqueous dyes and anions. J. Phys. Chem. C 2011, 115 (9), 3621-3629.
(20) Vecitis, C. D.; Schnoor, M. H.; Rahaman, M. S.; Schiffman, J. D.; Elimelech, M. Electrochemical multiwalled carbon nanotube filter for viral and bacterial removal and inactivation. Environ. Sci. Technol. 2011, 45 (8), 3672-3679.
(21) Pan, B.; Xing, B. S. Adsorption mechanisms of organic chemicals on carbon nanotubes. Environ. Sci. Technol. 2008, 42 (24), 9005-9013.
(22) Smith, B.; Wepasnick, K.; Schrote, K. E.; Bertele, A. H.; Ball, W. P.; O'Melia, C.; Fairbrother, D. H. Colloidal properties of aqueous suspensions of acid-treated, multi-walled carbon nanotubes. Environ. Sci. Technol. 2009, 43 (3), 819-825.
(23) Kang, S.; Mauter, M. S.; Elimelech, M. Physicochemical determinants of multiwalled carbon nanotube bacterial cytotoxicity. Environ. Sci. Technol. 2008, 42 (19), 7528-7534.
(24) Wang, X. M.; Li, N.; Webb, J. A.; Pfefferle, L. D.; Haller, G. L. Effect of surface oxygen containing groups on the catalytic activity of multi-walled carbon nanotube supported Pt catalyst. Appl. Catal., B 2010, 101 (102), 21-30.
(25) Kim, Y. K.; Park, H. Light-harvesting multi-walled carbon nanotubes and CdS hybrids: Application to photocatalytic hydrogen production from water. Energy Environ. Sci. 2011, 4 (3), 685-694.
(26) Kang, S.; Herzberg, M.; Rodrigues, D. F.; Elimelech, M. Antibacterial effects of carbon nanotubes: Size does matter. Langmuir 2008, 24 (13), 6409-6413.
(27) Kim, U. J.; Furtado, C. A.; Liu, X. M.; Chen, G. G.; Eklund, P. C. Raman and IR spectroscopy of chemically processed single-walled carbon nanotubes. J. Am. Chem. Soc. 2005, 127 (44), 15437-15445.
(28) Cho, H. H.; Wepasnick, K.; Smith, B. A.; Bangash, F. K.; Fairbrother, D. H.; Ball, W. P. Sorption of aqueous Zn[II] and Cd[II] by multiwall carbon nanotubes: The relative roles of oxygen-containing functional groups and graphenic carbon. Langmuir 2010, 26 (2), 967-981.
(29) Fujihara, S.; Maeda, T.; Ohgi, H.; Hosono, E.; Imai, H.; Kim, S. H. Hydrothermal routes to prepare nanocrystalline mesoporous SnO2 having high thermal stability. Langmuir 2004, 20 (15), 6476-6481.
(30) Wen, Z. H.; Wang, Q.; Zhang, Q.; Li, J. H. In situ growth of mesoporous SnO2 on multiwalled carbon nanotubes: A novel composite with porous-tube structure as anode for lithium batteries. Adv. Funct. Mater. 2007, 17 (15), 2772-2778.
(31) Moon, J. M.; An, K. H.; Lee, Y. H.; Park, Y. S.; Bae, D. J.; Park, G. S. High-yield purification process of single-walled carbon nanotubes. J. Phys. Chem. B 2001, 105 (24), 5677-5681.
(32) Shi, Z. J.; Lian, Y. F.; Liao, F. H.; Zhou, X. H.; Gu, Z. N.; Zhang, Y. G.; Iijima, S. Purification of single-wall carbon nanotubes. Solid State Commun. 1999, 112 (1), 35-37.
(33) Briggs, D.; Seah, M. P. Practical Surface Analysis: Auger and X-ray Photoelectron Spectroscopy, 2nd ed.; John Wiley & Sons Limited: New York, 1990.
(34) Hu, H.; Zhao, B.; Itkis, M. E.; Haddon, R. C. Nitric acid purification of single-walled carbon nanotubes. J. Phys. Chem. B 2003, 107 (50), 13838-13842.
(35) Rinzler, A. G.; Liu, J.; Dai, H.; Nikolaev, P.; Huffman, C. B.; Rodriguez-Macias, F. J.; Boul, P. J.; Lu, A. H.; Heymann, D.; Colbert, D. T.; Lee, R. S.; Fischer, J. E.; Rao, A. M.; Eklund, P. C.; Smalley, R. E. Large-scale purification of single-wall carbon nanotubes: Process, product, and characterization. Appl. Phys. A 1998, 67 (1), 29-37.
(36) Liu, L.; Li, F. B.; Feng, C. H.; Li, X. Z. Microbial fuel cell with an azo-dye-feeding cathode. Appl. Microbiol. Biotechnol. 2009, 85 (1), 175-183.
(37) McKenzie, K. J.; Marken, F. Direct electrochemistry of nano-particulate Fe2O3 in aqueous solution and adsorbed onto tin-doped indium oxide. Pure Appl. Chem. 2001, 73 (12), 1885-1894.
(38) Enami, S.; Hoffmann, M. R.; Colussi, A. J. Proton availability at the air/water interface. J. Phys. Chem. Lett. 2010, 1 (10), 1599-1604.
(39) Enami, S.; Stewart, L. A.; Hoffmann, M. R.; Colussi, A. J. Superacid chemistry on mildly acidic water. J. Phys Chem. Lett. 2010, 1 (24), 3488-3493.
(40) Conway, B. E.; Tilak, B. V. Interfacial processes involving electrocatalytic evolution and oxidation of H-2, and the role of chemisorbed H. Electrochim. Acta 2002, 47 (22□23), 3571-3594.
(41) Tilak, B. V.; Conway, B. E. Overpotential decay behavior 0.1. Complex electrode-reactions involving adsorption. Electrochim. Acta 1976, 21 (10), 745-752.
(42) Wardman, P. Reduction potentials of one-electron couples involving free-radicals in aqueous-solution. J. Phys. Chem. Ref. Data 1989, 18 (4), 1637-1755.
(43) Kotz, R.; Stucki, S.; Carcer, B. Electrochemical waste-water treatment using high overvoltage anodes 0.1. Physical and electrochemical properties of SnO2 anodes. J. Appl. Electrochem. 1991, 21 (1), 14-20.
(44) Stucki, S.; Kotz, R.; Career, B.; Suter, W. Electrochemical wastewater treatment using high overvoltage anodes 0.2. Anode performance and applications. J. Appl. Electrochem. 1991, 21 (2), 99-104.
(45) Fan, Y. W.; Goldsmith, B. R.; Collins, P. G. Identifying and counting point defects in carbon nanotubes. Nat. Mater. 2005, 4 (12), 906-911.
(46) Cho, H. H.; Smith, B. A.; Wnuk, J. D.; Fairbrother, D. H.; Ball, W. P. Influence of surface oxides on the adsorption of naphthalene onto multiwalled carbon nanotubes. Environ. Sci. Technol. 2008, 42 (8), 2899-2905.
(47) Yang, K.; Wu, W. H.; Jing, Q. F.; Jiang, W.; Xing, B. S. Competitive adsorption of naphthalene with 2,4-dichlorophenol and 4-chloroaniline on multiwalled carbon nanotubes. Environ. Sci. Technol. 2010, 44 (8), 3021-3027.
(48) Iniesta, J.; Michaud, P. A.; Panizza, M.; Cerisola, G.; Aldaz, A.; Comninellis, C. Electrochemical oxidation of phenol at boron-doped diamond electrode. Electrochim. Acta 2001, 46 (23), 3573-3578.
(49) Mrowetz, M.; Balcerski, W.; Colussi, A. J.; Hoffmann, M. R. Oxidative power of nitrogen-doped TiO2 photocatalysts under visible illumination. J. Phys. Chem. B 2004, 108 (45), 17269-17273.
(50) Park, H.; Vecitis, C. D.; Choi, W.; Weres, O.; Hoffmann, M. R. Solar-powered production of molecular hydrogen from water. J. Phys. Chem. C 2008, 112 (4), 885-889.

### REFERENCES FOR EXAMPLE 13

1. Cheng, I. F.; Fernando, Q.; Korte, N., Electrochemical dechlorination of 4-chlorophenol to phenol. Environmental Science & Technology 1997, 31, (4), 1074-1078.
2. Pelegrini, R. T.; Freire, R. S.; Duran, N.; Bertazzoli, R., Photoassisted electrochemical degradation of organic pollutants on a DSA type oxide electrode: Process test for a phenol synthetic solution and its application for the El bleach kraft mill effluent. Environmental Science & Technology 2001, 35, (13), 2849-2853.
3. Wu, Z. C.; Zhou, M. H., Partial degradation of phenol by advanced electrochemical oxidation process. Environmental Science & Technology 2001, 35, (13), 2698-2703.
4. Hu, B. X.; Chen, C. H.; Frueh, S. J.; Jin, L.; Joesten, R.; Suib, S. L., Removal of Aqueous Phenol by Adsorption and Oxidation with Doped Hydrophobic Cryptomelane-Type Manganese Oxide (K-OMS-2) Nanofibers. Journal of Physical Chemistry C 2010, 114, (21), 9835-9844.
5. Esplugas, S.; Gimenez, J.; Contreras, S.; Pascual, E.; Rodriguez, M., Comparison of different advanced oxidation processes for phenol degradation. Water Research 2002, 36, (4), 1034-1042.
6. Santos, A.; Yustos, P.; Durban, B.; Garcia-Ochoa, F., Catalytic wet oxidation of phenol: Kinetics of phenol uptake. Environmental Science & Technology 2001, 35, (13), 2828-2835.
7. Santos, A.; Yustos, P.; Quintanilla, A.; Garcia-Ochoa, F.; Casas, J. A.; Rodriguez, J. J., Evolution of toxicity upon wet catalytic oxidation of phenol. Environmental Science & Technology 2004, 38, (1), 133-138.
8. Carriazo, J.; Guelou, E.; Barrault, J.; Tatibouet, J. M.; Molina, R.; Moreno, S., Catalytic wet peroxide oxidation of phenol by pillared clays containing Al—Ce—Fe. Water Research 2005, 39, (16), 3891-3899.
9. Lin, S. S.; Chen, C. L.; Chang, D. J.; Chen, C. C., Catalytic wet air oxidation of phenol by various CeO2 catalysts. Water Research 2002, 36, (12), 3009-3014.
10. Canizares, P.; Lobato, J.; Garcia-Gomez, J.; Rodrigo, M. A., Combined adsorption and electrochemical processes for the treatment of acidic aqueous phenol wastes. Journal of Applied Electrochemistry 2004, 34, (1), 111-117.
11. Krawczyk, P.; Skowronski, J. M., Modification of expanded graphite resulting in enhancement of electrochemical activity in the process of phenol oxidation. Journal of Applied Electrochemistry 2010, 40, (1), 91-98.
12. Weiss, E.; Groenen-Serrano, K.; Savall, A., A comparison of electrochemical degradation of phenol on boron doped diamond and lead dioxide anodes. Journal of Applied Electrochemistry 2008, 38, (3), 329-337.
13. Li, X. Y.; Cui, Y. H.; Feng, Y. J.; Xie, Z. M.; Gu, J. D., Reaction pathways and mechanisms of the electrochemical degradation of phenol on different electrodes. Water Research 2005, 39, (10), 1972-1981.
14. Tahar, N. B.; Savall, A., Electrochemical removal of phenol in alkaline solution. Contribution of the anodic polymerization on different electrode materials. Electrochimica Acta 2009, 54, (21), 4809-4816.
15. Tahar, N. B.; Abdelhedi, R.; Savall, A., Electrochemical polymerisation of phenol in aqueous solution on a Ta/PbO(2) anode. Journal of Applied Electrochemistry 2009, 39, (5), 663-669.
16. Finklea, H. O.; Snider, D. A.; Fedyk, J., Passivation of Pinholes in Octadecanethiol Monolayers on Gold Electrodes by Electrochemical Polymerization of Phenol. Langmuir 1990, 6, (2), 371-376.
17. Gattrell, M.; Kirk, D. W., A Study of Electrode Passivation during Aqueous Phenol Electrolysis. Journal of the Electrochemical Society 1993, 140, (4), 903-911.
18. Brady-Estevez, A. S.; Schnoor, M. H.; Vecitis, C. D.; Saleh, N. B.; Ehmelech, M., Multiwalled Carbon Nanotube Filter: Improving Viral Removal at Low Pressure. Langmuir 26, (18), 14975-14982.
19. Gao, G.; Vecitis, C. D., Electrochemical Carbon Nanotube Filter Oxidative Performance as a Function of Surface Chemistry. Environmental Science & Technology 45, (22), 9726-9734.
20. Tiraferri, A.; Vecitis, C. D.; Elimelech, M., Covalent Binding of Single-Walled Carbon Nanotubes to Polyamide Membranes for Antimicrobial Surface Properties. ACS Appl. Mater. Interfaces 3, (8), 2869-2877.
21. Vecitis, C. D.; Gao, G. D.; Liu, H., Electrochemical Carbon Nanotube Filter for Adsorption, Desorption, and Oxidation of Aqueous Dyes and Anions. Journal of Physical Chemistry C 115, (9), 3621-3629.
22. Vecitis, C. D.; Schnoor, M. H.; Rahaman, M. S.; Schiffman, J. D.; Elimelech, M., Electrochemical Multiwalled Carbon Nanotube Filter for Viral and Bacterial Removal and Inactivation. Environmental Science & Technology 45, (8), 3672-3679.
23. Vecitis, C. D.; Zodrow, K. R.; Kang, S.; Elimelech, M., Electronic-Structure-Dependent Bacterial Cytotoxicity of Single-Walled Carbon Nanotubes. ACS Nano 4, (9), 5471-5479.
24. Rauscher, A.; Kutsan, G.; Lukacs, Z., Effects of Hydrogen-Sulfide and Temperature on Passivation Behavior of Titanium. Corrosion Science 1990, 31, 255-260.
25. Fokin, M. N.; Danilov, A. M.; Timonin, V. A., Measurement of Coulombs Consumed in Formation of Oxide Film during Passivation of Titanium. Doklady Akademii Nauk Sssr 1964, 158, (3), 702-&.
26. Frayret, J. P.; Caprani, A., Anodic Behavior of Titanium in Acidic Chloride Containing Media (Hcl-Nacl)—Influence of the Constituents of the Medium 0.3. Analysis of the Electrochemical Impedance—General Dissolution-Passivation Mechanism. Electrochimica Acta 1982, 27, (3), 391-399.
27. Dafonseca, C.; Boudin, S.; Belo, M. D., Characterization of Titanium Passivation Films by in-Situ Ac-Impedance Measurements and Xps Analysis. Journal of Electroanalytical Chemistry 1994, 379, (1-2), 173-180.
28. Frayret, C.; Botella, P.; Jaszay, T.; Delville, M. H., Titanium dissolution-passivation in highly chloridic and oxygenated aqueous solutions—Reaction mechanism extended to supercritical water conditions. Journal of the Electrochemical Society 2004, 151, (10), B543-B550.
29. Kelly, E. J., Anodic-Dissolution and Passivation of Titanium in Acidic Media 0.3. Chloride Solutions. Journal of the Electrochemical Society 1979, 126, (12), 2064-2075.
30. Comninellis, C.; Pulgarin, C., Electrochemical Oxidation of Phenol for Waste-Water Treatment Using Sno2 Anodes. Journal of Applied Electrochemistry 1993, 23, (2), 108-112.
31. Enache, T. A.; Oliveira-Brett, A. M., Phenol and para-substituted phenols electrochemical oxidation pathways. Journal of Electroanalytical Chemistry 2011, 655, (1), 9-16.
32. Canizares, P.; Martinez, F.; Diaz, M.; Garcia-Gomez, J.; Rodrigo, M. A., Electrochemical oxidation of aqueous phenol wastes using active and nonactive electrodes. Journal of the Electrochemical Society 2002, 149, (8), D118-D124.
33. Hagans, P. L.; Natishan, P. M.; Stoner, B. R.; O'Grady, W. E., Electrochemical oxidation of phenol using boron-doped diamond electrodes. Journal of the Electrochemical Society 2001, 148, (7), E298-E301.
34. Sharifian, H.; Kirk, D. W., Electrochemical Oxidation of Phenol. Journal of the Electrochemical Society 1986, 133, (5), 921-924.
35. Tahar, N. B.; Savall, A., Mechanistic aspects of phenol electrochemical degradation by oxidation on a Ta/PbO2 anode. Journal of the Electrochemical Society 1998, 145, (10), 3427-3434.
36. Polcaro, A. M.; Vacca, A.; Palmas, S.; Masciaaa, M., Electrochemical treatment of wastewater containing phenolic compounds: oxidation at boron-doped diamond electrodes. Journal of Applied Electrochemistry 2003, 33, (10), 885-892.

### REFERENCES FOR EXAMPLE 14

(1) Bard, A. J.; Faulkner, L. R., Electrochemical methods: Fundamentals and applications. 2nd ed.; John Wiley & Sons: New York, 2001; p 833.
(2) Yang, J.; Wang, J.; Jia, J. P., Environ. Sci. Technol. 2009, 43 (10), 3796-3802.
(3) Martinez-Huitle, C. A.; Brillas, E., Angew. Chem.-Int. Edit. 2008, 47 (11), 1998-2005.
(4) Panizza, M.; Cerisola, G., Chem. Rev. 2009, 109 (12), 6541-6569.
(5) Park, H.; Vecitis, C. D.; Choi, W.; Weres, O.; Hoffmann, M. R., J. Phys. Chem. C 2008, 112 (4), 885-889.
(6) Gao, G.; Vecitis, C. D., Environ. Sci. Technol. 2011, 45 (22), 9726-9734.
(7) Li, J.; Cassell, A.; Delzeit, L.; Han, J.; Meyyappan, M., J. Phys. Chem. B 2002, 106 (36), 9299-9305.
(8) Tong, X. L.; Zhao, G. H.; Liu, M. C.; Cao, T. C.; Liu, L.; Li, P. Q., J. Phys. Chem. C 2009, 113 (31), 13787-13792.
(9) Vecitis, C. D.; Schnoor, M. H.; Rahaman, M. S.; Schiffman, J. D.; Elimelech, M., Environ. Sci. Tech. 2011, 45 (8), 3672-3679.
(10) Hu, Y. S.; Adelhelm, P.; Smarsly, B. M.; Hore, S.; Antonietti, M.; Maier, J., Adv. Funct. Mater. 2007, 17 (12), 1873-1878.
(11) Brady-Estevez, A. S.; Schnoor, M. H.; Vecitis, C. D.; Saleh, N. B.; Elimelech, M., Langmuir 2010, 14975-14982.
(12) Vecitis, C. D.; Gao, G. D.; Liu, H., J. Phys. Chem. C 2011, 115 (9), 3621-3629.
(13) Bandow, S.; Numao, S.; Iijima, S., J. Phys. Chem. C 2007, 111 (32), 11763-11766.
(14) Carroll, D. L.; Redlich, P.; Blase, X.; Charlier, J. C.; Curran, S.; Ajayan, P. M.; Roth, S.; Ruhle, M., Phys. Rev. Lett. 1998, 81 (11), 2332-2335.
(15) Czerw, R.; Terrones, M.; Charlier, J. C.; Blase, X.; Foley, B.; Kamalakaran, R.; Grobert, N.; Terrones, H.; Tekleab, D.; Ajayan, P. M.; Blau, W.; Ruhle, M.; Carroll, D. L., Nano Lett. 2001, 1 (9), 457-460.
(16) Mukhopadhyay, I.; Hoshino, N.; Kawasaki, S.; Okino, F.; Hsu, W. K.; Touhara, H., J. Electrochem. Soc. 2002, 149 (1), A39-A44.
(17) Wiggins-Camacho, J. D.; Stevenson, K. J., J. Phys. Chem. C 2009, 113 (44), 19082-19090.
(18) Barone, V.; Peralta, J. E.; Uddin, J.; Scuseria, G. E., J. Chem. Phys. 2006, 124 (2), 1-5.
(19) Lee, J. M.; Park, J. S.; Lee, S. H.; Kim, H.; Yoo, S.; Kim, S. O., Adv. Mater. 2011, 23 (5), 629-631.
(20) Wang, R. X.; Zhang, D. J.; Zhang, Y. M.; Liu, C. B., J. Phys. Chem. B 2006, 110 (37), 18267-18271.
(21) Deng, C. Y.; Chen, J. H.; Chen, X. L.; Mao, C. H.; Nie, L. H.; Yao, S. Z., Biosens. Bioelectron. 2008, 23 (8), 1272-1277.
(22) Maldonado, S.; Morin, S.; Stevenson, K. J., Carbon 2006, 44 (8), 1429-1437. (23) Alexeyeva, N.; Shulga, E.; Kisand, V.; Kink, I.; Tammeveski, K., J. Electroanal. Chem. 2010, 648 (2), 169-175.
(24) Kim, U. J.; Furtado, C. A.; Liu, X. M.; Chen, G. G.; Eklund, P. C., J. Am. Chem. Soc. 2005, 127 (44), 15437-15445.
(25) Redlich, P.; Loeffler, J.; Ajayan, P. M.; Bill, J.; Aldinger, F.; Ruhle, M., Chem. Phys. Lett. 1996, 260 (3-4), 465-470.
(26) Cho, H. H.; Smith, B. A.; Wnuk, J. D.; Fairbrother, D. H.; Ball, W. P., Environ. Sci. Technol. 2008, 42 (8), 2899-2905.
(27) Pan, B.; Xing, B. S., Environ. Sci. Technol. 2008, 42 (24), 9005-9013.
(28) Ohnuki, Y.; Matsuda, H.; Ohsaka, T.; Oyama, N., J. Electroanal. Chem. 1983, 158 (1), 55-67.
(29) Comninellis, C.; Pulgarin, C., J. Appl. Electrochem. 1991, 21 (8), 703-708.
(30) Iniesta, J.; Michaud, P. A.; Panizza, M.; Cerisola, G.; Aldaz, A.; Comninellis, C., Electrochim. Acta 2001, 46 (23), 3573-3578.
(31) Mengoli, G.; Musiani, M. M., Electrochim. Acta 1986, 31 (2), 201-210. (32) Wardman, P., J. Phys. Chem. Ref Data 1989, 18 (4), 1637-1755.
(33) Park, H.; Vecitis, C. D.; Hoffmann, M. R., J. Phys. Chem. C 2009, 113 (18), 7935-7945.
(34) Datsyuk, V.; Kalyva, M.; Papagelis, K.; Parthenios, J.; Tasis, D.; Siokou, A.; Kallitsis, I.; Galiotis, C., Carbon 2008, 46 (6), 833-840.
(35) Neta, P.; Huie, R. E.; Ross, A. B., J. Phys. Chem. Ref Data 1988, 17 (3), 1027-1284.
(36) Lim, M.; Han, G. C.; Ahn, J. W.; You, K. S., Int. J. Environ. Res. Public Health 2010, 7 (1), 203-228.
(37) CRC Handbook of Chemistry and Physics. 91 ed.; CRC Press: Boca Raton, 2011.

### REFERENCES FOR EXAMPLE 15

(1) Iijima, S, Nature 1991, 354 (6348), 56-58.
(2) Guldi, D. M.; Rahman, G. M. A.; Sgobba, V.; Kotov, N. A.; Bonifazi, D.; Prato, M. J. Am. Chem. Soc. 2006, 128 (7), 2315-2323.
(3) Sinha, N.; Yeow, J. T. W. IEEE Trans. Nanobiosci. 2005, 4 (2), 180-195.
(4) Lin, D. H.; Xing, B. S. Environ. Sci. Technol. 2008, 42 (19), 7254-7259.
(5) Girishkumar, G.; Vinodgopal, K.; Kamat, P. V. J. Phys. Chem. B 2004, 108 (52), 19960-19966.
(6) Hu, C. G.; Zhang, Y. Y.; Bao, G.; Zhang, Y. L.; Liu, M. L.; Wang, Z. L. J. Phys. Chem. B 2005, 109 (43), 20072-20076.
(7) Kundu, S.; Nagaiah, T. C.; Xia, W.; Wang, Y. M.; Van Dommele, S.; Bitter, J. H.; Santa, M.; Grundmeier, G.; Bron, M.; Schuhmann, W.; Muhler, M. J. Phys. Chem. C 2009, 113 (32), 14302-14310.
(8) Li, J.; Cassell, A.; Delzeit, L.; Han, J.; Meyyappan, M. J. Phys. Chem. B 2002, 106 (36), 9299-9305.
(9) Katz, E.; Willner, I. ChemPhysChem 2004, 5 (8), 1085-1104.
(10) Wang, J. X.; Li, M. X.; Shi, Z. J.; Li, N. Q.; Gu, Z. N. Electroanal. 2002, 14 (3), 225-230.
(11) Britto, P. J.; Santhanam, K. S. V.; Ajayan, P. M. Bioelectrochem. Bioenerg. 1996, 41 (1), 121-125.
(12) Vecitis, C. D.; Gao, G. D.; Liu, H. J. Phys. Chem. C 2011, 115 (9), 3621-3629.
(13) Wang, J.; Musameh, M. Anal. Chem. 2003, 75 (9), 2075-2079.
(14) Yang, J.; Wang, J.; Jia, J. P. Environ. Sci. Technol. 2009, 43 (10), 3796-3802.
(15) Rajeshwar, K.; Ibanez, J. G.; Swain, G. M. J. Appl. Electrochem. 1994, 24 (11), 1077-1091.
(16) Bard, A. J., Electrochemical methods: Fundamentals and application, 2nd ed.; John Wiley & Sons, Inc.: New York, 2001.
(17) Rodrigo, M. A.; Canizares, P.; Sanchez-Carretero, A.; Saez, C. Catal. Today 2010, 151 (1-2), 173-177.
(18) Tahar, N. B.; Savall, A. Electrochim. Acta 2009, 54 (21), 4809-4816.
(19) Panizza, M.; Cerisola, G. J. Hazard. Mater. 2008, 153 (1-2), 83-88.
(20) Vecitis, C. D. V. C. D.; Schnoor, M. H.; Rahaman, M. S.; Schiffman, J. D.; Elimelech, M. Environ. Sci. Technol. 2011, 45 (8), 3672-3679.
(21) Brett, C. M. A.; Brett, A. M. O.; Serrano, S. H. P. J. Electroanal. Chem. 1994, 366 (1-2), 225-231.
(22) Colmati, F.; Tremiliosi-Filho, G.; Gonzalez, E. R.; Berna, A.; Herrero, E.; Feliu, J. M. Faraday Discuss. 2008, 140, 379-397.
(23) Peigney, A.; Laurent, C.; Flahaut, E.; Bacsa, R. R.; Rousset, A. Carbon 2001, 39 (4), 507-514.
(24) Zhang, S. J.; Shao, T.; Kose, H. S.; Karanfil, T. Environ. Sci. Technol. 2010, 44 (16), 6377-6383.
(25) Hyung, H.; Kim, J. H. Environ. Sci. Technol. 2008, 42 (12), 4416-1121.
(26) Pan, B.; Xing, B. S. Environ. Sci. Technol. 2008, 42 (24), 9005-9013.
(27) Koep, E.; Compson, C.; Liu, M. L.; Zhou, Z. P. Solid State Ion. 2005, 176 (1-2), 1-8.
(28) Masheter, A. T.; Abiman, P.; Wildgoose, G. G.; Wong, E.; Xiao, L.; Rees, N. V.; Taylor, R.; Attard, G. A.; Baron, R. J. Mater. Chem. 2007, 17 (25), 2616-2626.
(29) Kim, Y. H.; Kim, T.; Ryu, J. H.; Yoo, Y. J. Biosens. Bioelectron. 2010, 25 (5), 1160-1165.
(30) Banks, C. E.; Davies, T. J.; Wildgoose, G. G.; Compton, R. G. Chem. Commun. 2005, 7, 829-841.
(31) Luo, H. X.; Shi, Z. J.; Li, N. Q.; Gu, Z. N.; Zhuang, Q. K. Anal. Chem. 2001, 73 (5), 915-920.
(32) Gao, G.; Vecitis, C. D. Environ. Sci. Technol. 2011, 45 (22), 9726-9734.
(33) Zhang, Y. F.; Bo, X. J.; Luhana, C.; Guo, L. P. Electrochim. Acta 2011, 56 (17), 5849-5854.
(34) Welch, T. W.; Corbett, A. H.; Thorp, H. H. J. Phys. Chem. 1995, 99 (30), 11757-11763.
(35) Levich, V. G., Physicochemical hydrodynamics; Prentice-Hall: Englewood Cliffs, N.J., 1962.
(36) Zhang, D. S.; Pan, C. S.; Shi, L. Y.; Mai, H. L.; Gao, X. H. Appl. Surf. Sci. 2009, 255 (9), 4907-4912.
(37) Bermejo, M. R.; Gomez, J.; Martinez, A. M.; Barrado, E.; Castrillejo, Y. Electrochim. Acta 2008, 53 (16), 5106-5112.
(38) H. Eyring, S. H. L., Lin, S. M., Basic chemical kinetics; Wiley: New York, 1980.
(39) Liu, H.; Deng, S. B.; Li, Z. J.; Yu, G.; Huang, J. J. Hazard. Mater. 2010, 179 (1-3), 424-430.
(40) Al-Johani, H.; Salam, M. A. J. Colloid Interface Sci. 2011, 360 (2), 760-767.
(41) Lide, D. R., CRC handbook of chemistry and physics, 85th ed.; CRC Press: Boca Raton, Fla., 2004.
(42) Liu, L.; Li, F. B.; Feng, C. H.; Li, X. Z. Appl. Microbiol. Biotechnol. 2009, 85 (1), 175-183.
(43) Mrowetz, M.; Balcerski, W.; Colussi, A. J.; Hoffmann, M. R. J. Phys. Chem. B 2004, 108 (45), 17269-17273.
(44) Aider, M.; Arul, J.; Mateescu, A. M.; Brunet, S.; Bazinet, L. J. Agric. Food Chem. 2006, 54 (17), 6352-6357.
(45) Chen, L. C.; Chou, T. C. Ind. Eng. Chem. Res. 1993, 32 (7), 1520-1527.

### REFERENCES FOR EXAMPLE 16

(1) Bard, A. J., Electrochemical methods: Fundamentals and application. 2nd ed.; John Wiley & Sons, Inc.: 2001.
(2) Rodrigo, M. A.; Canizares, P.; Sanchez-Carretero, A.; Saez, C., Use of conductive-diamond electrochemical oxidation for wastewater treatment. 2010, 151 (1-2), 173-177.
(3) Tahar, N. B.; Savall, A., Electrochemical removal of phenol in alkaline solution. Contribution of the anodic polymerization on different electrode materials. Electrochim. Acta 2009, 54 (21), 4809-4816.
(4) Panizza, M.; Cerisola, G., Removal of colour and cod from wastewater containing acid blue 22 by electrochemical oxidation. J. Hazard. Mater. 2008, 153 (1-2), 83-88.
(5) Iijima, S., Helical microtubules of graphitic carbon. Nature 1991, 354 (6348), 56-58.
(6) Guldi, D. M.; Rahman, G. M. A.; Sgobba, V.; Kotov, N. A.; Bonifazi, D.; Prato, M., Cnt-cdte versatile donor-acceptor nanohybrids. J. Am. Chem. Soc. 2006, 128 (7), 2315-2323.
(7) Sinha, N.; Yeow, J. T. W., Carbon nanotubes for biomedical applications. IEEE Trans. Nanobiosci. 2005, 4 (2), 180-195.
(8) Lin, D. H.; Xing, B. S., Adsorption of phenolic compounds by carbon nanotubes: Role of aromaticity and substitution of hydroxyl groups. Environ. Sci. Technol. 2008, 42 (19), 7254-7259.
(9) Girishkumar, G.; Vinodgopal, K.; Kamat, P. V., Carbon nanostructures in portable fuel cells: Single-walled carbon nanotube electrodes for methanol oxidation and oxygen reduction. J. Phys. Chem. B 2004, 108 (52), 19960-19966.
(10) Hu, C. G.; Zhang, Y. Y.; Bao, G.; Zhang, Y. L.; Liu, M. L.; Wang, Z. L., DNA functionalized single-walled carbon nanotubes for electrochemical detection. J. Phys. Chem. B 2005, 109 (43), 20072-20076.
(11) Kundu, S.; Nagaiah, T. C.; Xia, W.; Wang, Y. M.; Van Dommele, S.; Bitter, J. H.; Santa, M.; Grundmeier, G.; Bron, M.; Schuhmann, W.; Muhler, M., Electrocatalytic activity and stability of nitrogen-containing carbon nanotubes in the oxygen reduction reaction. J. Phys. Chem. C 2009, 113 (32), 14302-14310.
(12) Li, J.; Cassell, A.; Delzeit, L.; Han, J.; Meyyappan, M., Novel three-dimensional electrodes: Electrochemical properties of carbon nanotube ensembles. 2002, 106 (36), 9299-9305.
(13) Vecitis, C. D. V. C. D.; Schnoor, M. H.; Rahaman, M. S.; Schiffman, J. D.; Elimelech, M., Electrochemical multiwalled carbon nanotube filter for viral and bacterial removal and inactivation. 2011, 45 (8), 3672-3679.
(14) Vecitis, C. D.; Gao, G. D.; Liu, H., Electrochemical carbon nanotube filter for adsorption, desorption, and oxidation of aqueous dyes and anions. J. Phys. Chem. C 2011, 115 (9), 3621-3629.
(15) Zhang, D.; Deutschmann, O.; Seidel, Y. E.; Behm, R. J., Interaction of mass transport and reaction kinetics during electrocatalytic co oxidation in a thin-layer flow cell. 2011, 115 (2), 468-478.

It is understood that the foregoing detailed description and example are illustrative only and are not to be taken as limitations upon the scope of the invention. Various changes and modifications to the disclosed embodiments, which will be apparent to those of skill in the art, may be made without departing from the spirit and scope of the present invention. Further, all patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A filtration apparatus, comprising:
a housing forming a chamber, the chamber including an inlet for receiving an input fluid and an outlet for releasing an output fluid;
a porous carbon nanotube filter material positioned between the inlet and the outlet, wherein at least a portion of the porous carbon nanotube filter material is in contact with a first conducting material; and
a second conducting material positioned between the inlet and the outlet.

2. The filtration apparatus of claim 1, wherein the housing has at least two openings for a first and a second conducting leads, wherein the first conducting lead contacts the first conducting material and the second conducting lead contacts the second conducting material.

3. The filtration apparatus of claim 1, wherein the second conducting material and the first conducting material are spaced apart.

4. The filtration apparatus of claim 1, wherein the second conducting material and the porous carbon nanotube filter material are spaced apart.

5. The filtration apparatus of claim 1, wherein the first conducting material includes titanium.

6. The filtration apparatus of claim 1, wherein the second conducting material includes stainless steel.

7. The filtration apparatus of claim 1, wherein the first conducting material is connected to a positive pole of a voltage source and the second conducting material is connected to a negative pole of a voltage source during filtration.

8. The filtration apparatus of claim 1, wherein the carbon nanotube filter material includes a network of carbon nanotubes.

9. The filtration apparatus of claim 8 wherein the network of carbon nanotubes comprises undoped carbon nanotubes, nitrogen-doped carbon nanotubes, boron-doped carbon nanotubes, fluorine-doped carbon nanotubes or any combinations thereof.

10. The filtration apparatus of claim 9, wherein the carbon nanotubes are multi-walled carbon nanotubes.

11. The filtration apparatus of claim 10, wherein at least a portion of the carbon nanotubes are modified by at least one processing treatment.

12. The filtration apparatus of claim 11, wherein said at least one processing treatment is selected from a group consisting of calcination, acid treatment, polymer coating, addition of an electrocatalyst, addition of at least one functional group, and any combinations thereof.

13. The filtration apparatus of claim 1, wherein the carbon nanotube filter material has an average pore size of at least about 0.5 nm.

14. The filtration apparatus of claim 1, further comprises a vent to release gas accumulated within the chamber during a filtration process.

15. A method for reducing at least one contaminant in an aqueous fluid, the method comprising:
providing at least one filtration apparatus, wherein said at least one filtration apparatus comprises:
a housing forming a chamber, the chamber including an inlet for receiving an input fluid and an outlet for releasing an output fluid;
a porous carbon nanotube filter material positioned between the inlet and the outlet, wherein at least a portion of the porous carbon nanotube filter material is in contact with a first conducting material; and
a second conducting material positioned between the inlet and the outlet;
connecting the first conducting material to a positive pole of a voltage source;
connecting the second conducting material to a negative pole of the voltage source;
applying a voltage from the voltage source;
flowing the aqueous fluid through the porous carbon nanotube filter material from the inlet of the filtration apparatus, wherein the porous carbon nanotube filter material separates the at least one contaminant from the aqueous fluid; and
collecting the output fluid from the outlet of the filtration apparatus, thereby reducing the at least one contaminant from the aqueous fluid.

16. The method of claim 15, wherein the aqueous fluid includes an electrolyte.

17. The method of claim 15, wherein the aqueous fluid includes the at least one contaminant selected from organic molecules, ions, biological microorganisms, or a combination thereof.

18. The method of claim 15, wherein the aqueous fluid comprises a biological fluid.

19. The method of claim 15, wherein the voltage generated by the voltage source is not greater than 10 volts.

20. The method of claim 15, further comprising regenerating at least the first conducting material of the filtration apparatus or the carbon nanotube filter material.

21. The method of claim 20, wherein the first conducting material of the filtration apparatus is regenerated by polishing a surface of the first conducting material.

22. The method of claim 20, wherein the carbon nanotube filter material of the filtration apparatus is regenerated by contacting the carbon nanotube filter material with an organic solvent or with an acid, or calcination or any combinations thereof.

23. The method of claim 15, wherein the first conducting material includes titanium.

24. The method of claim 15, wherein the second conducting material includes stainless steel.

25. The method of claim 18, wherein at least one biological contaminant of the biological fluid becomes inactivated by the applied voltage.

26. The method of claim 1, wherein the porous carbon nanotube filter material is a composite of two or more layers of the carbon nanotube filter materials.

27. A method for inactivating at least one biological contaminant in an aqueous fluid, the method comprising:
providing at least one filtration apparatus, wherein said at least one filtration apparatus comprises:
a housing forming a chamber, the chamber including an inlet for receiving an input fluid and an outlet for releasing an output fluid;
a porous carbon nanotube filter material positioned between the inlet and the outlet, wherein at least a portion of the porous carbon nanotube filter material is in contact with a first conducting material; and
a second conducting material positioned between the inlet and the outlet;
connecting the first conducting material to a positive pole of a voltage source;
connecting the second conducting material to a negative pole of the voltage source;
applying a voltage from the voltage source;
flowing the aqueous fluid through the porous carbon nanotube filter material from the inlet of the filtration apparatus, wherein said at least one biological contaminant in the aqueous fluid becomes inactivated by the applied voltage; and
collecting the output fluid from the outlet of the filtration apparatus, thereby inactivating said at least one biological contaminant in the aqueous fluid.

28. The method of claim 27, wherein the porous carbon nanotube filter material separates said at least one biological contaminant from the aqueous fluid, thus reducing the number of said at least one biological contaminant remained in the aqueous fluid.

29. The method of claim 27, wherein the aqueous fluid includes an electrolyte.

30. The method of claim 27, wherein the voltage generated by the voltage source is not greater than 10 volts.

31. The method of claim 27, wherein the aqueous fluid is a biological fluid.

32. The method of claim 31, wherein the biological fluid is selected from the group consisting of blood, lactation products, amniotic fluids, sputum, saliva, urine, semen, cerebrospinal fluid, bronchial aspirate, perspiration, mucus, liquefied feces, synovial fluid, lymphatic fluid, tears, tracheal aspirate, any fractions thereof, and any combinations thereof.

33. The method of claim 32, wherein the biological fluid is blood.

34. The method of claim 27, wherein the biological contaminant is selected from the group consisting of cells, viruses, bacteria, fungi, yeast, protozoan, parasites, disease-causing microorganisms, and any combinations thereof.
